(19) United States
(12) Patent Application Publication
(10) Pub. No.: US 2014/0370181 A1
(43) Pub. Date: Dec. 18, 2014

(54) COFFEE COMPOSITION FOR USE WITH A BEVERAGE UNIT AND METHODS OF USING THE SAME

(71) Applicant: The Folger Coffee Company, Orrville, OH (US)

(72) Inventors: Jerry Douglas Young, Medina, OH (US); Robert David Piotrowski, Medina, OH (US); Donald Lee Hughes, Akron, OH (US)

(73) Assignee: The Folger Coffee Company, Orrville, OH (US)

(21) Appl. No.: 14/213,349

(22) Filed: Mar. 14, 2014

Related U.S. Application Data
(60) Provisional application No. 61/793,567, filed on Mar. 15, 2013.

(51) Int. Cl. A23F 5/04; A23F 5/38; A23F 5/08

(52) U.S. Cl. CPC A23F 5/04; A23F 5/08; A23F 5/38
USPC 426/595; 426/466; 426/518; 426/507

(57) ABSTRACT

The present invention provides a coffee composition for use with a single serve beverage unit. The beverage unit consists of a container having a first structure to enable the introduction of a liquid such as hot water into the container to contact the coffee composition and a second structure to enable the release of a coffee extract out of the container. The coffee composition comprises various coffee ingredients demonstrating an improved property, or an improved balance between two or more of properties, selected from aroma, strength, flavor, cup color, acidity, density, extractability, bed permeability, brewing time, yield, structural integrity, quality consistence and uniformity, and cost-effectiveness. Methods of using such coffees are also disclosed.

### CROSS REFERENCE TO RELATED APPLICATIONS

This application claims benefit of U.S. provisional application No. 61/793,567, filed Mar. 15, 2013, herein incorporated by reference in its entirety.

### FIELD OF THE INVENTION

The present invention is related to coffee compositions for use with a beverage unit such as a cartridge, a capsule, and a pod, a method of making the same, and a method of using the same to prepare a beverage such as coffee.

### BACKGROUND OF THE INVENTION

Single serve brewing systems have been used by customers for more than a decade. The systems, which typically include a brewer device or machine and a beverage unit containing a single serving of a brew material, are designed to quickly brew a single cup of coffee, tea, hot chocolate, soup, or other hot food or beverage. Once the machine has warmed up, the user inserts the single-serving unit into the machine, places a mug under a spout, and presses the brew button. Within 20 to 90 seconds, the hot food or beverage is ready.

Such single serve brewing systems exhibit a few technical advantages, for example, the brewing operation is very user-friendly, fast, and convenient. When these systems are used to produce coffee, the coffee beverage is relatively fresh, because most of the single-serving units are sealed air tight and, consequently, the roast and ground coffee inside should not have experienced a significant loss of flavor. The seal is broken at the moment of brewing, when hot water wets the grounds and extracts the coffee.

However, many properties of the coffees used in these beverage units are far from satisfactory and need to be improved. Properties which could benefit from improvement may be those associated with the ready-to-drink coffee beverage produced using the single-serving unit, such as the beverage aroma, strength, flavor, cup color, yield, brewing time, and acidity; or they may be properties associated with the roast and ground coffee used in the single-serving unit, such as coffee density, extractability, bed permeability, bean quality, and roasting uniformity and consistency.

Advantageously, the present invention provides coffee compositions for use with a single-serve or multiple-serve beverage unit that improves one or more of the aforementioned properties, or improves the balance between two or more of the aforementioned properties.

### SUMMARY OF THE INVENTION

One aspect of the invention provides for a coffee composition for use in a beverage unit, wherein the beverage unit comprises a container having a first structure, to enable introduction of water into the container to contact the coffee composition; and a second structure, to enable release of a liquid coffee extract out of the container, wherein the liquid coffee extract is prepared by introducing water into the beverage unit containing the coffee composition.

Another aspect of the invention provides for a method of preparing a beverage using the above coffee composition contained within the beverage unit, which comprises (i) providing a beverage unit comprising a container and a coffee composition confined inside the container; (ii) introducing water into the container through a first structure of the container to contact the coffee composition; and (iii) releasing a liquid coffee extract out from the container through a second structure of the container.

### BRIEF DESCRIPTION OF THE DRAWINGS

Aspects of the invention are described with reference to the following drawings.

FIG. 1A is a side cross-sectional view of a beverage unit wherein a coffee composition such as an instant coffee composition is loaded and confined inside a beverage unit, which does not include a filter member.

FIG. 1B is a side cross-sectional view of a beverage unit wherein a coffee composition is loaded and confined inside a beverage unit, which includes a filter member.

FIG. 1C is a side cross-sectional view of another beverage unit wherein two coffee compositions are loaded and confined inside the beverage unit of FIG. 1B.

FIGS. 2 and 3 illustrate gas chromatograms for strength compounds including ethyl guaiacol in the first group of embodiments as exemplified by Examples 1-3.

FIGS. 4 and 5 illustrate gas chromatograms for burnt-rubbery compounds in the first group of embodiments as exemplified by Examples 1-3.

FIG. 6 illustrates a gas chromatogram for good flavor compounds in the first group of embodiments as exemplified by Examples 1-3.

FIG. 7 shows a typical drying curve for a typical blend of green coffee beans having an initial moisture content of 11% that are air-dried on a model 42200 Wenger belt dryer under 300 pound (136 kg) batch conditions in the first group of embodiments as exemplified by Examples 4-9, wherein the blend consists of equal parts Robusta, natural Arabica, and washed Arabica beans.

FIG. 8 is a perspective view of an example of mixed-moisture instant coffee flaked aggregates in the twelfth group of embodiments according to the present invention.

FIG. 9 is a perspective view of another example of mixed-moisture instant coffee flaked aggregates in the twelfth group of embodiments according to the present invention.

FIG. 10 an illustration of an instant coffee flake having an external planar face (2) polished to a high sheen in the thirteenth group of embodiments according to the present invention.

FIGS. 11 and 12 illustrate structured instant coffee particles, which are non-planar but which present a plurality of external planar faces exhibiting high sheen in the thirteenth group of embodiments according to the present invention.

FIG. 13 is a side view of a falling stream comprised of instant coffee flakes and densified instant coffee powder (8) being introduced to a jet of steam (9) in the thirteenth group of embodiments according to the present invention.

FIG. 14 is the perspective view of a beverage unit in an embodiment of the present invention, which may or may not include a filter member.

FIG. 14A is a side cross-sectional view of a beverage unit as shown in FIG. 14, which does not include a filter member.

FIG. 14B is a side cross-sectional view of a beverage unit as shown in FIG. 14, which includes a filter member.

FIG. 14C is a side cross-sectional view of another beverage unit as shown in FIG. 14, which includes a filter member.

FIG. 15 is the perspective view of a beverage unit in an embodiment of the present invention, which may or may not include a filter member.

FIG. 15A is a side cross-sectional view of a beverage unit as shown in FIG. 15, which does not include a filter member.

FIG. 15B is a side cross-sectional view of a beverage unit as shown in FIG. 15, which includes a filter member.

FIG. 15C is a side cross-sectional view of another beverage unit as shown in FIG. 15, which includes a filter member.

FIG. 16 is the perspective view of a beverage unit in an embodiment of the present invention, which may or may not include a filter member.

FIG. 16A is a side cross-sectional view of a beverage unit as shown in FIG. 16, which does not include a filter member.

FIG. 16B is a side cross-sectional view of a beverage unit as shown in FIG. 16, which includes a filter member.

FIG. 16C is a side cross-sectional view of another beverage unit as shown in FIG. 16, which includes a filter member.

FIG. 17 is the perspective view of a beverage unit in an embodiment of the present invention, which may or may not include a filter member.

FIG. 17A is a side cross-sectional view of a beverage unit as shown in FIG. 17, which does not include a filter member.

FIG. 17B is a side cross-sectional view of a beverage unit as shown in FIG. 17, which includes a filter member.

FIG. 17C is a side cross-sectional view of another beverage unit as shown in FIG. 17, which includes a filter member.

FIG. 18 is the perspective view of a beverage unit in an embodiment of the present invention, which may or may not include a filter member.

FIG. 18A is a side cross-sectional view of a beverage unit as shown in FIG. 18, which does not include a filter member.

FIG. 18B is a side cross-sectional view of a beverage unit as shown in FIG. 18, which includes a filter member.

FIG. 18C is a side cross-sectional view of another beverage unit as shown in FIG. 18, which includes a filter member.

FIG. 19 is the perspective view of a beverage unit in an embodiment of the present invention, which may or may not include a filter member.

FIG. 19A is a side cross-sectional view of a beverage unit as shown in FIG. 19, which does not include a filter member.

FIG. 19B is a side cross-sectional view of a beverage unit as shown in FIG. 19, which includes a filter member.

FIG. 20 is the perspective view of a beverage unit in an embodiment of the present invention, which includes a filter member.

FIG. 20A is a side cross-sectional view of a beverage unit as shown in FIG. 20.

FIG. 21 is the perspective view of a beverage unit in an embodiment of the present invention, which includes a filter member.

FIG. 21A is a side cross-sectional view of a beverage unit as shown in FIG. 21.

FIG. 22 is the perspective view of a beverage unit in an embodiment of the present invention, which includes a filter member.

FIG. 22A is a side cross-sectional view of a beverage unit as shown in FIG. 22.

FIG. 23 is the perspective view of a beverage unit in an embodiment of the present invention, which includes a filter member.

FIG. 23A is a side cross-sectional view of a beverage unit as shown in FIG. 23.

FIG. 24 is the perspective view of a beverage unit in an embodiment of the present invention, which may or may not include a filter member.

FIG. 24A is a side cross-sectional view of a beverage unit as shown in FIG. 24, which does not include a filter member.

FIG. 24B is a side cross-sectional view of a beverage unit as shown in FIG. 24, which includes a filter member.

FIG. 25 is the perspective view of a beverage unit in an embodiment of the present invention, which may or may not include a filter member.

FIG. 25A is a side cross-sectional view of a beverage unit as shown in FIG. 25, which does not include a filter member.

FIG. 25B is a side cross-sectional view of a beverage unit as shown in FIG. 25, which includes a filter member.

FIG. 26 is the perspective view of a beverage unit in an embodiment of the present invention, which may or may not include a filter member.

FIG. 26A is a side cross-sectional view of a beverage unit as shown in FIG. 26, which does not include a filter member.

FIG. 26B is a side cross-sectional view of a beverage unit as shown in FIG. 26, which includes a filter member.

FIG. 27 is the schematic diagram of an exemplary beverage-making system, which employs the various beverage units of the present invention to prepare a beverage.

### DETAILED DESCRIPTION OF THE INVENTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

### DEFINITIONS

As used herein, “beverage” refers to a liquid substance intended for drinking that is formed when a liquid interacts with a beverage material such the coffee composition of the present invention. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

To “brew” a beverage as used herein includes infusion, mixing, dissolving, steeping or otherwise forming a drinkable substance using water or other beverage precursor (e.g., flavored or otherwise treated water, or other liquid whether heated or not) with a beverage medium. Also, reference to “water” herein is to any suitable water formulation, e.g., filtered, deionized, softened, carbonated, etc., as well as any other suitable precursor liquid used to form a beverage, such as sweetened or flavored water, milk, etc.

“Instant coffee” refers to a flowable, particulate coffee product that has been made by evaporating water from the liquid extract of a roasted coffee, usually by concentration and drying. Typical drying means, such as spray drying and freeze drying are known in the art. An example of instant coffee production may be found in U.S. Pat. No. 3,700,466, which the entire disclosure is incorporated herein by reference.

### Processing of Coffee Beans

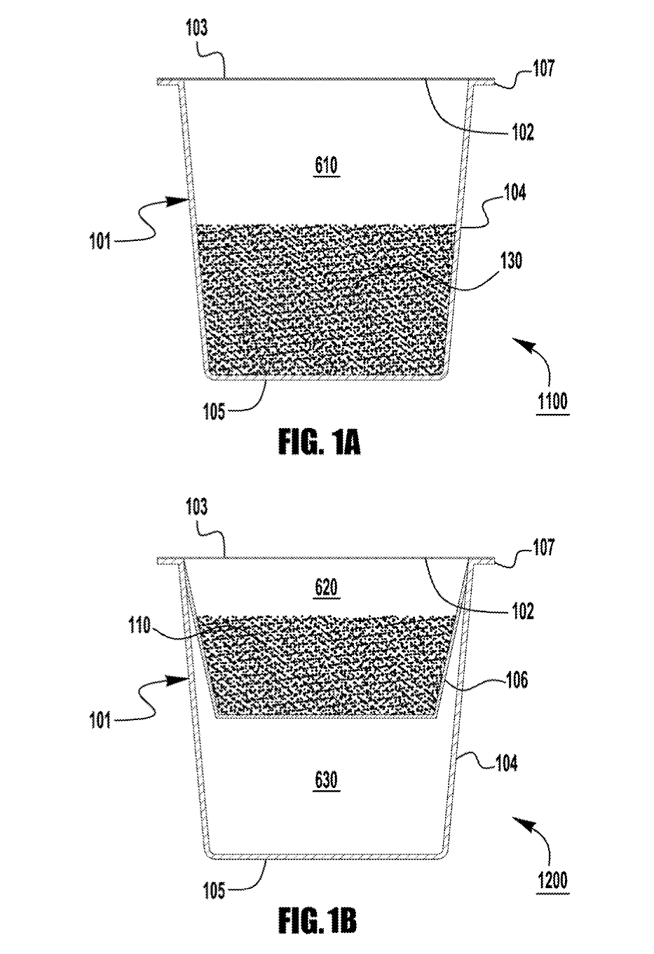

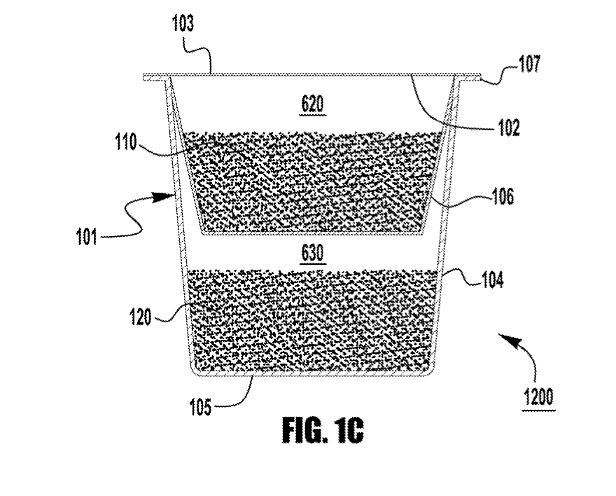

The coffee ingredient contained in the coffee composition 110/130 and beverage material 120 as shown in FIGS. 1A, 1B and 1C (as described in details in the “Beverage Unit” section of this application) may be independently from each other produced from any coffee beans or mixture thereof, either in their natural state or after being subject to various mechanical, physical, chemical, and/or biological treatments. Coffee beans are the seeds of “cherries” that grow on coffee trees in a narrow subtropical region around the world. There are many coffee varieties, however, it is generally recognized that there are two primary commercial coffee species: Coffea arabica (herein “Arabica(s)”) and Coffea canephora var. robusta (herein “Robusta(s)”). Coffees from the species arabica may be described as “Brazils,” which come from Brazil, or “Other Milds” which are grown in other premium coffee producing countries. Premium Arabica countries are generally recognized as including Colombia, Guatemala, Sumatra, Indonesia, Costa Rica, Mexico, united States (Hawaii), El Salvador, Peru, Kenya, Ethiopia and Jamaica. Coffees from the species canephora var. robusta are typically used as a low cost extender, as a body enhancer, or as a source of additional caffeine for Arabica coffees. These Robusta coffees are typically grown in the lower regions of West and Central Africa, India, South East Asia, Indonesia, and Brazil. See, US 2008/0118604, of which the disclosure is incorporated herein by reference.

When removed from the coffee cherry, coffee beans normally have a distinctly green color and high moisture content. In many embodiments of the invention, these beans are dried to a moisture content of e.g. about 12%. Historically, solar drying was the method of choice, although machine drying is now normally used due to the reliability and efficiency of the machine dryers available for this purpose. See, Sivetz et al., Coffee Technology, “Drying Green Coffee Beans”, pp. 112-169 (1979).

In the present invention, coffee beans may be dried differentially or equally, before they are subject to the roasting step. In the first group of embodiments, the coffee in the coffee composition 110/130 and beverage material 120 as shown in FIGS. 1A, 1B and 1C is made from green coffee beans that are dried differentially. Some coffee beans are pre-dried to a moisture content of from 0.5 to 7%. The drying is conducted at from 70° F. to 325° F. (21° C. to 163° C.) for from 1 minute to 24 hours. The dried green beans are fast roasted to a Hunter L-color of from 10-16. The dried roasted beans are blended with non-dried coffee beans roasted to a Hunter L-color of from 17-24 and having a moisture content before roasting of greater than about 7%. The blend contains from 1-50% of the dried dark roasted beans and from 50-99% of the non-dried roasted beans, giving a high-yield roasted coffee with balanced flavor. In the second group of embodiments, the coffee in the coffee composition 110/130 and beverage material 120 as shown in FIGS. 1A, 1B and 1C is made from green coffee beans that are dried substantially equally. These embodiments provide a process for preparing reduced density roast coffee beans. The process comprises predrying green coffee beans to a moisture content of from about 0.5% to about 10% by weight, fast roasting the beans, and cooling the roasted beans. The resulting roasted beans have a Hunter L-color of from about 14 to about 25, a Hunter ΔL-value is less than about 1.2 and a whole roast tamped bulk density of from about 0.28 to about 0.38 g/cc. The resulting roast coffee beans are more uniformly roasted than traditional reduced density coffee beans.

In connection to the background of the first group of embodiments, numerous attempts have been made in the past to make roasted coffee which has both an enhanced brew coffee yield (coffee brew solids per weight of roasted coffee) and an acceptable brewed flavor. The extractability of roasted coffee (the amount of brew solids that can be extracted from a given weight of coffee from which a coffee brew is made) can be increased by grinding the roasted coffee to finer particles sizes. These fine grinds, however, are physically difficult to brew. The fine particles are subject to pooling, channeling and compaction during brewing. Fine grinds also have an undesirable balance of flavor and strength. The extractability can also be enhanced by flaking roast and ground coffee. Flaking involves roll milling a roast and ground coffee. More coffee can be brewed from flaked coffee due to the increased extractability. However, the level of container aroma of flaked coffee needs to be further improved, and so does the balance of flavor and strength of flaked coffee. Fast roasting of coffee beans can also increase brew coffee yield. Roasting times affect product density and extractability. Fast roasted coffee, i.e., roast times less than about 5.5 minutes, is less dense than longer roasted coffee. Despite that fast roasted coffee provides an enhanced extractability, its balance of flavor and strength still needs to be improved.

The first group of embodiments can enhance extractability and brew coffee yield, but not at the expense of balanced flavor of the coffee brew, as exemplified in Examples 1-3. Green coffee beans are pre-dried, prior to roasting, to moisture content of from about 0.5 to about 7%. The drying is conducted at temperatures of from about 70° F. to about 325° F. (about 21° C. to about 163° C.) for from about 1 minute to about 24 hours. The dried coffee beans are fast roasted to an extreme Hunter L-color of from about 10 to about 16. The dried dark roasted coffee beans are blended with non-dried roasted coffee beans having moisture content before roasting of greater than about 7%. The blend comprises from about 1 about 50% of the dried dark roasted beans and from about 50 to about 99% of the non-dried roasted beans. The dried dark roasted beans provide strength with minimal burnt-rubbery flavor notes. The non-dried beans provide flavor and acidity. The resulting blend has a desirable balance of strength, flavor and acidity in a high-yield roasted coffee.

One aspect of the first group of embodiments provides for a coffee composition for use in a beverage unit and method thereof as defined in the Summary of the Invention, wherein the coffee composition comprises high-yield roasted coffee with balanced flavor made from a process comprising:

(a) drying green coffee beans prior to roasting to a moisture content of from about 0.5 to about 7% by weight, wherein the drying is conducted at a temperature of from about 21° C. to about 163° C. for from about 1 minute to about 24 hours;

(b) roasting the dried beans from drying step (a) at a temperature of from about 177° C. to about 649° C. for from about 10 seconds to about 5.5 minutes to a Hunter L-color of from about 10 to about 16; and

(c) blending the dried roasted beans from roasting step (b) with non-dried coffee beans roasted to a Hunter L-color of from about 17 to about 24 and having a moisture content before roasting of greater than about 7% by weight, wherein the blend comprises from about 1 to about 20% by weight of the dried roasted beans and from about 80 to about 99% by weight of the non-dried roasted beans; wherein the resulting roasted coffee blend has an improved brew yield of from about 30 to about 40%.

In more specific examples under this aspect, the dried roasted coffee beans from roasting step (b) may have a Hunter L-color of from about 12 to about 16. The blend of dried roasted coffee beans and non-dried roasted coffee beans from blending step (c) may comprise from about 5 to about 15% by weight of the dried roasted coffee beans and from about 85 to about 95% by weight of the non-dried roasted coffee beans. The dried green coffee beans in drying step (a) may be selected from the group consisting of low quality coffee beans, intermediate quality coffee beans and mixtures thereof, and the non-dried coffee beans in blending step (c) may be selected from the group consisting of intermediate quality coffee beans, high quality coffee beans and mixtures thereof. The dried green coffee beans in drying step (a) may be Robustas. The dried green coffee beans in roasting step (b) may be roasted at a temperature of from about 204° C. to about 427° C. for from about 1 to about 3 minutes. The drying in drying step (a) may be conducted at a temperature of from about 71° C. to about 121° C. for from about 1 to about 6 hours. The green coffee beans may be dried in drying step (a) to a moisture content of from about 3 to about 7% by weight. Moreover, the process may further comprise the steps of (i) flaking the blend of dried roasted and non-dried roasted coffee beans in blending step (c) to an average flake thickness of from about 102 to about 1016 um (e.g. from about 102 to about 254 um); (ii) blending the flaked coffee with roast and ground coffee, wherein the blend of flaked coffee and roast and ground coffee comprises from about 10 to about 50% (e.g. from about 25 to about 50%) by weight flaked coffee and from about 50 to about 90% (e.g. from about 50 to about 75%) by weight roast and ground coffee.

Another aspect of the first group of embodiments provides for a coffee composition for use in a beverage unit and method thereof as defined in the Summary of the Invention, wherein the coffee composition comprises a roasted coffee product including from about 1 to about 20% dark roasted coffee as the first component and from about 80 to about 99% coffee roasted to a Hunter L-color of from about 17 to about 24 and derived from green coffee beans having a moisture content prior to roasting of greater than about 7% as the second component, based on the total weight of the first component and the second component, wherein said dark roasted coffee is made by the process comprising:

(a)(i) drying green coffee beans prior to roasting to a moisture content of from about 0.5 to about 7% by weight, wherein the drying is conducted at a temperature of from about 21° C. to about 163° C. for from about 1 minute to about 24 hours; and

(a)(ii) roasting the dried beans from step (a)(i) at a temperature of from about 177° C. to about 649° C. for from about 10 seconds to about 5.5 minutes to a Hunter L-color of from about 10 to about 16;

wherein the roasted coffee product has an f(1) value greater than about 900, an f(2) value greater than about 1200, and an f(3) value greater than about 125, where

f(1)=10,000×[pyrazine+pyridine+pyrrole+guaiacol+ethyl guaiacol]/[3-thiazole+4-methylthiazole+peak 13+peak 14+peak 15+tetrahydrothiophene+peak 17+2-thiophenecarboxaldehyde+peak 19+3-acetylthiophene+2-acetylthiophene+peak 22],

f(2)=100×[ethyl guaiacol], and

f(3)=100×[ethanal+propanal+2-pentanone+3-pentanone+2,3-pentanedione]/[pyrazine+pyridine+pyrrole+guaiacol+ethyl guaiacol];

wherein the brewed acidity index is greater than about 2200, where brewed acidity index=1000×volume (ml) of 0.1 Normal sodium hydroxide added to 150 grams of coffee brew to adjust the pH of the brew to 7.00, and

wherein the roasted coffee product has an improved brew yield of from about 30 to about 100%.

In more specific examples under this aspect, the dried dark roasted coffee from (a) may have a Hunter L-color of from about 12 to about 16. The coffee product may comprise from about 5 to about 15% by weight of the dried roasted coffee from (a) and from about 85 to about 95% by weight of the non-dried roasted coffee from (b). The dried dark roasted coffee from (a) is derived from coffee beans selected from the group consisting of low quality coffee beans, intermediate quality coffee beans, and mixtures thereof, and the non-dried coffee from (b) is derived from coffee beans selected from the group consisting of high quality coffee, intermediate quality coffee, and mixtures thereof. The dark roasted coffee from (a) may be derived from Robusta beans. The roasting in step (a)(ii) may be conducted at a temperature of from about 204° to about 427° C. for from about 1 to about 3 minutes. The drying in step (a)(ii) may be conducted at a temperature of from about 71° to about 121° C. for from about 1 to about 6 hours. The green coffee beans may be dried in step (a)(ii) to a moisture content of from about 3 to about 7% by weight.

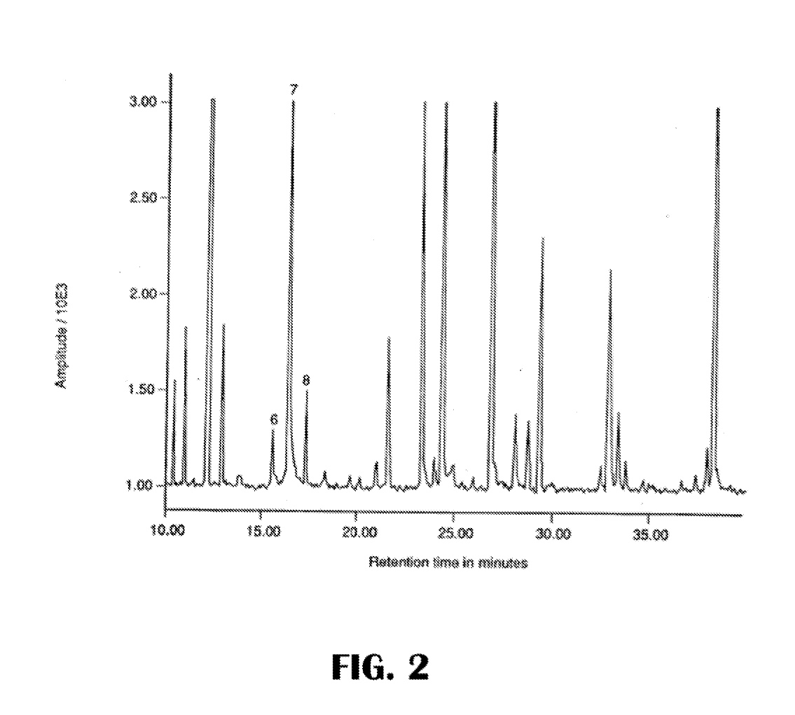

With respect to the first group of embodiments, as described above, as exemplified by Examples 1-3, and as illustrated in FIGS. 2-6, three steps are important. A first step involves drying green coffee beans. A second step involves fast roasting the dried beans to an extremely dark roast. A third step involves blending the dried dark roasted beans with roasted non-dried coffee beans.

The coffee product used in the first group of embodiments contains a unique and critical balance of strength and good flavor compounds and acidity.

As used in the first group of embodiments, all percentages and ratios are based on weight unless stated otherwise.

A) Drying Green Coffee Prior to Roasting in the First Group of Embodiments

In the drying step, green coffee beans having an initial moisture content greater than about 10%, preferably from about 10 to about 14%, are dried prior to roasting. The dried beans have a moisture content of less than about 7%, preferably from about 3 to about 7%.

The drying in the first group of embodiments should be conducted under gentle conditions. Large heat inputs and temperature differentials can result in tipping, burning or premature roast-related reactions of the coffee beans. The green beans are dried in an apparatus containing from 0 to 70% moisture. Drying temperatures are from about 70° F. to about 325° F. (about 21 C.° to about 163° C.), preferably from about 160 F.° to about 250° F. (about 71° C. to about 121° C.). Drying times are from about 1 minute to about 24 hours, preferably from about 2 to about 6 hours.

The drying step results in partially dehydrated coffee beans without causing significant roasting-related reactions to take place. Roasting reactions are described in Sivetz et al., “Coffee Technology”, AVI Publishing Company, Westport, Conn., pp. 250-262 (1979), herein incorporated by reference.

In the first group of embodiments, drying methods and apparatuses for use in the drying step are disclosed in U.S. Pat. No. 5,160,757 to Kirkpatrick et al., which is herein incorporated by reference.

After the coffee beans are dried, they are subjected to a roasting step described hereinafter. The coffee beans should have minimal contact, preferably no contact, with moisture between the drying and roasting steps.

B) Dark Roasting Dried Coffee Beans in the First Group of Embodiments

In the roasting step, the dried coffee beans are dark roasted to a Hunter L-color of from about 10 to about 16, preferably from about 12 to about 16, most preferably from about 14 to about 16. The dried dark roasted beans have tamped densities of from about 0.28 to about 0.42 grams/cc.

Conventional fast roasting methods can be used in the first group of embodiments. Roasting temperatures are from about 350° F. to about 1200° F. (about 177° C. to about 649° C.), preferably from about 400° F. to about 800° F. (about 204° C. to about 427° C.). Roast times are from about 10 seconds to about 5.5 minutes, preferably from about 1 to about 3 minutes. Fast roasting is described in U.S. Pat. No. 5,160,757 to Kirkpatrick et al. Fast roasting is also described in Sivetz, Coffee Technology, AVI Publishing Company, Westport, Conn., pp. 226-246 (1979), which is herein incorporated by reference.

At the desired Hunter L-color, the dark roasted beans are removed from the roaster heat. The beans are promptly cooled by typically ambient air and/or a water spray. Cooling the beans stops roast-related pyrolysis reactions.

In the first group of embodiments, roasting the dried beans to the darker Hunter L-colors develops strength compounds with minimal development of burnt-rubbery flavor compounds. The specific compounds are defined hereinafter. Dark roasting non-dried coffee beans, especially low quality beans such as Robustas, to these extremes would result in excessive burnt-rubbery flavor notes.

C) Blending Dried and Non-Dried Coffee Beans in the First Group of Embodiments

The dried dark roasted coffee beans are blended with non-dried roasted coffee beans. The dried beans provide strength with minimal burnt-rubbery flavor notes. The non-dried beans provide flavor and acidity. The blend comprises from about 1 to about 50%, preferably from about 1 to about 20%, most preferably from about 5 to about 15% of the dried beans and from about 50 to about 99%, preferably from about 80 to about 99%, most preferably from about 85 to about 95% of the non-dried beans.

The non-dried beans are derived from green coffee beans having moisture content prior to roasting of above about 7%, preferably from about 10 to about 14%. These green beans are not subjected to the drying step prior to roasting. The non-dried green coffee beans are roasted, preferably fast roasted, to a Hunter L-color of from about 17 to about 24. The non-dried roasted beans have tamped densities of from about 0.28 to about 0.42 grams/cc.

Both the dried and non-dried beans according to the first group of embodiments can be derived from low, intermediate or high quality coffee beans, or mixtures thereof. Preferably the dried beans are derived from intermediate or low quality beans or mixtures thereof, more preferably from low quality coffee beans, most preferably from Robustas. The non-dried beans are preferably derived from intermediate or high quality beans or mixtures thereof.

As used in the first group of embodiments, non-limiting examples of high quality coffee beans include “Milds” (high grade Arabicas) such as Colombians, Mexicans, and washed Milds such as strictly hard bean Costa Rica, Kenyas A and B, and strictly hard bean Guatemalans. As used in the first group of embodiments, non-limiting examples of intermediate quality coffee beans include Brazilians and African naturals. As used in the first group of embodiments, non-limiting examples of low quality coffee beans include Robustas, low grade Naturals, low grade Brazils, and low grade unwashed Arabicas.

It has been found that flavor strength in the coffee blends can be derived from relatively few coffee beans. In the blended coffee, the high-strength beans (dried dark roasted beans) preferably represent only from about 5 to about 15% of the blended beans. This small fraction of beans has a high f(1) value (ratio of strength compounds to burnt-rubbery compounds) and a low f(2) value (amount of good flavor compounds). These values are listed in Table 1 and described hereinafter.

Very small amounts of these dried dark roasted beans can now be added to weak but flavorful coffees (i.e., high quality coffee such as Colombian). The result is a flavorful, full-strength coffee unadulterated by excessive burnt-rubbery flavor notes.

D) Admixture of Flakes and Roast and Ground Coffee in the First Group of Embodiments

Optionally, the blend of roasted dried and non-dried coffee beans are ground, normalized and milled to an average flake thickness of from about 102 to about 1016 um (about 0.004 to about 0.04 inches), preferably from about 102 to about 508 um (about 0.004 to about 0.002 inches), most preferably from about 102 to about 254 um (about 0.004 to about 0.01 inches). Flaked coffees are described in: U.S. Pat. Nos. 5,064,676; 4,331,696; 4,267,200; 4,110,485; 3,660,106; 3,652,293; and 3,615,667, all of which are herein incorporated by reference.

Additionally, the flaked blend can be admixed with roast and ground coffee. The admixture comprises from about 10 to about 50%, preferably from about 25 to about 50% of the flaked blend and from about 50 to about 90%, preferably from about 50 to about 75% of the roast and ground coffee. The roast and ground coffee comprises the non-dried roasted beans, the dried roasted beans, or mixtures thereof, preferably the non-dried roasted beans.

It was found that thin flaking the dried dark roasted coffee beans, or blends containing the dried beans, results in a surprisingly dark cup color. Flaking increases brew solids by about 20% but increases cup color by about 40%. Cup color is important to consumer perceptions. Although cup color per se does not contribute to coffee flavor or strength, brewed coffee with darker colors are perceived as having richer, stronger flavors.

E) Characteristics of the Coffee Product in the First Group of Embodiments

The coffee product of the first group of embodiments has a unique chemistry profile. The unique chemistry provides a balanced flavor and a high yield.

1) Chemistry Profile

The chemistry profile of the coffee product is defined by f(1), f(2), and f(3) values wherein f(1) is greater than about 900, f(2) is greater than about 1200 and f(3) is greater than about 125. These values are determined as follows.

f(1)=10,000×[strength compounds]/[burnt-rubbery compounds]

f(2)=100×[ethyl guaiacol]

f(3)=100×[good flavor compounds]/[flavor strength compounds]

Strength compounds=[pyrazine+pyridine+pyrrole+guaiacol+ethyl guaiacol]

Burnt-rubbery compounds=[3-thiazol+4-methylthiazole+peak 13+peak 14+peak 15+tetrahydrothiophene+peak 17+2-thiophenecarboxaldehyde+peak 19+3-acetylthiophene+2-acetylthiophene+peak 22].

Good flavor compounds=[ethanal+propanal+2-pentanone+3-pentanone+2,3-pentanedione].

Individual compounds are measured in terms of total gas chromatograph (GC) counts. Methods for measuring GC counts for each of the three compound groups (strength, good flavor, burnt-rubbery) are described hereinafter. The unknown “peak” compounds are defined hereinafter.

The chemistry of the coffee product used in the first group of embodiments is unique when compared to conventional and/or dark roasted coffee. As shown in Table 1, only the coffee product has the critical combination of f(1), f(2) and f(3) values.

TABLE 1

| | Vacuum | Maxwell House | Chock Full of | French | Splendid Italian | Dried | Non-Dried | Blend of the Dried (10%) |
|---|---|---|---|---|---|---|---|---|
| Function | Folgers | Master Blend | Nuts Ultra-Roast | Roast | Expresso | Roasted Coffee | Roasted Coffee | and Non-Dried (90%) coffee |
| f(1) | 710 | 1000 | 870 | 940 | 1320 | 4300 | 700 | 1060 |
| f(2) | 770 | 835 | 1060 | 750 | 2140 | 7600 | 1000 | 1660 |
| f(3) | 310 | 150 | 210 | 220 | 50 | 95 | 200 | 190 |

The Table 1 coffees are defined as follows. These coffees can now all be used in the beverage units according to the present invention, for example, the first group of embodiments thereof. Vacuum Folgers is a 13 ounce, automatic drip grind (ADC) coffee manufactured by The Procter & Gamble Company, code date 2133N. Maxwell House Master Blend is an 11.5 ounce, ADC coffee manufactured by General Foods, code date 2054. Folgers French Roast is a 12 ounce, dark roast, ADC coffee made by The Procter & Gamble Company, code date 2106. Chock Full of Nuts Ultra Roast is an FAC (for all coffeemakers) coffee manufactured by Chock Full of Nuts Corp., code date 1N20. Splendid Italian Expresso is a 17.6 ounce, fine grind coffee manufactured by The Procter & Gamble Company, code date Mar90. The dried and non-dried coffees are the components of the 10:90 blend. The blend is a high-yield, balanced flavor coffee of the first group of embodiments.

2) Balanced Flavor Benefit

The chemistry profile of the coffee product in the first group of embodiments provides a balanced flavor to coffee brews. Other coffee products have from zero to two of the f(1), f(2) or f(3) values in the ranges recited herein. However, it is the combination of all three values at the recited levels that is important.

In the first group of embodiments, f(1) relates flavor strength to burnt-rubbery flavor. It is desirable to achieve a high f(1) value especially in high-yield coffee (i.e., low density, fast roasted coffee). High-yield coffees often have increased flavor strength and increased burnt-rubbery flavor. The coffee product in the first group of embodiments has increased flavor strength but only minimal increased burnt-rubbery flavors. The dried dark roasted beans provide this benefit to the coffee product.

In the first group of embodiments, f(2) relates to ethyl guaiacol levels. Ethyl guaiacol provides flavor strength. The high f(2) value indicates a selectively developed strength component from the dried roasted coffee beans.

In the first group of embodiments, f(3) relates good flavor to flavor strength. It is desirable to increase f(3) to develop a balance of good flavor with increased flavor strength. The good flavor arises from the non-dried roasted coffee beans. The flavor strength arises from the dried dark roasted coffee beans.

3) High Yield Benefit

It was found that the coffee product in the first group of embodiments has a surprisingly high yield. As used herein, “yield” means the weight in grams of a roasted coffee needed to brew one cup of coffee. Yields for various coffees are listed in Table 2.

TABLE 2

| | Weight of roasted coffee needed to |
|---|---|
| Coffee type (weight per 1000 cc | make one cup of brewed coffee |
| volume of roasted coffee) | (grams/cup) |
| Conventional roast and ground | |
| coffees: | |
| 16 ounce coffee | 5.16 |
| 13-ounce coffee* | 4.20 |
| 11.5-ounce coffee* | 3.71 |
| 10.5-ounce coffee* | 3.39 |
| High-yield coffee in the first group of | |
| embodiments: | |
| (13-ounce)* | 2.58 |

*fast roasted, low density coffee

The roasted coffee product of the first group of embodiments yields from about 30 to about 100% more brewed coffee. It also yields from about 30 to about 63% more brewed coffee than other low density, fast roasted coffee. The phrase “cup of brewed coffee” in Table 2 means coffee brews that, with respect to organoleptic properties, are similar to or better than that of conventionally brewed roast and ground coffee.

This high-yield coffee can be combined with soluble coffees or admixed with non-coffee materials. It can be caffeinated or decaffeinated. It can also be added to filter packs or used to manufacture soluble coffee.

4) Acidity

Brewed coffee from the coffee product has a brewed acidity index of above about 2200. The brewed acidity index described hereinafter is the expression of coffee acidity used herein. Brewed coffee with a brewed acidity index of less than about 2200 lacks the acidity, which is necessary for acceptable coffee flavor.

### Analytical Methods in the First Group of Embodiments

A) Analysis of Strength Compounds Including Ethyl Guaiacol

1) Analytical Method

The simultaneous steam distillation and extraction (SDE) method disclosed by Schultz et al., J. Agric. Food Chem. 25, 446-449 (1977), followed by capillary gas chromatography (CGC) of an SDE extract, is used to analyze the flavor strength compounds including ethyl quaiacol. The combined SDE-CGC method is disclosed in U.S. Pat. No. 4,857,351 to Neilson et al., issued Aug. 15, 1989, which is herein incorporated by reference.

An SDE extract (0.3 ml) is obtained from a roast and ground coffee by the SDE method described in U.S. Pat. No. 4,857,351. The extract is analyzed with a Hewlett-Packard 5880A Capillary Gas Chromatograph (HP-CGC). The HP-CGC has a fused silica column (DB5 column, 60 meter length, 0.32 mm internal column diameter, from J&W Scientific, Inc. of Cardova, Calif.) and a flame ionization detector (FID) to detect the carbon and hydrogen of the volatile compounds in the SDE extract. The column contains a film of crosslinked polyethylene glycols 1.0 um thick. A Hewlett-Packard Level Four data terminal is used to process the data for retention times, peak areas and area percents.

2) Application of the Analytical Method

Roast and ground coffee (5.0 grams) is placed in a 500 cc round bottom flask. Distilled water (200 grams) is added to the flask. Internal standard (3 ml) and boiling stones are added to the flask. The preferred internal standard is isoamyl acetate (5 mcl) dissolved in methylene chloride to make 100 ml. Contents of the flask are then processed into an SDE extract. The extract (3 mcl) is injected on to the column. The GC oven is maintained at 25° C. (77° F.) for 2.6 minutes. The oven temperature is raised 20° C./min. to 45° C. (113° F.) and then held for 7 minutes, raised again at 3.0° C./min. to 65° C. (149° F.) and then held for 6 minutes, raised again at 2.0° C./min. to 125° C. (257° F.) and held for 1 minute, raised again at 3.0° C./min. to 220° C. (428° F.) and held for 6 minutes, and finally raised to 230° C. (446° F.) and held for 30 minutes.

Conditions for the HP-CGC

| | | |
|---|---|---|
| Septum purge flow | 1 | cc/min. |
| Inlet pressure | 26 | psig |
| Vent flow | 30 | cc/min. |
| Make-up carrier flow | 30 | cc/min. |
| Flame Ionization Detector: | | |
| Hydrogen flow rate | 30 | cc/min. |
| Air flow rate | 400 | cc./min. |
| Column flow | 3 | cc./min. |

| | |
|---|---|
| Split ratio | 10/1 |

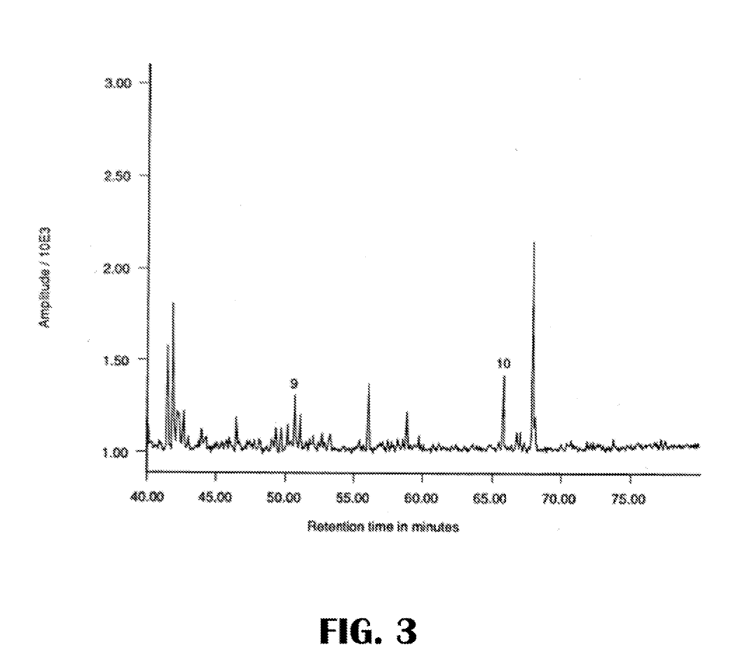

FIGS. 2 and 3 are gas chromatograms from the SDE-CGC analytical method using SDE extract obtained from the roasted coffee in the first group of embodiments. Peaks are labeled 6 to 10 which correspond to pyrazines (6), pyridines (7), pyrroles (8), guaiacols (9), and ethyl guaiacols (10).

The chromatogram is analyzed by determining the area of each recorded peak. The peaks are proportional to the GC counts (digitized electrical impulses proportional to GC peak areas).

Total GC counts as used herein are corrected GC counts. GC counts of each peak of a sample extract are normalized (corrected) to make all of the sample extracts on the same basis for comparison by ratioing the GC counts of each peak to the GC counts of the internal standard.

Corrected GC counts for a given compound are calculated using the following equation:

$$Corrected G C Counts = \frac{Area of a G C Peak}{Area of the Internal Standard Peak} \times Response Factor \times Dilution Factor$$

Response factors for specific compounds include pyrazine (1.200), pyridine (0.660), pyrrole (0.950), guaiacol (0.740) and ethyl guaiacol (1.000).

B) Analysis of Burnt-Rubbery Compounds

This method is used to analyze burnt-rubbery compounds. It is similar to that used in analyzing the flavor strength compounds. Differences in the two methods are described below.

The SDE extract is analyzed by a HP-CGC and a Supelcowax-10 fused silica column (Supelo, Inc. of Bellefontaine, Pa.). The column is used with a flame photometric detector (FPD) to detect volatile sulfur compounds (i.e., burnt-rubbery compounds) in the SDE extract.

In making the SDE extract, the preferred internal standard is 2,5-dimethyl thiophene dissolved in methylene chloride (10 mcl diluted to 25 ml in a first dilution, then 6 ml diluted to 200 ml in a second dilution).

The SDE extract is injected on to the column. The GC oven is maintained at 50° C. for 3.00 minutes. The oven temperature is raised 2.0° C./min. to 100° C. and then held for 15 minutes, raised again at 1.00° C./min. to 130° C. and then held for 1 minute, and then raised to 201° C. and held for 5 minutes.

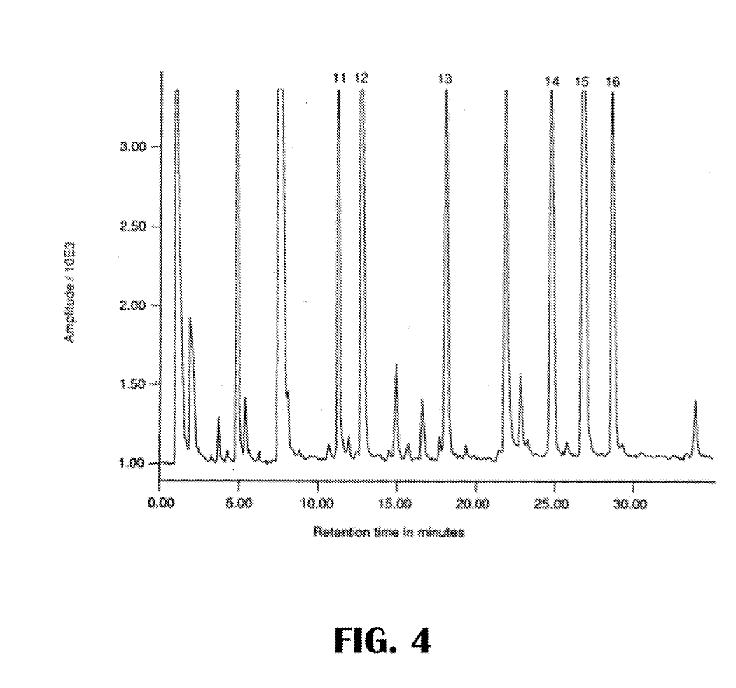

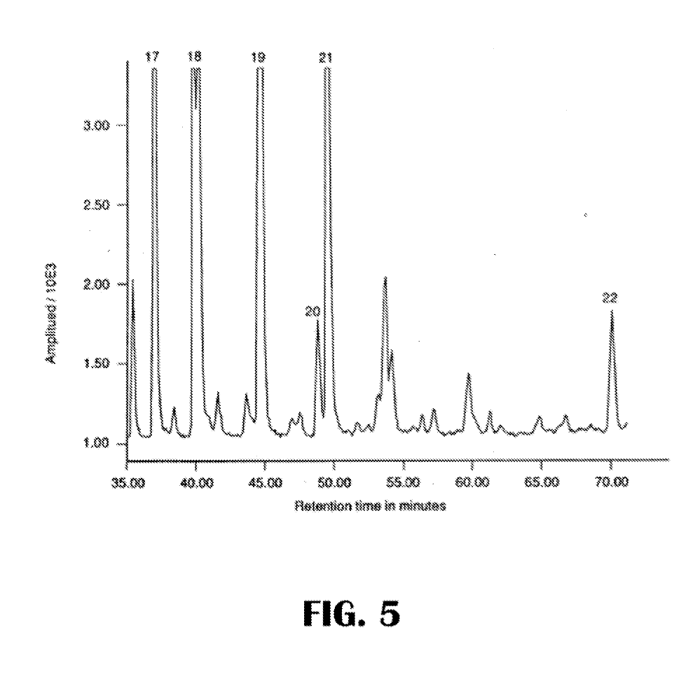

FIGS. 4 and 5 are gas chromatograms from this method using SDE extract obtained from the roasted coffee of the first group of embodiments. The peaks are labeled 11 to 22 which correspond to 3-thiazole (11), 4-methylthiazole (12), peak 13 (13), peak 14 (14), peak 15 (15), tetrahydrothiophene (16), peak 17 (17), 2-thiophenecarboxaldehyde (18), peak 19 (19), 3-acetylthiophene, 2-acetylthiophene and peak 22.

The response factor is 1 for each of the burnt-rubbery compounds.

C) Analysis of Good Flavor Compounds

1) Analytical Method

Programmed temperature GC analysis is used to analyze the good flavor compounds. Sodium sulfate and an internal standard are added to a brewed coffee inside a closed system and heated. A headspace sample from the heated combination is injected into a Varian model 3400 Gas Chromatograph (DB-1701 column, 30 meter length, 0.32 mm internal column diameter, from J&W Scientific of Folsom, Calif.). The column contains a film of crosslinked polyethylene glycols 1.0 μm thick.

2) Application of Analytical Method

Sodium sulfate (13.00±0.03 grams) is placed in a 120 cc septum bottle. A roast and ground coffee sample (13.00±0.01 grams) is added to the bottle followed by deionized water (65 ml) and internal standard (1 ml).

The internal standard is made by the following operation. A 1000 cc volumetric flask is filled with distilled water to within 5-10 cm of the 1000 cc calibration mark. With a pipet, 1 ml of regent grade ethyl acetate is added to the flask. The ethyl acetate should be dispensed into the flask by lowering the tip of the pipet just below the surface of the water and tipping the flask (and pipet) slightly so that when the ethyl acetate is released, the droplets will rise to the surface free of the pipet. When the ethyl acetate has stopped flowing, the pipet is raised inside the flask neck and the final few drops are “tipped off.” The flask is stoppered, inverted, and agitated by swirling and inverting it 5-10 times. Agitation is stopped and the air bubbles are allowed to rise. Distilled water is added to make 1000 ml. The liquid is again agitated. The resulting internal standard within the flask contains 1000 ppm (v/v) ethyl acetate.

After adding the internal standard, the bottle is sealed with a septum. A 2 cc gas syringe and the sealed bottle are placed into a Blue M oven (Model SW-11TA) for 45 minutes at 90° C. The bottle is removed from the oven. A needle attached to the heated syringe is inserted through the septum to a level halfway between the top of the bottle and the surface of the liquid therein. Headspace (2 ml) is removed and injected into the gas chromatograph.

The initial temperature of the column oven is 100° C. for 5 minutes, raised 4° C./minute to 115° C. and then held for 7 minutes, and finally raised 7° C./min. to 200° C. and then held for 2 minutes.

GC conditions are:

Carrier gas: helium—2.5 cc/min.

Injection port temperature: 646° F. (240° C.)

Flame Ionization Detector:

Temperature: 482° F. (250° C.)

Hydrogen flow rate: 30 cc/min.

Air flow rate: 300 cc/min.

Chart speed: 0.5 cm./min.

The chromatogram analysis is the same as that used in the analysis of flavor strength and good flavor compounds.

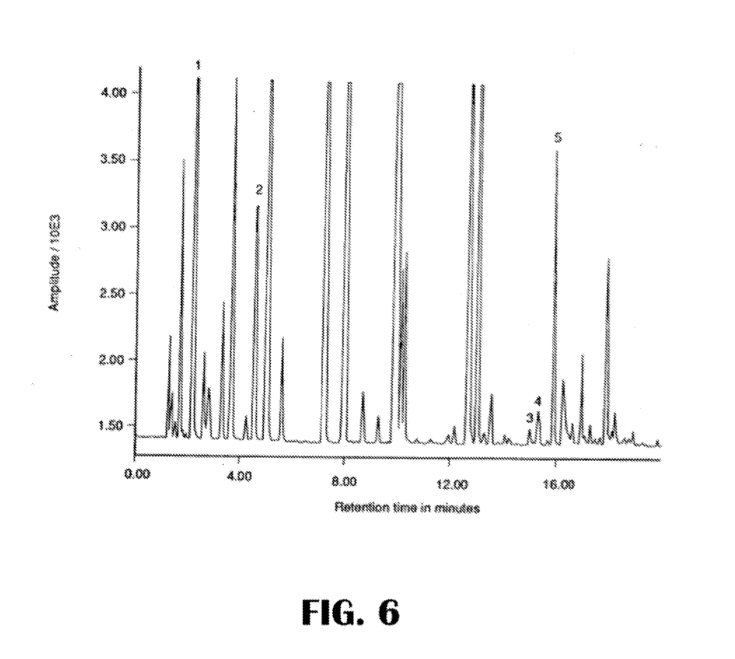

FIG. 6 is a gas chromatogram of this method using extract derived from roasted coffee from the first group of embodiments. The peaks are labeled 1 to 6 which correspond to ethanal (1), propanal (2), 2-pentanone (3), 3-pentanone (4) and 2,3-pentanedione (5).

In calculating corrected GC counts, the response factors include ethanal (71.59801), propanal (29.16200), 2-pentanone (18.42800), 3-pentanone (15.77300) and 2,3-pentanedione (41.89000).

C) Measuring Acidity

Brewed acidity index relates to the acidity of brewed coffee. Brewed coffee typically has a pH of from about 4 to 5. The brewed acidity index is a more discriminating acidity scale than logarithmic based pH units.

The brewed acidity index=1000×volume (ml) of 0.1 Normal sodium hydroxide added to 150 grams of coffee brew to raise its pH to 7.00. The coffee brew is prepared from 31.2 grams of roasted coffee particles and 1420 ml of distilled water in a conventional automatic drip coffeemaker.

As described previously, the coffee beans in the present invention may be dried differentially or equally, before they are subject to the roasting step. In the second group of embodiments, the coffee in the coffee composition 110/130 and beverage material 120 as shown in FIGS. 1A, 1B, and 1C is made from green coffee beans that are dried substantially equally. Specifically, the coffee composition in the second group of embodiments comprises coffee made from reduced density roast coffee beans. The process for preparing such beans comprises pre-drying green coffee beans to moisture content of from about 0.5% to about 10% by weight, fast roasting the beans, and cooling the roasted beans. The resulting roasted beans have a Hunter L-color of from about 14 to about 25, a Hunter ΔL-value is less than about 1.2 and a whole roast tamped bulk density of from about 0.28 to about 0.38 g/cc. The resulting roast coffee beans are more uniformly roasted than traditional reduced density coffee beans.

In connection to the background of the second group of embodiments, roast and ground coffee has been marketed on supermarket shelves by weight in 16-ounce cans. However, a later trend in the coffee market has resulted in the demise of the 16-ounce weight standard, and major coffee manufacturers began marketing 13-ounce blends. The blends were prepared using “fast roast” technology that resulted in a lower density bean. Thirteen ounces of these lower density blends have nearly the same volume as the traditional 16-ounce blends. As a result they could be marketed in the old 1-pound cans and were priced about 20 cents below the previous 16-ounce list price because they used fewer beans. This down-weighting of coffee in cans has met with widespread acceptance in the industry. Many “fast roast” coffees also have a higher yield of brew solids than previous 16-ounce coffees. These high yield fast roast and ground coffees exhibit improved extraction characteristics during brewing. Thus, they can make as many cups of coffee (or more) per 13 ounces as were previously prepared from 16 ounces.

Fast roasting results in a puffed or somewhat popped bean. Fast roasting of coffee typically occurs in large multistage roasters (e.g., Probat, Thermalo, Jetzone, etc.) with very large heat inputs. These high heat inputs result in the rapid expansion of the roasted bean. However, some aspects of the fast roast processing still need to be improved. The high heat inputs necessary to puff the bean result in a high degree of bean roasting variation within the roaster. Also, tipping and burning of the outer edges of the bean are a major problem.

The second group of embodiments according to the invention uses a reduced density roast coffee bean that is more uniformly roasted. The roast beans also exhibit less bean-to-bean color variation; less color variation within each bean; and less tipping and burning of the outer edges of the roasted bean.

With respect to the moisture content of exported green beans, Sivetz et al., Coffee Technology, “Drying Green Coffee Beans”, pp. 112-169 (1979), states that coffee beans are dried prior to export. Historically, solar drying was the method of choice. However, improved reliability and efficiency of machine dryers has led to their widespread use in the industry. The standard moisture target prior to export is about 12%. Sivetz also highlights the irreversible damage overdrying can have on coffee quality.

With respect to the effect of green bean moisture content on roasted density, Sivetz et al., supra, “Coffee Bean Processing”, pp. 254-6 states that the bulk density of roasted bean will vary with degrees of roast, speed of roast, and original moisture content of the green beans. Sivetz goes on to say: “Mast roasts on large beans, especially new-crop coffees with more than average moisture, may cause a 10-15% larger swelling than normal.” (Emphasis added)

In a discussion of bean roasting, Clifford, Tea and Coffee Trade Journal, “Physical Properties of the Coffee Bean”, pages 14-16, April 1986, states “Production of carbon dioxide, and its expansion along with water vapor, generate internal pressures in the range of 5.5 to 8.0 atmospheres and account for the swelling of the bean by some 170 to 230%.

U.S. Pat. No. 4,737,376, Brandlein et al., issued Apr. 12, 1988, describes a two-stage bubbling bed roasting process for producing low density (0.28 to 0.34 g/cc) coffee. During Stage 1 the beans are heated at 500° F. to 630° F. (260-332° C.) for from 0.25 to 1.5 minutes at atmospheric pressure. During State 2 the beans are heated at a temperature equal to or less than Stage 1 for from 0.25 to 1.5 minutes at atmospheric pressure. The '376 patent discusses the importance of retaining a high internal bean moisture. It is stated that high internal bean moisture promotes hydrolysis reaction and allows the beans to remain more pliable during roasting. This is said to allow for greater expansion of the bean during roasting. Typically, the beans fed into the Stage 1 roaster have a moisture content of 10±2%.

In the second group of embodiments according to the invention, the process for producing reduced density roasted coffee beans comprises the steps of (1) pre-drying green coffee beans to moisture content of from about 0.5% to about 10% by weight, (2) fast roasting the beans; and (3) cooling the roasted beans. The resulting roasted beans have a Hunter L-color of from about 14 to about 25, a Hunter ΔL-color of less than about 1.2 and a whole roast tamped bulk density of from about 0.28 to about 0.38 g/cc. The product beans can be ground or ground and flaked after roasting.

One aspect of the second group of embodiments provides for a coffee composition for use in a beverage unit and method thereof as defined in the Summary of the Invention, wherein the coffee composition comprises a coffee made from reduced density roasted coffee beans, which are produced by a process comprising the steps of:

(a) first, drying green coffee beans to a moisture content of from about 0.5% to about 7% by weight, wherein the drying is conducted at a temperature of from about 70° F. to about 325° F. for at least about 1 minute; then
(b) roasting the dried beans at a temperature of from about 350° F. to about 1200° F. for from about 10 seconds to not longer than about 5.5 minutes; and then
(c) cooling the roasted beans, wherein the resulting roast beans have:

(1) a Hunter L-color of from about 14 to about 25;

(2) a Hunter Δ L-color of less than about 1.2; and

(3) a whole roast tamped bulk density of from about 0.27 to about 0.38 g/cc.

In more specific examples under this aspect, the drying step (a) may be conducted for from about 1 minute to several months. The drying step (a) may be conducted at from about 120° F. to about 275° F. for from about 1 hour to about 24 hours, e.g. from about 160° F. to about 250° F. (about 71° C. to about 121° C.) for from 1 to 6 hours. The coffee beans in the process may be decaffeinated or non-decaffeinated. The roasting step (b) may be conducted at a temperature of from about 400° F. to about 800° F. for from about 10 seconds to about 3 minutes. The dried green coffee beans may have moisture content of from about 3% to about 6% after step (a). The whole roast tamped bulk density of the roasted beans is from about 0.30 to about 0.35 gm/cc. The process may further comprise a step of (d): grinding the cooled beans to an average particle size of from about 300 to about 3000 μm. The process may even further comprise a step of (e): flaking the ground beans.

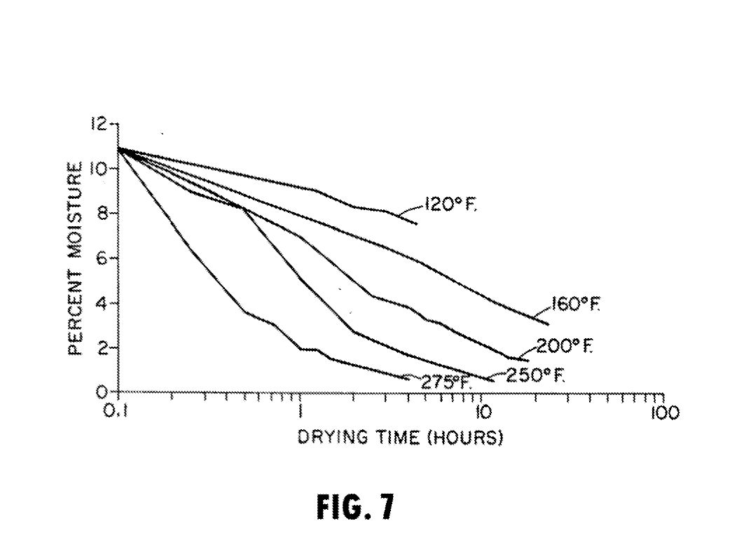

The second group of embodiments will be further described in the following, exemplified by Examples 4-9, and as illustrated in FIG. 7. All percents and ratios used in the second group of embodiments are on a weight basis unless otherwise indicated.

### Definitions in the Second Group of Embodiments

The term “reduced density coffee” relates to roasted coffee which has a roasted whole bean tamped density of from about 0.28 to 0.38 gm/cc.

The term “1-pound coffee can” relates to a coffee container which has a volume of 1000 cc. Historically, one pound (16 oz.) of coffee was sold in this volume container.

The term “pre-drying” relates to a green bean moisture removal operation which occurs prior to roasting, typically, less than 1 day prior to roasting.

Terms “tipping” and “burning” relate to the charring of the ends and outer edges of a bean during roasting. Tipping and burning of beans results in a burnt flavor in the resulting brewed beverage.

The term “density” refers to tamped bulk density, i.e. the overall density of a plurality of particles measured after vibratory settlement.

The term “percent moisture” relates to the amount of water in a green bean, a roasted bean or roasted and ground bean on a wet-basis. Moisture content is determined by oven drying. First, the material is ground to a mean particle size of about 900 μm. Ten grams of ground material is then weighed into a drying dish and placed in a 105° C. drying oven for 16 hours. The weight loss from the sample represents the moisture in the original sample and, accordingly, is used to calculate the percent moisture.

Pre-Drying of Coffee Prior to Roasting in the Second Group of Embodiments

It has been discovered that reduced density coffee can be produced from green coffee beans having a moisture content of less than about 10%. However, it also contemplated in the second group of embodiments that high levels of moisture and the resulting steam expansion in the bean during rapid roasting may be responsible for the swelling/puffing that results in a reduced density bean.

Without being bound to theory, it is believed that water is a possible contributor to coffee swelling/puffing, but not at the high levels discussed in the prior literature.

In the process of the second group of embodiments, green coffee beans having an initial moisture content greater than about 10%, preferably greater than about 10% to about 14%, most preferably greater than about 10% to about 12%, are first dried to a moisture content of from about 0.5 to about 10%, preferably from about 2% to about 7%, more preferably from about 2% to about 6%, more preferably from about 3% to about 6%, and most preferably about 3% to about 5%.

The drying stage, according to the second group of embodiments, results in partially dehydrated coffee bean without causing any significant roasting-related reactions to take place. Roasting reactions are described in Sivetz, supra, pp. 250-262, incorporated herein by reference.

Without being bound by theory, it is believed that the key to the pre-drying step of the second group of embodiments is that the moisture content of the resulting beans is relatively uniform throughout the bean, i.e. the moisture profile within the beans has equilibrated. Accordingly, the method of pre-drying is not critical, provided the moisture content of the resulting bean is uniformly low and no burning or roasting occurs. Beans with high moisture contents in their center and low moisture contents near the outer edges should not be charged to the roaster until such equilibration occurs.

Green bean drying involves the simultaneous application of heat and removal of moisture from the green beans. As applied to the second group of embodiments, moisture removal, i.e. dehydration, can be accomplished by heated air, heated surfaces, microwave, dielectric, radiant or freeze dryers. These drying operations are described in Fellows, Food Processing Technology, Chapters 14, 17 and 20, incorporated herein by reference. The preferred drying method is heated air drying; however, inert gases (e.g. helium and nitrogen) can also be used. Fluidized bed heated air dryers, rotary dryers, belt dryers, tray dryers, continuous dryers and conveyor and convective dryers are particularly preferred; rotary or belt dryers are most preferred.

Fluidized bed dryers may be batch or continuous. Continuous fluidized bed dryers can be filled with a vibrating base to help to advance the beans. Continuous “cascade” systems, in which the beans are discharged under gravity from one tray to the next can be used for higher production rates. Fluidized bed dryers suitable for use in the second group of embodiments include those manufactured by APV Crepaco, Inc., Attleboro Falls, Mass.; Bepex Corp., Rolling Meadows, Ill.; Littleford Bros., Inc., Florence, Ky.; and Wolverine Corporation, Merrimac, Mass.

Rotary dryers consist of a slightly inclined rotating metal cylinder, fitted with internal flights to cause the beans to cascade through a stream of hot air as they advance through the dryer. Air flow can be parallel to counter-current to the beans. Rotary dryers suitable for use in the second group of embodiments include those manufactured by APV Crepaco. Inc., Tonawanda, N.Y.; Aeroglide Corp., Raleigh, N.C.; Blaw-Knox Food & Chemical Equipment Co., Buflovak Division, Buffalo, N.Y.; and Littleford Bros. Inc., Florence, Ky.

Belt dryers suitable for use in the second group of embodiments include those manufactured by APV Crepaco, Inc., Attleboro Falls, Mass.; The National Drying Machinery Co., Philadelphia, Pa.; C. G. Sargent's Sons Corp., Westford, Mass.; Aeroglide Corp., Raleigh, N.C.; and Proctor & Schwartz, Inc., Horsham, Pa. Chamber dryers suitable for use in the second group of embodiments include those manufactured by Wyssmont Company, Inc., Fort Lee, N.J. Continuous conveyor dryers suitable for use in the second group of embodiments include those manufactured by APV Crepaco, Inc., Attleboro Falls, Mass.; The National Drying Machinery Co., Philadelphia, Pa.; C. G. Sargent's Sons Corp., Westford, Mass.; The Witte Co., Inc., Washington, N.J.; Wyssmont Company, Inc., Fort Leed, N.J.; Proctor & Schwartz, Inc., Horsham, Pa.; Wenger Mfg. Inc., Sabetha, Kans.; Werner & Pfleiderer Corp., Ramsey, N.J.; and Wolverine Corp., Merrimac, Mass. Convective dryers suitable for use in the second group of embodiments include those manufactured by APV Crepaco, Inc. Tonawanda, N.Y.; The National Drying Machinery Co., Philadelphia, Pa.; Wyssmont Company, Inc., Fort Lee, N.J.; Proctor & Schwartz, Inc., Horsham, Pa.; and Wenger Mfg. Inc., Sabetha, Kans.

The drying step in the second group of embodiments should be conducted under gentle conditions. Large heat inputs and temperature differentials can result in tipping and burning of the bean or premature roast-related reactions. Drying curves for a typical blend of green coffee beans with an initial moisture content of 11% are shown in FIG. 7. The drying curve was established on a Model 42200 Wenger Belt Dryer under 300 lb. batch conditions. The blend consists of equal parts Robusta, natural Arabicas and washed Arabica beans. Preferably, commercial drying is achieved by a convective air stream, which enters the drying compartment containing from 0% to 70% moisture at a temperature of from about 70° F. to about 325° F., preferably from about 70° F. to about 300° F., more preferably from about 120° F. to about 275° F., and most preferably about 160° F. to about 250° F. The drying time should be from about 1 minute to about 24 hours, preferably from about 30 minutes to about 24 hours, more preferably from about 1 hour to about 24 hours, more preferably from about 1 hour to about 12 hours, more preferably from about 1 hour to about 6 hours, and most preferably from about 2 hours to about 6 hours.

In the second group of embodiments, slow drying using conventional drying units, like the ones described above, are easily fitted into existing commercial roasting lines and are the preferred commercial embodiment. However, other drying schemes which achieve the same uniformity of moisture will produce a similar result and are also contemplated by the second group of embodiments. Examples of alternative drying schemes include: vacuum drying; warehouse-type drying (i.e. storage in a dehumidified warehouse for several months); or pulse drying by heating the beans with one or more short pulses of heat, e.g., 1 sec. to 1 min. at 300° F.-1000° F. (149° C.-538° C.), and then allowing the moisture and temperature within the bean to equilibrate.

In the second group of embodiments, warehouse-type drying can be performed in large rooms, warehouse or storage silos. The coffee may remain in the shipping bag provided air is free to flow in and out of the bag (e.g. a coarse weave burlap bag). Slow drying of this type is typically accomplished with air at about 70° F. to about 120° F. (about 21° C. to about 49° C.) and a relative humidity of less than 25%. Optionally, a small air flow is distributed throughout the drying environment. The time required to achieve desired moistures is a function of air distribution, air velocity, air temperature, air relative humidity and the initial moisture content of the green beans. Typically, the moisture levels are monitored periodically during the warehouse-type dryer period. The drying medium is not limited to air; inert gases (e.g. nitrogen and helium) can also be used.

According to the second group of embodiments, after the green coffee beans have been uniformly pre-dried and the moisture profile has equilibrated, they are ready for roasting. The beans should have minimal contact, preferably no contact, with moisture to prevent the absorption thereof. The pre-dried beans should not be allowed to rehydrate to a moisture level greater than about 10%, preferably not greater than about 7% and most preferably not greater than about 3%. It is desirable, but not critical, to charge the beans to the roaster as soon as possible after pre-drying.

Roasting of the Dried Beans in the Second Group of Embodiments

The process in the second group of embodiments combines the above pre-drying stage with a “fast” roaster. These roasters are characterized by their ability to provide an expanded roast bean with a whole roast tamped bulk density of from 0.28 to 0.38 gm/cc.

Fast roasters suitable for use in the second group of embodiments can utilize any method of heat transfer. However, convective heat transfer is preferred, with forced convection being most preferred. The convective media can be an inert gas or, preferably, air. Typically, the pre-dried beans are charged to a bubbling bed or fluidized bed roaster where a hot air stream is contacted with the bean. Fast roasters operate at inlet air temperature of from about 350° F. to about 1200° F. (about 177° C. to about 649° C.) preferably from about 400° F. to about 800° F. (about 204° C. to about 427° C.), at roast times from about 10 seconds to not longer than about 5.5 minutes, preferably from about 10 to about 47 seconds.

In a typical batch fast roast, a Thermalo Model 23R roaster manufactured by Jabez Burns, is charged with from about 100 to about 300 lbs. (from about 14 to about 136 kg) of dried beans. The beans are roasted for from 1 to about 3 million Btu/hr (about 293 kW to about 879 kW) and an initial preheat temperature of from about 300° F. to about 700° F. (about 149° C. to about 371° C.).

In a typical continuous fast roast, a Jetzone Model 6452 fluidized bed roaster, manufactured by Wolverine Corp., is operated with an inlet air temperature of from about 500° F. to about 700° F. (about 260° C. to about 371° C.) and a residence time of from 15 to about 60 sec at typical burner rates of about 2.4 MM Btu/hr (about 703 kW).

Roasting equipment and method suitable for roasting coffee beans according to the second group of embodiments are described, for example, in Sivetz, Coffee Technology, Avi Publishing Company, Westport, Conn. 1979, pp. 226-246, herein incorporated by reference. See also U.S. Pat. No. 3,964,175 to Sivetz, issued Jun. 22, 1976, which discloses a method for fluidized bed roasting of coffee beans.

Other fast roast methods useful in producing reduced density coffee are described in U.S. Pat. No. 4,737,376 to Brandlein et al., issued Apr. 12, 1988; U.S. Pat. No. 4,169,164 to Hubbard et al., issued Sep. 25, 1979; and U.S. Pat. No. 4,322,447 to Hubbard, issued Mar. 30, 1982, all of which are herein incorporated by reference.

Final roasting according to the second group of embodiments is characterized by two factors: the color of the final roast bean, and the density of the product.

Roast Bean Color: The coffee beans can be roasted to any desired roast color. Darker roasts develop strong flavors that are very desirable in many European countries. Lighter roasts can be used to produce clear, reddish cup colors with slightly weaker flavors. The Hunter Color “L” scale system is generally used to define the color of the coffee beans and the degree to which they have been roasted. A complete technical description of the system can be found in an article by R. S. Hunter “Photoelectric Color Difference Meter”, J. of the Optical Soc. of Amer., 48, 985-95 (1958). In general, it is noted that Hunter Color “L” scale values are units of light reflectance measurement, and the higher the value is, the lighter the color is since a lighter colored material reflects more light. In particular, in the Hunter Color system the “L” scale contains 100 equal units of division; absolute black is at the bottom of the scale (L=0) and absolute white is at the top (L=100). Thus, in measuring degrees of roast, the lower the “L” scale value the greater the degree of roast, since the greater the degree of roast, the darker is the color of the roasted bean.

The roast coffee beans of the second group of embodiments have a Hunter L-color of from about 14 to about 25, preferably from about 17 to about 23.

Reduced Density: The roast coffee beans of the second group of embodiments have a whole roast tamped bulk density of from about 0.27 to about 0.38 g/cc, preferably from about 0.29 to about 0.37 g/cc, more preferably from about 0.30 to about 0.36 g/cc, and most preferably from about 0.30 to about 0.35 g/cc.

Cooling the Roasted Beans in the Second Group of Embodiments

As soon as the desired roast bean color is reached, the beans are removed from the heated gases and promptly cooled by the typically ambient air and/or a water spray. Cooling of the beans stops the roast-related pyrolysis reactions.

Water spray cooling, also known as “quenching”, is the preferred cooling method in the second group of embodiments. The amount of water sprayed is carefully regulated so that most of the water evaporates off. Therefore, minimal water is absorbed by the roasted beans, e.g. typically less than about 6%.

Grinding of the Roasted Beans in Second Group of Embodiments

After the roast coffee beans have been cooled according to the second group of embodiments, they can be prepared for brewing. Coffee brewing is achieved by percolation, infusion or decoction. During a brewing operation, most coffee solubles and volatiles are extracted into an aqueous medium. This extraction is made more efficient by breaking down the whole bean into smaller pieces. This process is generally referred to as “grinding.” Preferred grinding techniques result in an average particle size of from about 300 to about 3000 microns.

Particle size also impacts the brew strength of coffees prepared from different brewing apparatus. Automatic Drip coffee grinds typically have an average particle size of about 900 μm and percolator grinds are typically from about 1500 μm to about 2200 μm.

Descriptions of grinding operations suitable for use in the second group of embodiments are described in Sivetz, supra. pp. 265-276, herein incorporated by reference.

The roast and ground coffee beans of the second group of embodiments have a ground tamped bulk density of from about 0.25 to about 0.39 gm/cc, preferably from about 0.28 to about 0.36 gm/cc, and most preferably from about 0.28 to about 0.34 gm/cc.

Flaking of the Resulting Ground & Roast Coffee in the Second Group of Embodiments

Flaked coffees may have improved characteristics. Flaked coffee is described in U.S. Pat. No. 4,331,696; U.S. Pat. No. 4,267,200; U.S. Pat. No. 4,110,485; U.S. Pat. No. 3,660,106; U.S. Pat. No. 3,652,293; and U.S. Pat. No. 3,615,667, of which are herein incorporated by reference.

Flaked roast & ground products of the second group of embodiments are desirable. Preferred flaked products are produced by grinding the roast coffee to an average particle size from about 300 to about 3000 μm, normalizing the ground product, and then milling the coffee to a flake thickness of from about 2 to about 40 thousandths of an inch (about 51 to about 1016 μm), preferably from about 10 to about 30 (about 254 to about 762 μm), most preferably from about 20 to about 24 (about 508 to about 610 μm).

Characteristics of the Roasted Products in the Second Group of Embodiments

The benefits of the second group of embodiments are observed by “fast roasting” the beans to produce a reduced density roast bean. Surprisingly, it has been discovered that when green beans are pre-dried prior to roasting according to the second group of embodiments, the resulting roasted beans exhibit the following characteristics:

More Uniform Roasting: The roasted beans produced according to the second group of embodiments show a high degree of roast uniformity when compared to non-dried beans roasted in a similar manner.

Less Bean to Bean Color Variation: Bean-to-bean color variation within the roast is an indication of uniformity of roast. Color variations within the bean are also another indicator of roast uniformity. Both are important to the aesthetic appeal of the coffee to the consumer.

The Hunter L-scale system is employed in the second group of embodiments to establish uniformity of roast within the bean. Hunter L-color of the roast bean is normally lower than that of the ground product. The reason for this effect is that the exterior of the roast bean is roasted to a greater degree (i.e. darker) than the interior of the bean. As used herein, the term Hunter ΔL-color relates to this increase in the Hunter L-color of roast beans when compared after and before grinding and is defined as follows:

Hunter ΔL=L_{after}−L_{before}

where,
L_{before}=Hunter L-color of the whole roast bean; and
L_{after}=Hunter L-color of the ground roast bean.

Hunter ΔL-color values for roast and ground coffee according to the second group of embodiments are less than about 1.2, preferably less than about 0.6.

Increased Flavor Strength: The brew flavor strength of the coffees produced by the second group of embodiments is typically greater than that produced by prior 16-ounce coffee blends, and even fast roast non-dried reduced density coffee blends.

Roast Time Reduction: Reduced roast bean densities are achieved under the roast conditions described above in from about 10 seconds to about 30 minutes, preferably from about 10 seconds to about 5.5 minutes, most preferably about 10 to about 47 seconds. It has been observed that the roasting times of the second group of embodiments are about ⅔ those observed when no pre-drying is utilized.

Preferred Coffee Varieties in Second Group of Embodiments

It has been observed that the process of the second group of embodiments is suitable for roasting all varieties of coffee. However, the flavor character of certain coffee is actually improved by the claimed process. “Milds” and washed arabicas show a slight improvement, while Brazilians and other natural Arabicas show more improvement. Robustas are improved the most and have a noticeably less harsh flavor. Accordingly, Brazilians, natural Arabicas, washed Arabicas and Robustas are preferred beans for use in the second group of embodiments. Robustas being the most preferred.

The blending of beans of several varieties, before and after roasting or pre-drying, is also contemplated by the second group of embodiments. Likewise, the processing of decaffeinated or partially decaffeinated coffee beans are also contemplated by the second group of embodiments.

### Analytical Methods in the Second Group of Embodiments

### I. Whole Roast Tamped Bulk Density Determination

This method specifies the procedure for determining the degree of puffing that occurs in the roasting of green coffee. This method is applicable to both decaffeinated and non-decaffeinated whole roasts.

### Apparatus

Weighing container: 1,000 ml stainless steel beaker or equivalent

Measuring container: 1,000 ml plastic graduated cylinder; 5 ml graduations

Scale: 0.1 gm sensitivity

Vibrator: Syntron Vibrating Jogger; Model J-1 or equivalent. Syntron Company—Homer City, Pa.

Funnel: Plastic funnel with tip cut off to about 1″ outlet

Automatic Timer: Electric, Dimco-Gray; Model No. 171 or equivalent

### Operation

Weigh 200 grams of whole bean coffee to be tested into beaker. Place the graduated cylinder on the vibrator. Using the funnel, pour the coffee sample into the cylinder. Level the coffee by gently tapping the side of the cylinder. Vibrate 30 seconds at No. 8 setting. Read volume to nearest 5 ml.

Tamped density can be determined by dividing the weight of the coffee by the volume occupied (after vibrating) in the graduated cylinder.

$$Tamped Density = \frac{Weight of Coffee ( gms )}{Volume of Coffee ( {cm}^{3} )}$$

For standardizing the measurements between different coffees, all density measurements herein are on a 4.5% adjusted moisture basis. For example, 200 grams of whole bean coffee having a 2% moisture content would contain 196 grams of dry coffee and 4 grams of water. If the volume was 600 cc's, the unadjusted density would be 200 gms/600 cc's=0.33 gm/cc. On a 4.5% adjusted moisture basis, the calculation is: 4.5%×200 gms=9 gms water. To make the density calculation on an adjusted moisture basis, take 196 gms dry coffee+9 gms water=205 gms total. Adjusted density=205 gms/600 cc's=0.34 gm/cc.

### II. Ground Tamped Bulk Density Determination

This method is applicable to ground or flaked product.

### Apparatus

Weighing container: 1,000 ml glass beaker or equivalent

Measuring container: 1,000 ml plastic graduated cylinder; 10 ml graduations

Scale: 0.1 gm or 0.01 ounce sensitivity

Vibrator: Syntron Vibrating Jogger-Model J-1A (or equivalent). Syntron Company-Homer City, Pa. (Calibrated by Factory analytical Services)

Funnel: Plastic funnel with tip cut off to about 1″ outlet hole.

Automatic timer (optional): automatic timer-automatic shutoff and reset.

Calibration device: Amplitude Meter and Transducer Mod. AM-100, Power Time Control, Indiana, Pa.

Calibration of Syntron Vibrating Jogger

An amplitude of 0.035 inches results in consistent density measurements with little product break-up when using the 300 gram density method.

### Operation

Weigh 300 grams of coffee to be measured into the beaker. Place the graduate cylinder on the vibrator table. Pour the coffee through the funnel into the graduate cylinder. Level the coffee by gently tapping the side of the cylinder. Vibrate for one minute. Read volume. Calculation

$$Tamped Density in gm \text{/} {cm}^{3} = \frac{300 gm}{Volume of coffee in ml}$$

The density measurements used herein are calculated on a 4.5% adjusted moisture basis, as described in the previous section.

### Roasting and Grinding

The coffee ingredient contained in the coffee composition 110/130 and beverage material 120 as shown in FIGS. 1A, 1B, and 1C may be independently from each other produced from any suitable roasting and grinding process, including those described above. For example, roasted coffee beans may be cracked, then ground, and then normalized. Cracking breaks the beans into very large pieces and releases the chaff During the grinding step the pieces of ground coffee and chaff are broken into smaller pieces. Since the surface area increases, more of the naturally occurring coffee oil is exposed. The normalizer is a mixing chamber with rotating paddles which beat the light-colored chaff into tiny fragments and mix them with the dark-colored coffee oil. Normalization gives the coffee a better appearance because the small, darkened chaff particles are more difficult to see against the background of the ground coffee beans.

In the third group of embodiments according to the present invention, the coffee composition 110/130 and beverage material 120 as shown in FIGS. 1A, 1B, and 1C comprises a reduced density roast and ground coffee product, which is produced by a process comprising the steps of: (a) cracking roasted coffee beans to a size such that about 40% to about 80% are retained in a 6-mesh screen (3.36 mm, 0.132 in.); then (b) normalizing the cracked beans; and then (c) grinding the cracked and normalized beans. The roast and ground coffee product produced by the combination of the three steps has a density between about 0.24 g/cc and about 0.41 g/cc. The reduced density roast and ground coffee product has an acceptable non-chaffy or less chaffy appearance. Problems associated with the use of an air removal step or screening step are avoided.

In connection to the background of the third group of embodiments, normalization has the additional effect of densifying the coffee because the mixing rounds off the edges of the coffee particles, allowing them to pack closer and more efficiently together. This densifying effect of normalization is a problem if one wishes to produce a lower density coffee product. An air removal step or screening step can be used instead of normalization to deal with the chaff problem; however, with air removal the small coffee particles are lost with the chaff, and with screening the small pieces of chaff are not removed. These alternatives to normalization are thus imperfect solutions to the chaff problem.

U.S. Pat. No. 4,349,573 to Stefanucci et al., issued Sep. 14, 1982, discloses a process for making a low density coffee. The process comprises: (a) preparing a roasted high quality coffee bean fraction under short roasting conditions effective to produce a roasted high quality coffee bean fraction having a roast color of no more than 50 and a bulk density less than 0.35 g/cc; (b) preparing a roasted intermediate quality coffee bean fraction under short roasting conditions effective to produce a roasted intermediate quality coffee bean fraction having a roast color of 60 and a bulk density less than 0.32 g/cc; (c) preparing a roasted low quality coffee bean fraction under short roasting conditions effective to produce a roasted low quality coffee bean fraction having a roast color of 85 and a bulk density less than 0.40 g/cc; (d) blending the roasted fractions of steps (a), (b) and (c) in a ratio effective to produce a ground blend having a maximum free flow density of 0.30 g/cc and wherein the high quality coffee constitutes 25-40%, the intermediate quality coffee constitutes 50-60% and the low quality coffee constitutes 10-15% of the final blend; (e) grinding the roasted blend of step (d), while bypassing the grinder normalizer, to an average particle size of 880-900 microns for electric percolator grind; of 830-850 microns for stove percolator grind; or of 740-760 microns for automatic drip grind.

In the Stefanucci et al. process the ground beans are not normalized. While this process produces a low density coffee, the low density is achieved by avoiding the normalization step altogether. This results in a chaffy appearance in the ground product. The chaff must then be removed using air or screens (with their inherent problems discussed above), or it can be left in the coffee, creating an unacceptable appearance.

The third group of embodiments provides a process of making a reduced density roast and ground coffee in which the chaff problem is addressed by a method other than by eliminating the normalization step. In other words, it provides a process which retains the normalization step but still produces a low density coffee. The third group of embodiments therefore produces a reduced density roast and ground coffee having a non-chaffy appearance.

One aspect of the third group of embodiments provides for a coffee composition for use in a beverage unit and method thereof as defined in the Summary of the Invention, wherein the coffee composition comprises a reduced density roast and ground coffee product made from a process comprising the steps of: (a) cracking roasted coffee beans to a size such that about 40% to about 80% are retained on a 6-mesh screen; then (b) normalizing the cracked beans; and then (c) grinding the cracked and normalized beans; the coffee product produced having a density between about 0.24 g/cc and about 0.41 g/cc.

In more specific examples under this aspect, the coffee beans may be cracked to a size such that about 50% to about 80% (e.g. about 60% to about 80%) are retained on a 6-mesh screen.

The third group of embodiments will be further described in the following, and exemplified by Examples 10-12.

In third group of embodiments, by changing the normal coffee grinding procedures, the normalization step can be retained to deal with the chaff problem, while at the same time a low density coffee can be produced.

Conventional commercial grinding equipment is built so that cracking rolls are first in the order, followed by grinding rolls and then a normalizer. In the original equipment design of a normalizer, two necessary functions were performed: making the appearance of the coffee more uniform and acceptable, and increasing the density of the coffee to fit into the appropriate container. When the need for a reduced density coffee product arose, the only obvious solution was to reduce or eliminate the normalizing step to lower density.

The unobvious solution, and a key to the third group of embodiments, was the discovery that the dual goals of reduced density and acceptable appearance can be achieved by reversing the order of the normalization and grinding steps. It was found that grinding coarse, already normalized coffee particles results in a low density product with an acceptable non-chaffy appearance.

In the process of the third group of embodiments, coffee beans are first cracked into very large pieces having a specific size, thereby releasing the chaff. If the beans are cracked too coarse, the final product will be chaffy, and if the beans are cracked too fine, the final product will be too dense.

The coffee is then normalized to color and break up the chaff. The density of the coffee is increased at this point because the edges of the large coffee particles have been rounded off. However, these large particles are then ground into smaller particles by passing them through grinding rolls. The grinding creates irregular edges again, and the coffee has a low density without a chaffy appearance. A unique contribution of this development is the discovery that grinding coarse, already normalized coffee particles results in a low density product with acceptable appearance.

The term “density” as used in third group of embodiments refers to tamped bulk density, the overall density of a plurality of particles measured after vibratory settlement in a manner such as that described on page 529 of Sivetz et al., “Coffee Technology”, Avi Publishing Company, Westport, Conn. (1979).

The process of the third group of embodiments works with any starting blend of green coffee beans. The three major types of coffee beans are milds, Brazilians, and Robustas. Botanically, the milds and Brazilians are traditionally thought of as Arabicas.

The milds give coffee brews which are fragrant and acidic. Brazilian beans result in coffee brews which are relatively neutral flavored. The Robusta beans produce brews with strong distinctive flavors that possess varying degrees of dirty or rubbery notes. Traditionally, the milds are the most expensive of the three types of beans, with Brazilians being of intermediate expense, and Robustas being least expensive.

Decaffeinated beans can be used in this process as well. Any standard decaffeination process is acceptable.

Any of the variety of roasting techniques known to the art can be used to roast the green coffee in the process of the third group of embodiments. In the normal operation of preparing conventional roast and ground coffee, coffee beans are roasted in a hot gas medium at a temperature of from about 176.7° C. (350° F.) to about 260° C. (500° F.) with the time of roasting being dependent on the flavor characteristics desired in the coffee beverage when brewed. Where coffee beans are roasted in a batch process, the batch roasting time at the hereinbefore given temperatures is generally from about 2 minutes to about 20 minutes. Where coffee beans are roasted in a continuous process, the residence time of the coffee beans in the roaster is typically from about 30 seconds to about 9 minutes. The roasting procedure can involve static bed roasting as well as fluidized bed roasting.

In the third group of embodiments, the coffee beans can be roasted to any desired roast color. Darker roasts develop strong flavors that are very desirable in many European countries. Lighter roasts can be used to produce clear, reddish cup colors with slightly weaker flavors. The Hunter Color “L” scale system is generally used to define the color of the coffee beans and the degree to which they have been roasted. A complete technical description of the system can be found in an article by R. S. Hunter, “Photoelectric Color Difference Meter”, J. of the Optical Soc. of Amer., 48, 985-95 (1958). In general, it is noted that Hunter Color “L” scale values are units of light reflectance measurement, and the higher the value is, the lighter the color is since a lighter colored material reflects more light. In particular, in the Hunter Color system the “L” scale contains 100 equal units of division; absolute black is at the bottom of the scale (L=0) and absolute white is at the top (L=100). Thus, in measuring degrees of roast, the lower the “L” scale value the greater the degree of roast, since the greater the degree of roast, the darker is the color of the roasted bean.

Typical roasting equipment and methods for roasting coffee beans are described, for example, in Sivetz & Desrosier, Coffee Technology, Avi Publishing Company, Westport, Conn., 1979, pp. 226-246. U.S. Pat. No. 3,964,175 to Sivetz, issued Jun. 22, 1976, discloses a method for fluidized bed roasting of coffee beans.

In the process of the third group of embodiments, the roasted coffee beans are first cracked to a size such that about 40% to about 80% are retained on a 6-mesh U.S. Standard Screen. Preferably, they will be cracked to a size of about 50% to about 80% on a 6-mesh U.S. Standard Screen, and most preferably to a size of about 60% to about 80% on the 6-mesh screen. [U.S. Standard Screens can be related to particle size. See Perry et al., “Perry's Chemical Engineers' Handbook”, 6th Ed., p. 21-15, McGraw-Hill Book Co., New York, N.Y. (1984)]. A 6-mesh screen has an opening of 3.36 mm. or 0.132 inches. This means that from about 40% to about 80% of the particles are larger than about 3.36 mm, and about 20% to about 60% are smaller.

The cracking operation cracks the beans to as coarse a size as possible with substantially all of the beans cracked, and with substantially all of the beans having their chaff loosened. It has been found that these conditions are met when about 40% to about 80% of the cracked beans are retained on a 6-mesh screen.

If more than about 80% of the cracked beans remain on a 6-mesh screen, the cracked beans are too coarse and not all of the chaff is loosened, and the final product has an appearance that is too chaffy. If less than about 40% of the cracked beans remain on the 6-mesh screen, the beans are cracked too finely, and the final product is too dense.

Any comminution equipment can be used for the cracking operation of this process. For example, a Gump grinder, manufactured by B. F. Gump Company, Chicago, Ill., contains both cracking and grinding rolls, and it is suitable for the practice of the third group of embodiments. The present process is not equipment specific. Any grinder with cracking rolls or any other type of comminution equipment or methods can be used as long as they are capable of cracking the beans to the desired size.

Some different equipment and methods for cracking, normalizing, and grinding coffee are found in Sivetz et al., Coffee Technology, Avi Publishing Company, Inc., Westport, Conn., pp. 265-276 (1979). Commercially sold equipment (for example, Gump) which combines apparatus for cracking, grinding, and then normalizing has the three operations in that order. Therefore, this commercial equipment will have to be changed to put the normalizing step before the grinding step.

In the third group of embodiments, it does not matter how many cracking rolls or grinding rolls are used in the cracking and grinding steps, or whether other comminution equipment is used for the cracking and grinding, as long as the coffee is cracked to the correct particle size range and ground to the desired size.

After cracking, the beans are normalized. In the normalization process the cracked coffee particles are heavily mixed together. This causes the chaff to break into smaller pieces and coffee oil to be released from the coffee particles. The smaller chaff particles mixed with the coffee oil are then less conspicuous against the background of the coffee particles. The oil is also absorbed into the chaff and is not lost. There it can provide aroma to the ground coffee and additional flavors during processing. In the process of the third group of embodiments, the ideal normalization procedure is to normalize the cracked coffee particles just enough to adequately change the appearance of the chaff, and then stop normalizing. Too much normalization will densify the coffee particles to an unacceptable extent. It is better to err on the side of leaving a small amount of chaff visible. This is especially true if the coffee particles will be mixed after the normalization operation, for example, in a screw conveyor. This mixing is in effect added normalization, so the normalization step may need to be shortened to compensate for this added handling. In general, the normalization may take between about 15 seconds and about 1 minute, depending on the type of equipment used and the feed rate.

The coffee particles are sufficiently normalized or mixed when the light-colored large pieces of chaff are turned into dark-colored (because of the coffee oil) small pieces of chaff that are difficult to see against the background of the coffee.

The type of normalization equipment used is not critical for the third group of embodiments. The normalizer is essentially just a mixer. Examples of suitable equipment are a Gump normalizer or a ribbon blender. The equipment can be modified (especially in length) for optimum industrial use.

In the last step of the present process in the third group of embodiments, the cracked and normalized beans are ground to the desired size. The process will work with any type of grind. The standard grinds (from coarsest to finest) are electric perk, regular, automatic drip coffee, drip, and fine. For example, automatic drip coffee has a particle size distribution of about 7% above a 14-mesh screen, about 18% above a 16-mesh screen, and about 50% above a 20-mesh screen, while regular coffee has a particle size distribution of about 32% above a 14-mesh screen, about 42% above a 16-mesh screen, and about 70% above a 20-mesh screen. Grinding of the coffee can be done in any of the ways known to those skilled in the art.

The roast and ground coffee product produced by the combination of the cracking, normalizing and grinding steps of the third group of embodiments must have a density between about 0.24 g/cc and about 0.41 g/cc. This density range is determined primarily by the need for a reduced density coffee, by the physical fit of the coffee product into the coffee container, and by the amount of coffee used to brew the coffee drink.

The final product density is controlled mostly by the cracking and normalizing steps as explained above, and by the degree of roast, with a darker roast generally producing a less dense coffee bean. The grinding step has little effect on the product density, according to the third group of embodiments.

### Post-Grinding Treatment: Flavoring

In preparing the coffee composition for use in a beverage unit as defined in the Summary of the Invention, the coffee in the coffee composition 110/130 and beverage material 120 as shown in FIGS. 1A, 1B, and 1C may result from any suitable flavoring treatment, before, during and/or after the roasting and/or grinding step(s). In the fourth group of embodiments according to the present invention, non-segregating, non-agglomerated flavored coffee compositions are provided. In particular, the fourth group of embodiments relates to novel flavored coffee compositions that minimize or inhibit the segregation and separation of constituent components, and the corresponding processes for making such compositions. The flavored coffee compositions herein are characterized as having a roast and ground, an instant coffee component, or mixtures thereof. The roast and ground coffee component will have a moisture level in the range of from about 1% to about 15%, a particle density in the range of from about 0.1 g/cc to about 0.45 g/cc, and a mean particle size distribution in the range of from about 400 microns to about 1300 microns. The instant coffee components used herein will have a particle density in the range of from about 0.1 g/cc to about 0.8 g/cc, a mean particle size distribution in the range of from about 250 microns to about 2360 microns, and a moisture level in the range of from about 1% to about 4.5%. The flavored coffee composition further includes a flavoring component with a moisture level in the range of from about 1% to about 7%, a particle density in the range of from about 0.1 g/cc to about 0.8 g/cc, and a mean particle size distribution in the range of from about 5 microns to about 150 microns. The ratio of coffee component particle size to flavor component particle size is in the range of from about 100:1 to about 5:1.

In connection to the background of the fourth group of embodiments, flavored coffee beverage products enjoy considerable popularity and make up an increasingly significant proportion of daily consumed beverages. However, these flavored coffee beverages are complicated and expensive to produce and frequently suffer from inconsistent product quality; one such reason is the way in which these coffee beverages are flavored.

One common approach to producing flavored coffee beverage products is the admixing of a dry coffee compound with a dried, agglomerated flavoring ingredient of similar size capable of solubilization when the coffee product is being extracted and/or dissolved. The flavoring ingredients are bound together via the application of an agglomerating fluid or binding solution. As there is little or no difference in relative particle sizes between the coffee particles and the flavoring ingredients, segregation and separation generally do not occur. See U.S. Pat. No. 6,207,206 B1 to Mickowski et al., herein incorporated by reference.

However, this approach has several deficiencies, most notable of which is the increased production cost resulting from both additional raw materials and additional processing steps required to produce the agglomerates. Moreover, inconsistent flavor delivery is frequently encountered, resulting from differing rates of extraction and/or solubilization between the coffee and the agglomerated flavoring ingredients.

In an attempt to overcome the deficiencies of the agglomeration flavoring method, liquid flavoring components have been used to deliver a desired degree of flavoring impact. In this approach, liquid flavoring ingredients are applied to the surface of coffee particles so as to coat them. However, this approach is not without its own set of problems. The liquid flavoring compounds typically used in these applications contain volatile compounds that may evaporate when exposed to the atmosphere, thereby losing their potency. Additionally, not all flavor combinations are possible, as a desired flavor may not be available in liquid form. Finally, liquid flavoring compositions frequently contain evaporative solvents that contribute to volatile flavor loss. These solvents also tend to undergo adverse reactions with the materials typically used in conventional coffee containers (e.g., tin, plastic, paper, and the like). The use of specially treated and costly packaging is therefore required in order to resist such reactions and preserve coffee flavor, quality, and aroma.

To compensate for evaporation it is necessary to apply the flavoring agent in amounts well in excess of what is actually required to deliver the desired flavor load. Another shortcoming of the application of liquid flavorants is the non-uniform coverage of the coffee particles, thereby resulting in inconsistent product quality in the ready to drink form of the beverage, as some prepared beverage portions will receive more or less than the intended flavor level.

Yet another approach to providing flavored coffee products is the practice of separating the flavor and coffee ingredients by combining the flavoring ingredient with a filter media or other membrane that the extracted or solubilized coffee solution must come into contact with. See U.S. Pat. No. 6,004,593 to Soughan et al., which is herein incorporated by reference. This process, however, requires the use of special equipment and/or materials (e.g., filters) to obtain a flavored coffee beverage product. Moreover, not all consumers desired flavors may be available in a form capable of being utilized in such a fashion.

Therefore, considerable effort has been expended in an attempt to address the product formulation and consumer acceptance limitations of using the flavored compositions and techniques heretofore described. Furthermore, there remains a need in the art for compositions and methods of flavoring coffee that ensure high quality and consistent flavor delivery. In particular, inexpensive non-segregating flavoring methods that are easily adaptable to a variety of coffee materials are desirable. Accordingly, it is an object of the fourth group of embodiments to provide coffee compositions and methods which address these needs and provide further related advantages.

The fourth group of embodiments is directed towards methods of flavoring coffee, and the products and compositions derived therefrom, that minimize both processing steps and cost while simultaneously ensuring a coffee product with a consist and uniform flavor impact. In particular, the fourth group of embodiments relates to novel flavored coffee compositions that minimize or inhibit the segregation and separation of constituent components, and the corresponding processes for making such compositions. The flavored coffee compositions herein comprise, on a dry weight basis, from about 80% to about 99.5% of a coffee component, preferably from about 85% to about 98%, more preferably from about 90% to about 97%, and yet more preferably from about 92% to about 96%.

The coffee component in fourth group of embodiments is comprised of a roast and ground coffee component, an instant coffee component, or mixtures thereof. The roast and ground coffee component will have a moisture level in the range of from about 1% to about 15%, a particle density in the range of from about 0.1 g/cc to about 0.45 g/cc, and a mean particle size distribution in the range of from about 400 microns to about 1300 microns. The instant coffee components used herein will have a particle density in the range of from about 0.1 g/cc to about 0.8 g/cc, a mean particle size distribution in the range of from about 250 microns to about 2360 microns, and a moisture level in the range of from about 1% to about 4.5%.

The flavored coffee composition herein further comprises, on a dry weight basis, from about 0.5% to about 20% of a flavoring component, preferably from about 2% to about 15%, more preferably from about 3% to about 10%, yet more preferably from about 4% to about 8%.

The flavoring component in fourth group of embodiments has a moisture level in the range of from about 1% to about 7%, a particle density in the range of from about 0.1 g/cc to about 0.8 g/cc, and a mean particle size distribution in the range of from about 5 microns to about 150 microns. The ratio of coffee component particle size to flavor component particle size is in the range of from about 100:1 to about 5:1.

As such, one aspect of the fourth group of embodiments provides for a coffee composition for use in a beverage unit such as a cartridge and method thereof as defined in the Summary of the Invention, wherein the coffee composition comprises a non-agglomerated flavored coffee composition made by a method comprising the steps of:

a) combining:
(i) from about 80% to about 99.9% of a coffee component, wherein said coffee component has a moisture level in the range of from about 1% to about 5%, a particle density in the range of from about 0.28 g/cc to about 0.33 g/cc, a mean particle size distribution in the range of from about 650 microns to about 800 microns; and
(ii) from about 0.1% to about 20% of a flavoring component, wherein said flavor component has a moisture level in the range of from about 1% to about 4%, a particle density in the range of from about 0.4 g/cc to about 0.5 g/cc, a mean particle size distribution in the range of from about 40 microns to about 50 microns;
wherein the size ratio of said coffee component to said flavor component is in the range of from about 100:1 to about 5:1;

b) mixing said coffee component and said flavoring component for a period of time sufficient for said flavored coffee composition to exhibit a Distribution Value of less than about 20% RSD;

wherein said coffee component is selected from the group consisting of roast and ground coffee, instant coffee, and mixtures thereof;

wherein said flavoring component is selected from the group consisting of dried flavoring compounds, crystalline flavor compounds, encapsulated flavoring compounds, encapsulated liquid flavoring compounds, and mixtures thereof; and

further comprising one or more additional ingredients selected from the group consisting of creamers, aroma enhancers, natural sweeteners, artificial sweeteners, thickening agents, and mixtures thereof.

The fourth group of embodiments as described above will be further described in the following, and exemplified by Examples 13-17.

### A. Definitions in the Fourth Group of Embodiments

The term “Bulk Density” refers to the overall density of a plurality of particles measured in the manner described on pp. 127-131 of Coffee Processing Technology, Vol. II, Avi Publishing Company, Westport, Conn. (1963), herein incorporated by reference. As used herein, the term “PSD” means particle size distribution as defined on pp. 137-140 of Coffee Processing Technology, Vol. II, Avi Publishing Company, Westport, Conn. (1963), herein incorporated by reference.

The term “Distribution Value” is defined as the numerical representation of the degree to which the flavoring components are distributed throughout the flavored coffee compositions, or portions thereof. The value is represented as a distribution value percentage relative standard deviation (DV % RSD), where a uniform distribution would be represented as 0% RSD. The Distribution Value is calculated according to the “Distribution Value Determination” method explained herein.

The term “Agglomeration” is defined as the process of preparing relatively larger particles by combining a number of relatively smaller particles into a single unit. Many specialized processes and types of processing equipment have been developed for the agglomeration of particulate solids. See, for example, pp. 177-209 of Coffee Solubilization Commercial Processes and Techniques, Pintaufo, N. D., Noyes Data Corporation, “Agglomeration Techniques”, (1975), herein incorporated by reference.

It will be appreciated by the ordinarily skilled artisan that the following basic operating principles are involved in practically all agglomeration techniques. First, an agglomerating fluid (e.g., oil, liquid water or steam) is dispersed throughout the particles to be agglomerated, causing part or all of the surfaces of the particles to become tacky. Subsequently, the particles are agitated, allowing the tacky surfaces of the particles to come into contact with and adhere to other particles. Proper control of the amount of agglomerating fluid and the type and time of agitation will provide control over the final size of the agglomerated product. Agglomeration methods which use water as an agglomerating fluid typically result in a high density product which does not quickly dissolve. Following agglomeration and agitation, the resulting agglomerated particles are dried, typically to a moisture content of about 3.5% or less. It is believed in the art that this moisture level will help minimize flavor deterioration and caking. The agglomerated particles can be air dried, vacuum dried, dried in a fluidized bed, dried in a vibratory fluidized bed, or with any other suitable drying apparatus.

Publications and patents are referred to throughout the fourth group of embodiments. All references cited in the fourth group of embodiments are hereby incorporated by reference. All percentages and ratios are calculated by weight in the fourth group of embodiments unless otherwise indicated. All percentages and ratios, unless otherwise indicated, are calculated based on the total composition.

As used in the fourth group of embodiments, and unless otherwise indicated, the use of a numeric range to indicate the value of a given variable is not intended to be limited to just that stated range. One of ordinary skill in the art will appreciate that the use of a numeric range to indicate the value of a variable is meant to include not just the values bounding the stated range, but also all values and sub-ranges contained therein. By way of example, consider variable X which is disclosed as having a value in the range of 1 to 5. One of ordinary skill in the art will understand that variable X is meant to include all integer and non-integer values bounded by the stated range. Moreover, one of ordinary skill in the art will appreciate that the value of the variable also includes all combinations and/or permutations of sub-ranges bounded by the integer and non-integer values, unless otherwise indicated.

All component or composition levels are in reference to the active level of that component or composition and are exclusive of impurities, for example, residual solvents or by-products, which may be present in commercially available sources.

Referred to herein are trade names for components including various ingredients utilized in the fourth group of embodiments. The inventors herein do not intend to be limited by materials under a certain trade name. Equivalent materials (e.g., those obtained from a different source under a different name or catalog number) to those referenced to by trade name may be substituted and utilized in the compositions, kits, and methods described herein.

In the description of the fourth group of embodiments, various embodiments and/or individual features are disclosed. As will be apparent to the ordinarily skilled practitioner, all combinations of such embodiments and features are possible and can result in preferred executions of the fourth group of embodiments.

### B. Ingredients in the Fourth Group of Embodiments

The non-agglomerated, flavored coffee compositions in the fourth group of embodiments comprise a coffee component and a flavoring component that are in intimate contact with each other. The flavoring and coffee components remain in contact with each other in the absence of a binding agent and/or agglomerating solution.

### 1. Coffee Component

The coffee component of the fourth group of embodiments is comprised of roast and ground coffee particles, instant coffee particles, or mixtures thereof. The roast and ground coffee utilized herein is commonly known in the art, and is a widely utilized form of coffee. A variety of processes are known to those skilled in the art for roasting, grinding or otherwise preparing coffee. The roasting conditions selected for a given coffee source can be characterized by roast time, roasting equipment, and a Hunter L* color.

Typically, roast and ground coffee is prepared by drying green coffee beans, roasting the beans, cooling the roasted beans, and subsequently grinding the beans, though those skilled in the art will appreciate that the exact sequence may vary somewhat. See, for example, U.S. Pat. No. 4,637,935, to Kirkpatrick et al., issued Jan. 20, 1987, herein incorporated by reference, which describes a unique process for preparing a roast and ground coffee, and also discusses other known processes for preparing roast and ground coffee.

The beans utilized in making the flavored coffee compositions of the fourth group of embodiments may be any of a variety of available coffee beans, or a blend of two or more varieties. For example, Brazilian, natural Arabica, washed Arabica, and Robusta varieties may be used, either alone or in combination. The roast and ground coffee can be caffeinated, decaffeinated, or a blend of both. The coffee may also be processed to reflect one of many unique flavor characteristic such as espresso, French roast, and the like. Suitable coffee components for use in the fourth group of embodiments can be prepared specifically for the formulation of the flavored coffee compositions and beverages, or may be purchased and used “as is” from a variety of commercial coffee houses. The roasting process in the fourth group of embodiments may utilize any method of heat transfer. For example, convective heat transfer is typical. Roasting equipment and methods suitable for roasting coffee beans are described in, for example, Sivetz, Coffee Technology, Avi Publishing Co., 1979. Additionally, U.S. Pat. No. 3,964,175, to Sivetz et al., issued Jun. 22, 1976 discloses a method for fluidized bed roasting of coffee beans. Other roasting techniques are described and referenced in U.S. Pat. No. 5,160,757, Kirkpatrick et al., issued Nov. 3, 1992.

Roasting may be applied until the desired roast bean color is achieved. Roast color and color differences are defined in terms of readings measured on a Hunter colorimeter and specifically the values L*, a* and b* derived from the Hunter CIE scale. See pages 985-95 of R. S. Hunter, “Photoelectric Color Difference Meter,” J. of the Optical Soc. of Amer., Volume 48, (1958). The beans are then cooled to stop roast-related pyrolysis reactions. The beans are then prepared for brewing or extracting, either on site or by the ultimate consumer, by grinding. Preferred grinding techniques for preparing the roast and ground coffees to be used herein will result in mean particle size distributions in the range of from about 400 microns to about 1300 microns, preferably in the range from about 450 microns to about 1000 microns, more preferably in the range from about 650 microns to about 800 microns.

As used herein, roast and ground coffee also refers to “flaked” coffees. Flaked coffee is described in U.S. Pat. Nos. 4,331,696; 4,267,200; 4,110,485; 3,660,106; 3,652,293; and 3,615,667, each of which is herein incorporated by reference.

The roast and ground coffee component used herein will have a particle density in the range of from about 0.1 g/cc to about 0.45 g/cc, preferably in the range from about 0.25 g/cc to about 0.4 g/cc, more preferably in the range from about 0.28 g/cc to about 0.33 g/cc. Moreover, the roast and ground coffee components used herein, will have a moisture level in the range of from about 1% to about 15%, preferably from about 1% to about 10%, more preferably from about 1% to about 7%, even more preferably from about 1% to about 5%.

The coffee component of the fourth group of embodiments may also be comprised of instant coffee, either alone or in combination with a roast and ground coffee. The instant coffee utilized herein is of the type commonly known in the art. Suitable instant coffees for use herein can be prepared from any single variety of coffee or a blend of different varieties. The instant coffee can be caffeinated, decaffeinated, or a blend of both and can be processed to reflect a particularly desirable flavor characteristic such as espresso, French roast, or the like.

An instant coffee component of the type used in the fourth group of embodiments can be prepared by any convenient processes, a variety of which are known to those skilled in the art. Typically, instant coffee is prepared by roasting and grinding a blend of coffee beans, extracting the roast and ground coffee with water to form an aqueous coffee extract, and drying the extract to form instant coffee. Instant coffee useful in the fourth group of embodiments is typically obtained by conventional spray drying processes. Representative spray drying processes that provide a suitable instant coffee for use in the fourth group of embodiments are disclosed in U.S. Pat. No. 2,750,998 to Moore et al., issued Jun. 19, 1956; U.S. Pat. No. 2,469,553 to Hall et al., issued May 10, 1949; U.S. Pat. No. 2,771,343 to Chase et al., issued Nov. 20, 1956; and at pages 382-513 of Sivetz & Foote, Coffee Processing Technology, Vol. 1, Avi Publishing Co., (1963), each of which is herein incorporated by reference.

Other suitable processes for providing an instant coffee component suitable for use in the fourth group of embodiments are disclosed in U.S. Pat. No. 3,436,227 to Bergeron et al., issued Apr. 1, 1969; U.S. Pat. No. 3,493,388 to Hair et al., issued Feb. 3, 1970; U.S. Pat. No. 3,615,669 to Hair et al., issued Oct. 26, 1971; U.S. Pat. No. 3,620,756, to Strobel et al., issued Nov. 16, 1971; and U.S. Pat. No. 3,652,293 to Lombana et al., issued Mar. 28, 1972, each of which is herein incorporated by reference. In addition to spray dried instant coffee powders, instant coffee useful in the fourth group of embodiments can include freeze-dried coffee.

The instant coffee components used herein will have a particle density in the range of from about 0.1 g/cc to about 0.8 g/cc, preferably from about 0.2 g/cc to about 0.5 g/cc, more preferably from about 0.2 g/cc to about 0.35 g/cc. Moreover, the instant coffee component will have a mean particle size distribution in the range of from about 250 microns to about 2360 microns, preferably from about 500 microns to about 1500 microns, more preferably from about 800 microns to about 1100 microns. Finally, the instant coffee components, as used herein, will have a moisture level in the range of from about 1% to about 4.5%, preferably from about 1% to about 4%, more preferably in the range from about 1% to about 3%.

Preferably, the coffee components used in the fourth group of embodiments, (e.g., roast and ground, instant, and mixtures thereof) will have a substantially non-uniform shape, wherein the surface will be characterized by having a pocketed, jagged, cratered, and/or creviced morphology.

### 2. Flavoring Component in the Fourth Group of Embodiments

The flavoring agents useful herein include any substantially dry flavoring agent with the appropriate physical characteristics. As used herein, the term “substantially dry” is defined as having a moisture level insufficient to produce “tackiness” on the surface of the compound. Suitable flavoring agents are selected from the group comprising dried flavoring compounds, crystalline flavor compounds, encapsulated flavoring compounds, including encapsulated liquid flavoring compounds, and mixtures thereof. Preferred flavoring agents are encapsulated liquid flavoring compounds that have been treated in such a way (e.g., by applying a coating) as to allow the resulting particle to behave as would a dry flavoring compound.

As used herein, the term “liquid” includes liquids, viscous liquids, slurries, foams, pastes, gels and the like. In the compositions of the fourth group of embodiments liquid flavoring compounds are encapsulated in a material comprising specifically selected materials, prior to their inclusion in the flavored coffee composition. As used herein, the term “encapsulated” is broadly defined to include any method whereby the flavoring component and the selected encapsulating material are comixed and are formed into discrete particles for addition into the flavored coffee composition. Thus, as used herein, the term “encapsulated” includes the operations known in the art as prilling, encapsulating, agglomerating, noodling, comixing, coating, flaking, shredding, marumerizing and the like.

One suitable method by which an additive component may be covered by an outer shell of encapsulating material is described in U.S. Pat. No. 3,310,612, to Somerville et al., issued Mar. 21, 1967, herein incorporated by reference. A prilled product can be formed by spraying a melt of the encapsulating material with the additive component into a tower through which a cold stream of air is introduced, thus causing the spray melt to solidify into small spheres or the like. An example of such a process is described in The Chemical Engineer, No. 304, December 1975, pp. 748-750, and in U.S. Pat. No. 3,742,100, each which is herein incorporated by reference. The process of marumerizing comprises the subjecting of flavor component-containing pellets, prepared by the extrusion of a mixture of the flavor component together with the encapsulating material, to a spheroidizing process using a rotational speed of up to about 2,000 rpm in an apparatus causing centrifugal and frictional forces to be applied to the pellets. An example of a suitable marumerizing process is described in British Pat. Specification No. 1,361,387, herein incorporated by reference.

The encapsulating material (i.e., the material used to encapsulate the flavoring compound) may comprise one or more conventional, food grade, normally solid, water-soluble materials, which are generally known and used for “encapsulating” particles in aqueous systems. Examples of such components include carboxymethylcellulose, ethyl cellulose, maltodextrin gelatin, gum arabic and gum agar. Crosslinking agents, such as TiO₂ and Monomide S may also be included.

Acceptable flavoring compounds may comprise natural flavors, artificial flavors, and mixtures thereof. As used herein, the term “natural flavors” is defined as a solid, liquid, or gaseous form of a specific natural flavorant (e.g., ground cocoa, liquid vanilla extract, powdered almonds, and the like). Mixtures of solid, liquid, and gaseous forms of a specific natural flavorant are also acceptable. The term “natural flavors” is also intended to encompass extracts, essences, distillates, and oils of a given flavorant.

As used herein, the term “artificial flavors” includes compounds capable of imparting a substantially similar flavor perception to that of a desired natural flavorant (e.g., chocolate, hazelnut, mint, etc.), though the artificial flavor is not necessarily derived from the specific natural flavorant. It is contemplated by the Applicants that though an artificial flavor source may comprise compounds similar or identical to those found in a corresponding natural flavorant, the artificial flavor source would not contain all of the ingredients or compounds typically found in the natural flavorant (e.g., naturally present compounds that would, if present, impart a dispreferred flavor note or detract from the desired flavor note). Additionally or alternatively, it is contemplated that the artificial flavor source may contain the desired flavor imparting compound(s) as found in the naturally occurring flavorant, although not necessarily in the same detectable concentration. Artificial flavors may be derived from both natural and synthetic processes and sources, as those terms are known and used in the art.

Preferred flavoring compounds include compounds capable of delivering the following flavors: almond nut, amaretto, anisette, brandy, butter rum, cappuccino, mint, cinnamon, cinnamon almond, creme de menthe, grand marnier, peppermint, pistachio, sambuca, apple, chamomile, chocolate, cinnamon spice, cocoa, cream, butter, lavender, maple, milk (in all forms), creme, vanilla, French vanilla, Irish creme, Kahlua, lemon, hazelnut, almond, pecan, lavender, macadamia nut, orange, orange leaf, peach, strawberry, grape, raspberry, cherry, other fruit flavors, and the like, including mixtures thereof. Aroma enhancers such as acetaldehyde, herbs, spices, as well as mixtures of these with the foregoing flavoring compounds may also be included.

Preferred artificial flavoring compounds include flavoring compounds capable of delivering vanilla, French vanilla, vanilla nut, coffee, hazelnut, Irish creme, amaretto, rum, caramel and almond flavors. In one embodiment in the fourth group, preferred flavoring compounds are artificial flavorants imparting a coffee or coffee-like flavor.

The flavoring components used herein will have a particle density in the range of from about 0.1 g/cc to about 0.8 g/cc, preferably from about 0.3 g/cc to about 0.6 g/cc, more preferably from about 0.4 g/cc to about 0.5 g/cc. Moreover, the flavoring components will have a moisture level in the range of from about 1% to about 7%, preferably from about 1% to about 5.5%, more preferably from about 1% to about 4%.

Suitable flavoring components for use in the fourth group of embodiments will have a mean particle size distribution in the range of from about 5 microns to about 150 microns, preferably from about 30 microns to about 100 microns, more preferably from about 40 microns to about 60 microns.

### 3. Optional Ingredients in the Fourth Group of Embodiments

i) Creamers

The flavored coffee compositions in the fourth group of embodiments may optionally contain one or more creamers. As used herein, the term “creamer” refers to an additive used in many ready-to-drink and instant beverage products. Commercial creamers are readily available, and are readily chosen by those of ordinary skill in the art. Prepared creamers generally comprise fat, emulsifiers, and processing aids. Accordingly, the beverage compositions of the fourth group of embodiments may utilize creamers and, depending on the composition of the particular creamer chosen, all or part of the fat, emulsifier or processing aids used in the composition can be, in fact, contributed by the creamer.

Suitable creamers for use in the flavored beverage products of the fourth group of embodiments include dairy and non-dairy creamers. Suitable dairy creamers include whole milk solids; butterfat solids; low-fat dry milk; and dry mixes used to prepare ice cream, milkshakes, and frozen desserts, as well as mixtures of these dairy creamers. Suitable non-dairy creamers can be made from a variety of fats and oils including soybean and partially-hydrogenated soybean oil, partially-hydrogenated canola oil, hydrogenated and partially-hydrogenated coconut oil, as well as other partially- or fully-hydrogenated vegetable oils, or combinations of such oils. Preferred creamers include non-dairy creamers made from vegetable oils, emulsifiers, co-emulsifiers, carbohydrates, sodium caseinate, and buffers. Additional creamers suitable for use in the fourth group of embodiments include those synthetic and imitation dairy products disclosed in KIRK-OTHMER ENCYCLOPEDIA OF CHEMICAL TECHNOLOGY, W. J. Harper, Willey Interscience, 3rd edition, Vol. 22, section entitled “Synthetic and Imitation Dairy Products,” pp. 465-498, (1978) of which is herein incorporated by reference.

Both foaming and non-foaming creamers can be used in the flavored beverage products of the fourth group of embodiments. Foaming creamers suitable for use in the fourth group of embodiments can comprise a non-dairy fat (e.g., partially hydrogenated oil), a water-soluble non-dairy carbohydrate (e.g., sucrose, dextrose, maltose, corn syrup solids and mixtures thereof), a buffer, a proteinaceous foam stabilizing agent (e.g., sodium caseinate) and/or optionally a gum thickener. These solid components can be mixed with water and then homogenized. A gas (e.g., nitrogen) can be injected or blended into this mixture and the mixture is spray-dried to provide the foaming creamer. See U.S. Pat. No. 4,438,147 (Hedrick, Jr.), issued Mar. 20, 1984; and U.S. Pat. No. 5,462,759 (Westerbeek et al), issued Oct. 31, 1995, each of which is herein incorporated by reference. Non-foaming creamers suitable for use in the fourth group of embodiments have an ingredient composition similar to that of the foaming creamers but without the incorporated gas. Also, foaming creamers typically have more proteinaceous components (typically about 12-13% of total ingredients) relative to non-foaming non-dairy creamers (typically about 3.5% of total ingredients).

ii) Aroma Enhancers

Aroma enhancers such as acetaldehyde, herbs, spices, and the like, may be included in the flavored coffee compositions of the fourth group of embodiments.

iii) Sweeteners

A sweetener or combination of sweeteners may be useful for sweetening the flavored coffee compositions of the fourth group of embodiments. Such sweeteners include natural and artificial sweeteners and combinations thereof. Suitable natural sweeteners useful in the fourth group of embodiments include, but are not limited to sucrose, fructose, dextrose, maltose, lactose, and mixtures thereof. Suitable artificial sweeteners include, but are not limited to saccharin, cyclamates, acesulfame K (Sunette®), L-aspartyl-L-phenylalanine lower alkyl ester sweeteners (e.g. Aspartame®); L-aspartyl-D-alanine amides disclosed in U.S. Pat. No. 4,411,925 to Brennan et al.; L-aspartyl-D-serine amides disclosed in U.S. Pat. No. 4,399,163 to Brennan et al.; L-aspartyl-L-1-hydroxymethylalkaneamide sweeteners disclosed in U.S. Pat. No. 4,338,346 to Brand; L-aspartyl-1-hydroxyethyalkaneamide sweeteners disclosed in U.S. Pat. No. 4,423,029 to Rizzi; and L-aspartyl-D-phenylglycine ester and amide sweeteners disclosed in European Pat. Application 168,112 to J. M. Janusz, published Jan. 15, 1986; and the like and mixtures thereof.

iv) Thickeners

Flavored coffee compositions according to the fourth group of embodiments can comprise thickening agents. These thickening agents can include natural and synthetic gums, and natural and chemically modified starches. Suitable gums include locust bean gum, guar gum, gellan gum, xanthan gum, gum ghatti, modified gum ghatti, tragacanth gum, carrageenan, and/or anionic polymers derived from cellulose such as carboxymethylcellulose, sodium carboxymethylcellulose, as well as mixtures of these gums. Suitable starches include, but are not limited to pregelatinized starch (corn, wheat, tapioca), pregelatinized high amylose content starch, pregelatinized hydrolyzed starches (maltodextrins, corn syrup solids), chemically modified starches such as pregelatinized substituted starches (e.g., octenyl succinate modified starches such as N-Creamer, N-Lite LP, TEXTRA, manufactured by National Starch), as well as mixtures of these starches. It is particularly preferred that thickening agents be predominantly made from starches and that no more than about 20%, most preferably no more than about 10%, of the thickener be made from gums. These thickening agents can also be incorporated into these flavored beverage products as part of the carrier for the emulsified fat on the spray dried non-foaming creamer.

### C. Flavored Coffee Compositions and Method of Making in the Fourth Group of Embodiments

The flavored coffee compositions of the fourth group of embodiments comprise a flavoring component in intimate contact with a coffee component, wherein said components remain in contact with each other without the use of an agglomerating solution or binding agent.

The ratio of the coffee component to the flavoring component is determined by the desired degree of flavor impact and flavor loading/concentration. Preferably, the flavored coffee compositions of the fourth group of embodiments comprise from about 80% to about 99.5%, on a dry weight basis, of the coffee component, and from about 0.5% to about 20%, on a dry weight basis, of a flavoring component. In preferred embodiments, the flavored coffee compositions comprise from about 85% to about 98% of a coffee component and from about from about 2% to about 15% of a flavoring component, more preferably the compositions comprises from about 90% to about 97% of a coffee component and from about 3% to about 10% of a flavoring component; yet more preferably from about 92% to about 96% of a coffee component and from about 4% to about 8% of a flavoring component.

The desired mean particle size distribution of the coffee component particles and the flavoring component particles of the fourth group of embodiments is determined in part by the exact type of coffee component and flavoring component selected for use. The ratio of the mean particle size distribution of the coffee component to the mean particle size distribution of the flavoring component is in the range of from about 100:1 to about 5:1, preferably from about 50:1 to about 5:1, more preferably from about 25:1 to about 6:1, yet more preferably from about 15:1 to about 7:1.

Not intending to be limited by theory, the inventors believe that the flavoring component particles remain in contact with the coffee component particles because of the particle size ratios and a combination of forces, including frictional forces and van der 'Waals forces.

“van der 'Waals” forces are defined as the series of attractive forces between unlike charged molecules or macromolecules. These electronic forces are based on the changing electronic charge (i.e., momentary dipoles) of a molecule, the induced electronic charge (i.e., induced dipole) of a molecule or the permanent electronic charge (i.e., symmetrical dipole) of a molecule contacting another molecule or macromolecule of an opposite charge.

It is believed that the electronegative material of the flavoring compound, or encapsulating material of an encapsulated flavoring compound, is attracted to the less polar coffee particle. The tumbling action of the particles during mixing provides the mixture enough energy to effectively allow each of the flavor component particles to move around the coffee until an area of positive charge (i.e., a bonding site) is located. From that point forward the flavor particle and the coffee particles remain in intimate contact until a more electronegative force breaks them apart (e.g., when water contacts the coffee and solubilizes the flavor component particles). For a more detailed discussion see Organic Chemistry, 3rd Edition, Morrison & Boyd pp. 3-4, herein incorporated by reference.

In preparing the non-agglomerated flavored coffee compositions contemplated by the fourth group of embodiments, the desired flavoring component is typically selected first. Based on the intended flavor impact, the type of flavoring component(s) selected (e.g., solid, crystalline, encapsulated liquid, etc.) the corresponding physical characteristics (e.g., particle size, particle density, particle moisture, etc.) and component morphology (e.g., pocketed, jagged, cratered, and/or creviced), a suitable coffee component is selected. However, it will be appreciated by one skilled in the art, upon reading the disclosure herein, that the coffee component (e.g., roast and ground, instant, or mixtures thereof) may be selected first and then a suitable flavoring component could be identified using the same criteria.

Once suitable coffee components and flavoring components are identified and selected, they are mixed together. One of ordinary skill in the art will appreciate that any mixing apparatus or process that imparts sufficient mechanical energy to allow the coffee and flavoring particles to tumble over each other is acceptable. Suitable mixing devices include ribbon, plough, screw, and paddle type mixers.

The particles of the coffee and flavoring components are mixed together for a time sufficient to provide a flavored coffee composition with a desired Distribution Value, utilizing the Distribution Value Determination method described herein.

It will be appreciated by one of ordinary skill in the art that some steps of the above described process may be avoided, additional steps may be added, or the sequence of steps may altered without deviating from the scope of the fourth group of embodiments.

### D. Segregation and Distribution Value in the Fourth Group of Embodiments

Segregation and separation of flavoring component particles from the coffee component particles and the bulk of the flavored coffee composition mass is caused by a variety of factors experienced during production, processing, packaging, shipping, storage, and dispensing. Of these factors, the most notable are vibration, percolation, trajectory of falling particles, angle of repose, and impact on a heap. In the flavored coffee compositions of the fourth group of embodiments, it is critical to inhibit the segregation or separation of particles in order to ensure a consistent flavor impact over multiple serving portions. For a more detailed discussion of segregation see Handbook of Powder Science & Technology, 2nd Edition, Edited by Fayed & Otten, International Thomson Publishing, 1997, pp. 446-453, herein incorporated by reference.

The degree of segregation or separation is measured using a Distribution Value. As used herein, the term “Distribution Value” is defined as the numerical representation of the degree to which the flavoring component particles are distributed throughout the flavored coffee compositions, or segment thereof. The Distribution Value is represented as a percentage relative standard deviation (DV % RSD), where a completely uniform distribution would be represented as 0% RSD.

In the flavored coffee compositions of the fourth group of embodiments, a Distribution Value of less than about 50% RSD is preferred, a Distribution Value of less than about 30% RSD is more preferred, a Distribution Value of less than about 20% RSD is still more preferred, and a Distribution Value of less than about 10% RSD is most preferred.

### Analytical Methods in the Fourth Group of Embodiments

A. Distribution Value Determination

The Distribution Value is defined herein as the numerical representation of the degree to which the particles of the flavoring component are distributed throughout the flavored coffee compositions, or segment thereof. The general process of measuring a given Distribution Value is characterized by the steps of:

(1) Developing and validating a partial least squares regression calibration model for the specific flavor component(s) to be used in the flavored coffee composition.

(2) Analyzing the Flavored Coffee Composition of interest by the process steps of;

(i) providing a flavored coffee composition of interest;

(ii) preparing and analyzing at least three (3) discrete samples of the flavored coffee composition on an Agilent Model 4440 mass spectroscopy (MS) sensor;

(iii) providing a partial least squares regression model, using chemometric techniques, for the specific flavor component(s) used in the preparation of the flavored coffee composition;

(iv) using the developed partial least squares regression model to calculate predicted flavor addition levels for the analyzed samples;

(v) calculating the mean and standard deviation of the output of the discrete samples; and,

(vi) applying Equation 1 to the resulting data to generate a Distribution Value.

Distribution Value=Standard Deviation×(100/mean) Equation 1

### Calibration Process

In order to accurately determine the Distribution Values for a flavored coffee composition of interest, it is necessary to develop a calibration model for the flavor component(s) used in the flavored coffee composition. The first step in the process is to provide a suitable Coffee Component as the base for a flavored coffee composition calibration sample set. Suitable coffee components are those coffee components as described herein. Secondly, a suitable flavor component is provided. Suitable flavor components, as described herein, comprise volatile components which would evaporate into any available packaging headspace. Suitable flavor sources will also exhibit at least one mass fragment difference, under MS analysis, from those of the provided coffee source.

Next, a calibration sample set is prepared by combining the provided coffee component(s) and flavor component(s) to make at least 3 discrete calibration samples of a flavored coffee composition. At least one calibration sample must contain the same amount of flavor component as is contained in the flavored coffee composition, which is to be analyzed for its Distribution Value. At least one calibration sample must contain an amount of flavoring component, which is less than the amount in the flavored coffee composition that is to be analyzed. Furthermore, at least one calibration sample must contain an amount of flavoring component in excess of the flavored coffee composition, which is to be analyzed.

For example, if the flavored coffee composition of interest (i.e., the flavored coffee composition to be measured for its Distribution Value) is believed to contain 2% by weight of a flavor component, then one calibration sample should be mixed with 2%, by weight of the flavor component, the second calibration sample should contain a smaller amount by weight of the flavor component (e.g., preferably 1%), and the third calibration sample should contain a flavor component amount in excess of the 2% contained in the flavored coffee composition of interest (e.g., 3%).

The calibration sample sets are then analyzed using mass spectroscopy equipment and techniques. Each calibration sample level is analyzed in triplicate under the following conditions: 1.00+/−0.05 grams of the sample was weighed into a standard 10 milliliter headspace vial and sealed using a crimp top lid. The vials are then placed into the Agilent 4440 Chemical Sensor for analysis. Within the chemical sensor the sample is equilibrated at 85° C. for 20 minutes and the headspace is sampled and transferred into a 3-milliliter sample loop. The carrier stream is then opened to the loop and the headspace is swept into the mass spectrometer for analysis.

The headspace autosampler conditions used are as follows:

i) sample oven: 85° C.;

ii) valve oven/loop: 105° C.;

iii) MS interface 120° C.;

iv) vial pressure 13.8 psi;

v) carrier gas (Helium) pressure 1.8 psi;

vi) loop equilibration time: 0.05 minutes;

vii) vial pressurization time: 0.20 minutes;

viii) loop fill time: 0.20 minutes;

ix) inject time 1.00 minutes

The MS conditions are as follows:

i) mass range 50-150 amu;

ii) split flow to MS 43.8 milliliters;

iii) solvent delay 0.45 minutes;

iv) run time 1.10 minutes;

v) threshold 150;

vi) sampling value 2, 10.26 scans/second.

The data generated from the mass spectroscopy procedure is then processed and analyzed using a commercial chemometrics spectral analysis program called Pirouette (Pirouette by Information, Inc. of Woodville, Wash.). The chemometric analysis program is used to develop a partial least squares regression calibration model. A discussion of partial least square (PLS) regression models and techniques can be found in Applied Spectroscopy Reviews, Vol. 31 (1&2), pp. 73-124 (1996) by Workman et al. which is herein incorporated by reference.

Chemometrics is the application of mathematical and statistical methods to extract more useful chemical information from chemical and physical measurement data. Chemometrics applies computerized data analysis techniques to help find relationships between variables among large volumes of raw data. Standard practices for infrared, multivariate, quantitative analysis are described in the “American Society for Testing Materials (ASTM) Practice E1655-94 (1995)”; ASTM Annual Book of Standards, West Conshohocken, Pa. 19428-2959 USA, Vol. 03.06; The Association of Official Analytical Chemists (AOAC) Official Methods of Analysis, 15th Ed. (1990), pp. 74-76, each of which is incorporated herein by reference.

After the calibration model is developed it is validated utilizing cross validation techniques, whereby the model is progressively developed by sequentially omitting 1 sample from analysis and then that sample is used for prediction. Performance statistics are accumulated for each group of removed samples. The optimum number of factors contained within the calibration model is determined by the number of factors which produces a minimum in overall error between modeled and referenced values (standard error of cross validation—SECV) for the samples removed during cross validation. The preprocessing transformations used were the optimum required to improve the SECV compared to PLS analysis with untransformed data.

Determination of Distribution Values During/Following Coffee Composition Mixing

The Distribution Value for the flavoring component in the flavored coffee composition of the fourth group of embodiments, either during or following mixing, is determined according to the following process:

i) Provide flavored a flavored coffee composition with a flavor component addition level between the upper and lower values used to create the calibration model (e.g., 1%, 2%, 3%, etc.);

ii) Select at least 3 samples of the flavored coffee composition from different regions of the mixer, and at least 1 sample randomly drawn from the composition following mixing;

iii) Run samples on the MS Sensor; samples are a 1.0 gram sample weight and are analyzed in triplicate under the same conditions and instrument settings as described in the calibration sample sets;

iv) Use chemometric model to calculate flavor level from raw data;

v) Calculate mean and standard deviation of samples; and,

vi) Using Equation 1 to calculate a Distribution Value.

Determination of Distribution Values During/Following Shipping

The Distribution Value for the flavoring component in the flavored coffee compositions of the fourth group of embodiments, either during or following shipping, is determined according to the following process:

i) Provide flavored a flavored coffee composition with a flavor component addition level between the upper and lower values used to create the calibration model (e.g., 1%, 2%, 3%, etc.);

ii) Pack the flavored coffee composition into a selected package (can or plastic container).

iii) Place the packaged products onto a standard shipping support (pallet). Perform ship test using Test Method D5112-98, Standard Test Method for Vibration (Horizontal Linear Sinusoidal Motion) Test of Products, from the American Society for Testing and Materials, West Conshohocken, Pa.

iv) Select at least 3 samples of the flavored coffee composition from different regions of the mixer, and at least 1 sample randomly drawn from the composition following mixing;

v) Run samples on the MS Sensor; samples are a 1.0 gram sample weight and are analyzed in triplicate under the same conditions and instrument settings as described in the calibration sample sets;

vi) Use chemometric model to calculate flavor level from raw data;

vii) Calculate mean and standard deviation of samples; and,

viii) Using Equation 1 to calculate a Distribution Value.

### Post-Grinding Treatment: Cell Structure Engineering

In preparing the coffee composition for use in a beverage unit as defined in the Summary of the Invention, the coffee in the coffee composition 110/130 and beverage material 120 as shown in FIGS. 1A, 1B, and 1C may have various cell structures. For example, roast and ground coffee comprises conventionally prepared roast and ground coffee particles and also decaffeinated forms thereof. Such a product is composed of clearly defined cells providing a distinct structure defined by the individual cell walls. The invention also contemplates light-milled, cell-distorted roast and ground coffee referred to as “light-milled coffee”; as well as “flaked roast and ground coffee”. While light-milled coffee and flaked coffee are both produced by roll milling roast and ground coffee, the two products are to be distinguished. Light-milled coffee, as the name implies, is produced by generally using low roll mill pressures. From the cell structure point of view light-milled coffee has partial cell wall fracture, partial cell disruption and cells, which have generally been flattened and compressed together to provide weakened and distorted but still definite cell structure. Flaked coffee, on the other hand, is produced by utilizing generally higher roll mill pressures to produce an easily definable flake shape, which has nearly total cell disruption. In other words, speaking in general terms, light-milled coffee has weakened cell walls and partial cell disruption whereas flaked coffee has crushed cell walls and nearly total cell disruption. These differences can conveniently be seen when examining photomicrographs.

The coffee in the coffee composition 110/130 and beverage material 120 as shown in FIGS. 1A, 1B, and 1C may result from any suitable milling treatment before, during, and/or after the roasting, and/or grinding step(s). The fifth group of embodiments, according to the present invention, is related to light-milled, cell-distorted roast and ground coffee. The light-milled coffee has a bulk density equal to that of conventional roast and ground coffee products. The product has some cell fracture and partial cell disruption and therefore has increased extractability. The light-milled, cell-distorted roast and ground coffee, when viewed in bulk, has the appearance of conventional roast and ground coffee but has from 10 to 30% increase in flavor strength. The method of producing this product comprises passing roast and ground coffee through a roll mill under controlled conditions of feed rate, pressure, and roll speed.

The fifth group of embodiments relates to light-milled, roast and ground coffee, which has the same bulk appearance as conventional roast and ground coffee particles as well as the same bulk density as conventional roast and ground coffee particles, but which has from 10 percent to 30 percent increase in flavor strength over and above conventional roast and ground coffee products. The fifth group of embodiments also relates to a method of making light-milled roast and ground coffee, which comprises passing roast and ground coffee through a roll mill within a range of carefully defined coffee feed rates, roll mill pressures, and roll peripheral surface speeds.

In connection to the background of the fifth group of embodiments, flaked coffee per se is known in the art (see McKinnis, U.S. Pat. No. 1,903,362, Rosenthal, U.S. Pat. No. 2,123,207, and Carter, U.S. Pat. No. 2,368,113). Light-milled roast and ground coffee, which when viewed in bulk has the appearance and bulk density of conventional roast and ground coffee but has from 10% to 30% increase in flavor strength, has not heretofore been known in the art.

U.S. Pat. No. 3,615,667, of Joffe, entitled “FLAKED COFFEE AND PRODUCTS PRODUCED THEREFROM,” relates to the flaking of roast and ground coffee as a means of advantageously controlling and regulating the flavor and aroma of coffee as well as the extractability of coffee. The Joffe patent discloses utilizing the varying effect of flaking on high, low, and intermediate grade coffees, as a method of making an improved roast coffee product comprising as a major portion low and/or intermediate grade coffee flakes, and as a minor portion, high grade roast and ground coffee. An additional application of McSwiggin et al. entitled “A METHOD OF MAKING FLAKED ROAST AND GROUND COFFEE,” Ser. No. 823,942, filed May 12, 1969 now U.S. Pat. No. 3,660,106, discloses preferred conditions for making flaked roast and ground coffee.

The flaked coffee product and processes disclosed in the above identified applications are excellent products from the standpoint of versatility and consumer acceptance. However, it is often of an advantage to provide a series of products each having its own distinctive characteristics. Moreover, for those people who have become familiar with conventional roast and ground coffee, it is at times of a definite advantage to provide a product having that same appearance. Light-milled roast and ground coffee has the bulk appearance of conventional roast and ground coffee and, surprisingly, the same bulk density, and yet has from 10 percent to 30 percent increase in flavor strength over and above conventional roast and ground coffee. It should be noted that light-milled coffee is characterized as having the “bulk appearance” of roast and ground coffee. While individual particles may by pure chance have the geometric shape of a flake, they all differ from flakes in cell characterization and extractability characteristics and, when viewed in bulk, give a visual impression distinct from flakes and very much like roast and ground coffee.

It is an object of the fifth group of embodiments to provide light-milled roast and ground coffee, which has the bulk appearance of conventional roast and ground coffee particles, the same bulk density as conventional roast and ground coffee particles and, yet, which is from 10 percent to 30 percent greater in flavor strength than conventional roast and ground coffee.

One aspect of the fifth group of embodiments provides a coffee composition for use in a beverage unit and method thereof as defined in the Summary of the Invention, wherein the coffee composition comprises a light-milled roast and ground coffee having a bulk appearance and density like that of roast and ground coffee but providing from about 10% to about 30% increased flavor strength over an equivalent amount of roast and ground coffee; said light-milled roast and ground coffee obtained by a process comprising:

passing roast and ground coffee through a roll mill under one of a three-variable set of mutually exclusive processing conditions; said mutually exclusive processing sets comprising: a roll pressure of from 750 pounds/inch of nip to 1,400 pounds/inch of nip, at a roll peripheral surface speed of from 200 feet/minute to 350 feet/minute, and at a roast and ground coffee feed rate to the mill of from 100 pounds/hour per inch of nip to 275 pounds/hour per inch of nip; a roll pressure of from 850 pounds/inch of nip to 1,700 pounds/inch of nip, at a roll peripheral surface speed of from 350 feet/minute to 600 feet/minute at a roast and ground coffee feed rate to the mill of from 275 pounds/hour per inch of nip to 400 pounds/hour per inch of nip; a roll pressure of from 1,000 pounds/inch of nip to 2,000 pounds/inch of nip at a roll peripheral surface speed of from 600 feet/minute to 750 feet/minute at a roast and ground coffee feed rate to the mill of from 400 pounds/hour per inch of nip to 500 pounds/hour per inch of nip, respectively.

Another aspect of the fifth group of embodiments provides a coffee composition for use in a beverage unit and method thereof as defined in the Summary of the Invention, wherein the coffee composition comprises a light milled roast and ground coffee, which has a bulk appearance of conventional roast and ground coffee particles and, which has 10 to 30% increase in flavor strength over an equivalent amount of conventional roast and ground coffee particles; made from a method comprising passing roast and ground coffee through a roll mill at a roll pressure of from 750 pounds/inch of nip to 1,400 pounds/inch of nip, at a roll peripheral surface speed of from 200 feet/minute to 350 feet/minute and at a roast and ground coffee feed rate to the mill of from 100 pounds/hour per inch of nip to 275 pounds/hour per inch of nip. For example, the roll mill surface temperature may be from 50° F. to 200° F., such as from 90° F. to 180° F.

Still another aspect of the fifth group of embodiments provides a coffee composition for use in a beverage unit and method thereof as defined in the Summary of the Invention, wherein the coffee composition comprises a light milled roast and ground coffee which has a bulk appearance of conventional roast and ground coffee particles and which has 10 to 30% increase in flavor strength over an equivalent amount of conventional roast and ground coffee particles; made from a method comprising passing roast and ground coffee through a roll mill at a roll pressure of from 850 pounds/inch of nip to 1,700 pounds/inch of nip, at a roll peripheral surface speed of from 350 feet/minute to 600 feet/minute and at a roast and ground coffee feed rate to the mill of from 275 pounds/hour per inch of nip to 400 pounds/hour per inch of nip. For example, the roll mill surface temperature may be from 50° F. to 200° F., such as from 90° F. to 180° F.

A further aspect of the fifth group of embodiments provides a beverage unit and method thereof as defined in the Summary of the Invention, wherein the coffee composition comprises a light milled roast and ground coffee which has a bulk appearance of conventional roast and ground coffee particles and which has 10 to 30% increase in flavor strength over an equivalent amount of conventional roast and ground coffee particles; made from a method comprising passing roast and ground coffee through a roll mill at a roll pressure of from 1,000 pounds/inch of nip to 2,000 pounds/inch of nip, at a roll peripheral surface speed of from 600 feet/minute to 750 feet/minute and at a roast and ground coffee feed rate to the mill of from 400 pounds/hour per inch of nip to 550 pounds/hour per inch of nip. For example, the roll mill surface temperature may be from 50° F. to 200° F., such as from 90° F. to 180° F.

The fifth group of embodiments as described above will be further described in the following paragraphs and exemplified in Examples 18-20. In forming light-milled roast and ground coffee, roast and ground coffee is subjected to mechanical pressure by passing conventional roast and ground coffee particles through two parallel smooth or highly polished rolls so that the coffee particles passing between the rolls are subjected to sufficient stress in order to provide the previously described cell distortion, i.e., partial cell fracture, partial cell disruption, some cell flattening and compression and generally a weakened and distorted but still definite cell structure.

In roll milling roast and ground coffee to produce light-milled coffee, it has been found important to control several process variables besides pressure. These additional variables which are essential to control within hereinafter-defined ranges include roast and ground coffee feed rate to the mill and roll peripheral surface speed. Other variables of less importance from the standpoint of producing a light-milled coffee but still important from an overall efficiency standpoint include mill diameter, coffee moisture content and particle size, and roll surface temperature.

The three most important factors in the fifth group of embodiments, which must be controlled in producing light-milled, cell-fractured roast and ground coffee are the roll pressure, the roast and ground coffee feed rate, and roll peripheral surface speed. Roll pressure is measured in pounds/inch of nip. Nip is a term used in the art to define the length of surface contact between two rolls when the rolls are at rest. To illustrate, it can be thought of as a line extending the full length of the rolls and defining the point of contact between two rolls. Feed rate as used herein is defined as the pounds of roast and ground coffee per hour passing through each inch of nip. The third variable, roll peripheral surface speed, is measured in feet/minute of surface circumference which passes by the nip. Generally, higher peripheral speeds mean that pressures within the lower portion of the hereinafter described ranges can be employed to produce satisfactory light-milled coffee of the requisite bulk density. Conversely, at lower peripheral speeds pressures at or near the higher end of the hereinafter described ranges must be employed to produce light-milled coffee of the requisite bulk density.

In further regard to roll peripheral surface speeds, it should be mentioned that it is preferred in the fifth group of embodiments that the individual rolls of the roller mill be operated at the same speeds. Differential roll speeds, however, can be utilized. If differential roll speeds are utilized, roll speed ratios in excess of 1.5:1 are not desirable. Preferably, when differential roll speeds are employed the roll speed rate is within the range of 1:1 to 1.4:1.

It is to be understood that the three important variables in fifth group of embodiments, i.e. pressure, roll speed and feed rate, are all interrelated and act in a combined manner to produce light-milled coffee. Thus, within a given range for a single variable manipulation within a corresponding range must occur for the other two variables in order to insure preparation of light-milled coffee rather than flakes. For example, as feed rate is increased the pressure and roll speed must also be increased to continue production of light-milled coffee as that product is defined herein.

Because the relationship of the important variables includes three determinations, i.e., pressure, roll speed and feed rate, it cannot adequately be presented on two-dimensional graphic illustration. Moreover, because the interdependence of these three variables in producing light-milled coffee is not a linear relationship but rather a curved line relationship, they cannot be expressed as absolute ranges, the entire scope of which will produce light-milled coffee. Of course, this non-straight line relationship and non-planar (three-dimensional as opposed to two-dimensional) relationship makes definition difficult. However, by experimentation it has been found that the relationships shown in the following Table will produce the desired light-milled product. The three sets of relationships presented in the Table below represent an experimental integration of a plurality of data points.

TABLE

| | Pressure, | Roll speed, | Feed rate, |
|---|---|---|---|
| Set No. | lbs./in. | ft./min. | lbs./hr./in. |
| 1 | 750-1400 | 200-350 | 100-275 |
| 2 | 850-1700 | 350-600 | 275-400 |
| 3 | 1000-2000 | 600-750 | 400-550 |

The important factor to remember is that within each given set of conditions, operation at points within the expressed ranges will produce light-milled coffee. The overlap of ranges occurs because of the non-linear and non-planar relationship that exists. For example, at a roll pressure of 2,000 lbs./inch of nip and a roll speed of 700 ft./min., a 0.012 inch thickness flake will be produced at a feed rate of 100 lbs./hr./inch, a 0.020 inch thickness flake will be produced at a feed rate of 300 lbs./hr./inch and light-milled coffee will be produced at a feed rate of 550 lbs./hr./inch. In like manner, at a roll speed of 700 ft./min. and a feed rate of 445 lbs./hr./inch, a 0.27 inch thickness flake will be produced at a pressure of 2,200 lbs./inch of nip; light-milled coffee will be produced at 1,400 lbs./inch of nip; and at a pressure of 660 lbs./inch of nip roast and ground coffee passing through the mill will remain unchanged in terms of cell characterization. Thus, as can be seen from the above specific examples only conditions of pressure, roll peripheral surface speed and coffee feed rate falling wholly within a single one of the above sets specified in the Table, as opposed to falling within the entire range of conditions expressed amongst all three sets, will assure preparation of light-milled coffee. Put still another way, where pressure, roll speed and feed rate fall wholly within set No. 3 of conditions, light-milled coffee will result, but where both pressure and roll speed fall within the ranges for set No. 3 conditions and the feed rate falls within set No. 1 conditions, the result may be a flake (see the first example given in this paragraph).

It should be understood that as roll speed is increased beyond 750 ft./min., if pressure is increased beyond 2,000 lbs./inch and feed rate is increased beyond 550 lbs./hr./inch, some light-milled coffee may be formed. Likewise, as pressure is reduced below 750 lbs./inch and roll speed is reduced below 200 ft./min. and feed rate is reduced below 100 lbs./hr./inch, some light-milled coffee may be produced. However, such conditions are not practical because of the resulting low capacities.

Roll surface temperature, as used herein, is measured in degrees Fahrenheit, and refers to the average surface temperature of the rolls. Control of the roll mill surface temperature is accomplished by controlling the temperature of a heat exchange fluid passing through the inner core of the rolls. Generally, the fluid, which is most often water, is heated or cooled and passed through the inside of the rolls. The result is that the roll surface, which is usually a smooth, highly polished steel surface, is subjected to temperature control by means of heat transfer. Of course, in actual operation the surface temperature will not be exactly the same as the temperature of the heat exchange fluid, and will be somewhat higher because milling of coffee particles to produce light-milled coffee tends to increase the roll surface temperature. Accordingly, the required heat exchange fluid temperature to maintain any specific roll surface temperature depends upon several factors, such as the kind of metal the roll surfaces are made of, the speed of operation of the roll mills, and the heat exchange fluid employed.

Generally, it can be stated that higher roll surface temperatures tend to increase the propensity for flavor degradation of the light-milled, roast and ground coffee, and therefore should be avoided. On the other hand, lower roll surface temperatures can be employed without disadvantages. However, no particular advantage is gained in utilizing temperatures below room temperatures so that a cooling medium must be employed. Generally, satisfactory light-milled coffee can be produced wherein the roll surface temperature is within the range of from 50° F. to 200° F. Temperatures less than 50° F. are undesirable because cooling systems must be employed and the resulting product tends to be quite brittle and easily fractured to produce large quantities of coffee fines, which are undesirable because they result in a change in product bulk density. Temperatures above 200° F. should be avoided because at temperatures elevated above 200° F. noticeable degradation of coffee flavor occurs. To produce light-milled coffee having a bulk density, which is essentially the same as that of roast and ground coffee without noticeable flavor degradation, it is preferred that the roll mill surface temperature be within the range of 90° F. to 180° F. When roll surface temperatures are within this range the majority of the resultant cell-fractured, light-milled coffee is of a proper structural integrity to insure a bulk density near that of roast and ground coffee coupled with a product which exhibits little or no flavor degradation.

In the fifth group of embodiments, the bulk density of roast and ground coffee is generally within the range of from 0.38 g/cc to 0.50 g/cc, and most often within the preferred range of from 0.42 g/cc to 0.48 g/cc. Such bulk densities are generally those of conventionally prepared roast and ground coffees of regular, drip, and fine grinds. If the light-milled product bulk density varies from this range and is, for example, higher, the consumer would need to use substantially less than usual quantities of coffee to produce a brew of given strength. This required adjustment in consumer habits might be met with difficulty, and therefore careful attention is given to producing product having a bulk density similar to that of roast and ground coffee so that familiar measurement techniques can still be employed. Using the process conditions specified herein gives a product having the bulk density of roast and ground coffee.

In producing light-milled roast and ground coffee, the light-milled, cell-fractured coffee product moisture content preferably should be from 2.5 to 7.0 percent by weight, with from 3.0 to 6.0 percent being most preferred. Consequently, the moisture content of the conventional roast and ground coffee particles which are utilized to prepare light-milled coffee preferably should be within the range of from 2.5 to 7.0%. At moisture contents less than 2.5% the conventional roast and ground coffee is often too dry to produce light-milled coffee, and may have a tendency to grind into fines rather than become light-milled. On the other hand, moisture contents above 7.0% preferably are to be avoided because the staling propensity of the resulting light-milled coffee is substantially increased at such high moisture contents. Providing a moisture content of the conventional roast and ground coffee to be light-milled within the range of from 3.0 to 6.0% provides the highest yield of light-milled coffee coupled with little or no flavor degradation, and is most therefore preferred.

In regard to the particle size of the conventional roast and ground coffee employed in producing the light-milled product of the fifth group of embodiments, no criticality exists. However, from the standpoint of producing products of a bulk density similar to that of conventional roast and ground coffee, it is preferred that the roast and ground coffee particles be of conventional size distributions; that is, have a particle size of from 0.0 to 18.0% retained on a 12 mesh U.S. Standard Screen, from 0.0 to 46.0% retained on a 16 mesh U.S. Standard Screen, from 15.0 to 50.0% retained on a 20 mesh U.S. Standard Screen, from 7.0 to 30.0% retained on a 30 mesh U.S. Standard Screen, from 4.0 to 15.0% retained on a 40 mesh U.S. Standard Screen, and from 3.0 to 8.0% passing through a 40 mesh U.S. Standard Screen. Speaking in more familiar terms, the roast and ground coffee to be light milled can be “regular”, “drip” or “fine” grind as these terms are used in a traditional sense. The standards of these grinds as suggested in the 1948 Simplified Practice Recommendation by the U.S. Department of Commerce (see Coffee Brewing Workshop Manual, page 33, published by the Coffee Brewing Center of the Pan American Bureau are as follows: “Regular grind”, 33% is retained on a 14 mesh Tyler Standard Sieve, 55% is retained on a 28 mesh Tyler Standard Sieve and 12% passes through a 28 mesh Tyler Standard Sieve; “drip grind”, 7% is retained on a 14 mesh Tyler Standard Screen, 73% on a 28 mesh Tyler Standard Sieve and 20% passes through a 28 mesh Tyler Standard Sieve; and “fine grind” 100% passes through a 14 mesh Tyler Standard Sieve, 70% being retained on a 28 mesh Tyler Standard Sieve and 30% passing through a 28 mesh Tyler Standard Sieve. Of the above mentioned traditional grind sizes, the most preferred is “regular grind.”

In further regard to particle size, it has previously been mentioned that the light-milled, cell-fractured coffee product of the fifth group of embodiments has a bulk density substantially similar to that of conventional roast and ground coffee. In other words, it is important to remember that the light milling process of the fifth group of embodiments does not involve bulk density change but merely changes the individual cell characteristics. The input of conventional roast and ground coffee particles has the same bulk density as the output of light-milled coffee, the only difference being that the output, despite the fact that it has the overall appearance of roast and ground coffee, has been cell distorted as that term is used herein. The distortion that occurs results in from 20 to 65% of the cells being at least partially disrupted and therefore extractability of the product is increased.

The diameter of the roll mills employed controls the angle of entry into the nip. Angle of entry into the nip in turn has a direct effect on the particle size of the coffee that will pass through the nip, and consequently on the bulk density of the resultant light-milled coffee. To produce the hereinbefore described light-milled coffee, with the requisite bulk density which is within the range of bulk densities for roast and ground coffee, it is preferred that the roll diameter be within the range of 6 inches to 30 inches with from 9 inches to 25 inches being most preferred. If rolls having a diameter of less than 6 inches are utilized the roast and ground coffee particles with a normal particle size distribution as hereinbefore described often tend to churn on the mill surfaces and not pass through the nip; consequently, the throughput rate of the conventional roast and ground coffee employed to produce light-milled coffee is so slow as to be impractical. Roll mills having roll diameters greater than 30 inches are not readily available.

As can be seen from the foregoing description of the fifth group of embodiments, the ranges of each of the described milling process variables are closely tied to and correlated with each of the other processing variables. A change in one variable often has a direct effect in changing another variable.

In preparing the coffee composition for use in a beverage unit as defined in the Summary of the Invention, the coffee in the coffee composition 110/130 and beverage material 120 as shown in FIGS. 1A, 1B, and 1C may have various cell structures. As previously mentioned, the invention contemplates flaked roast and ground coffee. Flaking of roast and ground coffee can be used advantageously to control or regulate the flavor and aroma of coffee as well as the extractability. In the sixth group of embodiments according to the present invention, an improved roast coffee product comprising as a major portion low and/or intermediate grade flaked coffees, and as a minor portion high-grade roasted and ground coffee, is prepared by utilizing the varying effect of flaking on high, low, and intermediate grade coffees. Also disclosed in the sixth group of embodiments are flakes having particularly desirable physical properties.

The sixth group of embodiments relates to an improved roast coffee product characterized by enhanced extractability and a predominance of the delicate flavor and aroma characteristics of high quality coffee, said product utilizing, in predominating proportions, flaked coffee of intermediate and/or low quality varieties.

Briefly and generally, the objects and advantages of the sixth group of embodiments are accomplished by compressing roast and ground coffee selected from a class consisting of the low and intermediate grade coffees into the form of flakes to diminish the undesirable flavor and aroma constituents and bring out the more desirable of such constituents naturally present in such coffees thereby enhancing their flavor and aroma properties from a consumer acceptance standpoint while simultaneously increasing their extractability, and thereafter admixing such coffee flakes with lesser amounts of non-compressed roast and ground particles of the more expensive high grade coffees whose natural flavor and aroma properties are substantially unimpaired. Preferably, the resultant coffee product comprises from 70 to 90 percent by weight of a blend of low and intermediate quality coffee flakes. More preferably, the low and intermediate quality coffee flakes comprise 75 to 85 percent by weight of the coffee product, and the weight ratio of low to intermediate quality flakes is from 0.1:1 to 3:1.

In connection to the background of the sixth group of embodiments, roast and ground coffee products presently available in the market place comprise various blends of differing grades of coffees. The differing grades of coffees are classified in the art as “low,” “intermediate,” and “high.” These terms, i.e. low, intermediate, and high, define three distinct classes of coffees, each having its own characteristic properties. For example, in regard to natural flavor and aroma, low grade coffees such as Robustas and others enumerated hereinafter are often characterized as “dirty,” “earthy,” “rubbery,” “fermented,” “musty,” and “strong, pungent and bitter.” Intermediate grade coffees such as Brazilian coffees, African naturals and others detailed hereinafter, are characterized in terms of natural flavor and aroma as “bland,” “neutral,” “lacking in aromatic and high grown notes,” “sweet,” and “not offensive.” High grown coffee such as good quality Arabicas and Colombians, are characterized in terms of natural flavor and aroma as having “excellent body,” “acid,” “fragrant,” “thin,” “aromatic,” and occasionally “chocolatey.” For details in regard to definitions of these natural flavor and aroma characterization phases, see Sivetz, Coffee Processing Technology, Vol. 1, published in 1963 by Avi Publishing Company, at pages 173 through 175.

Consumer-acceptable roast and ground coffees generally comprise a blend of all three classes of coffees. Blending is utilized to emphasize the desirable characteristics of each grade of coffees. For example, some strong body notes characteristic of low grade coffees are desirable as well as some fragrant and aromatic notes characteristic of high grown coffees. Intermediate grade quality coffees typically contribute to overall taste impact and body of the coffee. Because the most desirable flavor and aromas obtainable in roast and ground coffee blends come from high grown coffees, it is desirable to include high percentages of high grown coffees in roast and ground coffee blends. However, high grown coffees, as one might expect, are the most expensive of the three classes of coffees; and moreover, high grown flavor not complemented by other flavors is not desirable.

In regard to the blends of coffees presently sold in the market, it should be remembered that each of the roast and ground coffee products presently sold are characterized as being ground particles prepared from roasted whole coffee beans. These particles are substantially intact in cellular structure and are not compressed to provide substantial cellular disruption.

As used in the sixth group of embodiments, the term “roast and ground coffee” refers to a coffee product comprising conventionally prepared roast and ground coffee particles often characterized herein as non-compressed coffee particles. It does not include flaked roast and ground coffee particles which are hereinafter referred to as “flaked coffee”; the term “roast and ground” encompasses both caffeinated and decaffeinated versions, unless otherwise stated.

While the presently marketed roast and ground coffee products do enjoy a substantial part of the coffee market, they have several disadvantages. One of the primary disadvantages is that conventional roast and ground coffee products have poor extractability. That is, during preparation of cups of roast and ground coffee beverage, it has been shown that only about 20 percent of the solid material contained in the roast and ground coffee is extracted during conventional percolation processes. The remaining portion of the coffee is discarded as grounds. The poor extractability either results in a weakened beverage or in excessive brewing time; in order to compensate for low extractability consumers usually increase the amount of coffee used to make a cup which increases expense to the consumer.

Flaked coffee is known in the art. McKinnis, U.S. Pat. No. 1,903,362, Rosenthal, U.S. Pat. No. 2,123,207, and Carter, U.S. Pat. No. 2,368,113, all disclose preparation of flaked coffee by roll milling roast and ground coffee. Of these three patents, the most relevant is McKinnis who discloses production of “very thin” and “substantially uniform thickness” coffee flakes by roll milling roast and ground coffee particles.

While each of the above-cited patents discloses broadly the concept of flaking roast and ground coffee to increase extractability, none of the cited patents disclose flaking of roast and ground coffee as a means of regulating coffee flavor and aroma. Therefore, while increasing extractability is taught by these three prior art patents, the effect of flaking on coffee flavor and aroma is not taught by the prior art, and actually the prior art teaches away from this concept. The essence of the sixth group of embodiments lies in the discovery that flaking can be utilized as an effective process tool in regulating coffee flavor and aroma and in producing coffee products comprising as a major portion flaked intermediate and/or low grade coffees, and as a minor portion high grade roast and ground coffee.

In sixth group of embodiments, flaking of roast and ground coffee not only has an effect on the property of extractability, it also can have a very definite effect on flavor and aroma. Even more surprisingly, the effect of flaking on flavor and aroma varies widely depending on the grade of coffee involved, and that flaking can be used selectively to advantageously regulate coffee flavor and aroma to produce an improved coffee product in accord with the objects of sixth group of embodiments. The sixth group of embodiments resides in the selective utilization of this heretofore unknown aspect of flaking as an effective process tool to produce improved novel coffee products comprising unique mixtures of the different grades of coffees.

It is the object of the sixth group of embodiments to regulate and control the flavor strength and aroma of coffee by providing a coffee product comprising as a major portion flaked coffee particles, said flakes being of low and/or intermediate quality, and as a minor portion roast and ground coffee particles, said roast and ground coffee comprising high grade coffees.

An additional object of the sixth group of embodiments is to provide roast and ground coffee flakes having unique physical characteristics suitable for providing a commercially attractive coffee product.

An additional object of the sixth group of embodiments is to provide a process of making a coffee product comprising as a major portion flaked roast and ground coffee, said coffees being of intermediate and/or low grade coffees, and as a minor portion, roast and ground coffee particles, said particles being of high grade coffee varieties.

One aspect of the sixth group of embodiments provides for a coffee composition for use in a beverage unit such as a cartridge and method thereof as defined in the Summary of the Invention, wherein the coffee composition comprises an improved roast coffee product of enhanced extractability, flavor and aroma characterized by predominance of the delicate flavor and aroma notes naturally characteristic solely of high grade coffees comprising:

a. as a minor portion thereof, non-compressed, high grade roast and ground coffee particles of unimpaired natural flavor and aroma; and

b. as a major portion thereof, roast and ground coffee selected from a class of coffee consisting of the low and intermediate grade coffees, said low and intermediate grade coffees being in the form of compressed flakes wherein the undesirable natural flavor and aroma constituents thereof have been diminished and the extractability thereof enhanced.

In more specific examples under this aspect, the major portion of the improved roast coffee product comprises low quality coffees.

In more specific examples under this aspect, the major portion of the improved roast coffee product comprises intermediate quality coffees.

In more specific examples under this aspect, the major portion of the improved roast coffee product comprises a blend of low and intermediate quality coffees. Such flaked roast and ground coffee may have a flake bulk density of from 0.38 g./cc to 0.50 g./cc. The weight ratio of low quality flakes to intermediate quality flakes is within the range of from 0.1 to 1 to 3 to 1. Such improved roast coffee product may comprise flaked roast and ground coffee and roast and ground coffee particles wherein said roast and ground coffee particles comprise from 10 percent to 30 percent by weight of said product. From 3 to 10 percent of said product may pass through a 40 mesh U.S. Standard screen and wherein not more than 35 percent of said product will remain on a 12 mesh U.S. Standard screen. The roast and ground coffee particles may comprise from 15 to 25 percent by weight of the product. The flaked roast and ground coffee may have a flake thickness of from 0.008 inch to 0.25 inch, such as from 0.010 inch to 0.016 inch.

In more specific examples under this aspect, the improved roast coffee product may comprise flaked roast and ground coffee and roast and ground coffee particles wherein said roast and ground coffee particles comprise from 10 to 30 percent by weight of said product. For instance, from 3 to 10 percent of said product will pass through a 40 mesh U.S. Standard screen and wherein not more than 35 percent of said product will remain on a 12 mesh U.S. Standard screen. The roast and ground coffee particles may comprise from 15 to 25 percent by weight of said product. The flaked roast and ground coffee has a flake thickness of from 0.010 inch to 0.016 inch.

In more specific examples under this aspect, the flaked roast and ground coffee has a flake thickness of 0.008 inch to 0.25 inch; and/or a flake bulk density of from 0.38 g./cc. to 0.50 g./cc.

In more specific examples under this aspect, the coffee flakes may comprise low grade Robusta coffees and said non-compressed coffee particles comprise high grade Arabica coffees.

In more specific examples under this aspect, the coffee flakes may comprise intermediate grade Brazilian coffees and said non-compressed coffee particles comprise high grade Arabica coffees.

In more specific examples under this aspect, the coffee flakes may comprise low grade Robustas and intermediate grade Brazilian coffees, and in which said non-compressed coffee particles comprise high grade Arabica coffees.

In more specific examples under this aspect, the flakes may be made from coffee selected from the class consisting of Robustas, low grade Naturals, low grade Brazils, low grade unwashed Arabicas, intermediate Brazils, African Naturals, others free from strong Rioy flavors and combinations thereof; and in which the non-compressed high grade roast and ground coffee particles are made from coffees selected from the class consisting of high grade Arabicas and combinations thereof. Said low grade Naturals may comprise Haiti XXX, Peru Naturals, and Current Salvadors, said low grade unwashed Arabicas comprise Ugandas, Indonesians, Ivory Coast, Dominican Republics, Ecuador Resacas, and Guatemalan TEM's, said intermediate grade Brazils comprise Santos and Paranas, and said other coffees free from strong Rioy flavors comprise good quality Sul de Minas; and said high grade Arabicas comprise Colombians, Mexicans, and other washed Milds such as strictly hard bean Guatemalans.

In more specific examples under this aspect, the compressed coffee flakes may have a substantial portion of their cells disrupted. For instance, the compressed coffee flakes may have at least from about 70 to about 85 percent of their coffee cells disrupted.

Another aspect of the sixth group of embodiments provides for a coffee composition for use in a beverage unit and method thereof as defined in the Summary of the Invention, wherein the coffee composition comprises an improved roast coffee product characterized by enhanced extractability and a predominance of the delicate flavor and aroma characteristics of high quality coffee utilizing in predominating proportions flaked roast and ground coffee of low and intermediate quality varieties, made from a method comprising:

a. roasting and grinding into particles low quality coffees and thereafter substantially enhancing the extractability of said coffee particles while simultaneously substantially reducing their natural volatile flavor constituents by expelling a substantial portion of the natural flavor-producing constituents normally entrapped therein by compressing said coffee particles into flakes;

b. roasting and grinding into particles intermediate quality coffees and thereafter substantially enhancing the extractability of said coffee particles while simultaneously decreasing their aroma and increasing their natural flavor producing capacity by expelling a substantial portion of the natural gases normally entrapped therein by compressing said coffee particles into flakes;

c. roasting and grinding coffee of the high quality variety to form non-compressed coffee particles of unimpaired flavor and aroma; and

d. admixing said low and intermediate quality coffee flakes in predominating proportions with said high quality coffee particles to form a highly extractable coffee product of prime quality flavor and aroma.

In more specific examples under this aspect, steps (a) and (b) may be conducted simultaneously by using a blend of low and intermediate quality coffees. The flakes may have a substantial portion of their coffee cells disrupted, e.g. at least from about 70 to about 85 percent of their coffee cells disrupted.

Still another aspect of the sixth group of embodiments provides for a coffee composition for use in a beverage unit and method thereof as defined in the Summary of the Invention, wherein the coffee composition comprises an improved roast coffee product characterized by enhanced extractability and a predominance of the delicate flavor and aroma characteristics of high quality coffee utilizing in predominating proportions flaked roast and ground coffee of low quality variety, made from a method comprising:

a. roasting and grinding into particles low quality coffees and thereafter substantially enhancing the extractability of said coffee particles while simultaneously substantially reducing their natural volatile flavor constituents by expelling a substantial portion of the natural flavor-producing constituents normally entrapped therein by compressing said coffee particles into flakes;

b. roasting and grinding coffee of the high quality variety to form non-compressed coffee particles of unimpaired flavor and aroma; and

c. admixing said low quality coffee flakes in predominating proportions with said high quality coffee particles to form a highly extractable coffee product of prime quality flavor and aroma.

In more specific examples under this aspect, the flakes may have a substantial portion of their coffee cells disrupted, such as at least from about 70 to about 85 percent of their coffee cells disrupted.

Still another aspect of the sixth group of embodiments provides for a coffee composition for use in a beverage unit and method thereof as defined in the Summary of the Invention, wherein the coffee composition comprises an improved roast coffee product characterized by enhanced extractability and a predominance of the delicate flavor and aroma characteristics of high quality coffee utilizing in predominating proportions flaked roast and ground coffee of intermediate quality varieties, made from a method comprising:

a. roasting and grinding into particles intermediate quality coffees and thereafter substantially enhancing the extractability of said coffee particles while simultaneously decreasing their aroma and increasing their natural flavor producing capability by expelling a substantial portion of the natural gases normally entrapped therein by compressing said coffee particles into flakes;

b. roasting and grinding coffee of the high quality variety to form non-compressed coffee particles of unimpaired flavor and aroma; and

c. admixing said intermediate quality coffee flakes in predominating proportions with said high quality coffee particles to form a highly extractable coffee product of prime quality flavor and aroma.

In more specific examples under this aspect, said flakes may have at least from about 70 to about 85 percent of their coffee cells disrupted, e.g. at least from about 70 to about 85 percent of their coffee cells disrupted.

A further aspect of the sixth group of embodiments provides a coffee composition for use in a beverage unit and method thereof as defined in the Summary of the Invention, wherein the coffee composition comprises a roast and ground coffee flakes having a flake bulk density of from 0.38 g./cc. to 0.50 g./cc. a flake thickness of from 0.008 inch to 0.025 inch and a flake moisture content from 2.5 to 7.0 percent.

In more specific examples under this aspect, the roast and ground coffee flakes may be caffeinated; the bulk density may be from 0.42 g./cc. to 0.48 g./cc; the coffee flakes may have a flake thickness of from 0.010 inch to 0.016 inch; the coffee flakes may have a flake moisture content of from 3.0 to 6.0 percent; the coffee flakes may have a color on the Hunter Color “L” scale of from 18 to 23, such as from 19 to 21; the coffee flakes may be further characterized as low grade and/or intermediate grade coffee flakes; they may be Robusta coffee flakes; from 3 to 10 percent of said flakes may pass through a 40 mesh U.S. Standard screen, e.g. not more than 35 percent of said flakes will remain on a 12 mesh U.S. Standard screen; and/or the coffee flakes may be decaffeinated coffee flakes.

The sixth group of embodiments as described above will be further described in the following, and exemplified by Examples 21-25.

The essence of the sixth group of embodiments lies in the discovery that flaking of roast and ground coffee particles can be used as an effective tool to modify flavor and aroma characteristics of various grades of coffees.

As used in the sixth group of embodiments, “natural flavor and aroma” refers to the flavor and aroma of conventional roast and ground coffees; the phrase “flavor and aroma” per se refers to the flavor and aroma result achieved by compressing roast and ground coffee into flakes.

The effect of flaking of roast and ground coffee particles varies with the grade of roast and ground coffee particles to be flaked. For example, flaking of low grade coffees increases the strength of coffee beverages produced therefrom and also enhances the flavor and aroma of the low grade coffees by expelling natural volatile flavor constituents producing the bitter, rubbery-tasting notes which characterize these coffees. Conversely, when high grade coffees are flaked, while there is an increase in beverage strength, there is a decrease in favorable natural flavor and aroma qualities. When intermediate grade quality coffees are flaked, there is a slight decrease in aroma, an increase in strength and an increase in those natural flavors which are regarded as typically characteristic of intermediate grade coffees. The effect of flaking on each of these coffees will now be discussed in detail.

First in regard to low grade coffees, flaking of low grade coffees increases the strength of the resulting coffee beverage and enhances the flavor and aroma of a resulting coffee beverage.

Generally speaking, low quality coffees such as Robustas, produce brews with strong distinctive natural flavor characteristics often noted as bitter and possessing varying degrees of a rubbery flavor note, which are not considered desirable in large quantities in united States coffee products. However, it has been surprisingly discovered that producing flaked low quality coffees enhances the flavor and aroma of the low quality coffee coupled with an increase in strength. In other words, the natural bitterness and rubber note usually characteristic of low quality coffees becomes much less dominant when the low quality coffee is a flaked low quality coffee.

This phenomenon, i.e., increase in strength coupled with an enhancement in flavor and aroma, is seen in low quality coffees such as Robustas, low grade naturals such as Haiti XXX, Peru naturals, current Salvadors, low grade Brazils, and low grade unwashed Arabicas such as Ugandas, Indonesians, Ivory Coast, Dominican Republics, Ecuador Resacas, and Guatemalan TEM's.

Turning now to intermediate grade quality coffees, when intermediate quality coffees are flaked, the resulting flaked coffee is characterized by an increase in strength, a slight loss of natural aroma, and an increase in those natural flavors which are regarded as typically characteristic of intermediate grade coffees. In other words, flaked intermediate grade coffee exhibits an increase in extractability, a slight decrease in natural aroma, and surprisingly, an increase in the typical, i.e. natural, flavor characteristics usually associated with the specific coffee involved. For example when intermediate grade Brazilian coffees are flaked, there is an increase in extractability, a slight loss of natural Brazilian aroma, and surprisingly, an increase in the typical flavor of Brazilian coffees. This phenomenon, i.e., increase in extractability, slight loss of aroma, and increase in characteristic and/or natural flavor, is seen in flaked intermediate grade coffees. Suitable intermediate grade coffees for flaking are Brazilian coffees such as Santos and Paranas, African naturals, and others free from strong Rioy flavors such as good quality Sul de Minas.

Turning now to the effect of flaking on high grade coffees, when high grade coffees are flaked the resulting coffee is increased in strength, i.e., extractability, and there is a substantial decrease in both natural flavor and aroma. For example, when high grade Arabicas such as Colombians are flaked, there is a decrease in natural flavor and aroma of the resulting flaked high grade Colombian, coupled with an increase in strength. Examples of typical high quality coffees are “milds” often referred to as high grade Arabicas, and include, among others, Colombians, Mexicans, and other washed milds, such as strictly hard bean Costa Ricans, Kenyas A and B's, and strictly hard bean Guatemalans.

It is believed that, utilizing the above-described effects of flaking on coffee flavor and aroma, an improved roast coffee product can be prepared. The improved roast coffee product of the sixth group of embodiments is superior to products comprising all roast and ground coffee particles in that it has increased extractability, greater flavor strength, and an aroma equal to that of conventional roast and ground coffee products. The improved roast coffee product of the sixth group of embodiments is superior to a 100 percent flaked coffee product in that it has a superior flavor and aroma.

In its broadest aspect, the improved roast coffee product of the sixth group of embodiments comprises as a major portion low and/or intermediate quality coffee flakes, and as a minor portion high grade coffee grounds.

It is preferred that the major portion of the improved coffee product of the sixth group of embodiments, i.e., the flake portion, be comprised of a blend of low quality and intermediate quality coffee flakes. However, if desired, all low quality coffee flakes or all intermediate quality coffee flakes can be utilized. Of course, because flaking affects the flavor and aroma of low quality coffees and intermediate quality coffees in a different manner, utilization of all one grade to the exclusion of the other will provide a product of differing flavor and aroma. In the preferred embodiment of utilizing a blend of low and intermediate quality flakes, it is preferred that the weight ratio of low to intermediate quality flakes be within the range of from 0.1:1 to 3:1, and most preferably within the range of 0.5:1 to 2:1. Preferably the low grade and intermediate grade coffees are blended and then flaked simultaneously; however, they can also be flaked individually and subsequently blended.

Suitable high grade coffees for the roast and ground coffee minor portion of the improved roast coffee product of the sixth group of embodiments, and suitable low and intermediate quality coffees for the major flake portion of the improved roast coffee product of the sixth group of embodiments have been previously set forth in this specification.

In a most preferred aspect of the sixth group of embodiments, the improved roast coffee product comprises a mixture of flaked roast and ground coffee with roast and ground coffee particles wherein the roast and ground coffee particles comprise from 10 percent to 30 percent by weight of said product, said roast and ground coffee particles being of high grade variety, and said flaked roast and ground coffee being of low and/or intermediate quality coffees.

The principal advantages of producing a product comprising as a major portion thereof flaked roast and ground coffee are three-fold.

First, the modification in flavor strength and aroma capable of being achieved by utilization of flaked coffee allows greater control over ultimate product flavor and aroma as well as blend variation in producing the product.

The second principal advantage of a product comprising as a major portion thereof, flaked roast and ground coffee, is that the product provides a brew of increased strength. As mentioned previously in the sixth group of embodiments, flaked roast and ground coffee provides increased extractability and therefore increases brew strength; consequently, the improved roast coffee product of the sixth group of embodiments because a major portion of said product is flaked roast and ground coffee, provides a product of substantially increased beverage strength.

Third, disruption of the cellular structure of coffee during milling to compress into flakes provides an easy means of escape for gases contained in coffee cells. Degassing is highly advantageous in that in subsequent packaging compensation for slow gas evolution need not be made. For instance, many roast and ground coffees presently sold on the market are vacuum packed in strong metal containers. Vacuum packing is employed as a means of providing a reduction in the internal container pressure, the buildup of which is caused by gases evolving from coffee cells. Thus, slow gas evolution from coffee cells can necessitate the employment of an expensive vacuum packing procedure. It also can necessitate the utilization of strong metal containers. The strong metal containers are employed to prevent internal pressure from bulging the container. Providing a substantially degassed flaked roast and ground coffee product avoids the need for a vacuum packing procedure and for utilizing expensive strong metal containers. The improved roast coffee product disclosed herein can be packed in foil fiber containers or in thinner and less expensive metal containers and need not be vacuum packed.

One disadvantage of flaked roast and ground coffee per se, with the exception of flaked low quality coffees, is the lack of desirable aroma and volatile constituents. Providing a product with pleasing aroma and flavor-laden volatile constituents is essential if high consumer acceptance is to be obtained.

Admixing roast and ground coffee particles with flaked roast and ground coffee within the most preferred range of from 10 percent to 30 percent by weight of roast and ground coffee particles overcomes the disadvantage of flaked roast and ground coffee and yet retains the principal advantages of flaked roast and ground coffee.

As mentioned previously in the sixth group of embodiments, it is preferred that the mixture of flaked roast and ground coffee and roast and ground coffee particles consist of from 10 percent to 30 percent by weight of roast and ground coffee particles. If less than 10 percent by weight of roast and ground coffee particles is utilized the product may not have a significant increase in aroma quality. On the other hand, if amounts of roast and ground coffee particles substantially in excess of 30 percent by weight are utilized the advantages of utilizing flakes of roast and ground coffee in the mixture may be substantially decreased, i.e., the substantial increase in brew strength coupled with flavor changes may not occur to a significantly noticeable degree. To obtain the advantages of flaked roast and ground coffee and yet maintain a product of high aroma and flavor, especially good results are achieved when the roast and ground coffee particles comprise from 15 percent to 25 percent by weight of the mixture.

Of course, as explained with respect to the broader description of the sixth group of embodiments, as long as the flaked coffee is a major portion (i.e., greater than 50 percent) and the roast and ground coffee a minor portion (i.e. less than 50 percent), an improved roast coffee product is still produced. Thus, the above narrower weight percentages are given with reference to highly preferred embodiments.

In regard to the particle size of the roast and ground coffee employed in the flaking process, it is preferred that the coffee be regular, drip, or fine grind as these terms are used in a traditional sense. The standards of these grinds as suggested in the 1948 Simplified Practice Recommendation by the U.S. Department of Commerce (see Coffee Brewing Workshop Manual, page 33, published by the Coffee Brewing Center of the Pan American Coffee Bureau) are as follows: “Regular grind,” 33 percent is retained on a 14 mesh Tyler standard sieve, 55 percent is retained on a 28 mesh Tyler standard sieve and 12 percent passes through a 28 mesh Tyler standard sieve; “drip grind” 7 percent is retained on a 14 mesh Tyler standard sieve, 73 percent on a 28 mesh Tyler standard sieve and 27 percent passes through a 28 mesh Tyler standard sieve; and “fine grind,” 100 percent passes through a 14 mesh Tyler sieve, 70 percent being retained on a 28 mesh Tyler standard sieve and 30 percent passing through a 28 mesh Tyler standard sieve. Of the above mentioned grind sizes, the most preferred is regular grind.

In making the flaked roast and ground coffee to be utilized in the sixth group of embodiments, it is preferred that grind sizes finer than fine grind not be employed. For example, when Espresso grind is utilized a high incidence of fine coffee particles is found to exist after the roll milling operation which is utilized in producing flaked coffee; this high incidence of fine coffee particles has the disadvantage of producing unsightly coffee dust which is often associated with high percentages of fines. However, a certain small percentage of fines present in the improved roast coffee product of the sixth group of embodiments has been found to be desirable. More specifically, in providing a consumer acceptable product it is preferred that the improved roast coffee product, i.e., the flakes and grounds mixture, have suitable particle dimensions such that from 3 to 10 percent of said product will pass through a 40 mesh U.S. Standard screen and not more than 35 percent will remain on a 12 mesh U.S. Standard screen. It is believed that if less than 3 percent of the improved roast coffee product passes through a 40 mesh screen, the liquid flow through a percolator basket containing said product becomes too rapid and insufficient contact time of the extraction liquid and the flaked coffee portion of the coffee product will result in a weakening of the brew strength. On the other hand, if more than 10 percent of the improved coffee product passes through a 40 mesh screen the high incidence of very fine particles may tend to produce a consumer-undesirable “float brew” and also increases the amount of pot sediment. A float brew refers to a condition in a percolator basket wherein the basket holes become plugged. This may cause a buildup of liquid in the basket and floating of coffee particles to the top of the basket. The result may be a weak brew due to under extraction. Additionally, it is believed that if more than 35 percent of the improved roast coffee product is of particle dimensions such that it remains on a 12 mesh U.S. Standard screen, consumer preference for the product is substantially decreased.

As previously mentioned, a preferred embodiment of the sixth group of embodiments provides a flavor-enhanced product of high consumer preference. This preferred embodiment comprises producing flaked coffee from a blend of low and intermediate quality coffees and admixing therewith, within the prescribed ranges, roast and ground coffee particles produced from high quality coffees.

In this preferred embodiment, the flakes of roast and ground coffee are prepared from coffee beans such as those listed above under the intermediate and low quality categories.

The coffees to be utilized in forming the roast and ground coffee particles are those listed above under high quality coffee beans and can be generically described as “milds.” It is within the scope of the sixth group of embodiments that various blends of high quality coffees such as a blend of Mexicans and Colombians, for example, can be employed in producing high quality roast and ground coffee particles.

A principal advantage of producing the improved roast coffee product of the sixth group of embodiments from low and intermediate quality coffee beans in regard to the roast and ground flakes and high quality coffee beans in regard to the roast and ground coffee particles is that a substantial flavor and aroma enhancement is noted. While not wishing to be bound by any theory it is believed that the explanation for this is as follows: The roll milling process, hereinafter explained, utilized to produce flaked roast and ground coffee disrupts the cellular structure of the coffee particles and allows for easy exiting of gases contained within the coffee cells. While this is advantageous in that a degassed coffee product is produced, some of the escaping constituents, such as delicate aroma and volatile constituents, are desirable. Thus, flaking especially of high quality coffees, may involve a loss of prime quality coffee flavor notes. On the other hand, flaking of roast and ground coffee particles greatly increases the surface area of the particles and consequently when brewed, flakes produce a strong flavored coffee with excellent body. In regard to roast and ground coffee particles produced from high-quality coffee beans, these ground particles are flavor laden with delicate, natural, prime aroma and flavor constituents. Thus, any admixture of these two components produces a substantially degassed product which has a strong body flavor and which is additionally characterized by having delicate prime flavor and aroma characteristics present even though a substantial portion of the coffee in the novel product has been flaked.

In forming flakes of roast and ground coffee particles to be utilized in the coffee product, the roast and ground coffee is subjected to a mechanical compressing pressure by passing roast and ground coffee through two parallel smooth or highly polished rolls so that the coffee particles passing between the rolls are crushed and flattened such that the coffee cellular structure is disrupted and the resulting appearance is that of a flake. Smooth or highly polished rolls are desirable because these rolls are easy to clean. Other rolls can be used if the desired flaking of roast and ground coffee particles can be obtained. The flakes are formed in integral units, are moderately firm and can be easily handled. If desired, the flaked roast and ground coffee can also be passed through a series of roll mills but in the preferred embodiment for forming flaked roast and ground coffee to be utilized in the product of the sixth group of embodiments passage of the roast and ground coffee particles through two parallel rolls is used.

The flaking operation results in the roast and ground coffee particles being crushed and dropped from the rolls in the form of flakes. The roll milling can be accomplished in any of the well-known and commercially available roll mills such as those sold under the trademarks of Lehmann, Thropp, Farrell and Lahoff.

The process of mixing flaked roast and ground coffee and roast and ground coffee particles within the prescribed ranges to form the improved roast coffee product of the sixth group of embodiments is not critical. Any suitable method of admixing which does not involve shear mixing can be employed. Shear mixing is unsuitable because shear mixes cold work the flakes of roast and ground coffee causing them to break up and form fines and unsightly coffee dust. Especially desirable and suitable mixing devices are revolving “horizontal plane baffle” mixers such as a common cement mixer; however, the most preferred blenders are falling chute riffle blenders.

A falling chute riffle blender is comprised of a large cylindrical tube-like vessel with downwardly angled baffles mounted on the inside walls thereof. To promote gentle tumbling and intermixing the roast and ground coffee particles and flaked roast and ground coffee to be admixed are gravity fed through the baffled vessel. As the flakes and grounds tumble down they hit each baffle and, because the baffles are mounted in a downward angle, slide off and fall down onto baffles mounted in lower positions. By the time the flakes and grounds reach the bottom they have become (more or less) uniformly admixed. At the bottom of the vessel the mixture can be drawn off into a vessel or can be carried away on a conveyor belt for easy packaging.

To insure uniform intermixing within the preferred range of from 10 to 30 percent by weight of roast and ground coffee particles, the roast and ground coffee particles and the flaked roast and ground coffee are gravity fed into the top of the falling chute riffle blender at flow rates calculated to give mixtures within the prescribed range. For instance, if a mixture comprising 20 percent roast and ground coffee particles is desired, roast and ground coffee particles can be fed into the falling chute riffle blender at a rate of 900 lbs./hr. and flaked roast and ground coffee particles can be fed into the blender at a rate of 3600 lbs./hr.

While flaking of roast and ground coffee offers several advantages, all enumerated above, flaking of roast and ground coffee also produces a disadvantage in regard to packaging of the product. This is the tendency of flaked roast and ground coffee to vary in bulk density from the bulk density and/or “tamped bulk density,” the two being used interchangeably (in the sixth group of embodiments), of roast and ground coffee. As used these terms herein refer to the overall density of a plurality of particles measured after vibratory settlement in a manner such as that described on pages 130 and 131 of Sivetz, “Coffee Processing Technology,” Avi Publishing Company, Westport, Conn., 1963, Volume II. It is believed that flaked roast and ground coffee having a certain range of thicknesses, elaborated in detail below, will not change their bulk density after packaging and handling.

More specifically, providing roast and ground coffee flakes having a bulk density of from 0.38 g./cc. to 0.50 g./cc. is important if consumer acceptance is desired. This is so because bulk densities within this range are generally the bulk densities of conventionally prepared roast and ground coffees of “regular,” “drip” and “fine” grind. If the bulk density varies from this range and is for example higher, the consumer would need to use a substantially lesser than usual quantity of coffee to produce a brew of given strength; this required adjustment in consumer habits might be made with some difficulty.

A preferred roast and ground coffee flakes bulk density is from 0.42 g./cc. to 0.48 g./cc. However, providing roast and ground coffee flakes having a bulk density within the previously referred to broader range or the preferred narrower range of from 0.42 g./cc. to 0.48 g./cc. is not an easy accomplishment because the physical characteristics of thin flaked coffee are such that a propensity for variegated product bulk density exists. This is so because upon packing in a container flaked coffee has a tendency for the flakes to align themselves in parallel planes producing a very compact product with a bulk density substantially higher than that of roast and ground coffees presently marketed. Moreover, the parallel plane alignment, which takes place primarily after packing, increases the container outage. In other words, the space between the upper surface of the product and the upper surface of the container is increased due to settling of the flaked product. Large container outages are not appreciated by the consumer. Additionally, the higher tamped bulk density would necessitate an adjustment in consumer habits of volumetric measurement.

Flaked coffee generally has a flake thickness of from 0.001 inch to 0.030 inch. Thin flakes (i.e. 0.001 inch to 0.007 inch) are undesirable because of their cellophanelike appearance and fragile nature; on the other hand, very thick flakes (i.e. 0.026 inch to 0.030 inch) are undesirable because of their high flake density. Flakes of intermediate thickness, (i.e. from 0.008 inch to 0.025 inch) have been found especially desirable for a number of reasons, enumerated below.

To produce roast and ground coffee flakes having the requisite bulk density as previously discussed, and which do not have a propensity towards changing bulk density after packing, it is important that the flaked coffee have a flake thickness of from 0.008 inch to 0.025 inch and preferably from 0.010 inch to 0.016 inch. Flaked coffee having a flake thickness within the above referred to broader range and especially within the preferred narrower range, is believed to be more stable with respect to product bulk density. This is to say, flaked coffee of intermediate thickness ranges is much less susceptible to variable bulk density.

Flaked coffee having a flake thickness within the prescribed range has an additional physical characteristic in that at least from 70 to 85 percent of the coffee cells are disrupted, as revealed by microscopic examination. This large amount of cellular disruption is advantageous in that 33 percent more cups of coffee of uniform beverage strength can be prepared from a given weight of flaked coffee having a flake thickness of from 0.008 inch to 0.025 inch than from the same weight of roast and ground non-compressed, i.e. non-flaked, coffee. While not wishing to be bound by any theory, it is believed this is so primarily because flaked coffee within the previously specified thickness range lacks a visible cell structure, i.e. is amorphous in structure which in turn allows for easy releasing of coffee components in extraction. This is contrary to roast and ground coffee wherein the coffee particles are cube shaped and cellular disruption occurs only along the sides of the cubes.

In providing an acceptable flaked coffee product it is also essential that the flake moisture level be from 2.5 to 7.0 percent by weight. It is preferred that the moisture level be from 3.0 to 6.0 percent. Lower moisture contents than 2.5 percent are to be avoided because the resulting flake is very fragile and often breaks during process handling and packing Too large a percentage of broken flakes in turn changes the product bulk density which if it falls without the range of from 0.38 g./cc. to 0.50 g./cc. will produce a consumer unacceptable product. On the other hand moisture contents above 7.0 percent should be avoided because the flakes become tacky and oily in appearance. Moreover, if the coffee moisture content is higher than 7.0 percent prior to roll milling to produce flakes, water extrusion during milling occurs and the staling propensity of the resultant flakes is substantially increased.

In providing a consumer acceptable flaked coffee product it is preferred that the flaked coffee have a color which is defined by a Hunter Color “L” scale value ranging from 18 to 23, with from 19 to 21 being most preferred. Flaked coffee Hunter Colors within these ranges have been found to be desirable because within these ranges the flaked product has a color impression substantially equal to that of roast and ground coffee, which the consumer regards as highly desirable.

The Hunter Color scale values, utilized herein to define a preferred color of a flaked coffee product, are units of color measurement in the Hunter Color system. That system is a well-known means of defining the color of a given material. A complete technical description of the system can be found in an article by R. S. Hunter, “Photoelectric Color Difference Meter,” Journal of the Optical Society of America, Vol. 48, pp 985-95, 1958. Devices specifically designed for the measurement of color on the Hunter scales are described in U.S. Pat. No. 3,003,388 to Hunter et al., issued Oct. 10, 1961. In general, Hunter Color “L” scale values are units of light reflectance measurement, and the higher the value is, the lighter the color is since a lighter colored material reflects more light. In particular in the Hunter Color system the “L” scale contains 100 equal units of division; absolute black is at the bottom of the scale (L=0) and absolute white is at the top of the scale (L=100). Thus in measuring Hunter Color values of the flaked coffee of the sixth group of embodiments, the lower the “L” scale value the darker the flakes. The “L” scale values described herein are also accurate means of defining the degree of roast necessary to produce a coffee which when flaked gives a product within the “L” scale values herein described. Determination of optimum roasting conditions varies with the coffee employed but is within the skill of one knowledgeable in the field and can be determined after a few Hunter Color measurements of degrees of roast and comparison of the roasted and ground color values with the roasted ground and flaked color values.

Certain roll milling processing conditions are believed to be especially desirable in producing flakes having the desired physical characteristics such that the tendency for variation in bulk density is eliminated. Generally speaking, these conditions are roll temperature, roll pressure, and roll diameters.

The temperature of operation of the roll mill in forming flaked roast and ground coffee is normally from 32° F. to 300° F. However, for utilization in preparing the flaked coffee used in the sixth group of embodiments, the temperature of the roll mill during flaking is not critical. Extremely high temperatures should be avoided because degradation of flavor and aroma constituents of the roast and ground coffee particles can result and extremely low temperatures are not practical in that the use of refrigeration equipment is necessitated. In the usual method of operation the coffee particles immediately after being ground are passed through a roll mill to obtain flaked roast and ground coffee. The ground coffee can, if desired, be allowed to cool to room temperature and subsequently passed through the roll mill to form flakes of roast and ground coffee.

The pressure exerted on the ground coffee by the rollers in the roll mill ranges from 100 lbs./linear inch of nip to 10,000 lbs./linear inch of nip and preferably from 600 lbs./linear inch of nip to 6000 lbs./linear inch of nip. Extremely high pressures, i.e., above 10,000 lbs./linear inch of nip are to be avoided because with high pressures too much coffee oil is expelled coating the surface of the roll. The oil on the rolls acts as a lubricant making the flaking operation difficult. Additionally, extremely high pressures make very thin, weak flakes. Very low pressures are to be avoided because of the insufficient cellular disruption which is necessary to obtain proper extraction.

Flakes can be made with one pass through a two roll mill having roll diameters within a wide range, for example, as small as 4 inches and as large as 80 inches or even larger, but preferably from 6 inches to 30 inches and operating at peripheral speeds of from 1 ft./min. up to 1500 ft./min., but preferably from 10 ft./min. to 900 ft./min. The optimum yield of desirable flakes may be obtained when the rolls operate at approximately the same speeds. Differential roll speeds, however, can be utilized. Roll speed ratios in excess of 1.5:1 are not desirable. Preferably when differential roll speeds are employed the roll speed ratio is within the range of from 1:1 to 1.4:1.

The feed rate of the roast and ground coffee to be flaked, into the roll mill is not critical; either choke feeding or starve feeding can be employed. Choke feeding is defined as having excess amounts of coffee settling on the roll mills waiting to pass through the nip. It is the opposite of starve feeding.

In preparing the coffee composition for use in a beverage unit as defined in the Summary of the Invention, the coffee in the coffee composition 110/130 and beverage material 120 as shown in FIGS. 1A, 1B, and 1C may have various cell structures. As previously mentioned, flaked roast and ground coffee is contemplated in the present invention. Flaking of roast and ground coffee can be used advantageously to control or regulate the flavor and aroma of coffee as well as the extractability. The seventh group of embodiments according to the present invention provides a method of making flakes of roast and ground coffee wherein said flakes have a flake bulk density of from 0.38 grams/cc to 0.50 grams/cc, a flake thickness of from 0.008 inches to 0.025 inches and a flake moisture content of from 2.5 to 7.0 percent. The method comprises passing roast and ground coffee having a moisture content of from 2.5 to 7.0 percent through a roll mill having a roll diameter of from 6.0 inches to 30.0 inches, at a roll pressure of from 1,500 lbs./inch of nip to 5,000 lbs./inch of nip, at a roll surface temperature of from 50° F. to 200° F. and at a roll peripheral surface speed of from 100 ft./min. to 1,500 ft./min.

The seventh group of embodiments relates to a method of making flakes of roast and ground coffee wherein said flakes have a flake bulk density of from 0.38 grams/cc to 0.50 grams/cc, a flake thickness of from 0.008 inches to 0.025 inches and a flake moisture content of from 2.5 to 7.0 percent, said method comprising passing roast and ground coffee having a moisture content of from 2.5 to 7.0 percent through a roll mill having a roll diameter of from 6.0 inches to 30.0 inches, at a roll pressure of from 1,500 lbs./inch of nip to 5,000 lbs./inch of nip, at a roll surface temperature of from 50° F. to 200° F. and at a roll peripheral surface speed of from 100 ft./min. to 1,500 ft./min. This process produces consumer acceptable coffee flakes at consistently high yields and further produces flakes of high structural integrity and flakes having little or no flavor degradation.

In connection to the background of the first group of embodiments, the term roast and ground coffee refers to a coffee product comprising conventionally prepared roast and ground coffee particles and also decaffeinated roast and ground coffee particles. It does not include flaked roast and ground coffee particles which are hereinafter referred to as flaked coffee or roast and ground coffee flakes, the two terms being used interchangeably.

Flaked coffee is known in the art. McKinnis, U.S. Pat. No. 1,903,362, Rosenthal U.S. Pat. No. 2,123,207, and Carter U.S. Pat. No. 2,368,113 all disclose preparation of flaked coffee by roll milling roast and ground coffee. Of these three patents the most relevant is McKinnis who discloses production of “very thin” and “substantially uniform thickness” coffee flakes by roll milling roast and ground coffee particles.

The reason for the present lack of a consumer acceptable flaked coffee product is believed to be because heretofore certain essential coffee flake characteristics discussed hereinafter were unknown.

Application Ser. No. 30,246, filed Apr. 20, 1970, as a continuation-in-part of now abandoned application Ser. No. 823,954, filed May 12, 1969, Joffe, entitled, “Flaked Coffee and Products Produced Therefrom,” relates to roast and ground coffee flakes having a flake bulk density of from 0.38 grams/cc to 0.50 grams/cc and preferably from 0.42 grams/cc to 0.48 grams/cc, and a flake thickness of from 0.008 inches to 0.025 inches, preferably from 0.10 inches to 0.016 inches, and a flake moisture content of from 2.5 to 7.0 percent, preferably from 3.0 to 6.0 percent. The above identified Joffe application, now U.S. Pat. No. 3,615,667, also relates to mixtures of the above described roast and ground coffee flakes and conventional roast and ground coffee particles to produce a product of excellent aroma, strength and flavor.

Producing roast and ground coffee flakes having the above specified physical characteristics is believed to be essential in regard to production of a consumer acceptable flaked coffee product.

Providing a flaked bulk density within the range of from 0.38 grams/cc to 0.50 grams/cc is important because bulk densities within this range are generally the bulk densities of conventionally prepared roast and ground coffees of “regular,” “drip” and “fine” ground. If the bulk density varies from this range and is, for example, higher, the consumer would need to use substantially lesser than usual quantities of coffee to produce a brew of given strength; this required adjustment in consumer habits might be made with some difficulty.

Providing roast and ground coffee flakes having a flake thickness of from 0.008 inches to 0.025 inches is important in producing roast and ground coffee flakes having the requisite bulk density as previously discussed and in producing flakes which do not have a propensity towards changing in bulk density after packing

Providing roast and ground coffee flakes having a flake moisture level of from 2.5 to 7.0 percent by weight is important because flakes having lower moisture contents are too fragile and often break during processing and packaging. Such breaking changes the product bulk density, which if it falls without the range of from 0.38 grams/cc to 0.50 grams/cc, will produce a consumer unacceptable product. On the other hand, moisture contents above 7.0 percent are consumer unacceptable because the flakes become tacky and oily in appearance.

In summary, the Joffe application, which is incorporated herein by reference, discloses and claims a flaked coffee having a carefully controlled bulk density, flake thickness and moisture content, all of which have been found important in producing consumer acceptable coffee flakes. Hereinafter, the coffee flakes having the above described physical characteristics disclosed and claimed in the Joffe application will be referred to as consumer acceptable coffee flakes.

In regard to specific processing conditions, the prior art patents are vague and merely teach passing roast and ground coffee through a roll mill. It is believed that the coaction of particular roll milling processing variables within the hereinafter described ranges provides high yields of flaked coffee having the requisite physical characteristics for consumer acceptable flakes. While some processing conditions not within the hereinafter described ranges produces some flakes having the requisite bulk density, thickness and moisture content, operation within the specified ranges insures consistently high yields of flakes of high structural integrity which have little or no flavor degradation. Broadly, this application relates to a specific method of producing roast and ground coffee flakes having the above-enumerated essential physical characteristics.

Accordingly, it is an object of the seventh group of embodiments to provide a method of making the roast and ground coffee flakes claimed in Joffe, entitled “Flaked Coffee and Products Produced Therefrom” by a procedure which insures consistently high yields of flakes of high structural integrity having little or no flavor degradation.

One aspect of the seventh group of embodiments provides for a coffee composition for use in a beverage unit and method thereof as defined in the Summary of the Invention, wherein the coffee composition comprises flakes of roast and ground coffee wherein said flakes have a flake bulk density of from 0.38 grams/cc to 0.50 grams/cc, a flake thickness of from 0.008 inch to 0.025 inch, and a flake moisture content of from 3.0 to 6.0 percent, made from a method comprising passing roasted and ground coffee having a moisture content of from 3.0 to 6 percent through a roll mill having a roll diameter of from 9 inches to 25 inches, at a roll pressure of from 2,000 lbs./inch of nip to 4,000 lbs./inch of nip, at a roll surface temperature of from 110° F. to 180° F. and at a roll peripheral surface speed of from 350 ft/min. to 800 ft/min., removing from said roll mill on a weight basis of the feed roast and ground coffee a yield of flaked coffee of over 80 percent to provide a flaked coffee product of high structural integrity, which does not have a propensity towards changing bulk density after packing.

In more specific examples, the roast and ground coffee to be flaked is decaffeinated coffee. The roast and ground coffee (e.g. regular grind) to be flaked is further characterized by having a particle size of from 0.0 to 18.0 percent on 12 mesh, from 0.0 to 46.0 percent on 16 mesh, from 15.0 to 50.0 percent on 20 mesh, from 7.0 to 30.0 percent on 30 mesh, from 4.0 to 15.0 percent on 40 mesh and from 3.0 to 8.0 percent through a 40 mesh.

The seventh group of embodiments as described above will be further described in the following paragraphs and exemplified in Example 26.

In forming flaked roast and ground coffee, roast and ground coffee is subjected to a mechanical pressure by passing roast and ground coffee through two parallel smooth or highly polished rolls so that the coffee particles passing between the rolls are crushed and flattened such that the coffee cellular structure is disrupted and the resulting appearance is that of a flake. In roll milling roast and ground coffee to produce consumer acceptable flaked coffee, it has been found important to control at least five processing variables. These variables are roll pressure, roll surface temperature, roll peripheral surface speed, roast and ground coffee moisture content and roll diameters. An additional variable which is not as important, but because it helps in producing higher yields and therefore should preferably be carefully controlled, is roast and ground coffee particle size.

Roll pressure is measured in pounds per inch of nip. Nip is a term used in the art to define the length of surface contact between two rolls when the rolls are at rest. To illustrate, it can be thought of as a line extending the full length of the rolls and defining the point of contact between two rolls.

To produce high yields of the heretofore described consumer acceptable flaked coffee, it is important that the roll pressure be within the range of from 1,500 lbs./inch of nip to 5,000 lbs./inch of nip and preferably within the range of from 2,000 lbs./inch of nip to 4,000 lbs./inch of nip. If pressures much less than 1,500 lbs./inch of nip are employed, the resulting product may not have a flaked coffee appearance. Moreover, any flakes that are produced are much thicker than 0.025 inches and consequently the flakes are not consumer acceptable. On the other hand, if pressures in excess of 5,000 lbs./inch of nip are employed the roast and ground coffee flakes tend to be thinner than 0.008 inches and the product bulk density is less than the required minimum of 0.38 grams/cc needed for a consumer acceptable coffee flake. Additionally, at pressures in excess of 5,000 lbs./inch of nip the roll friction produces excessive amounts of heat which as hereinafter related also tends to produce thin, undesirable flakes having unacceptable bulk densities. For overall process efficiency roll pressures within the range of from 2,000 lbs./inch of nip to 4,000 lbs./inch of nip are preferred.

Roll surface temperature, as used herein, is measured in degrees Fahrenheit and refers to the average surface temperature of the rolls. Control of roll mill surface temperatures is accomplished by controlling the temperature of a heat exchange fluid passing through the inner core of the rolls. Generally, the fluid, which is most often water, is heated or cooled and passed through the inside of the rolls. The result is that the roll surface which is usually a smooth, high polished steel surface, is subjected to temperature control by means of heat transfer. Of course, in actual operation the surface temperature will likely not be exactly the same as the temperature of the heat exchange fluid and will be somewhat higher because milling of coffee particles to produce flakes tends to increase the roll surface temperature. Accordingly, the required heat exchange fluid temperature to maintain any specific roll surface temperature can depend upon several factors such as the kind of metal the roll surfaces are made of, the speed of operation of the roll mills, and the heat exchange fluid employed.

Generally, it can be stated that higher roll surface temperatures will tend to produce thinner flakes of roast and ground coffee. Additionally, at higher temperatures the propensity for flavor degradation becomes increased. On the other hand, lower roll surface temperatures will tend to produce thicker flakes with little or no flavor degradation. To produce the consumer acceptable flaked roast and ground coffee heretofore described it is important that the roll surface temperature be within the range of from 50° F. to 200° F. Temperatures less than 50° F. are undesirable because expensive cooling systems must be employed and at such low temperatures the flake thickness tends to be greater than 0.025 inches; consequently, the flakes are consumer unacceptable. Additionally, at temperatures less than 50° F. the resultant coffee flakes are very brittle and have a tendency to break during subsequent processing and packaging. This is undesirable because breaking of brittle flakes results in a change in product bulk density which may affect the consumer acceptability of the coffee flakes produced. Such weak flakes often have bulk densities not within the range of consumer acceptable flake bulk densities.

To produce flaked roast and ground coffee having the hereinbefore defined consumer acceptable bulk density, flake thickness and moisture content, it is preferred that the roll mill surface temperature be within the range of from 110° F. to 180° F. When roll surface temperatures within this range are employed the majority of the resultant coffee flakes are of a proper thickness to produce a consumer acceptable bulk density coupled with a product having high structural integrity and little or no flavor degradation.

The roll peripheral surface speed is measured in feet per minute of surface circumference which passes by the nip. Generally, higher peripheral surface speeds produce thinner flakes and conversely lower peripheral surface speeds produce thicker flakes. Here again, the interplay of the milling conditions can be seen. For instance, at higher peripheral surface speeds friction increases the roll surface temperature which tends to produce thinner consumer unacceptable coffee flakes. Thus, roll peripheral surface speeds which result in roll surface temperatures above 200° F. should not be employed. On the other hand, extremely low roll peripheral surface speeds tend to produce thicker and less consumer acceptable flakes. Roll peripheral speeds within the range of 100 ft./min. to 1,500 ft./min. are important in producing flaked roast and ground coffee having the hereinbefore defined consumer acceptable flake characteristics. If roll peripheral surface speeds in excess of 1,500 ft./min. are employed, the resultant flakes are too thin for consumer acceptability. Moreover, at speeds in excess of 1,500 ft./min., the heat of friction is so great that the roll surface temperatures cannot be maintained at or less than the maximum temperature of 200° F. Consequently, a significant amount of flavor degradation of the flaked coffee occurs. On the other hand, at roll peripheral surface speeds less than 100 ft./min. the rate of production of flaked roast and ground coffee is so slow as to be commercially impractical. Especially preferred roll peripheral surface speeds which allow for easy temperature control and desirable throughput rates are from 350 ft./min. to 800 ft./min.

In further regard to the roll peripheral surface speeds, it should be mentioned that optimum yields of consumer acceptable flakes are generally obtained when the rolls operate at approximately the same speeds. Differential roll speeds, however, can be utilized. Roll speed ratios in excess of 1.5 to 1.0 are not desirable. Preferably when differential roll speeds are employed the roll speed rate is within the range of greater than 1:1 up to 1.4:1. However, in no event should the speed of the fastest roll be in excess of 1,500 ft./min.

In producing consumer acceptable flaked roast and ground coffee it is important that the flake moisture content be from 2.5 to 7.0 percent by weight, with from 3.0 to 6.0 percent being preferred. Consequently, the moisture content of the roast and ground coffee particles to be flaked should be within the range of from 2.5 to 7.0 percent. At moisture contents less than 2.5 percent the roast and ground coffee is too dry to flake during roll milling and has a tendency to grind rather than flake. A minimum moisture content of 2.5 percent by weight is required to soften the coffee cellular construction thereby making it more susceptible to flaking during milling. On the other hand, moisture contents above 7.0 percent are to be avoided because the flakes become unsightly in appearance. Moreover, if the coffee moisture content is higher than 7.0 percent, prior to milling to produce flakes, the staling propensity of the resultant flakes is substantially increased. Providing a moisture content of the roast and ground coffee to be flaked within the range of from 3.0 to 6.0 percent provides the highest yield of consumer acceptable flaked coffee coupled with little or no flavor degradation and is therefore preferred.

In regard to the particle size of the roast and ground coffee employed in the flaking process no criticality exists. However, from the standpoint of producing consumer appealing flaked coffee appearance, it is preferred that the roast and ground coffee particles have a particle size of from 0.0 to 18.0 percent retained on a 12 mesh U.S. Standard screen, from 0.0 to 46.0 percent retained on a 16 mesh U.S. Standard Screen, from 15.0 to 50.0 percent retained on a 20 mesh U.S. Standard Screen, from 7.0 to 30.0 percent retained on a 30 mesh U.S. Standard Screen, from 4.0 to 15.0 percent retained on a 40 mesh U.S. Standard Screen and from 3.0 to 8.0 percent passing through a 40 mesh U.S. Standard Screen. Speaking in more familiar terms, the roast and ground coffee to be flaked can be “regular,” “drip” or “fine” grind as these terms are used in a traditional sense. The standards of these grinds as suggested in the 1948 Simplified Practice Recommendation by the U.S. Department of Commerce (see Coffee Brewing Workshop Manual, page 33, published by the Coffee Brewing Center of the Pan American Bureau are as follows: “Regular grind,” 33 percent is retained on a 14 mesh Tyler Standard Sieve, 55 percent is retained on a 28 mesh Tyler Standard Sieve and 12 percent passes through a 28 mesh Tyler Standard Sieve; “drip grind,” 7 percent is retained on a 14 mesh Tyler Standard Screen, 73 percent on a 28 mesh Tyler Standard Sieve and 27 percent passes through a 28 mesh Tyler Standard Sieve; and “fine grind” 100 percent passes through a 14 mesh Tyler Standard Sieve, 70 percent being retained on a 28 mesh Tyler Standard Sieve and 30 percent passing through a 28 mesh Tyler Standard Sieve. Of the above mentioned traditional grind sizes the most preferred is “regular grind.”

As can be seen from the foregoing description, the grind size of the roast and ground coffee to be flaked does not represent a critical aspect of the flaking method of the seventh group of embodiments; however, while the particle size is not critical, it is desirable to regulate the particle size because this in turn regulates the sieve analysis of the resulting roast and ground coffee flakes. This can be important in producing a flaked coffee product having different “grind sizes,” i.e., “regular grind,” “fine grind,” and “drip grind” as those terms are used in their traditional sense.

The diameter of the roll mills employed controls the angle of entry into the nip. The angle of entry into the nip in turn has a direct effect on the flake thickness, and consequently on the bulk density of the resultant roast and ground coffee flakes. To produce the hereinbefore defined consumer acceptable flaked roast and ground coffee it is important that the roll diameter be within the range of from 6 inches to 30 inches with from 9 inches to 25 inches being preferred. If rolls having a diameter of less than 6 inches are utilized the roast and ground coffee particles tend to churn on the mill surfaces and not pass through the nip; consequently, the throughput rate of the roast and ground coffee to be flaked becomes so slow as to be impractical. Roll mills having roll diameters greater than 30 inches may not be readily commercially available.

As can be seen from the foregoing description the ranges of each of the described milling process variables are closely tied to and correlated with each of the other processing variables. A change in one variable often has a direct effect in changing another variable. For instance, operation at high roll pressures, in excess of 5,000 lbs./inch of nip, increases the frictional resistance which in turn generates heat and increases the roll surface temperature. The increased inward pressure at the nip of the roll mills coupled with the resulting higher temperatures produces thin, weak flakes; and if the pressure is sufficient to increase the roll surface temperature above 200° F. the flaked coffee undergoes a flavor degradation. Likewise, roll peripheral surface speeds in excess of 1,500 ft./min. may produce some flakes of proper thickness for consumer acceptability but because of the increase of roll surface temperatures which accompanies the high speed, the flakes will be of inferior structural integrity and often will have undergone flavor degradation; moreover, the yield of flakes of proper thickness and density will be substantially decreased. Thus, the flaking procedure of the seventh group of embodiments takes into account the interrelated and coacting nature or roll pressure, roll temperatures, coffee moisture levels, roll diameter, roll peripheral surface speed and to a lesser extent the particle size of the roast and ground coffee to be flaked. The result of operation of each of these process variables within the hereinbefore described ranges is that high yields of consumer acceptable flaked roast and ground coffee having little or no flavor loss and further characterized by having suitable structural integrity to prevent breaking when packaging, is produced.

The feed rate into the roll mill, of the roast and ground coffee to be flaked, is not critical; either choke feeding or starve feeding can be employed as long as the previously discussed processing variables are operated within their prescribed ranges. Choke feeding is defined as having excess amounts of coffee settling on the roll mills waiting to pass through the nip. It is the opposite of starve feeding.

In further regard to the feeding rate, where either starve feeding or choke feeding can be employed, starve feeding is preferred because of particular process advantages offered by starve feeding such as greater economic efficiency, increased equipment life and increased process flexibility. For a detailed description of starve feeding see Menzies et al., entitled “A Method of Starve Feeding Coffee Particles,” Ser. No. 823,900, now abandoned, and Menzies, “An Apparatus For Starve Feeding Coffee Particles,” Ser. No. 823,901, now abandoned.

In regard to the types of roast and ground coffee utilized in the flaking process of the seventh group of embodiments see the previously incorporated by reference application of Joffe entitled, “A Flaked Coffee Product.”

As indicated previously, the process of the seventh group of embodiments not only produces consumer acceptable flakes but also produces them at consistently high yields, i.e., yields on a weight basis of over 80 percent and usually in excess of 90 percent. Such high yields are highly desirable in producing a consumer product on a large scale. Yield as used herein refers to the percent on a weight basis of flakes having the requisite physical characteristics for consumer acceptability, particles not meeting these criteria are screened out and can be recycled for further processing.

Two more important advantages of this process are that the flakes produced by this process are of high structural integrity and have undergone little or no flavor degradation. Producing flakes of high structural integrity (i.e. physically strong and not easily susceptible to breakage during packing) is important because large percentages of broken flakes may change the product bulk density and is known to present a consumer unappealing appearance. The fact that little or no coffee flavor degradation occurs during operation of the process of the seventh group of embodiments is, of course, important in respect to consumer preference for the product.

In preparing the coffee composition for use in a beverage unit as defined in the Summary of the Invention, the coffee in the coffee composition 110/130 and beverage material 120 as shown in FIGS. 1A, 1B, and 1C may have various cell structures. As previously mentioned, flaked roast and ground coffee is contemplated in the present invention. Flaking of roast and ground coffee can be used advantageously to control or regulate the flavor and aroma of coffee as well as the extractability. The eighth group of embodiments according to the present invention provides extra-thin flaked roast and ground coffee with structural integrity and increased extractability for a less acidic beverage and a novel process for making same.

In the eighth group of embodiments, it is believed that a superior coffee product is provided by a thin-flaked roast and ground coffee product having a minimum amount of coffee flakes which have a flake thickness within a very select flake thickness range.

The eighth group of embodiments provides a method for preparing that thin-flaked roast and ground coffee which exhibits enhanced extractability and yet possesses consumer-acceptable flake physical properties. It is believed that the thin-flaked roast and ground coffee of superior extractability and structural integrity is provided by the novel flaking method described herein, comprising flaking roast and ground coffee having a particle size within a very select size range and moisture level by roll milling the unflaked R&G coffee under particular roll mill operating conditions.

In connection to the background of the eighth group of embodiments, numerous attempts have been made in the past to increase the extractability of roast coffee of those flavorful water-soluble constituents often referred to as brew solids. That is, attempts have been made to increase the amount of brew solids which are able to be extracted from a given weight of coffee from which a coffee brew is made.

It is known that the extractability of roast coffee may be increased by grinding the coffee to finer particle sizes. However, roast coffee products ground to very fine grinds have bed-permeability characteristics which inhibit the extraction of the water-soluble constituents due to bed compaction, pooling, channeling, etc. To avoid such brewing problems, it has been conventional to provide roast coffee ground to mixtures of variously sized particles, such as the traditional grinds of “regular”, “drip” and “fine”.

Other than adjusting the particle size distribution by grinding, relatively little effort has been directed toward altering the fundamental physical characteristics of coffee. Green coffee beans have been roll-milled prior to roasting and grinding to increase the extractability of coffee (see U.S. Pat. No. 2,123,207, issued Jul. 12, 1938 to Rosenthal). Roast and ground coffee has been light-milled to provide a coffee product which has the same bulk appearance as conventional roast and ground coffee but which has increased extractability (see U.S. Pat. No. 3,769,031, issued Oct. 26, 1973 to J. R. McSwinggin). Flaked green coffee has also been subjected to compressive and shear forces via extruder roasting to provide a roast coffee product which yields higher soluble solids (see, for example, U.S. Pat. No. 3,762,930, issued Oct. 2, 1973 to J. P. Mahlmann). Although these efforts may result in some level of improvement in extracting desirable coffee flavor constituents, further enhancement of coffee's extractability is provided by flaked roast and ground coffee.

Roast and ground coffee has been transformed into flaked coffee by roll milling the roast and ground coffee (see, for example, U.S. Pat. No. 1,903,362, issued Apr. 4, 1933 to R. B. McKinnis and U.S. Pat. No. 2,368,113, issued Jan. 30, 1945 C. W. Carter). Thick-flaked (i.e., flaked coffee having an average flake thickness greater than 0.008 inch) roast and ground of enhanced extractability is disclosed by Joffe in U.S. Pat. No. 3,615,667, issued Oct. 26, 1971 as well as a method for its production in U.S. Pat. No. 3,660,106, issued May 2, 1972 to J. R. McSwiggin et al. A visually appealing high-sheen flaked roast and ground coffee of improved extractability is disclosed in U.S. Pat. No. 4,110,485, issued Aug. 29, 1978 to Grubbs.

In contrast to the consumer acceptability of thick-flaked roast and ground coffee, both the Joffe '667 patent and the McSwiggin '106 patent teach that thin-flaked coffee having an average flake thickness of less than 0.008 inch is taught to be consumer-unacceptable. The thin-flaked coffee produced by such prior art methods is described as having a “cellophane-like” nature and, therefore, visually unappealing. Moreover, the “cellophane-like” thin flakes are also disclosed as being undesirably fragile and have both an unacceptably low and a variable bulk density (Joffe '667, Column 8, lines 46-54).

The prior art teaches that the fragile nature of the thin flakes of the prior art leads to product breakup during normal packaging, transportation and handling. The product breakup is accompanied by the flakes aligning themselves in parallel planes producing a very compact product with a bulk density substantially higher than that of roast and ground coffees presently marketed. When the parallel plane alignment takes place after packaging, there occurs an objectionable increase in container outage (i.e. the space between the upper surface of the product and the upper surface of the container). Large container outages are viewed negatively by the consumer. Thus, the thin-flaked roast and ground coffee produced by art-known methods is consumer unacceptable.

Given the state of the coffee art as described above, there is a continuing need to provide a roast and ground coffee product which provides improved extractability of soluble brew solids and which possesses consumer acceptable physical properties and appearance. Accordingly, it is an object of the eighth group of embodiments to provide a roast and ground coffee product exhibiting desirable organoleptic and physical properties.

The methods known in the art for preparing flaked roast and ground coffee comprise passing roast and ground coffee through a roll mill under particular conditions of roll pressure, roll peripheral speed, roll temperature, roll diameters, and flake moisture content. While known methods of making flaked coffee having realized thick-flaked roast and ground coffee which provides an extractability advantage compared to conventional roast and ground coffee and possesses consumer acceptable flake physical properties, these methods have been unable to produce thin-flaked roast and ground coffee exhibiting desirable physical properties.

One aspect of the eighth group of embodiments provides for a coffee composition for use in a beverage unit and method thereof as defined in the Summary of the Invention, wherein the coffee composition comprises a thin flaked coffee product having improved structural integrity and enhanced extractability for a less acidic beverage, made from a method of flaking roast and ground coffee comprising the steps of:

(1) passing through a roll mill coarse roast and ground coffee having a coarse particle size distribution such that:
(a) from about 90% to 100% by weight is retained on a No. 30 U.S. Standard Screen,
(b) from about 51% to 89% by weight is retained on a No. 16 U.S. Standard Screen, and
(c) from about 20% to 50% by weight is retained on a No. 12 U.S. Standard Screen,

(2) operating said roll mill:
(a) at a static gap setting of less than about 0.1 mm.,
(b) a roll peripheral speed of from about 150 meters/min. to about 800 meters/min.,
(c) a roll temperature of below about 40° C., and
(d) at a pressure of about 100 kilonewtons/meter to about 400 kilonewtons/meter of nip, and

wherein the rolls of said roll mill have a roll diameter of at least about 15 cm, and

wherein the resultant thin flaked coffee comprises:

thin flakes of roast and ground coffee, wherein about 80% to about 98% by weight of said flakes have an average thickness of from about 0.1 mm. to about 0.175 mm.,

said improved roast and ground coffee product having a particle size distribution such that about 30% to about 90% by weight of said product passes through a No. 30 U.S. Standard sieve,

said product having a tamped bulk density of from about 0.35 g./cc. to about 0.50 g./cc., and

a moisture content of from about 2.5% to about 9.0% by weight.

In more specific examples under this aspect, said operating roll force is from about 200 kilonewtons to about 400 kilonewtons per meter of nip. Said coarse roast and ground coffee has a moisture content of from about 3.5% to about 7% by weight. Said thin flaked coffee product has a moisture content of from about 3.5% to about 5%, and wherein about 40% to about 70% of said product passes through a No. 30 U.S. Standard sieve. Said operating roll temperature is from about 5° C. to about 30° C. Said thin flakes have at least 50% of their microscopic observable internal and surface cells disrupted. Said tamped bulk density is from about 0.38 to about 0.48.

In more specific examples under this aspect, said thin flakes have an average thickness of less than about 0.175 mm. They may have at least about 50% of said internal and surface cells disrupted. They may have about 70% to about 85% of said internal and surface cells disrupted.

In more specific examples under this aspect, said thin flakes have about 70% to about 85% of their microscopic observable internal and surface cells disrupted and yet said flakes have substantial structural integrity to provide a substantially non-fragile non-cellophanelike improved thin-flaked coffee product. For example, the moisture content of the flakes is from about 3.5% to about 7%, and about 40% to about 70% of said product passes through a No. 30 U.S. Standard sieve. For another example, said thin flakes may have a substantial portion of their microscopic observable internal and surface (cells disrupted and yet have substantial structural integrity to provide a substantial non-fragile improved thin flaked coffee product.

The eighth group of embodiments as described above will be further described in the following paragraphs and exemplified in Examples 27-29.

The eighth group of embodiments relates to thin-flaked roast and ground coffee products of improved extractability of the water-soluble flavor constituents. There is further provided herein an improvement in the coffee flaking process enabling the provision of the thin-flaked coffee product herein.

### Thin-Flake Coffee

In the provision of a thin-flaked roast and ground coffee product of enhanced extractability and low acidity, it is important to control the flake thickness, particle size distribution, bulk density and flake moisture content in order to insure its consumer acceptability. Each of these coffee product properties, as well as product preparation and product use, are described in detail as follows:

### A. Flake Thickness

The improved coffee flaking process described hereinafter can provide flakes of almost any desired thickness. However, it is believed that a flaked coffee product of superior increased extractability of the desirable coffee flavor constituents can be realized if the thickness of the coffee flakes are within a very select flake thickness range. The terms “coffee flakes” or “flaked coffee”, as used interchangeably herein, refer to compressed roast and ground coffee. The term “flake thickness” as used herein means the average thickness of the flakes passing through a No. 12 U.S. Standard Sieve and remaining on a No. 16. The improved thin-flaked coffee product provided herein comprises flaked roast and ground coffee wherein about 80% to about 98% by weight of the flakes have a flake thickness ranging from about 0.1 mm to about 0.2 mm (i.e. about 0.004 inch to 0.008 inch), preferably about 0.125 to about 0.175 mm. Such thin flakes provide improved extractability of the water-soluble coffee constituents compared to the thicker flaked coffee products disclosed by the prior art or commercially sold.

While not wishing to be bound by the proposed theory, it is believed that the increased extractability compared to prior art flaked coffee, particularly flaked coffee having a flake thickness exceeding 0.2 mm, is due to the increased internal cellular disruption of the thin coffee flakes made by the process of the eighth group of embodiments. Although the prior art teaches that thicker coffee flakes have 70% to 85% of the coffee cells disrupted, as revealed by microscopic evaluation, such cellular disruption is evident only in the planar surface regions of the prior art flakes. Microscopic evaluation of a “cross-section” of such thicker coffee flakes reveals that the cellular disruption indicated is confined to the regions near the surface of the flake plane. A cross-section of the thin-flaked coffee of the eighth group of embodiments, however, reveals that substantially all, i.e. from 50% to almost 100%, of the cells exposed from a cross-section view of the thin flakes of the eighth group of embodiments are disrupted. That is, the cellular disruption speculated to be responsible for increased extractability is not confined to the surface regions of the flake. The cellular disruption of the interior of the thin-flaked coffee herein is believed caused by the particular combination of conditions herein disclosed, including a more severe compressive force required to transform the relatively large “coarse” grind size roast and ground coffee feed into the thinner thin-flaked coffee of the eighth group of embodiments, as explained in more detail below.

The greater extractability provided by the novel thin-flaked coffee provided herein enables more cups of equal-brew strength and flavor to be brewed from a given amount of coffee. The normal method of measuring the strength of a coffee brew is to measure the percent soluble solids which is more commonly referred to as brew solids. This measurement can be made by oven-drying the brewed coffee and weighing the remainder. The percent soluble solids can also be ascertained optically by measuring the index of refraction of the coffee brew. The index of refraction is correlated to brew solids as measured by the oven-drying technique. Although the extractability of acidity constituents is also increased, it is believed that the increase is proportionately smaller than the increase in flavor constituents. Therefore, not only could more cups of equal-brew strength be brewed from a given amount of thin-flaked coffee, but the equal-brew strength cups would also have lower titratable acidity.

The thin-flaked coffee provided herein can be made from a variety of roast and ground coffee blends including those which may be classified for convenience and simplification as low-grade, intermediate grade and high-grade coffees. Examples and blends thereof are known in the art and illustrated in, for example, U.S. Pat. No. 3,615,667 (issued Oct. 26, 1971 to Joffe) herein incorporated by reference in its entirety.

Decaffeinated roast and ground coffee can also be used to make a decaffeinated thin-flaked coffee product. As is known in the art, the removal of caffeine from coffee products frequently is accomplished at the expense of the removal of certain other desirable components which contribute to flavor. The tendency of decaffeinated products to be either weak or deficient in flavor has, thus, been reported in the literature. The provision of thin-flaked coffee made from decaffeinated roast and ground coffee by the novel thin-flaking method of the eighth group of embodiments provides a compensatory advantage. The added flavor and strength advantages achievable by enhanced extractability permits realization of levels of flavor and brew strength which might otherwise not be attainable in the case of a conventional decaffeinated roast and ground product.

Typically, decaffeination of coffee is accomplished by solvent extraction prior to the roasting of green coffee beans. Such decaffeination methods are well known in the art. After roasting, the decaffeinated beans are ground to the suitable particle size, described in more detail below, and are thereafter roll-milled according to the method of the eighth group of embodiments which is also described in more detail below.

### B. Particle Size Distribution

As noted above, the thin-flaked coffee provided herein has a flake thickness within a select, very particular thickness range. It is also important to control the dimension which characterizes the particle size of the coffee flakes. It is conventional in the coffee art to describe coffee particle size distribution, including flaked coffee, in terms of sieve fractions, i.e. that weight percentage which remains on a particular sieve or that weight percentage which passes through a particular sieve.

It is believed that coffee products comprising 60% or more of fine particles experience decreased extractability which drops dramatically as the average particle size decreases. The thin-flaked coffee products of the eighth group of embodiments should have no more than 90% by weight passing through a No. 30 U.S. Standard screen, and preferably from about 40% to about 70% passing through a No. 30 U.S. Standard screen. This particle size distribution insures efficient extraction.

### C. Bulk Density

The thin-flaked coffee product of the present development should have a bulk density of from 0.35 g./cc. to 0.50 g./cc and preferably 0.38 to 0.48 g./cc in order to assure proper performance. Fortunately, the eighth group of embodiments provides flakes of high structural integrity. The desirability of flakes of high structural integrity (i.e. physical strength and resistance to attrition or breakage during handling) is important because large percentages of broken flakes markedly change the product bulk density and particle size distribution, which in turn adversely affect the brewing properties of the product.

### D. Flake Moisture Content

The thin-flake coffee composition disclosed herein has, on the average, a flake moisture level of from about 2.5% to about 9.0% by weight, preferably from about 3.5% to about 7.0%, and most preferably 3.5% to about 5.0%. Of course, it is recognized that individual flakes can have different individual moisture contents. However, the weight percentages of such flakes should be controlled such that the coffee product as a whole has average moisture content within the above-given range. Moisture contents lower than 2.5% are to be avoided because the resulting flakes are very fragile and often break during process handling and packing Too large a percentage of broken flakes in turn changes the product bulk density which if it falls without the range of from 0.35 g./cc. to 0.50 g./cc. and, as noted above, will produce a consumer-unacceptable product. On the other hand, moisture contents above 7.0% are less desirable.

Typically, flake moisture content is adjusted by varying the moisture level of the roast and ground coffee feed from which the flakes are produced. The adjustments to the feed moisture level can be controlled, for example, by controlling the amount of water used to quench and to thereby halt the exothermic roasting operation. The moisture content of the roasted beans is not appreciably affected by grinding or even by the flaking operations unless high roll surface temperatures are used.

### E. Aroma-Enriched, Thin-Flaked Coffee

Penalty exacted by the flaking operation is the loss of aroma constituents usually associated with fresh roast and ground coffee. This relative deficiency in the aromas characteristic of fresh roast and ground coffee has been attributed to the loss of aroma principles during the roll milling of roast and ground coffee into flakes. Accordingly, it may be optionally desirable to aroma-enrich the thin-flaked coffee product of the eighth group of embodiments so as to restore or enhance the aroma to approximate that of fresh roast and ground coffee.

A variety of methods are known in the art for providing coffee products with coffee aromas, for example, U.S. Pat. No. 2,947,634, Aug. 2, 1960 to Feldman et al., U.S. Pat. No. 3,148,070, Sep. 8, 1964 to Mishkin et al., and U.S. Pat. No. 3,769,032, Oct. 30, 1973 to Lubsen et al., each of which is herein incorporated by reference in its entirety. These patents describe methods for aromatizing soluble powders by addition of an edible carrier oil, such as coffee oil, triglyceride vegetable oil, propylene glycol and carrying volatile coffee aromas. Aroma-enriched carrier oil is generally prepared by mixing the carrier oil with an aroma frost, allowing the mixture to equilibrate and allowing the mixture to liquify. An aroma frost can be obtained by the condensation of the aroma constituents from a variety of sources. Suitable examples of aromatizing coffee volatiles are those obtained from roaster and grinder gases and from the condensation of steam-distilled volatile aromas. Examples of suitable aroma materials are described in said U.S. Pat. No. 2,947,634 to Feldman et al., U.S. Pat. No. 3,148,070 to Mishkin et al., U.S. Pat. No. 2,562,206 to Nutting, U.S. Pat. No. 3,132,947 to Mahlmann, U.S. Pat. No. 3,615,665 to White et al., and Strobel U.S. Pat. No. 3,997,683.

### Preparation of Thin-Flaked Coffee

The thin-flaked roast and ground coffee of the eighth group of embodiments can be formed by subjecting conventional roast and ground coffee to the compressive pressures of a roll mill. The roast and ground coffee is first passed through the roll mill, which comprises a pair of parallel, smooth or highly polished rolls that crush and flatten the coffee into flakes. Thereafter, the flaked coffee so produced is sized by suitable means to achieve the requisite particle size distribution.

### A. Roll Milling

In the step of roll milling roast and ground coffee to produce consumer-acceptable flaked coffee, it is important to control at least several processing variables: particle size distribution, roll pressure, roll surface temperature, static gap, roast and ground feed moisture content, feed rate, roll peripheral surface speed, and roll diameters. These and other processing variables are described in detail hereinafter.

### 1. Particle Size Distribution

In marked contrast to the teachings of the art, the particle size distribution of the roast and ground coffee feed is believed to be an important process variable in the production of thin-flaked coffee of higher extractability. Prior art processes have utilized grind sizes traditionally referred to as “regular”, “drip” and “fine.” The standards of these grinds, as suggested in the 1948 “Coffee Grinds: Simplified Practice Recommendation R231-48”, published by the Coffee Brewing Institute, Inc., New York, herein incorporated by reference in its entirety.

It is believed, however, that larger “coarse” grind size particles are suitable in the novel method of making the thin-flaked coffee disclosed herein. The term “coarse” grind is used liberally in the coffee art to characterize grinds of widely varying particle size distributions. As used herein, “coarse” grind size indicates that the roast and ground coffee has a particle size distribution such that:

(a) from about 90% to 100% by weight is retained on a No. 30 U.S. Standard Sieve,

(b) from about 51% to 89% by weight is retained on a No. 16 U.S. Standard Sieve, and

(c) from about 20% to 50% by weight is retained on a No. 12 U.S. Standard Sieve.

The extractability advantage for flaked coffee prepared by utilizing a “coarse” size grind feed to the roll milling operation decreases rapidly as flake thickness increases beyond 0.20 mm. Stated differently, as flake thickness increases, the particle size of the feed to the roll mill becomes less significant in increasing the extractability of flaked coffee.

Typical grinding equipment and methods for grinding roasted coffee beans are described in detail in, for example, Sivetz & Foote, “Coffee Processing Technology”, 1963, Vol. 1, pp. 239-250, herein incorporated by reference.

### 2. Roll Pressure or Force

Roll pressure will also influence the nature of the roast and ground coffee flakes obtained by the process of the eighth group of embodiments. Roll pressure is measured in pounds per inch of nip. In metric units it is measured in kilonewtons/meter of nip. Nip is a term used in the art to define the length of surface contact between two rolls when the rolls are at rest. To illustrate, it can be thought of as a line extending the full length of two cylindrical rolls and defining the point or line of contact between two rolls.

To produce thin-flaked roast and ground coffee of high extractability and in high yield, the roll mill should be operated at a static gap setting of less than about 0.1 mm, a roll peripheral speed of from about 150 meters/min. to about 800 meters/min., a roll surface temperature of below about 40° C., and at a pressure of about 100 kilonewtons/meter to about 400 kilonewtons/meter of nip, and wherein the rolls of said mill have a roll diameter of at least about 15 cm. In general, operable feed rates are directly related to the roll pressure. Thus, higher roll pressure allows a higher feed rate to the roll mill to produce a flake of specific thickness for otherwise equivalent operating conditions of the roll. The disadvantages of using higher roll pressures are simply mechanical, e.g. more expensive equipment is needed to produce higher roll pressures. Conversely, at low roll pressures, the feed rate can drop below commercially desirable rates.

### 3. Roll Surface Temperature

Control of the surface temperature of each roll is believed to be important to the provision of thin-flaked roast and ground coffee of high extractability. Roll surface temperature refers to the average surface temperature of each roll of the roll mill. The rolls can be operated at differential operating temperatures. However, operation under conditions of differential roll temperatures is not preferred.

The surface temperature of each of the respective rolls can be controlled by a heat exchange fluid passing through the inner core of the rolls. Generally, the fluid, which is most often water, is heated or cooled and passed through the inside of the rolls. The result is that the roll surface which is usually a smooth, highly polished steel surface, is subjected to temperature control by means of heat transfer. Of course, in actual operation the surface temperature will not be exactly the same as the temperature of the heat exchange fluid and will be somewhat higher because milling of coffee particles to produce flakes tends to increase the roll surface temperature. Accordingly, determination of the temperature of the exchange fluid necessary to maintain any specific roll surface temperature will depend upon several factors, such as the kind of metal the roll is made of, the roll wall thickness, the speed of operation of the roll mills, and the nature of the heat exchange fluid employed.

To produce the thin-flaked roast and ground coffee of the eighth group of embodiments, it is important that the roll surface temperature be less than about 40° C., preferably between about 5° C. to 30° C.

### 4. Static Gap

As used herein, the term “static gap” represents that distance separating the two roll mills along the line of nip while at rest and is typically measured in mm or mils. A special condition of roll spacing is “zero static gap” which is used herein to indicate that the two rolls are in actual contact with each other along the line of nip when the roll mills are at rest. As roast and ground coffee is fed into the roll mills and drawn through the nip, it causes the rolls to deflect an amount which is dependent upon the roll peripheral speed, roll pressure, and coffee feed rate. Accordingly, the thin-flaked coffee of the eighth group of embodiments can be made even when the roll mills are set at zero static gap. Because of the deflecting action of the coffee feed as it passes through the roll mill, the static gap setting should be less than the desired flake thickness. Suitable static gap settings range from 0 (i.e. from a zero gap setting) up to about 0.1 mm. Preferably, the gap setting ranges from about 0 to about 0.1 mm.

In the most preferred method of practice, a zero static gap spacing of the roll mills is employed. Differential roll peripheral surface speeds are to be strictly avoided when the roll mills are set for zero static gap operation. Contact along the line of nip between rolls operating at differential peripheral surface speeds can cause severe physical damage to the roll mill. Differential roll peripheral surface speeds can be utilized, however, with static gap spacings exceeding about 0.05 mm.

### 5. Moisture Content

In producing consumer-acceptable flaked roast and ground coffee, it is important that the average flake moisture content be from about 2.5% to 9.0% by weight, with 3.5% to 7.0% being preferred. Since the moisture level of the coffee particles is not significantly affected by the flaking operation, the moisture level of the thin-flaked coffee product herein can be controlled by controlling the moisture content of the roast and ground coffee feed. Consequently, the average moisture content of the roast and ground coffee particles to be flaked should be within the range of from about 2.5% to about 9.0%. Flaked roast and ground coffee particles having lower moisture levels tend to be more brittle, which leads to the production of an undesirably high level of fines.

### 6. Feed Rate

The feed rate to the roll mill is that amount of material per hour per meter of nip which is fed into the nip area. The throughput rate is the amount of material per hour per meter of nip that actually passes through the roll mill. When the feed rate exceeds the throughput rate, a condition occurs which is referred to in the art as “choke feeding”. Conversely, when the feed rate falls below the theoretical throughput rate, the feed rate and throughput rate are the same. This condition is referred to in the art as “starve feeding”. Starve feeding offers the particular process advantages such as increased process control, increased equipment life, and increased process flexibility and is, therefore, the more suitable mode of operation in the method of the eighth group of embodiments.

### 7. Roll Peripheral Surface Speed

Control of the peripheral surface speeds of the rolls is believed to be important to the provision of the thin-flaked roast and ground coffee herein. The roll peripheral surface speed is measured in meters per minute of roll surface circumference which passes by the nip. Generally, the roll mill should be operated at a roll speed of from about 150 meters/min. to 800 meters/min., preferably from about 200 meters/min. to about 700 meters/min.

For a given set of roll mill operating conditions, the throughput rate, the roll peripheral surface speed and the thickness of the flaked coffee produced are closely related. In the production of flaked coffee of a specified thickness, the throughput rate is directly related to the roll peripheral surface speed. Thus, an increase in the roll peripheral surface speed allows an increase in the throughput rate in producing flakes of specified thickness. When a constant throughput rate is maintained (e.g. by controlling the feed rate), higher roll peripheral surface speeds produce thinner flakes and conversely, lower roll peripheral surface speeds produce thicker flakes. If the throughput rate is increased, the roll peripheral surface speed should be increased to maintain the production of flakes of a desired thickness.

While peripheral surface roll speeds have been set forth in connection with operation of a roll mill to provide thin-flaked coffee of improved extractability, it will be appreciated that optimal speeds will be determined in part by the other roll mill conditions, such as the size of the rolls employed, the static gap setting, etc., as well as the physical and organoleptic properties desired in the flaked product.

### 8. Roll Diameters

The process of the eighth group of embodiments can be practiced with the aid of any of a variety of roll mills of various roll diameters capable of subjecting roast and ground coffee to mechanical compressing action and adapted to the adjustment of roll pressure, roll speed and roll temperature. Suitable mills are those having two parallel rolls so that coffee particles passed between the rolls are crushed or flattened into flakes. Normally, smooth or highly polished rolls will be employed as they permit ready cleaning; other rolls can, however, be employed if the desired flaking effects can be obtained.

In the selection of suitable roll mill equipment attention should be given to the diameters of rolls. The diameter of the roll mills, while it controls the angle of entry into the nip which in turn affects flake thickness and bulk density, is not critical per se. While rolls smaller than about 15 cm in diameter can be employed to flake coffee, roll mills having a diameter of less than about 15 cm tend to hamper passage of the coffee through the mill by a churning effect which decreases throughput and efficiency. If available, roll mills of even as high as 122 cm in diameter should be suitable. However, good results are obtained from mills having diameters in the range of from 15 to 76 cm. Examples of suitable mills which can be adapted in known manner to operation within the parameters defined hereinbefore include any of the well-known and commercially available roll mills, such as those sold under the tradenames of Lehmann, Thropp, Ross, Farrell and Lauhoff.

### B. Screening

After the roast and ground coffee feed has been flaked by being passed through the roll mill, it is important that the thin-flaked coffee produced goes through a sizing operation so as to insure that the thin-flaked coffee product has a particle size distribution as described below. Impurities in the roast and ground coffee feed to the roll mill typically produce oversized flakes which can be readily removed by the sizing operation. And too, since operation of the roll mill within the parameter ranges given above can result in a secondary grinder effect, the sizing operation can serve to remove an undesirable level of fine particles.

A wide variety of suitable sizing methods and apparatus are known in the art (see, for example, “Perry's Handbook for Chemical Engineers”, McGraw-Hill Book Co., pp. 21-46 to 21-52, incorporated herein by reference). For example, the thin-flake coffee can be effectively screen-sized by dropping the thin-flaked coffee particles from a hopper, chute or other feeding device into a mechanically vibrating screen or into a multiple sieve shaker such as those marketed by Newark Wire Cloth Company and the W. S. Tyler Company. Typically, the sizing operation separates the flaked coffee of various particle sizes into desired size fractions in less than one minute. Such equipment typically have exit or drawoff ports which allow the withdrawal of oversize or plus material. Such drawoff parts also allow withdrawal of fines (i.e. through a No. 30 U.S. Standard Sieve) so as to achieve a sieve analysis or particle size distribution such that a thin-flaked coffee product is produced such that about 30% to about 90% by weight passes through a No. 30 U.S. Standard Sieve.

In preparing the coffee compositions as defined in the Summary of the Invention, the coffee in the coffee composition 110/130 and beverage material 120 as shown in FIGS. 1A, 1B, and 1C may have various cell structures. As previously mentioned, flaked roast and ground coffee is contemplated in the present invention. The ninth group of embodiments according to the present invention provides roast and ground coffee in the form of high-sheen flakes and having improved extractability. A process for preparing flaked roast and ground coffee of high sheen and improved extractability by passing roast and ground coffee through a roll mill operating at differential speeds and temperatures is also disclosed. The process comprises: passing roast and ground coffee through a roll mill wherein a first roll has a peripheral surface speed of 30 ft./min. to 850 ft./min. and a surface temperature of from 0° F. to 140° F. and a second roll has a peripheral surface speed corresponding to from 2 to 8 times that of the first roll and a surface temperature of from 150° F. to 300° F.; and removing from said roll mill roast and ground flakes of high sheen and extractability.

In the ninth group of embodiments, desirable organoleptic and physical appearance properties in a roast and ground coffee product can be realized by providing the product in the form of high-sheen flakes prepared by roll milling under conditions of differential surface roll speeds and differential temperatures. In its product aspect, the ninth group of embodiments resides in high-sheen roast and ground coffee flakes characterized by a reflectance value of at least 35 units as determined by reflectance of a laser beam having a wave length of 6328 A.

In its process aspect, the ninth group of embodiments provides a method for producing flaked roast and ground coffee of high sheen and improved extractability by (1) passing roast and ground coffee through a roll mill having a first roll operating at a peripheral surface speed of from 30 ft./min. to 850 ft./min. and at a surface temperature of from 0° F. to 140° F. and a second roll operating at a peripheral surface speed of from 2 to 8 times that of the first roll and a surface temperature of from 150° F. to 300° F.; and (2) removing from said roll mill, roast and ground flakes of high sheen and extractability.

The ninth group of embodiments relates to roast and ground coffee and to a method for preparing same. More particularly, it relates to roast and ground coffee in the form of high-sheen flakes which exhibit improved extractability and to a process for preparing same.

In connection to the background of the ninth group of embodiments, roast and ground coffee, i.e. coffee obtained by the grinding of roasted coffee beans, has for the most part existed in the conventional form known to all consumers. While considerable effort has been expended in the area of “instant” coffees to simulate the organoleptic and physical characteristics of roast and ground coffee, little relative effort has been directed to altering the fundamental physical characteristics of conventional roast and ground coffee. For example, U.S. Pat. No. 1,903,362 (issued Apr. 4, 1933 to McKinnis), U.S. Pat. No. 3,615,667 (issued Oct. 26, 1971 to Joffe), and U.S. Pat. No. 3,660,106 (issued May 2, 1972 to McSwiggin et al.) disclose coffee products in the form of flakes, while U.S. Pat. No. 3,713,842 (issued Jan. 30, 1973 to Lubsen et al.) describes panagglomerated roast and ground coffee of unique appearance. Similarly, U.S. Pat. No. 3,801,716 (issued Apr. 2, 1974 to Mahlmann et al.) describes a process of compressing and granulating roast coffee beans for the purpose of developing unique physical and/or organoleptic properties. While these patents illustrate prior art efforts to alter the conventional appearance of roast and ground coffee, the great bulk of the roast and ground coffee presently commercialized exists in its appearance aspects in relatively non-distinctive form. An especially distinctive and desirable appearance is, however, considered preferable by some consumers. Thus, it would be desirable to provide a roast and ground coffee product combining desirable organoleptic properties, improved extractability and an especially distinctive and pleasing physical appearance.

It is an object of the ninth group of embodiments to provide a roast and ground coffee product exhibiting desirable organoleptic and physical properties and a process for providing same.

Another object of the ninth group of embodiments is the provision of a roast and ground coffee product in a particularly unique and pleasing physical form attractive to some consumers.

One aspect of the ninth group of embodiments provides for a coffee composition for use in a beverage unit and method thereof as defined in the Summary of the Invention, wherein the coffee composition comprises a roast and ground coffee composition comprising from 10 to 80% by weight of the composition of roast and ground coffee in the form of flakes of high sheen and extractability, said roasted and ground flaked having a flake thickness of between 0.008 and 0.025 in. and having a reflectance value of at least 35 reflectance units, said reflectance units representing reflectance by coffee flakes of light from 0.88 helium/neon gas laser beam of 6328 Angstrom wavelength, calibrated against reflectance values of 2 and 89 units, respectively, for the Federal Bureau of Standards Paint Chips 15042 and 11670; and from 20 to 90% of non-flaked roast and ground coffee.

In more specific examples under this aspect, the roast and ground coffee flakes comprise from 25 to 60% by weight and the non-flaked roast and ground coffee comprises from 40 to 75%. For example, such roast and ground coffee flakes may be characterized by a reflectance value of from 40 to 60 reflectance units.

Another aspect of the ninth group of embodiments provides for a coffee composition for use in a beverage unit and method thereof as defined in the Summary of the Invention, wherein the coffee composition comprises roast and ground coffee flakes of high sheen and extractability, made from a process which comprises: passing roast and ground coffee through a roll mill having a first roll operating at a peripheral surface speed of from 30 to 850 feet per minute and at a surface temperature of from 0° F. to 140° F. and having a second roll operating at a peripheral surface speed of from 2 to 8 times that of the first roll and a surface temperature of from 150° F. to 300° F.; and removing from said roll mill said roast and ground coffee flakes.

In more specific examples under this aspect, said second roll has a peripheral surface speed of from 3 to 5 times that of said first roll; or said second roll has a peripheral surface speed of from 3 to 5 times that of said first roll and a surface temperature of from 180° F. to 220° F.

In more specific examples under this aspect, said first roll has a peripheral surface speed of from 250 to 650 feet per minute and a surface temperature of from 50° to 100° F. For example, said second roll has a peripheral surface speed of from 3 to 5 times that of said first roll and a surface temperature of from 180° F. to 220° F.

In more specific examples under this aspect, the roll mill has a roll pressure of from 1500 to 3500 pounds per inch of nip. For example, the roll pressure is from 2000 to 3000 pounds per inch of nip.

The ninth group of embodiments as described above will be further described in the following paragraphs and exemplified in Examples 30-34.

As used in the ninth group of embodiments, the terms flaked roast and ground coffee and roast and ground coffee flakes are used interchangeably to refer to roast and ground coffee in the form of flakes.

The flaked roast and ground coffee of the ninth group of embodiments can be formed by subjecting conventional roast and ground coffee to the mechanical pressures of a roll mill operating under conditions of differential roll speed and temperature. The roast and ground coffee is passed through the roll mill which comprises a pair of parallel smooth or highly polished rolls and which crushes and flattens the coffee particles into flakes. The differential-speed and -temperature conditions of the mill cause the flakes to take on a high sheen or glistening appearance which is preferred by some consumers. The differential-speed and -temperature conditions also effect a disruption of the cellular structure and the coffee particles in such a manner as to provide a higher level of extractability than generally obtained from roast and ground coffee flakes. The provision of roast and ground coffee flakes of high sheen and improved extractability is believed to depend upon the control of certain processing parameters including the peripheral surface speeds of the rolls and the temperatures of the rolls. These and other processing variables are described in detail hereinafter.

The flaked roast and ground coffee of the ninth group of embodiments is provided in the form of high-sheen flakes of improved extractability largely as the result of the employment of differential roll speed which hereinafter refers to the employment of roll mill conditions whereby the rolls operate at different roll peripheral surface speeds, i.e., one roll is allowed to operate at a speed greater than that of the other roll. The peripheral surface speed of the rolls is measured in feet per minute of surface circumference which passes by the nip of the rolls. It is believed that a high sheen or glazed appearance can be provided on at least one surface of coffee flakes by operating a first roll within the range of from 30 to 850 ft./min. and a second or faster roll at a speed with respect to the slower roll corresponding to the ratio of from 2:1 to 8:1.

The employment of differential roll speeds permits individual coffee particles to be glazed or shined by a relatively faster moving smooth roll. The slower of the rolls allows the particles to be held momentarily onto the roll and sufficiently long for the faster roll to effect a glazing or smoothing operation on one side of each flake. The resulting high-shear effect enables the provision of flakes which exhibit a distinctive and high-sheen appearance and which are characterized by extensive cell disruption and high extractability.

The slower of the two rolls will normally be operated at a speed of from 30 to 850 ft./min. A roll speed slower than about 30 ft./min. tends to be impractical from the standpoint of desired product throughput. The flakes also tend to be thicker than those normally considered to be consumer acceptable. A roll speed greater than about 850 ft./min. tends to produce flakes which are thin and which contain more fines than might be considered acceptable. Moreover, high peripheral surface speeds promote frictional temperature increases which can alter and degrade the flavor of the roast and ground flakes. The employment of a peripheral roll speed for the slower roll of from 250 to 650 ft./min. permits the attainment of desirable throughput rates and enables the manufacture of high-sheen flakes having a thickness in a preferred range of from 0.008 to 0.025 inch. Thus, a preferred range of peripheral roll speed in the case of the slower roll is from 250 to 650 ft./min.

The peripheral roll speed of the second and relatively faster roll is an important parameter in the manufacture of high-sheen flakes of improved extractability. Normally, the faster roll will be operated at a speed with respect to the slower roll corresponding to the range of from 2:1 to 8:1. The faster roll affects the shining or glazing of individual compressed or flaked particles as they are momentarily held by the relatively slower roll. If the faster roll is operated so slow as to provide a speed differential of less than 2:1, the flaked particles do not take on the distinctive and desirable sheen which characterizes the product of the ninth group of embodiments. The shearing action provided by the requisite speed differential is lacking where this minimum differential is not maintained. Conversely, the speed of the faster roll should not exceed a rate corresponding to a differential of about 8:1. A differential peripheral roll speed of greater than 8:1 causes the flakes to be thinner and to contain excessive fines with the result that the flakes are readily broken with the formation of appreciable quantities of undesirable powder or fines. Excessive speed of the faster roll also tends to promote increases in the surface temperature of the rolls with the result that flavor degradation is obtained. As is described hereinafter, roll surface temperatures in excess of 300° F. are undesirable from the standpoint of product flavor degradation and, accordingly, roll speeds tending to promote the attainment of such temperatures and adverse flavor effects are desirably avoided. Best results are obtained when the differential is from 3:1 to 5:1.

While peripheral surface roll speeds and speed differentials have been set forth in connection with operation of a roll mill to provide high-sheen flakes of improved extractability, it will be appreciated that optimal speeds will be determined in part by the size of the rolls employed and the physical and organoleptic properties desired in the flaked product.

The roll-mill surface temperature, measured in degrees Fahrenheit, refers to the average surface temperature of each roll of the roll mill. Control of the surface temperature of each roll has been found to be important to the provision of high-sheen roast and ground coffee flakes of improved extractability. Moreover, the temperature of each roll has been found to be closely tied to and correlated with the peripheral surface speeds of the respective rolls. For example, it is believed that the faster of the two rolls may also be operated at a surface temperature higher than that of the relatively slower roll.

In general, higher roll surface temperatures produce thinner flakes of roast and ground coffee which typically have high fines levels and increase the propensity for flavor degradation. On the other hand, lower roll surface temperatures produce relatively thicker flakes with little or no flavor degradation. High-sheen roast and ground flakes of high extractability and desirable thickness can be produced in an efficient manner and at high throughput by employing a roll surface temperature for the slower roll in the range of from 0° F. to 140° F. Temperatures less than 0° F. are undesirable because expensive cooling systems must be employed and at such low temperatures the flake thickness tends to be greater than 0.025 inches; consequently, the flakes are thicker than those normally considered consumer acceptable. Additionally, at temperatures less than 0° F. the resultant coffee flakes are very brittle and have a tendency to break during subsequent processing and packaging. This is undesirable because breaking of brittle flakes results in a change in product bulk density which may affect the consumer acceptability of the coffee flakes produced. Such weak flakes often have bulk densities not within the range of consumer acceptable flake bulk densities.

It is preferred that the surface temperature of the slower roll be within the range of from 50° F. to 100° F. When roll surface temperatures within this range are employed the majority of the resultant coffee flakes exhibit high sheen, have a thickness generally considered consumer acceptable, and combine high structural integrity and little or no flavor degradation.

The roll surface temperature of the faster roll is believed to have a material effect on the nature of the flakes produced by the process of the ninth group of embodiments. In order to obtain a desirable high-sheen effect, it is believed that the faster roll of the two rolls of the roll mill should also be operated at a higher surface temperature than the slower roll. Roast and ground coffee flakes of high sheen and extractability are produced when the surface temperature of the faster roll is in the range of from 150° F. to 300° F. If the temperature of the faster roll is such that the temperature is less than about 150° F., the flakes tend to have little plasticity and do not take on the desired and characteristic sheen. Moreover, a low yield of roast and ground coffee flakes is obtained as the flakes tend to be grabbed by the faster roll and torn into fragments. A roll surface temperature for the faster roll in excess of 300° F. is also undesirable from the standpoint of flavor degradation or over-heating the product. Preferably, the faster roll is operated at a temperature of from 180° F. to 220° F. which provides best results from the standpoint of sheen, yield and flavor results.

The surface temperature of each of the respective rolls can be controlled in known manner. This is accomplished by control of the temperature of a heat exchange fluid passing through the inner core of the rolls. Generally, the fluid, which is most often water, is heated or cooled and passed through the inside of the rolls. The result is that the roll surface which is usually a smooth, highly polished steel surface, is subjected to temperature control by means of heat transfer. Of course, in actual operation the surface temperature will not be exactly the same as the temperature of the heat exchange fluid and will be somewhat higher because milling of coffee particles to produce flakes tends to increase the roll surface temperature. This is especially true with respect to the faster roll which constantly slides or rubs over the surface of coffee flakes. Accordingly, determination of the temperature of the exchange fluid necessary to maintain any specific roll surface temperature will depend upon several factors such as the kind of metal the roll is made of, the roll wall thickness, the speed of operation of the roll mills, and the nature of the heat-exchange fluid employed.

Roll pressure will also influence the nature of the roast and ground coffee flakes obtained by the process of the ninth group of embodiments.

Roll pressure is measured in pounds per inch of nip. Nip is a term used in the art to define the length of surface contact between two rolls when the rolls are at rest. To illustrate, it can be thought of as a line extending the full length of two cylindrical rolls and defining the point or area of contact between two rolls.

To produce flaked roast and ground coffee of high sheen and extractability and in high yield, roll pressure should be within the range of from 1500 to 3500 lbs./inch of nip and preferably within the range of from 2000 to 3000 lbs./inch of nip. If pressures much less than 1500 lbs./inch of nip are employed, the resulting flakes do not take on a high-sheen appearance. Moreover, any flakes that are produced are much thicker than 0.025 inches and consequently the flakes are not normally considered consumer acceptable. On the other hand, if pressures in excess of 3500 lbs./inch of nip are employed the roast and ground coffee flakes tend to be thin and readily fractured because of the differential speed with the result that a low yield of large flakes and an appreciable amount of coffee fines is obtained. Additionally, at pressures in excess of 3500 lbs./inch of nip the roll friction produces excessive amounts of heat which as hereinbefore related also tends to produce thin flakes of impaired flavor characteristics. Best results are obtained when the roll pressure is within the range of from 2000 to 3000 lbs./inch of nip.

The process of the ninth group of embodiments can be practiced with the aid of any of a variety of roll mills capable of subjecting roast and ground coffee to mechanical compressing action and adapted to the adjustment of pressure, roll speed and temperature. Suitable mills are those having two parallel rolls so that coffee particles passed between the rolls are crushed or flattened into flakes. Such mills will permit independent adjustment or variation of speed and temperature parameters such that a relatively faster and hotter roll can effect shining of individual flakes of roast and ground coffee. Normally, smooth or highly polished rolls will be employed as they permit ready cleaning; other rolls can, however, be employed if the desired flaking and high-sheen effects can be obtained.

The diameter of the roll mills, while it controls the angle of entry into the nip which in turn affects flake thickness and bulk density, is not critical per se. While rolls smaller than 6 inches in diameter can be employed to nip fine grind coffees, roll mills having a diameter of less than about 6 inches tend to hamper passage of the coffee through the mill by a churning effect which decreases throughput and efficiency. Best results will be obtained from mills having diameters in the range of from 6 to 30 inches. Examples of suitable mills which can be adapted in known manner to operation within the parameters defined hereinbefore include any of the well-known and commercially available roll mills such as those sold under the tradenames of Lehmann, Thropp, Ross, Farrell and Lauhoff.

The process of the ninth group of embodiments can be readily practiced by simply passing roast and ground coffee into a roll mill operating within the parameters hereinbefore defined and removing the high-sheen flakes which are dropped from the rolls. Normally, a chute or other feeding device will be employed to drop roast and ground coffee particles into the nip of the roll mill, as for example, by dropping the coffee particles from a hopper or by vibrating a falling cascade of particles into the nip.

The feed rate into the roll mill, of the roast and ground coffee to be flaked, is not critical. Either choke feeding or starve feeding can be employed as long as the previously discussed processing variables are operated within their prescribed ranges. Choke feeding is defined as having excess amounts of coffee settling on the roll mills waiting to pass through the nip. It is the opposite of starve feeding.

In further regard to the feeding rate, while either starve feeding or choke feeding can be employed, starve feeding is preferred because of particular process advantages offered by starve feeding such as greater economic efficiency, increased equipment life and increased process flexibility.

The process of the ninth group of embodiments has applicability to a variety of roast and ground coffee products including those which may be classified for convenience and simplification as low-grade, intermediate grade, and high-grade coffees. Suitable examples of low-grade coffees include the natural Robustas such as the Ivory Coast Robustas and Angola Robustas; and the Natural Arabicas such as the natural Perus and natural Ecuadors. Suitable intermediate-grade coffees include the natural Arabicas from Brazil such as Santos, Paranas and Minas; and natural Arabicas such as Ethiopians. Examples of high-grade coffees include the washed Arabicas such as Mexicans, Costa Ricans, Colombians, Kenyas and New Guineas. Other examples and blends thereof are known in the art and illustrated for example in U.S. Pat. No. 3,615,667 (issued Oct. 26, 1971 to Joffe).

The roast and ground coffee suitable for use in the preparation of the high-sheen flakes of the ninth group of embodiments include those conventionally prepared by known grinding means into “regular”, “drip”, or “fine” grinds as these terms are used in the art. The standards of these grinds are suggested in the 1948 Simplified Practice Recommendation by the U.S. Department of Commerce (see Coffee Brewing Workshop Manual, page 33, published by the Coffee Brewing Center of the Pan American Bureau). The particle size of the feed is not, however, critical and can be varied widely. The choice of grind will in part depend upon the particle size distribution and bulk density desired in the flaked product.

The roast and ground coffee suitable for manufacture into high-sheen flakes can be roasted to any of the roast colors generally recognized in the coffee arts. Thus, the light and dark roasts known in the art can be suitably employed. In actual practice, dark roasts are preferred inasmuch as the high-sheen effect is particularly evident against the darker background of a dark-roast product and the greatest impact or visual impression can be realized.

As previously stated in the ninth group of embodiments, the flaked roast and ground coffee product prepared by the process of the ninth group of embodiments is distinctly different in appearance from the conventional roast and ground and flaked roast and ground coffee products described in the art. The distinctive physical appearance can be quantified by resort to reflectance measurement techniques and calibration against standardized reflecting surfaces.

A suitable technique for measuring the reflectance of the roast and ground coffee flakes produced by the process of the ninth group of embodiments is based upon the principle that high-sheen surfaces reflect a greater proportion of incident light than relatively dull surfaces. Based upon measurement of the light reflected by the surfaces of flaked coffee particles and comparison with the light reflected by standard surfaces, a reflectance value for flaked coffee can be readily obtained.

In actual practice, the reflectance value of flaked coffee particles can be determined by measuring the light reflected by a single flake particle impinged with light from a standardized source. The following method and apparatus can be employed for this purpose. A random sample flake, of a size which permits handling, is placed on a movable platform or table within a light-tight enclosure. The table is adjustable for forward, backward and lateral movement by means of inner tracks and other controls. Suitable apparatus for this purpose is a conventional thin-film scanner unit equipped with movable scanner platform (American Instrument Company, Div. of Travenol Laboratories, Inc., Silver Spring, Md., Cat. No. 4-7410). The lid of the light-tight enclosure (thin-film scanner unit) is provided with a light port (hole) by means of which a light beam from an outside source is allowed to impinge at a 90° angle upon the sample placed on the platform inside the enclosure. The lid is provided with an outside mounting block having a superimposed light port and means for mounting a fiber optic sensing element. An inside mount, a plate having a 3-inch diameter hole and positioned on the inside of the lid such that the light passes through the center of the three-inch hole is provided for mounting of a photocell. The fiber optic sensor (Edmund Scientific, duPont Crofon ⅛-inch light guide) is mounted in the outside mount behind the light port and inwardly toward the light beam at a 45° angle. The tip of the sensor element protrudes into the three-inch circle of the inner mount and picks up reflected light from the sample. A selenium photocell (B2M Photocell, International Rectifier Corp.) is mounted in the circle of the inner mount immediately adjacent the protruding fiber optic sensor element. The impulse from the photocell is passed to an amplifier and then to an electronic recorder.

A helium-neon gas laser unit (Spectraphysics Model 155, Spectra-Physics, Mountain View, Calif.) is mounted vertically on the lid in an abutting relationship to the outside mount. The laser beam, 0.88 mm. diameter and 6328 A wavelength, is directed at a 90° angle through and into the enclosure and is impinged upon the sample flake. The distance between the laser beam and the platform is 2 5/16 inches. The flake surface is scanned by manual adjustment of the platform to locate the point of highest reflectance as detected by the fiber-optic sensor. The electronic signal from the photocell is amplified and registered on a 0-to-100 scale of an electronic recorder (Honeywell Electronik 193, Honeywell Inc., Minneapolis, Minn.). A zero reading is obtained when the laser unit is off, i.e. there is no reflected light.

The apparatus is calibrated by reference to standarized reflective surfaces. A standardized paint chip of dark blue color and hue (No. 15042, Federal Standard 595, 1961 Edition, available from National Bureau of Standards, Washington, D.C.) is utilized as a standard reflecting surface and the recorder is adjusted so as to provide a reading of two on the 0-to-100 recorder scale. Similarly, a standardized paint chip of beige color and hue (No. 11670, Federal Standard 595, 1961 Edition, available from National Bureau of Standards, Washington, D.C.) is utilized as a standard for calibration in the higher range of the scale, the recorder being adjusted so that a reading of 89 is obtained. The reflectance values for the two standard paint chips are measured alternately and the recorder is adjusted until readings of 2 and 89 are obtained. The test coffee flake is then impinged with the standardized light source described hereinbefore and a reading of reflectance value is recorded on the 0-to-100 scale.

Since coffee flakes do not provide a perfectly planar reflective surface and, thus, a degree of light scattering is observed, an average of three readings is taken to minimize reflectance variations from a single flake. An initial reading is recorded at a first flake orientation, referred to as the zero degree orientation. A second reading is taken at the position obtained by rotating the flake 120° clockwise from the first orientation (the 120° orientation) and a third reflectance reading is taken at the orientation obtained by rotating the flake 120° clockwise from the second orientation (referred to as the third orientation). At each orientation, the flake is manually scanned by the larger beam and the highest reflectance reading at that orientation is recorded. The average of the three readings represents the reflectance value of the coffee flake. The process of measuring the reflectance value of individual flakes is repeated a minimum of five or six times or as a means of minimizing any variations in flakes and to ascertain an average value which is taken as the reflectance value for the particular batch of coffee tested.

As used in the ninth group of embodiments and claims 27 and 28, reflectance value, expressed as arbitrary reflectance units, represents the reflectance by coffee flakes of light from a 0.88 mm. helium/neon gas laser beam of 6328A wavelength, calibrated against reflectance values of 2 and 89 units, respectively, for Federal Bureau of Standards Paint Chips 15042 and 11670.

The flaked roast and ground coffee of the ninth group of embodiments is characterized by a reflectance value of at least about 35 reflectance units. A roast and ground coffee product which is comprised of flakes which have a surface providing 35 reflectance units is readily appreciated as exhibiting a distinct, high-sheen or glistening effect. Below about 35 reflectance units, a high-sheen effect is not observed. As used herein, high-sheen flakes are characterized by a reflectance value of at least 35.

While reflectance values above about 60 are desirable from the standpoint of the visual effect and distinctiveness, such values tend to be difficult to attain. High-sheen flakes of reflectance value 40 to 60 can be conveniently and economically produced by the process described herein and combine readily recognizable sheen and are, thus, preferred herein.

The roast and ground coffee flakes of the ninth group of embodiments can be packaged and utilized in the preparation of a brew or extract in known manner. When the flakes are produced by the milling process herein described, a content of fines will normally be present and depending upon the particular extraction method employed a greater or lesser amount of cup sediment may be observed. According to preferred practice, the high-sheen flakes will be employed in combination with conventional roast and ground coffee. Normally, flake-containing compositions will comprise from about 10 to about 80% by weight of the composition of the high-sheen flakes and from about 90 to about 20% conventional, i.e., non-flaked, roast and ground coffee. Thus, the content of high-sheen flakes can be varied depending upon the amount of sheen desirably provided in the product and upon the desired contribution of the flakes to cup solids and flavor. The balance of the composition, i.e., conventional roast and ground coffee, can be controlled, if desired, to diminish its contribution to cup solids in recognition of the enhanced extractability of the flakes of the ninth group of embodiments.

A preferred composition combining a distinctive physical appearance with high extractability and desirable organoleptic properties comprises from about 25 to 60% of flakes exhibiting a reflectance value of from 40 to 60; and from about 40 to about 75% of conventional roast and ground coffee.

An important aspect of the process of the ninth group of embodiments is the provision of roast and ground coffee flakes of improved extractability. It is believed that the employment of differential roll-speed and temperature conditions during flake rolling provides an enhancement in extractability of the resulting flakes over that normally encountered in the flaking of roast and ground coffee. This enhancement is manifested by higher brew strength per weight of coffee employed in making a brew or infusion and is especially desirable where flaked decaffeinated product is desired. As is known in the art, the removal of caffeine from coffee products frequently is accomplished at the expense of the removal of certain other desirable components that contribute to flavor. The tendency of decaffeinated products to be either weak or deficient in flavor has, thus, been reported in the literature. The process of the ninth group of embodiments as applied to decaffeinated roast and ground coffee by enhancing extractability provides a compensatory advantage. The added flavor and strength advantages achievable by enhanced extractability permits realization of levels of flavor and brew strength which might otherwise not be attainable in the case of a conventional decaffeinated roast and ground product.

Other important advantages of the ninth group of embodiments are the provision of high-sheen flakes of high structural integrity and with little or no flavor degradation. The desirability of flakes of high structural integrity (i.e., physical strength and resistance to attrition or breakage during packing) is important because large percentages of broken flakes can change the produce bulk density and present unappealing appearance and cause cup sediment in the brew. Minimized coffee flavor degradation is, of course, important in respect to consumer preference for a coffee product.

In preparing the coffee compositions as defined in the Summary of the Invention, the coffee in the coffee composition 110/130 and beverage material 120 as shown in FIGS. 1A, 1B, and 1C may have various cell structures. As previously mentioned, flaked roast and ground coffee is contemplated in the present invention. The tenth group of embodiments according to the present invention provides a fast roasted coffee that exhibits increased brew strength and darker cup color with desirable brew acidity. The tenth group of embodiments relates to roast and ground and flaked coffee products that have been fast roasted. This application particularly relates to fast roasted coffees that provide a darker cup color and improved flavor strength, yet with a desirable level of brew acidity.

In the tenth group of embodiments, roast and ground or flaked coffee products provide more brew strength and cup color at lower levels of brews solids. These coffee products contain darker faster roasted coffee that is predominantly high acidity-type coffee that provide, when brewed appropriate conditions, a consumable coffee beverage having: (1) a brew solids level of from about 0.4 to about 0.6%; (2) a Titratable Acidity of at least about 1.52; (3) a brew absorbance of at least about 1.25, provided that when the Titratable Acidity is in the range of from about 1.52 to about 2.0, the brew absorbance is equal to or greater than the value defined by the equation:

1.25+[0.625×(2.0−TA)]

where TA is the Titratable Acidity.

The tenth group of embodiments relates to a roast and ground or flaked coffee product which provides more brew strength and cup color, yet with a desirable level of brew acidity. This coffee product has a Hunter L-color of from about 13 to about 19 and comprises from about 50 to 100% high acidity-type coffee, from 0 to about 30% low acidity-type coffee, and from 0 to about 50% moderate acidity-type coffee. This coffee product, when brewed under appropriate conditions, is capable of providing a consumable coffee beverage having:

(1) a brew solids level of from about 0.4 to about 0.6%;

(2) a Titratable Acidity of at least about 1.52;

(3) a brew absorbance of at least about 1.25, provided that when the Titratable Acidity is in the range of from about 1.52 to about 2.0, said brew absorbance being equal to or greater than the value defined by the equation:

1.25+[0.625×(2.0−TA)]

where TA is the Titratable Acidity.

The tenth group of embodiments further relates to a process for preparing these roast and ground or flaked coffee products. This process comprises the steps of:

(a) fast roasting green coffee beans comprising from about 50 to 100% high acidity-type coffee beans, from 0 to about 30% low acidity-type coffee beans and from 0 to about 50 moderate acidity-type coffee beans that have not been predried, or only partially predried, to a Hunter L-color of from about 13 to about 19 under conditions that prevent burning and tipping of the beans;

(b) grinding the roasted coffee beans;

(c) optionally flaking the ground coffee beans.

Coffee products of the tenth group of embodiments perform across a wide range of brewers delivering a high quality beverage with desirable strength and cup color at a drastically reduced usage. These products are believed to have increased brew absorbance due to the formation (during fast roasting) and extraction of very large molecules (e.g., polysaccharides) from the coffee. What was previously unknown was how to make and extract these molecules using higher quality coffees and still maintain the desired higher acidity. What has been surprisingly discovered is that by careful fast roasting, even high quality washed Arabicas can be fast roasted to darker colors without burning. Careful fast roasting of these higher acidity-type Arabica beans produces the desired absorbance compounds, and sufficiently puffs the beans to allow extraction of these desired compounds. Subsequent mechanical disruption of the beans and cells (grinding and/or flaking) is also key in extracting these absorbance compounds to provide a consumable coffee beverage have the desired brew strength and cup color.

In connection to the background of the tenth group of embodiments, historically roast and ground coffee has been marketed on supermarket shelves by weight in 16-ounce cans. However, a recent trend in the coffee market has resulted in the demise of the 16-ounce weight standard. This trend emerged in 1988, when major coffee manufacturers began marketing 13-ounce blends. The blends were prepared using “fast roast” technology that resulted in a lower density bean. Thirteen ounces of these lower density blends have nearly the same volume as the traditional 16-ounce blends. As a result they could be marketed in the old 1-pound cans and were priced about 20 cents below the previous 16-ounce list price because they used fewer beans. This down-weighting of coffee in cans has met with widespread acceptance in the industry.

One process using fast roasting to lower bean density is disclosed in U.S. Pat. No. 5,160,757 (Kirkpatrick et al), issued Nov. 3, 1992. In the Kirkpatrick et al process, the green coffee beans are pre-dried to a moisture content of from about 0.5% to about 10% by weight, fast roasted to a Hunter L-color of from about 14 to about 25 and a Hunter ΔL-color of less than about 1.2, and then ground, or ground and flaked. The resulting coffee product has a tamped bulk density of from about 0.28 to about 0.38 g/cc and is more uniformly roasted compared to traditional reduced density coffee beans. See abstract and column 2, lines 35-45.

Many recent “fast roast” coffees also have a higher yield of brew solids than previous 16-ounce coffees. These high yield fast roast and ground coffees exhibit improved extraction characteristics during brewing. Higher yield (sometimes referred to as higher mileage) coffees have typically been defined by the ability to extract more brew solids from the coffee beans so that an equivalent brew solids is achieved in the final brew but with less coffee used. In other words, these higher yield coffees can make more cups of coffee per ounce when compared to previous 16-ounce coffees.

Fast roasting results in a puffed or somewhat popped bean. Fast roasting of coffee typically occurs in large multistage roasters (e.g., Probat, Thermalo, Jetzone, etc.) with very large heat inputs. These high heat inputs result in the rapid expansion of the roasted bean, but can also cause a high degree of bean roasting variation within the roaster. In addition, tipping and burning of the outer edges of the bean can be a major problem during fast roasting.

One proposed solution for dealing with problems caused by fast roasting, including tipping and burning, is disclosed in U.S. Pat. No. 5,322,703 (Jensen et at), issued Jun. 21, 1994. In the Jensen et al process, green coffee beans are dried prior to roasting to a moisture content of from about 0.5 to about 7%. These predried beans are then fast roasted to a Hunter L-color of from about 10 to about 16. These dried dark roasted coffee beans (about 1 to about 50%) are blended with non-dried roasted coffee beans (about 50 to about 99%), and then ground, or ground and flaked. See abstract and column 1, lines 50-63.

The purpose in predrying according to the Kirkpatrick et al and Jensen et al processes is to make the moisture content of the resultant predried more uniform throughout. See column 3, lines 52-56 of Kirkpartrick et al. While predrying improves the flavor of all coffees, it particularly improves the flavor of lower grade coffees such as the Robustas. See column 8, lines 45-47. See also column 3, lines 13-15 of Jensen et al (dark roasting of non-dried coffee beans, especially low quality beans such as Robustas can result in excessive burnt-rubbery notes.)

As alluded to in Jensen et al, a major problem with prior high yield coffees is their unbalanced flavor and lack of acidity. See column 1, lines 42-44 (enhancing extractability and brew coffee yield can be achieved but often at the expense of balanced flavor of the coffee brew). The Jensen et al process tried to improve this balance by blending the dark roasted pre-dried beans (providing strength with minimal burnt-rubbery flavor notes) with the lighter roasted non-dried coffees (to provide flavor and acidity). See column 1, line 64-68. This blending does result in higher acidity, but at the expense of diluting the high yield benefits of the pre-dried beans.

Historically, coffee brew strength, as well as cup color, has been directly correlated to the level of brew solids present in the brewed cup of coffee. To achieve increased brew strength and cup color, the coffee beans have previously been roasted faster, darker and with greater concentrations of Robustas. Grinding the beans finer and flaking the ground beans thinner have also been used to increase brew strength and cup color. This often leads to undesired tipping and burning of the beans, along with harsh, rubbery notes (from the Robustas) in the brewed coffee. Coffee made this way also generally leads to a lack of desired acidity in the brewed coffee.

Accordingly, it would be desirable to have a high yield roast and ground or flaked coffee product that provides a coffee beverage having: (1) a darker cup color; (2) increased brew strength; (3) yet with a desirable level of acidity.

One aspect of the tenth group of embodiments provides a coffee composition for use in a beverage unit and method thereof as defined in the Summary of the Invention, wherein the coffee composition comprises a roast and ground or flaked coffee product having a Hunter L-color of from about 13 to about 19 and which comprises from about 50 to 100% high acidity-type coffee, from 0 to about 30% low acidity-type coffee, and from 0 to about 50% moderate acidity-type coffee, said coffee product being capable of providing a consumable coffee beverage having:

(1) a brew solids level of from about 0.4 to about 0.6%;

(2) a Titratable Acidity of at least about 1.52;

(3) a brew absorbance of at least about 1.25, provided that when the Titratable Acidity is in the range of from about 1.52 to about 2.0, said brew absorbance value is equal to or greater than the value defined by the equation:

1.25+[0.625×(2.0−TA)]

wherein TA is the Titratable Acidity.

In more specific examples under this aspect, the coffee product comprises from about 70 to 100% high acidity-type coffee, from 0 to about 20% low acidity-type coffee, and from 0 to about 30% moderate acidity-type coffee, and optionally from about 90 to 100% high acidity-type coffee, from 0 to about 10% low acidity-type coffee, and from 0 to about 10% moderate acidity-type coffee. For example, the coffee product has a Hunter L-color of from about 14 to about 18 such as from about 15 to about 17. The coffee product may provide a coffee beverage having Titratable Acidity of from about 1.6 to about 3.0; at least about 1.58; and or from about 1.8 to about 2.7.

In more specific examples under this aspect, the coffee product comprises from about 70 to 100% high acidity-type coffee, from 0 to about 20% low acidity-type coffee, and from 0 to about 30% moderate acidity-type coffee, and provides a coffee beverage having a brew absorbance from about 1.3 to about 1.9.

In more specific examples under this aspect, the coffee product comprises from about 70 to 100% high acidity-type coffee, from 0 to about 20% low acidity-type coffee, and from 0 to about 30% moderate acidity-type coffee, and provides a coffee beverage wherein when the Titratable Acidity is in the range of from about 1.58 to about 2.2, said brew absorbance is equal to or greater than the value defined by the equation:

1.25+[0.625×(2.2−TA)].

In more specific examples under this aspect, the coffee product comprises from about 70 to 100% high acidity-type coffee, from 0 to about 20% low acidity-type coffee, and from 0 to about 30% moderate acidity-type coffee, and provides a coffee beverage having a brew solids level of from about 0.42 to about 0.58%.

In more specific examples under this aspect, the coffee product comprises from about 70 to 100% high acidity-type coffee, from 0 to about 20% low acidity-type coffee, and from 0 to about 30% moderate acidity-type coffee, and the brew absorbance is equal to or greater than the value defined by the equation:

2.475−[0.075×(Hunter L-color of coffee)].

The tenth group of embodiments as described above will be further described in the following paragraphs and exemplified in Examples 35-44

### A. Definitions in the Tenth Group of Embodiments

The term “density” means bulk density. Density or bulk density values herein can be measured by conventional means as tamped bulk density values. “Brew solids” refer to brew solids in a coffee brew obtained under standard brewing conditions (as described hereafter in the Analytical Methods section) using one ounce of a roasted and ground or flaked coffee product in a Bunn OL-35 automatic drip coffee maker with a water feed of 1860 ml at 195° F. (90° C.).

As used herein, the term “1-pound coffee can” relates to a coffee container which has a volume of 1000 cc. Historically, one pound (16 oz.) of coffee was sold in this volume container.

All particle screens referred to in the tenth group of embodiments are based on the U.S. Standard Sieve Screen Series or on the average particle size in microns (μm) as measured by Laser Diffraction on a Sympatec Rodos Helos laser particle size analyzer.

As used herein, the term “comprising” means that the various coffees, other ingredients, or steps, can be conjointly employed in practicing the tenth group of embodiments. Accordingly, the term “comprising” encompasses the more restrictive terms “consisting essentially of” and “consisting of.”

All ratios and percentages in the tenth group of embodiments are based on weight unless otherwise specified.

### B. Types and Grades of Coffee in the Tenth Group of Embodiments

Coffee beans useful in the tenth group of embodiments can be either of a single type or grade of bean or can be formed from blends of various bean types or grades, and can be caffeinated or decaffeinated. In order to provide the desired acidity in the coffee beverage, the coffee beans useful in the tenth group of embodiments are predominantly high acidity-type beans in mounts of from about 50 to 100%, preferably from about 70 to 100% and most preferably from about 90 to 100%. As used herein, “high acidity-type beans” are defined as beans that deliver greater than about 1.9 Titratable Acidity. These high acidity-type beans are typically referred to as high grade coffees. Suitable high grade coffee having high acidity include Arabicas and Colombians characterized as having “excellent body,” “acid,” “fragrant,” “aromatic” and occasionally “chocolatey.” Examples of typical high quality coffees are “Milds” often referred to as high grade Arabicas, and include among others Colombians, Mexicans, and other washed Milds such as strictly hard bean Costa Rica, Kenyas A and B, and strictly hard bean Guatemalans.

Coffees useful in the tenth group of embodiments can also include from 0 to about 50%, preferably from 0 to about 30% and most preferably from 0 to about 10% moderate acidity-type coffee beans. As used herein, “moderate acidity-type beans” are defined as beans that deliver between about 1.7 and 1.9 titratable acidity as defined in the Analytical Methods section. These moderate acidity-type beans are typically referred to as intermediate grade coffees. Suitable intermediate quality coffees are the Brazilian coffees such as Santos and Paranas, African Naturals, and Brazils free from the strong Rioy flavor such as good quality Suldeminas. Intermediate coffees are characterized as having bland, neutral flavor and aroma, lacking in aromatic and high notes, and are generally thought to be sweet and non-offensive.

Coffees useful in the tenth group of embodiments can also include from 0 to about 30%, preferably from 0 to about 20% and most preferable from 0 to about 10% low acidity-type coffee beans. As used herein, “low acidity-type beans” are defined as beans that deliver less than about 1.7 titratable acidity as defined in the Analytical Methods section. These low acidity-type beans are typically referred to as low grade coffees. Suitable low grade coffees having low acidity include Robustas, or low acidity natural Arabicas. These low grade coffees are generally described as having rubbery flavor notes and produce brews with strong distinctive natural flavor characteristics often noted as bitter.

### C. Roasting Coffee Beans in the Tenth Group of Embodiments

Prior to roasting, the coffee beans can be partially predried to a moisture content of from about 3 to about 7%, preferably from about 5 to about 7%. Partial predrying can be desirable where a higher proportion of moderate to low acidity-type coffees are used make the moisture more uniform and thus less susceptible to tipping and burning. Partial predrying can be carried out according to any of the methods disclosed in U.S. Pat. No. 5,160,757 (Kirkpatrick et al), issued Nov. 3, 1992 or U.S. Pat. No. 5,322,703 (Jensen et al), issued Jun. 21, 1994, both of which are incorporated by reference to provide the indicated moisture content values. Preferably, the coffee beans are not predried prior to roasting and typically have moisture contents in the range of from about 8 to 14%.

The coffee beans are carefully roasted under conditions that avoid tipping and burning of the beans. As used herein, the terms “tipping” and “burning” relate to the charting of the ends and outer edges of a bean during roasting. Tipping and burning of beans results in a burnt flavor in the resulting brewed beverage. Tipping and burning can be avoided by the combination of using high quality beans with minimal defects, roasting similar sizes and types together, uniform heat transfer (preferably convective), and controlling the heat input rate through the roast to prevent the edges of the beans from burning.

In order to achieve the desired darker roast color without tipping or burning, the coffee beans are fast roasted in the process of the tenth group of embodiments. Fast roasters suitable for use in the tenth group of embodiments can utilize any method of heat transfer. However, convective heat transfer is preferred, with forced convection being most preferred. The convective media can be an inert gas or, preferably, air. Typically, the pre-dried beans are charged to a bubbling bed or fluidized bed roaster where a hot air stream is contacted with the bean. Suitable roasters capable of forming a fluidized bed of green coffee beans include the Jetzone® roaster manufacture by Wolverine (U.S.), the Probat® roaster manufactured by Probat-Werke (Germany), the Probat RT or RZ. roaster manufactured by Probat-Werke (Germany), the Burns System 90 roaster by Burns (Buffalo, N.Y.), the HYC roaster by Scolari Engineering (Italy), and the Neotec RFB by Neotec (Germany). Any other roasting equipment which causes a rapid heating of the bean such as that achieved through fluidization can be used.

Roasting equipment and methods suitable for roasting coffee beans according to the tenth group of embodiments are described, for example, in Sivetz, Coffee Technology, Avi Publishing Company, Westport, Conn. 1979, pp. 226-246, incorporated herein by reference. See also U.S. Pat. No. 3,964,175 (Sivetz) issued Jun. 22, 1976, which discloses a method for fluidized bed roasting of coffee beans.

Other fast roasting methods useful in tenth group of embodiments are described in U.S. Pat. No. 5,160,757 (Kirkpatrick et al), issued Nov. 3, 1992; U.S. Pat. No. 4,737,376 (Brandlein et al.), issued Apr. 12, 1988; U.S. Pat. No. 4,169,164 (Hubbard et al.), issued Sep. 25, 1979; and U.S. Pat. No. 4,322,447 (Hubbard), issued Mar. 30, 1982, all of which are incorporated by reference.

In the process of the tenth group of embodiments, the green coffee beans are fast roasted in from about 10 seconds to about 5.5 minutes, preferably in from about 1 to about 3 minutes, using air or another fluidizing heat exchange medium having a temperature of from about 350° F. (177° C.) to about 1200° F. (649° C.), preferably a temperature of from about 400° F. (240° C.) to about 800° F. (427° C.). The green coffees are fast roasted to an average color of from about 13 to about 19 Hunter “Hunter” units, preferably from about 14 to about 18 Hunter “L” units, and most preferably from about 15 to about 17 Hunter “L” units. The Hunter Color “L” scale system is generally used to define the color of the coffee beans and the degree to which they have been roasted. Hunter Color “L” scale values are units of light reflectance measurement, and the higher the value is, the lighter the color is since a lighter colored material reflects more light. Thus, in measuring degrees of roast, the lower the “L” scale value the greater the degree of roast, since the greater the degree of roast, the darker is the color of the roasted bean. This roast color is usually measured on the roasted, quenched and cooled coffee beans prior to subsequent processing (e.g., grinding and/or flaking) into a finished coffee product.

As soon as the desired roast bean color is reached, the beans are removed from the heated gases and promptly cooled, typically by ambient air and/or a water spray. Cooling of the beans stops the roast-related pyrolysis reactions. Water spray cooling, also known as “quenching,” is the preferred cooling method in the tenth group of embodiments. The amount of water sprayed is carefully regulated so that most of the water evaporates off. The roasted and quenched beans are further cooled with air.

After cooling, the roast coffee beans of the tenth group of embodiments have a whole roast tamped bulk density of from about 0.27 to about 0.38 g/cc, preferably from about 0.29 to about 0.36 g/cc, more preferably from about 0.30 to about 0.36 g/cc, and most preferably from about 0.30 to about 0.35 g/cc.

### D. Grinding Roasted Beans in the Tenth Group of Embodiments

The roasted coffee beans can then be ground using any conventional coffee grinder. Depending upon the specific particle size distribution desired in the final product of the tenth group of embodiments, the coffee fractions can be ground to the particle size distributions or “grind sizes” traditionally referred to as “regular,” “drip,” or “fine” grinds. For example, automatic drip coffee grinds typically have an average particle size of about 900 μm and percolator grinds are typically from about 1500 μm to about 2200 μm. The standards of these grinds as suggested in the 1948 Simplified Practice Recommendation by the U.S. Department of Commerce (see Coffee Brewing Workshop Manual, page 33, published by the Coffee Brewing Center of the Pan American Bureau) are as follows:

| Grind | Sieve (Tyler) | Wt. % |
|---|---|---|
| Regular | on 14-mesh | 33 |
| | on 28-mesh | 55 |
| | through 38-mesh | 12 |
| Drip | on 28-mesh | 73 |
| | through 28-mesh | 27 |
| Fine | through 14-mesh | 100 |
| | on 28-mesh | 70 |
| | through 28-mesh | 30 |

Typical grinding equipment and methods for grinding roasted coffee beans are described, for example, in Sivetz & Foote, “Coffee Processing Technology,” Avi Publishing Company, Westport, Conn., 1963, Vol. 1, pp. 239-250.

### E. Flaking Roast and Ground Coffee in the Tenth Group of Embodiments

Coffee products according to the tenth group of embodiments can be flaked.

Preferred flaked products are produced by grinding the roast coffee to an average particle size from about 300 to about 3000 μm, normalizing the ground product, and then milling the coffee to a flake thickness of from about 2 to about 40 thousandths of an inch (about 51 to about 1016 μm), preferably from about 5 to about 30 (about 127 to about 762 μm), most preferably from about 5 to about 20 (about 127 to about 508 μm). Suitable methods and apparatus for flaking are disclosed in, for example, U.S. Pat. No. 3,615,667 (Joffe), issued Oct. 26, 1971; U.S. Pat. No. 3,660,106 (McSwiggin et al), issued May 2, 1972; U.S. Pat. No. 3,769,031 (McSwiggin), issued Oct. 30, 1973; U.S. Pat. No. 4,110,485 (Grubbs et al), issued Aug. 29, 1978; and U.S. Pat. No. 5,064,676 (Gore), issued—Nov. 12, 1991, all of which are incorporated by reference.

### F. Characteristics of Beverage Obtained by Brewing Roast and Ground or Flaked Coffee Product in the Tenth Group of Embodiments

### 1. Brew and Titratable Acidity

An important characteristic of coffee beverages prepared from roast and ground or flaked coffee products according to the tenth group of embodiments is brew acidity. A high quality coffee brew is typically noted for its acidity. Coffee brews having high acidity are typically obtained from high quality beans. The problem previously with high yield, high mileage coffees is the use of less coffee (dilution), darker roasting (which tends to decrease acidity) and the use of stronger flavored Robustas (which generally have less acidity). Therefore, higher acidity becomes vital in maintaining a high quality brew for high mileage coffees.

The ability of coffee to buffer pH changes in the mouth is its main indicator of acidity perception. This buffering capability can be measured by titrating the brew to pH 7 with sodium hydroxide and is thus referred to as Titratable Acidity (TA). Coffee beverages prepared from roast and ground or flaked coffee products according to the tenth group of embodiments have a TA of at least about 1.52, with a typical range of from about 1.6 to about 3.0. Preferably, these coffee products have a TA of at least about 1.58, with a typical range of from about 1.8 to about 2.7.

### 2. Cup Color and Brew Absorbance

Another important characteristic of coffee beverages prepared from roast and ground or flaked coffee products according to the tenth group of embodiments is cup color. A dark cup of coffee is the first thing that a coffee drinker typically looks for. The coffee drinker will initially look at the cup of coffee to visually judge its strength. If the cup is too clear and allows light to transmit through it, it is usually considered too weak. However, if the brew in the cup is too dark so that virtually no light can transmit through it, it is usually considered too strong.

Before ever tasting the coffee, the coffee drinker has thus judged in their mind as to what the strength will be, and by tasting it, confirms through taste what they have already visually seen. Therefore, an adequately strong cup of coffee must first visually look dark. Second, with the lower usage's of high yield, high mileage coffees, the consumer is constantly skeptical of the coffee being weak. Therefore, especially for high mileage coffees, the brew must be dark to prevent it from being judged weak.

Traditionally, the darker the cup of coffee, the stronger it is. This observation is true of high mileage coffees. Except for the formation of offensive flavors (burnt, robbery, rioy), the darkness of the cup almost always correlates with the strength. Therefore, by measuring and controlling the cup darkness, one can not only predict the visual response to cup darkness, but can also somewhat predict its true strength (assume no offensive flavors).

To technically measure the darkness of the coffee brew, a spectrophotometer is used to measure the amount of light absorbance by the liquid brewed coffee. A wavelength of 480 nanometers was chosen because it corresponds with the Brown Color absorbance on the visible spectrum. (Brown color is typically associated with stronger coffee brews.) This absorbance at 480 nm correlates with the visually perceived darkness in the cup.

Coffee beverages prepared from roast and ground or flaked coffee products according to the tenth group of embodiments have a brew absorbance of at least about 1.25, with a typical range of from about 1.3 to about 1.9. However, when the coffee beverage has a Titratable Acidity (TA) in the range of from about 1.52 to about 2.0, this brew absorbance is equal to or greater than the value defined by the equation:

1.25+[0.625×(2.0−TA)]

Preferably, when the coffee beverage has a TA in the range of from about 1.58 to about 2.2, this brew absorbance is equal to or greater than the value defined by the equation:

1.25+[0.625×(2.2−TA)]

### 3. Brew Solids in the Tenth Group of Embodiments

Another important characteristic of coffee beverages prepared from roast and ground or flaked coffee products according to the tenth group of embodiments is the level of brew solids. Brew solids are simply the solids remaining after oven drying the brewed coffee. Brew solids is an indication of the mass transfer that has occurred from the solid grounds to the water phase during brewing. While the level of brew solids is a good indicator of the efficiency of the extraction and completeness, it does not discriminate as to what compounds are extracted. Indeed, green coffee has a considerable fraction of extractable brew solids, even though the subsequent brew prepared from this green coffee lacks coffee flavor.

High yield, high mileage coffees have concentrated on extracting more of the available brew solids. This has been beneficial in providing good extraction of the majority of the compounds that are low molecular weight (i.e., simple sugars). However, until the tenth group of embodiments, very little attention has been paid to studying how to make and extract more of the strength compounds.

It is believed that the compounds that contribute to the additional strength and cup darkness of coffee beverages prepared from roast and ground or flaked coffee products according to the tenth group of embodiments is due to very high molecular weight molecules such as polysaccharides. These compounds may not be at very high levels, but are very functional because of their size, geometry and full chemical structure. The low level of these very functional molecules can be almost insignificant when compared to the total brew solids.

Although the level of brew solids is an incomplete measurement of brew strength, it is still a good indicator of overall extraction efficiency. Accordingly, coffee products according to the tenth group of embodiments maintain a high extraction efficiency, as measured by brew solids. For coffee beverages prepared from roast and ground or flaked coffee products according to the tenth group of embodiments, the level of brew solids is in the range of from about 0.4 to about 0.6%. Preferably, coffee beverages prepared from coffee products according to the tenth group of embodiments have a level of brew solids in the range of from about 0.42 to about 0.58%.

### 4. Relationship of Brew Absorbance to Roast Color of Coffee

Another important characteristic of roast and ground or flaked coffee products according to the tenth group of embodiments is the relationship of brew absorbance to roast color. There is a natural tendency as the coffee is roasted darker for it to produce more of the strength and color compounds. Coffee products according to the tenth group of embodiments provide coffee beverages having an increased brew absorbance at a given degree of roast color. This can be quantified by the relationship of the brew absorbance of the coffee beverage produced from the coffee product relative the roast color of the coffee product. Coffee products according to the tenth group of embodiments preferably have a brew absorbance equal to or greater than the value defined by the equation:

2.475−[0.075×(Hunter L-color of coffee)]

### G. Analytical Methods in the Tenth Group of Embodiments

### 1. Whole Roast Tamped Bulk Density Determination

This method determines the degree of puffing that occurs in the roasting of green coffee and is applicable to both decaffeinated and non-decaffeinated whole roasts.

a. Apparatus

Weighing container: 1,000 ml stainless steel beaker or equivalent

Measuring container: 1,000 ml plastic graduated cylinder; 5 ml graduations

Scale: 0.1 gm sensitivity

Vibrator: Syntron Vibrating Jogger; Model J-1 or equivalent. Syntron Company—Homer City, Pa.

Funnel: Plastic funnel with tip cut off to about 1″ outlet

Automatic Timer: Electric, Dimco-Gray; Model No. 171 or equivalent

b. Operation

Weigh 200 g of whole bean coffee to be tested into beaker. Place the graduated cylinder on the vibrator. Using the funnel, pour the coffee sample into the cylinder. Level the coffee by gently tapping the side of the cylinder. Vibrate 30 seconds at No. 8 setting. Read volume to nearest 5 ml. Tamped density can be determined by dividing the weight of the coffee by the volume occupied (after vibrating) in the graduated cylinder.

For standardizing the measurements between different coffees, all density measurements herein are on a 4.5% adjusted moisture basis. For example, 200 grams of whole bean coffee having a 2% moisture content would contain 196 g of dry coffee and 4 g of water. If the volume was 600 cc, the unadjusted density would be 200 g/600 cc=0.33 g/cc. On a 4.5% adjusted moisture basis, the calculation is: 4.5%×200 gms=9 gms water. To make the density calculation on an adjusted moisture basis, take 196 g dry coffee+9 g water=205 g total. Adjusted density=205 g/600 cc=0.34 g/cc.

### 2. Roasted Coffee Color

The Hunter Color “L” scale system is generally used to define the color of the coffee beans and the degree to which they have been roasted. A complete technical description of the system can be found in an article by R. S. Hunter “Photoelectric Color Difference Meter,” J. of the Optical Soc. of Amer., 48, 985-95 (1958). In general, it is noted that Hunter Color “L” scale values are units of light reflectance measurement, and the higher the value is, the lighter the color is since a lighter colored material reflects more light. In particular, in the Hunter Color system the “L” scale contains 100 equal units of division; absolute black is at the bottom of the scale (L=0) and absolute white is at the top (L=100). Thus, in measuring degrees of roast, the lower the “L” scale value the greater the degree of roast, since the greater the degree of roast, the darker is the color of the roasted bean.

### 3. Brewing

Coffee is brewed on a Bunn OL-35 automated drip brewer. Coffee filters are 12 cup oxygen processed Bunn Coffee filters (Reg. 6001). One ounce of coffee is added to the filter in the basket. The brewer is supplied with distilled water and feeds 1860 ml at 195° F. (90° C.) in 146 seconds to the brew basket. Brewed coffee is collected in a carafe and then mixed. Samples for brew solids, brew absorbance, and Titratable Acidity are then collected.

### 4. Brew Absorbance

The brewed coffee is placed in a 12 ml sealed vial and then cooled for 10 minutes in a water bath at 29° C. The sample is then transferred to a cuvette and the absorbance is measured in a Milton Roy Spectrophotometer 401 at 480 nm wavelength.

### 5. Brew Solids

The brewed coffee is placed in a 12 ml sealed vial and allowed to cool. The sample is then analyzed for solids content by index of refraction using a Bellingham & Stanley RFM 81, where the sample temperature during the measurement is maintained at 29° C. The readings are correlated with readings of reference solutions of known brew solids content based on oven drying techniques using a correlation of:

Refractive Index=0.001785×(% brew solids)+1.331995.

### 6. Titratable Acidity

From a mixed carafe, 100 g of a coffee brew is collected, covered with a lid, and allowed to cool. The coffee brew is then titrated to 7 pH using 0.1N sodium hydroxide solution, recording the milliliters required as the Titratable Acidity (ml 0.1N NaOH).

### 7. Green Coffee Acidity

To assess the acidity level in green coffee, the coffee is roasted in a standard way, to a standard condition, ground and flaked, brewed and then the Titratable Acidity measured: A 100 pound charge of coffee is fed to a Thermalo roaster, Model Number 23R, manufactured by Jabez Burns and a gas burner input rate of about 1.4 million BTU/hr. such that the coffee is roasted to color of 17 Hunter L in approximately 210 seconds. The coffee is then quenched to 4.5% moisture and cooled. After grinding and subsequent flaking to a 14 mil thickness, the product is brewed (per method 3 above) and the Titratable Acidity is measured (per method 6 above method).

In preparing the coffee compositions as defined in the Summary of the Invention, the coffee in the coffee composition 110/130 and beverage material 120 as shown in FIGS. 1A, 1B, and 1C may have various cell structures. As previously mentioned, flaked roast and ground coffee is contemplated in the present invention. The eleventh group of embodiments according to the present invention provides a flaked coffee with improved brewing properties. More particularly, the eleventh group of embodiments relates to flaked coffee with increased extractability and decreased brewing time.

The eleventh group of embodiments is related to a roast and ground flaked coffee that provides the benefits of increased extractability and decreased brewing time. The coffee flakes may have a thickness of from about 0.004 inch to about 0.018 inch (about 0.10 mm to about 0.46 mm), a moisture level of from about 3% by weight to about 6% by weight, and a particle size fines level such that from about 30% to about 50% by weight of the particles pass through a No. 20 U.S. Standard Screen. The flake thickness, moisture level, and fines level are related by a brew solids equation.

In connection to the background of the eleventh group of embodiments, numerous prior patents disclose various kinds of flaked roast and ground coffee. For example, U.S. Pat. No. 3,615,667 to Joffe, issued Oct. 26, 1971, discloses thick-flaked roast and ground coffee characterized by improved flavor and aroma. The flake thickness is 0.008-0.025 inch (0.20-0.63 mm), preferably 0.010-0.016 inch (0.25-0.41 mm), and the flake moisture level is 2.5-7.0% by weight, preferably 3.0-6.0%. The flakes have a particle size such that 3-10% pass through a No. 40 U.S. Standard Screen and not more than 35% remain on a No. 12 screen.

U.S. Pat. No. 4,331,696 to Bruce, issued May 25, 1982, discloses extra-thin flaked roast and ground coffee with structural integrity. The flake thickness ranges from 0.004 to 0.008 inch (0.10-0.20 mm). The flaked coffee has no more than 90% by weight particles passing through a No. 30 U.S. Standard Screen, and preferably 40-70% particles passing through a No. 30 screen. The moisture content of the flakes is between 2.5% and 9.0% by weight, preferably between 3.5% and 7.0%.

U.S. Pat. No. 4,267,200 to Klien et al., issued May 12, 1981, discloses coffee flake particles that are aggregates of low moisture flakes (1% to 3.5% moisture by weight) and high moisture flakes (4.5% to 7% moisture by weight). The flake thickness is between 0.009 and 0.016 inch (0.23-0.41 mm). Preferred flaked coffee compositions have a particle size such that 0-12% remains on a No. 12 U.S. Standard Screen, 2-28% passes through a No. 12 but remains on a No. 16 screen, 10-30% passes through a No. 16 but remains on a No. 20 screen, 10-25% passes through a No. 20 but remains on a No. 30 screen, and 30-60% passes through a No. 30 screen.

U.S. Pat. No. 3,625,704 to Andre et al., issued Dec. 7, 1971, discloses instant coffee flakes with improved aroma and flowability having a thickness preferably between 0.002 and 0.010 inch (0.05-0.25 mm), and a moisture content before flaking of between 0.5% and 7.0%. The flakes have a size ranging between 0.02 and 0.10 inch (0.5-2.5 mm).

U.S. Pat. No. 3,660,106 to McSwiggin et al., issued May 2, 1972, discloses roast and ground coffee flakes having a thickness of 0.008-0.025 inch (0.20-0.63 mm) and a moisture content before flaking of 2.5-7.0% by weight. The particle size of the coffee after flaking is not disclosed. The flakes are said to be produced in high yield, and to have good structural integrity and little or no flavor degradation.

U.S. Pat. No. 4,110,485 to Grubbs et al., issued Aug. 29, 1978, discloses high sheen roast and ground coffee flakes having a flake thickness of 0.008-0.025 inch (0.20-0.63 mm). Particle size of the flakes is not disclosed. The moisture level before flaking is about 5-6%.

U.S. Pat. No. 3,769,031 to McSwiggin, issued Oct. 30, 1973, discloses roast and ground coffee flakes having a thickness between 0.012 inch and 0.027 inch (0.3-0.7 mm), and a moisture content before flaking between 2.5% and 7.0%. Particle size of the flakes is not disclosed.

U.S. Pat. No. 2,281,320 to Odell, issued Apr. 28, 1942, discloses roast and ground coffee flakes having a thickness between 0.001 and 0.020 inch (0.025-0.51 mm), preferably between 0.007 and 0.010 inch (0.18-0.25 mm), and a moisture content between 25% and 45% before flaking. The patent does not discuss particle size after flaking U.S. Pat. No. 3,640,727 to Heusinkveld, issued Feb. 8, 1972, discloses flaked coffee having a flake thickness preferably between 0.005 and 0.025 inch (0.13-0.64 mm), and a moisture content before flaking between 2% and 8%. Particle size after flaking is not discussed.

Although some of the patents state that their flakes have improved extractability, the patents do not suggest how to make a flaked coffee that provides maximum extractability when it is brewed in the ½-gallon coffee brewers and urn brewers typically used in the foodservice industry. Moreover, the prior patents do not describe how to control the interaction between flake thickness, moisture level, and fine particle size level to achieve this increased extractability.

One aspect of the eleventh group of embodiments provides for a coffee composition for use in a beverage unit and method thereof as defined in the Summary of the Invention, wherein the coffee composition comprises non-decaffeinated roast and ground coffee flakes, wherein the flakes have:

(a) an average thickness of from about 0.004 inch to about 0.022 inch;

(b) an average moisture level of from about 3% to about 6% by weight; and

(c) a particle size fines level such that from about 30% to about 50% by weight of the particles pass through a No. 20 U.S. Standard Screen, and from about 20% to about 50% by weight of the particles pass through a No. 40 U.S. Standard Screen; and

(d) wherein the average flake thickness (“FT”), average moisture level (“MO”), and particle size fines level (“FF”) are adjusted according to the following equation:

0.36 to 0.96=0.686+(0.0244×FT)−(0.0150×FF)+(0.00217×MO×FF).

For example, the average flake thickness, average moisture level, and particle size fines level may be adjusted according to the following equation:

0.79 to 0.89=0.686+(0.0244×FT)−(0.0150×FF)+(0.00217×MO×FF).

Another aspect of the eleventh group of embodiments provides for a coffee composition for use in a beverage unit and method thereof as defined in the Summary of the Invention, wherein the coffee composition comprises decaffeinated roast and ground coffee flakes particularly suited for use in an urn brewer, wherein the flakes have:

(a) an average thickness of from about 0.004 inch to about 0.022 inch;

(b) an average moisture level of from about 3% to about 6% by weight; and

(c) a particle size fines level such that from about 30% to about 50% by weight of the particles pass through a No. 20 U.S. Standard Screen, and from about 20% to about 50% by weight of the particles pass through a No. 40 U.S. Standard Screen; and

(d) wherein the average flake thickness (“FT”), average moisture level (“MO”), and particle size fines level (“FF”) are adjusted according to the following equation:

0.30 to 0.90=0.686+(0.0244×FT)−(0.0150×FF)+(0.00217×MO×FF).

For example, the average flake thickness, average moisture level, and particle size fines level may be adjusted according to the following equation:

0.73 to 0.83=0.686+(0.0244×FT)−(0.0150×FF)+(0.00217×MO×FF).

In more specific examples under the above two aspects, the flakes may have an average thickness of from about 0.014 inch to about 0.022 inch.

In more specific examples under the above two aspects, the flakes may have an average moisture level of from about 4.5% to about 5.5% by weight.

In more specific examples under the above two aspects, the flakes may have a particle size fines level such that from about 35% to about 45% by weight of the particles pass through a No. 20 U.S. Standard Screen.

In more specific examples under the above two aspects, the flakes may have been fast roasted for a time between about 1 minute and about 1.5 minutes at a temperature between about 590° F. and about 605° F.

Still another aspect of the eleventh group of embodiments provides for a coffee composition for use in a beverage unit and method thereof as defined in the Summary of the Invention, wherein the coffee composition comprises non-decaffeinated roast and ground coffee flakes particularly suited for use in a ½-gallon brewer, wherein the flakes have:

(a) an average thickness of from about 0.004 inch to about 0.018 inch;

(b) an average moisture level of from about 3% to about 6% by weight; and

(c) a particle size fines level such that form about 30% to about 50% by weight of the particles pass through a No. 20 U.S. Standard Screen, and from about 20% to about 50% by weight of the particles pass through a No. 40 U.S. Standard Screen; and

(d) wherein the average flake thickness (“FT”), average moisture level (“MO”), and particle size fines level (“FF”) are adjusted according to the following equation:

0.57 to 0.90=1.254−(0.0361×MO)−(0.0221×FT)−(0.00504×FF)+(0.00068×MO×FF).

For example, the average flake thickness, average moisture level, and particle size fines level may be adjusted according to the following equation:

0.79 to 0.89=0.686+(0.0244×FT)−(0.0150×FF)+(0.00217×MO×FF).

Still another aspect of the eleventh group of embodiments provides for a coffee composition for use in a beverage unit and method thereof as defined in the Summary of the Invention, wherein the coffee composition comprises decaffeinated roast and ground coffee flakes particularly suited for use in a ½-gallon brewer, wherein the flakes have:

(a) an average thickness of from about 0.004 inch to about 0.018 inch;

(b) an average moisture level of from about 3% to about 6% by weight; and

(c) a particle size fines level such that from about 30% to about 50% by weight of the particles pass through a No. 20 U.S. Standard Screen, and from about 20% to about 50% by weight of the particles pass through a No. 40 U.S. Standard Screen; and

(d) wherein the average flake thickness (“FT”), average moisture level (“MO”), and particle size fines level (“FF”) are adjusted according to the following equation:

0.51 to 0.84=1.254−(0.0361×MO)−(0.0221×FT)−(0.00504×FF)+(0.00068×MO×FF).

For example, the average flake thickness, average moisture level, and particle size fines level may be adjusted according to the following equation:

0.73 to 0.83=0.686+(0.0244×FT)−(0.0150×FF)+(0.00217×MO×FF).

In more specific examples under the above two aspects, the flakes may have an average moisture level of from about 0.004 inch to about 0.014 inch.

In more specific examples under the above two aspects, the flakes may have an average moisture level of from about 4.5% to about 5.5% by weight.

In more specific examples under the above two aspects, the flakes may have a particle size fines level such that from about 35% to about 45% by weight of the particles pass through a No. 20 U.S. Standard Screen.

In more specific examples under the above two aspects, the flakes may have been fast roasted for a time between about 1 minute and about 1.5 minutes at a temperature between about 590° F. and about 605° F.

The eleventh group of embodiments as described above will be further described in the following paragraphs and exemplified in Examples 45-46.

It was discovered that there were drawbacks associated with the flaked coffee previously sold to customers in the foodservice industry. A weak-tasting brewed coffee was produced because the coffee flakes did not provide optimum extractability in foodservice industry brewing machines. The brewing time was longer than desired. There were occasional incidences of cup sediment resulting from filter overflow.

In view of these problems with the previous coffee, work was conducted in which flaked coffee samples were made having varying moisture levels, flake thicknesses, and particle size fines levels (defined here as percent particles through a No. 20 U.S. Standard Screen). The samples were brewed in two brewing machines commonly used in the foodservice industry: a Bunn OL-20 ½-gallon brewer and a Cecilware FE-100 urn brewer. Data on brew solids, brew time, and extraction efficiency were collected.

It is believed that different moisture levels, flake thicknesses, and particle sizes, and different relationships between these parameters, are needed to provide optimum extractability of flaked coffee brewed in different kinds of brewing machines (i.e., foodservice industry brewers versus other brewers, and ½-gallon brewers versus urn brewers).

Specifically, for a ½-gallon brewer used in the foodservice industry it is believed that flake thickness, the interaction between moisture level and fines level, and the interaction between flake thickness and fines level are important to maximizing brew solids yield. Optimum brewing performance occurs as moisture level increased, flake thickness decreases, and particle size fines level decrease.

For a foodservice industry urn brewer it is believed that moisture level, flake thickness, finished product fines level, and the interaction effect between moisture level and fines level are important to maximizing brew solids yield. Optimum brewing performance occurs as moisture level increases, flake thickness increases, and particle size fines level decrease. These interactions are described by different equations which have been calculated for the ½-gallon brewer and the urn brewer, and which are disclosed below in Section 4.

Roast and ground coffee flakes made according to the eleventh group of embodiments by carefully controlling the moisture level, flake thickness, product fines level, and interactions between these parameters, have increased extractability so that a desirably stronger coffee beverage can be made. The coffee flakes brew more rapidly, so a shorter brewing time is required. When the coffee flakes are used in the form of loose ground coffee in paper filters, there are fewer incidences of cup sediment resulting from filter overflow.

Flake thickness, moisture level, particle size distribution, and the relationship between these characteristics for the present coffee flakes are discussed herein below:

### 1. Flake Thickness

The roast and ground coffee flakes of the eleventh group of embodiments particularly suited for use in an urn brewer have an average flake thickness between about 0.004 inch (0.10 mm) and about 0.022 inch (0.56 mm), preferably between about 0.014 inch (0.36 mm) and about 0.022 inch (0.56 mm). The method for measuring average flake thickness is described hereinbelow in Section 6.

Coffee flakes particularly suited for use in a ½-gallon brewer have an average thickness between about 0.004 inch (0.10 mm) and about 0.018 inch (0.46 mm), preferably between about 0.004 inch (0.10 mm) and about 0.014 inch (0.36 mm).

### 2. Moisture Level

The coffee flakes of the eleventh group of embodiments have an average moisture level of about 3% to about 6% by weight of the coffee flakes. Preferred coffee flakes have an average moisture level of about 4.5% to about 5.5% by weight.

Typically, moisture level of the flaked coffee is adjusted by varying the moisture level of the roast and ground coffee feed from which the flakes are produced. The adjustments to the feed moisture level can be controlled, for example, by controlling the amount of water used to quench and thereby halt the roasting operation. If a cool air quench is used, the moisture level can be adjusted by spraying on additional water after quenching or after grinding. The moisture level of the roasted beans is not appreciably affected by the grinding or milling operations.

### 3. Particle Size Distribution

The coffee flakes of the eleventh group of embodiments have a particle size which is adjusted so that the level of fine particles is within a specified range, where “fine particles” is defined herein as the percentage of particles that pass through a No. 20 U.S. Standard Screen. The coffee flakes have a particle size fines level such that from about 30% to about 50% by weight of the particles pass through a No. 20 U.S. Standard Screen. Preferably from about 35% to about 45% by weight of the particles pass through a No. 20 U.S. Standard Screen.

It is conventional in the coffee art to describe coffee particle size distribution, including flaked coffee, in terms of screen or “sieve” fractions, i.e. that weight percentage which remains on a particular screen or that weight percentage which passes through a particular screen. For example, a flaked coffee product might have a screen analysis such that 40% by weight passes through a U.S. Standard No. 20 Screen with 60% by weight remaining on the No. 20 screen. Since the screen opening for a No. 20 U.S. Standard Screen is approximately 0.033 inch (0.84 mm), such a coffee product would comprise about 40% by weight of particles which have a particle width less than 0.033 inch, while the remaining weight fraction would comprise particles which have a particle size greater than the 0.033 inch size opening.

The present coffee flakes have a particle size that is larger than the extra-thin flakes described in U.S. Pat. No. 4,331,696 to Bruce, and smaller than the thick flakes described in U.S. Pat. No. 3,615,667 to Joffe. Whereas the flakes disclosed by Joffe have a particle size such that 3-10% pass through a No. 40 U.S. Standard Screen, the flakes of the eleventh group of embodiments have a size such that between about 20% and about 50% pass through a No. 40 screen. The most preferred flakes disclosed by Bruce have a particle size such that about 50% passes through a No. 30 U.S. Standard Screen, while the flakes of the eleventh group of embodiments have a size such that between about 20% and about 60% pass through a No. 30 screen. Further, the Bruce flakes will have too many particles that pass through a No. 20 screen.

### 4. Brew Solids Equations

The following equations describe the interactions between flake thickness, moisture level and particle size fines level necessary to produce maximum brew solids when brewing in an urn brewer or a ½-gallon brewer:

### a) Urn Brewer

For caffeinated (regular) coffee flakes particularly suited for use in an urn brewer, the desired brew solids yield is between about 0.36% and about 0.96%, preferably between about 0.79% and about 0.89%. This brew solids yield is on the basis of brewing 283.5 grams of the flaked coffee in an urn brewer with 3 gallons of water. Key variables are adjusted according to the following equation to provide a target yield of from about 0.36% to about 0.96% brew solids during brewing:

0.36 to 0.96=0.686+(0.0244×FT)−(0.0150×FF)+(0.00217×MO×FF).

“FT” represents the average flake thickness in mils (thousandths of an inch). (If “FT” is given in millimeters, the FT part of the equation changes to “(0.959×FT)”.) “FF” represents the particle size fines level, which is defined as the percentage of flakes which pass through a No. 20 U.S. Standard Screen. “MO” represents the average moisture level in weight percent.

The actual measured brew solids yield may be slightly different from the brew solids yield calculated from the equation. However, the important thing is that the moisture level, flake thickness and fines level be chosen to fit into the equation to provide the target brew solids range; if they are so chosen, that will provide the optimum actual brew solids. As discussed above, preferably the actual measured brew solids is within the target calculated range.

As an illustration, if a flaked coffee product has a flake thickness of 0.008 inch (8 mils), a fines level of 54%, and a moisture level of 5.9%, the percent calculated brew solids is 0.76% as follows:

0.686+(0.0244×8)−(0.0150×54)+(0.00217×5.9×54)=0.76

Since about 0.06% soluble solids in a regular non-decaffeinated coffee brew consist of caffeine, coffee which has been decaffeinated will contain fewer brew solids. For decaffeninated coffee the desired brew solids range is 0.30% to 0.90%, preferably 0.73% to 0.83%.

b) ½-Gallon Brewer

For non-decaffeinated (regular) coffee flakes particularly suited for use in a ½-gallon brewer, the desired brew solids yield is between about 0.57% and about 0.90%, preferably between about 0.79% and about 0.89%, when 48.2 grams of the flaked coffee is brewed with ½ gallon of water. The following equation is used for these flakes:

0.57 to 0.90=1.254−(0.0361×MO)−(0.0221×FT)−(0.00504×FF)+(0.00068×MO×FF).

(If “FT” is given in millimeters instead of mils, the FT part of the equation changes to “(0.871×FT)”.)

For decaffeinated coffee the desired brew solids range is 0.51% to 0.84%, preferably 0.73% to 0.83%.

### c) Definitions

The greater extractability provided by the flaked coffee of the eleventh group of embodiments enables more cups of equal brew strength and flavor to be brewed from a given amount of coffee. The normal method of measuring the strength of a coffee brew is to measure the percent soluble solids, which is commonly referred to as “brew solids”. The method for measuring brew solids is described in Section 6 hereinbelow.

The percent brew solids measurement is dependent on the weight of coffee and the volume of water used in the brewing process. For example, at column 12, lines 29-62 of U.S. Pat. No. 4,331,696 to Bruce, 57.0 grams of coffee are brewed in a Bunn OL20 12-cup (½-gallon) brewing machine, and the percent brew solids is 0.88%. On the other hand, the percent brew solids range in the eleventh group of embodiments is on the basis of brewing 48.2 grams of coffee with ½ gallon of water. The Bruce example would have about 0.74% brew solids on the basis of using 48.2 grams of coffee (0.88%×48.2/57.0), whereas in the eleventh group of embodiments up to about 0.90% brew solids can be obtained using a ½-gallon brewer.

“Urn brewers” and “½-gallon brewers” are the two types of brewers commonly used in the foodservice industry, and these terms are known to those skilled in the art. Examples of urn brewers are a Cecilware FE-100 urn brewer, a Bunn urn brewer, and a Blickman urn brewer. Examples of ½-gallon brewers are a Bunn OL-20 ½-gallon brewer, a Cecilware ½-gallon brewer, and a Curtis ½-gallon brewer.

Urn brewers are described in Sivetz et al., Coffee Technology, Avi Publishing Co. (1979), at pages 635, 636, 673-675 and 676-680. Essentially, urn brewers are large heated pots that hold a large volume of coffee (e.g., between 3 and 12 gallons or more). The coffee is generally prepared by pumping or spraying near boiling water through ground or flaked coffee held in a filter at the top of the urn. Half gallon brewers can have various designs and operating modes (most common is a drip coffee maker), but what they all have in common is that they hold ½ gallon of coffee. Sivetz et al., supra, at pages 673-675, discusses coffee brewing in the foodservice industry. Urns and ½-gallon brewers are discussed at the bottom of page 674. In Table 17.1 at page 675, it is disclosed that ½-gallon brewers comprise about 70% of the brewing equipment used in restaurants, while urns comprise about 23%.

### 5. Preparation of the Flaked Coffee

### a) Starting Material Selection

The roast and ground flaked coffee of the eleventh group of embodiments can be made from a variety of roast and ground coffee blends, including those which may be classified for convenience and simplification as low-grade, intermediate-grade, and high-grade coffees. Suitable examples of low-grade coffees include the natural Robustas such as the Ivory Coast Robustas and Angola Robustas, and the Natural Arabicas such as the natural Penis and natural Ecuadors. Suitable intermediate-grade coffees include the natural Arabicas from Brazil such as Santos, Paranas and Minas, and natural Arabicas such as Ethiopians. Examples of high-grade coffees include the washed Arabicas such as Mexicans, Costa Ricans, Colombians, Kenyas and New Guineas. Other examples and blends thereof are known in the art. Decaffeinated roast and ground coffee also can be used herein to make a decaffeinated flaked coffee product.

### b) Roasting

Green coffee beans are roasted to a Hunter “L” color of from about 18 to about 23. It is preferable that the beans are subjected to a “fast roasting” process whereby they are roasted for approximately 1 to approximately 5 minutes, more preferably for about 1 to about 1.5 minutes, at temperatures between about 590° F. (310° C.) and about 605° F. (318° C.). If beans are roasted for less than 1 minute, the roast is not uniform and insufficient flavor development occurs. Fast roasting is preferred because higher aroma levels and extractable solids are generated.

After the coffee beans have been roasted they are cooled to a temperature below about 65° F. (18° C.) by conventional water quenching, followed by additional cooling using refrigerated air to achieve the desired temperature. Instead of water quenching, other cooling methods such as liquid nitrogen, carbon dioxide, cool air, etc., can also be used.

### c) Grinding

The flaked coffee of the eleventh group of embodiments can be ground to “coarse”, “regular”, “drip” or “fine” sizes known to the art. Preferably the coffee is ground to a “coarse” grind. As used herein, “coarse” grind size indicates that the roast and ground coffee has a particle size distribution such that:

(a) from 40% to 95% by weight retained on a No. 12 U.S. Standard Screen,

(b) from 0% to 37% by weight retained on a No. 16 U.S. Standard Screen,

(c) from 0% to 12% by weight retained on a No. 20 U.S. Standard Screen,

(d) from 0% to 10% by weight retained on a No. 30 U.S. Standard Screen,

(e) from 0% to 8% by weight pass through a No. 30 U.S. Standard Screen.

Typical grinding equipment and methods for grinding roasted coffee beans are described, for example, in Sivetz & Foote, “Coffee Processing Technology” 1963, Vol. 1, pp. 239-250.

### d) Roll Milling

The roll milling operation to make the flaked coffee of the eleventh group of embodiments is similar to that described at column 7, line 8, to column 9, line 56, of the U.S. Pat. No. 4,331,696 to Bruce, issued May 25, 1982, which disclosure is herein incorporated by reference. However, the present coffee flakes are not as thin as the extra-thin flaked coffee described by Bruce, and the present flakes are larger in particle size than the Bruce flakes. Accordingly, compared to the Bruce patent, the roll milling conditions will be adjusted somewhat to produce slightly larger and thicker flakes. The means of producing these flakes is not critical as long as the resultant flakes have the required product characteristics. Larger, thicker flakes can be made by adjusting any of several processing parameters, such as decreasing the roll pressure, increasing the static gap between the rolls, or decreasing the roll peripheral surface speed at the same feed rate. These interactions are described generally at column 10, line 39 to column 13, line 37 of U.S. Pat. No. 4,267,200 to Klien et al., which disclosure is incorporated by reference herein, and specifically at column 12, lines 52-64 and column 13, lines 26-37.

To produce the present coffee flakes, the roll pressure should be within the range of from about 37.5 lbs./linear inch of nip to about 300 lbs./linear inch of nip, preferably from about 56 lbs./linear inch to about 94 lbs./linear inch. The roll surface temperature should be between 50° F. and 80° F., preferably between 60° F. and 80° F. The diameter of the roll mills should be between about 6 inches and about 48 inches, preferably between about 6 inches and about 30 inches. Preferably a zero static gap is used, but suitable gap settings range from 0 up to about 0.001 inch. The moisture content of the roast and ground coffee feed is between about 3% and about 6%. The feed rate is between about 50 lbs./hr./inch and about 160 lbs./hr./inch; preferably starve feeding is used. The roll peripheral surface speed of the roll mill is from about 328 ft./minute to about 1,414 ft./minute, preferably from about 707 ft./minute to about 1,178 ft./minute.

After the roast and ground coffee feed has been flaked by being passed through the roll mill, it is preferred but not essential that the flaked coffee be screened to remove any oversized flakes caused by the presence of impurities in the roast and ground coffee feed. It is also possible to remove excessive fine particles caused by a secondary grinder effect. If screening is conducted, it is preferred to use a Sweco screening device equipped with a 12 mesh U.S. Standard Screen, and to screen the coffee between about 120 seconds and 240 seconds.

### 6. Measurement Techniques

### a) Flake Thickness

100 grams of the flaked coffee is poured onto a circular U.S. Standard No. 12 Screen and is agitated by a “Ro-Tap” sieve (screen) shaker (manufactured by U.S. Tyler Co.) for three minutes. The flaked coffee which passes through the No. 12 screen is thereafter similarly screened for three minutes using a U.S. Standard Screen No. 16. Ten representative flakes from the portion remaining on the No. 16 screen are selected for flake thickness measurement. Each representative flake particle is measured for thickness using a Federal Model 22P-10 gauge manufactured by Federal Co. The ten flake thickness measurements are averaged to characterize the average flake thickness.

### b) Moisture Level

The average moisture level of the flakes is measured using a standard moisture meter, specifically a Computrac Moisture Analyzer, Model MA-5A, manufactured by Quintel Corporation.

### c) Particle Size Distribution

The particle size distribution of the coffee flakes is measured by the use of a “Ro-Tap” multiple sieve shaker manufactured by U.S. Tyler Co. The following circular U.S. Standard Screens are mounted on the sieve shaker: No. 12, No. 16, No. 20, No. 30, and optionally No. 40 (and a pan to collect the particles passing through all the screens). 100 grams of the coffee flakes are poured onto the No. 12 screen, and the sieve shaker is agitated for 3 minutes. Then the weight percentage of particles on each screen and in the pan are measured.

### d) Brew Solids

The percent “brew solids” or soluble solids in the coffee brew can be measured by oven-drying the brewed coffee and weighing the remaining solids. The percent brew solids can also be ascertained optically by measuring the index of refraction of the coffee brew. The index of refraction is correlated to brew solids as measured by the oven-drying technique.

In preparing the coffee compositions as defined in the Summary of the Invention, the coffee in the coffee composition 110/130 and beverage material 120 as shown in FIGS. 1A, 1B, and 1C may have various cell structures. As previously mentioned, flaked roast and ground coffee is contemplated in the present invention. The twelfth group of embodiments according to the present invention provides aggregated mixed-moisture flaked coffee of high aroma. The twelfth group of embodiments relates to roast and ground coffee products comprising aggregated coffee flake particles which comprise a plurality of compressed coffee flakes bonded together. The aggregated flake coffee products provide improved extractability of the water-soluble flavor constituents, superior initial aroma levels and acceptable bed permeabilities. The twelfth group of embodiments also relates to a novel process for preparing the aggregated flake coffee particles by the roll milling of a cold processed coffee feed blend of ground coffees having differing moisture contents under particular roll mill operating conditions.

More particularly, the twelfth group of embodiments is related to aggregated coffee flake particles that comprise a plurality of compressed coffee flakes bonded together wherein at least one of which is a low-moisture flake (1% to 3.5% by weight) and at least one of which is a high-moisture flake (4.5% to 7% by weight) are disclosed. The composite flake particles range in thickness from 9 to 16 mils. The flaked coffees provide improved extractability of the water-soluble flavor constituents, exhibit high initial aroma levels, and exhibit high bed permeability. Also disclosed is a process for preparing aggregated mixed-moisture flaked coffee. The process comprises: (1) separately cold-grinding dual streams of roast coffee, relatively high-moisture and low-moisture, respectively; (2) combining of the two ground coffee streams to provide a roll mill feed having a specified particle size distribution and average moisture content, and (3) passing the coffee feed through a roll mill under specific conditions, and (4) screening the roll-milled, aggregated flaked coffee to produce a product such that no more than 60% by weight passes through a 30-mesh U.S. Standard screen.

In connection to the background of the twelfth group of embodiments, roast and ground coffee which has been transformed into flaked coffee by roll milling the roast and ground coffee is known in the art (see, for example, U.S. Pat. No. 1,903,362, issued Apr. 4, 1933 to R. B. McKinnis, and U.S. Pat. No. 2,368,113, issued Jan. 30, 1945 to C. W. Carter). An improved flaked roast and ground coffee of enhanced extractability is disclosed by Joffe in U.S. Pat. No. 3,615,667, issued Oct. 26, 1971, as well as a method for its production in U.S. Pat. No. 3,660,106, issued May 2, 1972 to J. R. McSwiggin et al.

Art attempts are realizing superior roast coffee products have included improving other coffee attributes in addition to improving the extractability of those flavorful water-soluble coffee constituents often referred to as coffee brew solids. A visually appealing, high-sheen flaked roast and ground coffee of improved extractability of its brew solids is disclosed in U.S. Pat. No. 4,110,485, issued Aug. 29, 1978 to D. R. Grubbs. A flaked coffee product with large visually distinctive flakes can be prepared by flaking a mixture of two roast and ground coffee blends of equal weight fractions. The two coffee blends differ only in their moisture content; one being a high moisture (5.0% by weight) coffee, and one being a low moisture coffee (3% by weight).

While flaking can provide roast coffee in a form which provides certain benefits such as increased extractability and can be used to provide visually distinctive coffee products, coffee flaking can detrimentally affect certain attributes of roast and ground coffee. Flaking is known, for example, to reduce the initial aroma level of packaged coffee as well as to affect the quality of the aroma. To minimize the aroma penalty exacted by flaking, mixtures of conventional roast and ground coffee and of flaked coffee have been formulated (see, for example, U.S. Pat. No. 3,615,667 issued Oct. 26, 1971 to F. M. Joffe). However, such mixtures merely trade off increased initial aroma for increased extractability when conventional roast and ground coffee which has a higher aroma level is substituted for flaked coffee which has higher extractability.

The initial aroma level of flaked coffee could be increased by the simple addition of a highly aromatized carrier oil such as is disclosed in U.S. Pat. No. 3,769,032, issued Oct. 30, 1973 to Lubsen et al. Such an addition, however, would undesirably increase the oil level of the coffee itself as well as any coffee brew made therefrom. Moreover, the aroma material from relatively large quantities of donor coffee must be collected in order to aromatize small quantities of flaked coffee.

A variety of non-donative or unadulterating aromatization methods are known in the art for increasing the aroma of roast and ground coffee. Typically, these methods involve reducing the working temperature of coffee at various stages of processing such as grinding. The cooler working temperatures reduce losses of the volatile aroma materials during these steps (see, for example, U.S. Pat. No. 1,924,059, issued Aug. 22, 1933 to W. Hoskins). These cold grinding processes for conserving aroma have not been applied to minimizing the aroma losses of flaked coffee, apparently, because, as noted above, flaking is known to reduce the level of coffee aroma. Thus, any increase in the aroma of roast and ground coffee apparently would be lost during flaking. However, it is believed that application of pre-flaking, non-donative aroma conservation methods such as cold processing can provide an increase in the initial aroma level of flaked coffee.

Such a combination of aroma conservation and flaking methods is, however, not made without certain difficulties. An unforeseen disadvantage associated with flaked coffee which has been cold processed is a dramatic decrease in the bed permeability of a coffee product produced. Such decreases in bed permeability lead to unacceptably long drain times needed to prepare coffee brews.

Given the state of the coffee flaking art as described above, there is continuing need for new and useful roast coffee products which provide increased extractability of the flavorful coffee brew solids and which possess high initial aroma levels. Accordingly, it is an object of the twelfth group of embodiments to provide a flaked roast coffee product of increased extractability and enhanced initial aroma.

It is a further object of the twelfth group of embodiments to provide roast coffee products of enhanced extractability and initial aroma which are substantially free of additive aroma carrier oils.

It is a further object of the twelfth group of embodiments to provide flaked roast coffee products of enhanced extractability and initial aroma which have bed permeabilities great enough to provide acceptable coffee bed draining performance.

It is believed that the above objects can be realized and superior flaked roast coffee products provided which exhibit both enhanced extractability and initial aroma levels as well as adequate bed permeability by formulating aggregated, mixed-moisture flaked coffee compositions. Such coffee compositions are realized by mixing a low-moisture roast and ground coffee fraction and a high-moisture coffee fraction, each of which has been cold processed to minimize coffee aroma losses, and thereafter flaking the roast and ground coffee mixed-moisture blend under particular roll mill conditions. The novel, mixed-moisture coffee flake aggregates produced surprisingly possess sufficient structural strength and integrity to provide bed permeability equivalent to non-cold processed flaked coffee.

One aspect of the twelfth group of embodiments provides a coffee composition for use in a beverage unit and method thereof as defined in the Summary of the Invention, wherein the coffee composition comprises an improved flaked roast coffee product characterized by increased extractability of the water-soluble flavor constituents and increased initial aroma intensity and comprising coffee flake aggregates, made from a method comprising the steps of:

(A) comminuting roasted low-moisture coffee beans at a temperature of below 40° F., said low-moisture coffee beans having a moisture content of from about 1% to about 3.5% by weight of said low-moisture coffee beans thereby forming a low-moisture roast and ground coffee;

(B) comminuting roasted high-moisture coffee beans at a temperature of below 40° F., said high-moisture coffee beans having a moisture content of about 4.5% to 7% by weight of said high-moisture coffee, thereby forming a high-moisture roast and ground coffee;

(C) admixing said low-moisture roast and ground coffee and said high-moisture roast and ground coffee at a temperature of below 40° F., the mixture having an average moisture content of about 3% to 5% by weight; (D) passing the coffee mixture of step (C) through a roll mill at a feed rate of about 10 lbs./hr.-inch of nip to 400 lbs./hr.-inch of nip, said roll mill having

(I) a roll pressure of from about 150 lbs./in. of nip to about 4000 lbs./in. of nip,

(II) a roll temperature of from about 40° F. to about 80° F.,

(III) a static gap setting of less than 0.001 inch,

(IV) a roll peripheral speed of from about 470 ft./min. to 1880 ft./min., and

(V) a roll diameter of from about 6 inches to 48 inches, to produce coffee flake aggregates having a flake thickness of about 0.009 inch to 0.016 inch; and thereafter

(E) screening said coffee flake aggregates to produce a flaked roast coffee product such that no more than 60% by weight of said product passes through a U.S. Standard 30 mesh screen.

In more specific examples under this aspect, the particle size distribution of said coffee mixture is such that

(a) from 0% to about 80% by weight of the roll mill coffee feed is retained on a 12 mesh U.S. Standard size screen,

(b) from about 0% to 40% by weight of the roll mill coffee feed (goes through 12 but) is retained on a 16 mesh U.S. Standard screen, and

(c) from about 0% to 45% by weight of the roll mill coffee feed (goes through 16 but) is retained on a 20 mesh U.S. Standard size screen,

(d) from 0% to 55% by weight of the roll mill coffee feed (goes through 20 but) is retained on a 30-mesh U.S. Standard size screen, and

(e) from 0% to 40% by weight of the roll mill coffee feed goes through a 30 mesh U.S. Standard size screen.

For example, the low-moisture coffee beans may have a moisture content of from about 1.5% to 2.5% by weight of said low-moisture coffee and wherein the high-moisture coffee has a moisture content of from about 5.5% to 6.5% by weight of the high-moisture coffee. The coffee mixture of step (C) may have an average moisture content of 3.5% to 4.5%. The comminuting of the roasted low-moisture coffee beans and the comminuting of the roasted high-moisture coffee beans may be each at a temperature of between 20° F. and 35° F. The roll mill may be operated at a zero static gap. In that case, the roll mill may have

I. a roll pressure of from about 1,000 lbs./linear inch of nip to 2,000 lbs./linear inch of nip,

II. a roll temperature of about 60° F. to 70° F., and

III. a roll peripheral speed of from about 1180 ft./min. to 1650 ft./min.

For example, the low-moisture coffee beans and the high-moisture coffee beans may be each separately comminuted along with frozen carbon dioxide in a weight ratio of beans to carbon dioxide of about 6:1, said carbon dioxide having a particle size of less than about 0.25 inch in diameter. For such a process, the low-moisture coffee beans may have a moisture content of 2% by weight of said beans and wherein the high-moisture coffee beans may have a moisture content of 6% by weight.

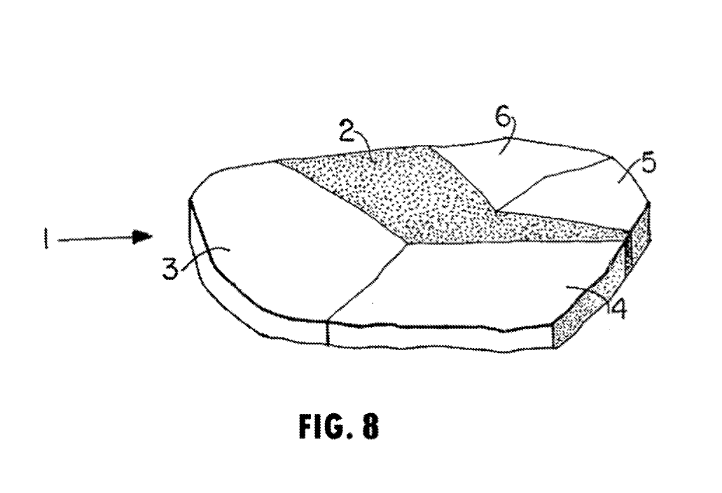

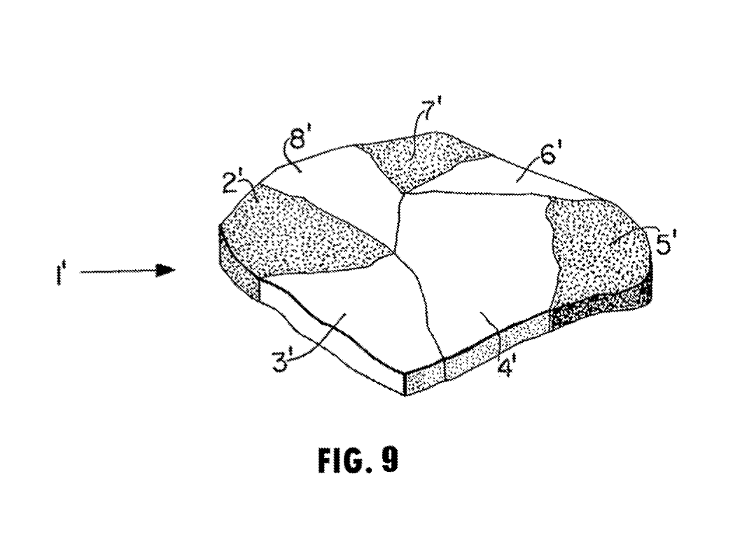

The twelfth group of embodiments as described above will be further described in the following paragraphs, illustrated in FIGS. 8-9, and exemplified in Examples 47-49.

The twelfth group of embodiments relates to unadulterated, highly aromatic flaked coffee compositions which nonetheless exhibit normal drain time performance characteristics and to the process by which such compositions are prepared. The present roast coffee compositions comprise from about 80% to 100% by weight of coffee flake aggregates. The coffee flaked aggregates comprise a plurality of compressed coffee flakes bonded together. At least one of the coffee flakes in each aggregate is a low-moisture flake, having a moisture content of from about 1% to about 3.5% by weight. Additionally, at least one of said coffee flakes in each aggregate is a high-moisture flake, having moisture content of from about 4.5% to 7% by weight of the high-moisture flake. The average moisture content is from about 3% to about 5% by weight of the coffee composition.

The balance of the present roast coffee compositions comprises other conventional coffee materials including conventional flaked coffee, high-sheen flaked coffee, and roast and ground coffee or the like, including grains.

The coffee flake aggregates have an average flake thickness of from about 0.009 to 0.016 in. The bulk density of the present coffee compositions range from about 0.395 g./cc. to 0.485 g./cc. The initial aroma intensity of the present compositions is about 20,000 G.C. total counts or above as measured by the procedure described herein.

The twelfth group of embodiments also provides a process by which the above-described roast coffee compositions can be prepared. In the present process two separate green bean fractions are separately roasted and quenched with sufficient amounts of water such as to provide individual moisture contents of from about 1% to about 3.5% and from 4.5% to 7%, respectively, in conventional manner. Thereafter, each whole roast fraction is cooled to −5° F. to 5° F., and is separately ground so as to provide a low-moisture roast and ground coffee and a high-moisture roast and ground coffee respectively. Each of these fractions is within the temperature range of 20° F. to 40° F. after grinding. The high-moisture and low-moisture coffees are blended while maintaining the temperature of the coffee below 40° F., preferably within the range of 30° F. to 40° F. to form a mixed-moisture roll mill roast and ground coffee feed having an average moisture content of from about 3% to 5% by weight of the coffee feed. The roll mill coffee feed is then fed to a roll mill at a temperature of about 35° F. to 40° F. and at a feed rate of about 10 to 400 lbs./hr./in. The roll mill operates at a roll pressure of about 150 to 4000 lbs./linear in.; a roll temperature of from about 40° F. to 80° F.; a mechanical static gap of less than 0.001 in.; a roll peripheral speed of from about 470 to 1180 ft./min.; and a roll diameter of from about 6 to 48 inches. The aggregated, mixed-moisture flaked coffee falling from between the rolls is thereafter screened to adjust the final particle size distribution.

The twelfth group of embodiments relates to flaked roast coffee compositions comprising particles of aggregated mixed-moisture flakes of roast coffee. The present coffee products exhibit increased extractability of the water-soluble contents, superior levels of aroma, and acceptable bed permeability so as to allow the expeditious provision of a flavorful coffee brew. The processes by which the present flaked coffees are prepared are also disclosed herein.

### Aggregated Mixed-Moisture Flaked Coffee

In the provision of an aggregated mixed-moisture flaked coffee product having enhanced extractability, enhanced aroma, and acceptable bed permeability, it is important to control the structure of the aggregated flaked particles, the flake thickness, flake moisture content, particle size distribution, bulk density, and aroma intensity. Each of these coffee product properties, as well as product preparation and product use, are described in detail as follows:

### A. Structure

The mixed-moisture flaked coffee of the twelfth group of embodiments comprises particles which are coffee flake aggregates. Such flake aggregates comprise a plurality of compressed coffee flakes bonded together. The terms “coffee flakes” or “flaked coffee” as used interchangeably herein refer to compressed roast and ground coffee particles which have length to thickness ratios exceeding about 2:1 and generally less than about 8:1. Such coffee flakes can be produced by roll milling roast and ground coffee.

When certain processing conditions are employed (as described in detail below) in the roll milling step, coffee flake aggregates are prepared. During roll milling, individual roast and ground particles can enter the roll mill in sufficient proximity to one another such that when flattened by the compressive action of the roll milling operation, the edges of compressed coffee can overlap. The compressive force of the roll mill presses together the overlapping flake platelets and forms a particle wherein a plurality of flakes are bonded together. Due to the cohesive nature of the coffee, bonding of the flake platelets occurs simply as a result of the roll milling operation and without the presence of any adulterating binding agents.

Surprisingly, it is believed that certain flake aggregates have sufficient structural strength such as to provide acceptable bed permeability even though made from cold processed roast and ground coffee. To possess such structural strength, it is essential that each flake aggregate comprise at least one high-moisture coffee flake or “flake platelet” bonded to at least one low-moisture flake coffee. By “high-moisture” flake platelet as used herein, it is meant the coffee flake platelet which is prepared from a roast and ground coffee having a moisture content of from about 4.5% to 7% by weight. Similarly, a “low-moisture” flake platelet is prepared from “low moisture” roast and ground coffee having a moisture content of from about 1% to 3.5% by weight. Since each flake aggregate contains at least one high-moisture and one low-moisture flake platelet, the present flake aggregates are referred to herein as “mixed-moisture” flake aggregates.

Referring now to the FIGS. 8 and 9, particularly to FIG. 9, there is shown a perspective view of one embodiment of the present mixed-moisture flaked aggregates. The flake aggregate 1 is comprised of a plurality of flake platelets 2, 3, 4, 5 and 6 of any shape bonded together. Each flake aggregate contains at least one low-moisture flake platelet 2. Each flake aggregate also contains at least one high-moisture flake platelets 3, 4, 5 and 6.

Of course, the present coffee flake aggregates can contain more than one high- or one low-moisture flake platelet. Indeed, the larger coffee flake aggregates (e.g., flakes retained on a U.S. Standard 12 mesh screen) comprise a large number of each of low-moisture and high-moisture coffee flakes. Referring to FIG. 9, there is shown a perspective view of a second embodiment of the mixed-moisture flaked aggregates. The flake 1′ is comprised of a plurality of flake platelets 2′, 3′, 4′, 5′, 6′, 7′ and 8′. Such a flake aggregate contains a plurality of low-moisture flake platelets 2′, 5′, and 7′. Also, each such flake aggregate contains a plurality of high-moisture flake platelets 3′, 4′, 6′, and 8′.

Superior aggregated mixed-moisture coffee flakes are realized when the low-moisture flakes or flake platelets have a moisture content of from about 1.5% to 2.5% and the high moisture of flakes or flake platelets have a moisture content of from about 5.5% to 6.5%. Suitable results are achieved when the low-moisture flakes have a moisture content of 2% by weight and the high-moisture flake content is 6% by weight.

### B. Flake Thickness

The improved flaked coffee products provided herein comprise coffee flake aggregates having a flake thickness ranging from about 9 mils to 16 mils (i.e., 0.009 inch to 0.016 inch). A superior coffee product has an average flake thickness within the range of from 10 to 14 mils. Suitable results are achieved when the flake thickness is about 12 mils. Such coffee flake aggregates provide improved extractability of the flavorful, water-soluble coffee constituents compared to thicker flaked coffee products disclosed by the prior art or commercially sold.

The greater extractability provided by the novel aggregated mixed-moisture flaked coffee product provided herein enables more cups of equal-brew strength and flavor to be brewed from a given amount of coffee. In comparison to an equal weight of conventionally processed coffee, it is believed that the increase in titratable acidity for the aggregated flaked coffee product described herein is proportionately less than the increase in extractability. Therefore, not only could more cups of equal-brew strength be brewed from a given amount of thin-flaked coffee, but the equal-brew strength cups would also have lower acidity, which is often described by a consumer as less bitter.

The normal method of measuring the strength of a coffee brew is to measure the percent soluble solids, commonly referred to as brew solids. This measurement can be made by oven-drying the brewed coffee and weighing the remainder. The percent soluble solids can also be ascertained optically by measuring the index of refraction of the coffee brew. The index of refraction is correlated to brew solids as measured by the oven-drying technique.

Production of thinner flake aggregates requires, generally, more severe compression during the roll milling operation. The more severe compression adversely affects the aroma levels of flaked coffee. Thus, even for the more highly aromatic, cold-processed coffee of the twelfth group of embodiments, thicker flaked coffee (e.g., 15 mils in thickness) will have an initial aroma level higher than thinner flaked coffee (e.g., 10 mils in thickness). However, thinner flaked coffee generally provides greater brew solids per unit weight. Particular balances of extractability and aroma level are thus a matter of choice.

### C. Moisture Content

The aggregated flake coffee products disclosed herein have an average moisture content of from about 3% to 5% by weight of the coffee product. Preferred coffee products have an average moisture content of from about 3.5% to 4.5% by weight. For best results, the average moisture content of the present coffee products should be 4.2%. Of course, the average moisture content of the present coffee compositions is to be distinguished from the moisture content of individual flake platelets of which the present aggregated flake particles are comprised.

Low average moisture contents are to be avoided because, in general, the aggregated flakes are fragile. The fragile agglomerated flakes can break during process handling, packaging and shipping. Too large a percentage of broken flakes in turn changes the bulk density. If the density falls outside the range of from 0.395 g/cc to 0.485 g/cc, the product is unacceptable to the consumer. Moreover, even the present aggregated flake particles will exhibit poor bed permeability/drain time performance if the average moisture content is too low. On the other hand, excessively high moisture contents are to be avoided because the flakes can become tacky and oily in appearance. Additionally, high average moisture contents promote water extrusion during milling which can cause a substantial increase in the staling propensity of the resultant coffee product.

Typically, the average moisture content of the present aggregated flake coffee products is controlled by varying the moisture levels of the high moisture flakes and the low moisture flakes within the above-specified ranges for these flake components as well as the respective weight fractions of the low- and high-moisture flakes.

The component flake or flake platelet moisture contents are adjusted by varying the moisture levels of the whole roast beans and thereby the roast and ground coffee feeds from which the flakes are produced. The adjustments to the feed moisture level can be controlled, for example, by controlling the amount of water used to quench and thereby to halt the exothermic roasting operation, and, thereafter, allowing the coffee beans to come to moisture equilibrium prior to grinding. Neither the grinding nor the flaking operations appreciably affect the moisture content of the coffee.

### D. Particle Size Distribution

As noted above, the aggregated flaked coffee provided herein has a flake thickness within a select, particular thickness range. It is also important to control the dimension which characterizes the particle size of the coffee flakes in order to control bed draining performance.

It is conventional in the coffee art to describe coffee particle size distribution—including flaked coffee—in terms of sieve fractions, i.e., that weight percentage which remains on a particular sieve or that weight percentage which passes through a particular sieve. For example, a hypothetical coffee product might have a sieve analysis such that 40% by weight remains on a U.S. Standard No. 14 sieve with 60% by weight passing through a No. 14 sieve. Since the sieve opening for a No. 14 sieve is approximately 55 mils, such a coffee product would comprise about 40% by weight of particles which have a particle size greater than 55 mils, while the remaining weight fraction would comprise particles which have a particle size less than the 55 mil-size opening.

Many coffee users have their standards based on using “Tyler” standard screen scale testing sieves. The only difference between U.S. Standard sieves and the Tyler screen scale sieves is the identification method. Tyler screen scale sieves are identified by the nominal meshes per liner inch while the U.S. Standard sieves are identified by millimeters or microns or by an arbitrary number which does not necessarily mean mesh count.

Generally, an acceptable aggregated flaked coffee product can be made whose sieve analysis corresponds to those particle size distributions commonly referred to as “regular”, “drip” and “fine” (defined below). Preferred flaked coffee compositions have a particle size distribution such that:

| Sieve (U.S. Standard) | Wt. % |
|---|---|
| Remains on No. 12 | 0-12 |
| Through No. 12 but remains on No. 16 | 2-28 |
| Through No. 16 but remains on No. 20 | 10-30 |
| Through No. 20 but remains on No. 30 | 10-25 |
| Passes through No. 30 | 30-60 |

Maintenance of the particle size distribution of the present aggregated coffee products within the above given ranges provides both improved extractability as well as acceptable bed draining performance.

### E. Bulk Density

The aggregated flaked coffee product of the twelfth group of embodiments should have a bulk density of from about 0.395 g./cc. to 0.485 g./cc. in order to assure its consumer acceptability. Bulk densities within this range are desirable since conventionally prepared roast and ground coffees of “regular”, “drip”, and “fine” grinds have bulk densities within this range. Fortunately, the twelfth group of embodiments provides flakes of high structural integrity. The desirability of flakes of high structural integrity (i.e., physical strength and resistance to attrition or breakage during packaging) is important because large percentages of broken flakes occasioned by transportation can markedly change the bulk density as well as present an unappealing appearance, produce settlement after packaging, and cause cup sediment in the brew.

### F. Initial Aroma Concentration

The present flaked coffee product has an initial aroma concentration as measured by the method described below of at least about 20,000 GC total counts. Better flaked coffee products of the twelfth group of embodiments have at least about 25,000 GC total counts. For best results, the present fixed coffee products should have an initial aroma concentration of at least about 30,000 GC total counts.

As used herein, “aroma” refers to those aromatic volatile materials which are present in the headspace or void space in contained or packaged coffee. Thus, “aroma” as used herein is to be distinguished from the coffee aroma resulting from brewing, and from the coffee aroma detectable above a freshly prepared coffee brew. The term “initial aroma” is intended to refer to the aroma level of the present flaked coffee products at equilibrium in a sealed container prior to opening. It is, of course, realized that any coffee product if allowed to remain exposed to open air will eventually lose its aroma due to the volatile and fugitive nature of coffee aroma materials.

High initial aroma concentrations of coffee aroma, of course, provide the desirable “fresh coffee” aroma impression to the coffee user upon opening the coffee container. Further, the high initial aroma concentrations of the twelfth group of embodiments have some beneficial effect upon the organoleptic properties of coffee brews made from the present coffee products.

The high initial aroma concentrations of the present development are achieved by minimizing the aroma losses of the roast coffee in the grinding, mixing and flaking steps of the present process of preparation. While it is hypothetically possible to achieve similar initial aroma levels by the addition of a highly aromatized oleaginous carrier oil, the addition of such adulterating substances is not contemplated herein. The addition of such materials would undesirably increase the oil level in the present coffee products above the natural oil level of the coffee.

### G. Starting Material Selection

The aggregated, mixed-moisture flaked coffee provided herein can be made from a variety of roast and ground coffee blends, including those which may be classified for convenience and simplification as low-grade, intermediate grade, and high-grade coffees. Suitable examples of low-grade coffees include the natural Robustas such as the Ivory Coast Robustas and Angola Robustas; and the Natural Arabicas such as the natural Penis and natural Ecuadors. Suitable intermediate-grade coffees include the natural Arabicas from Brazil such as Santos, Paranas and Minas; and natural Arabicas such as Ethiopians. Examples of high-grade coffees include the washed Arabicas such as Mexicans, Costa Ricans, Colombians, Kenyas and New Guineas. Other examples and blends thereof are known in the art and illustrated in, for example, U.S. Pat. No. 3,615,667 (issued Oct. 26, 1971 to Joffe), herein incorporated by reference.

Decaffeinated roast and ground coffee can also be used herein to make a decaffeinated thin-flaked coffee product. As is known in the art, the removal of caffeine from coffee products frequency is accomplished at the expense of the removal of certain other desirable components which contribute to flavor. The tendency of decaffeinated products to be either weak or deficient in flavor has, thus, been reported in the literature. The provision of thin-flaked coffee made from decaffeinated roast and ground coffee by the novel thin-flaking method of the twelfth group of embodiments provides a compensatory advantage. The added flavor and strength advantages achievable by enhanced extractability permits realization of levels of flavor and brew strength which might otherwise not be attainable in the case of a conventional decaffeinated roast and ground product.

Typically, decaffeination of coffee is accomplished by solvent extraction prior to the roasting of green coffee beans. Such decaffeination methods are well known in the art and illustrated in, for example, U.S. Pat. No. 3,671,263 (issued Jun. 20, 1972 to Patel); U.S. Pat. No. 3,700,464 (issued Oct. 24, 1972 to Patel); U.S. Pat. No. 3,700,465 (issued Oct. 24, 1972 to Lawrence); and U.S. Pat. No. 3,671,262 (issued Jun. 20, 1972 to Wolfson). See also “Coffee Processing Technology”, by Sivetz & Foote, The Avi Publishing Co., Westport, Conn., 1963, Vol. II, pp. 207 to 278. Each of these references are herein incorporated by reference.

### Preparation of Aggregated Flaked Coffee

The aggregated, mixed-moisture flaked coffee of the twelfth group of embodiments can be formed by mixing together a low-moisture stream and a high-moisture stream of conventional roast and ground coffee, each of which has been cold processed, and then subjecting the coffee to the compressive pressures of a roll mill operating under particular roll milling conditions. Thereafter, the aggregated flaked coffee so produced is sized by suitable means to achieve the requisite particle size distribution of the present aggregated flake coffee compositions.

### A. Cold Grinding

Two coffee bean fractions are independently ground in the process of the twelfth group of embodiments. A first coffee fraction is a low-moisture fraction and comprises coffee beans having a moisture content of from about 1% to 3.5% by weight of the low-moisture beans. The second bean fraction is a high-moisture fraction and comprises coffee beans having a moisture content of from about 4.5% to 7.0% by weight of the high-moisture beans. Each coffee fraction is ground separately but in a similar manner.

It is important in the process of preparing the present flaked coffee product that each coffee fraction be cold ground. By “cold grinding” or “cold comminuting” herein, it is meant that the ground coffee exit the coffee grinder at a ground coffee temperature below 40° F., preferably from about 20° F. to 40° F.

A variety of cold grinding methods are known and may be used herein. Two common “cold grinding” processes are (1) cooling the whole roast coffee to a temperature of −5° F. to 5° F. before grinding, and (2) mixing the whole roast coffee with solid carbon dioxide, dry ice, just prior to grinding.

The grinding of the coffee beans mixed with solid carbon dioxide or the like is described in detail in U.S. Pat. No. 1,924,059 (issued Aug. 22, 1933 to W. Hoskins). The dry ice, for example, is mixed with coffee beans in a weight ratio of coffee to dry ice of about 6 to 9 lbs. to 1 lb. The dry ice should have a particle size of less than about ¼ in. diameter. Thereafter, the dry ice/coffee bean mixture is comminuted in a conventional manner to form a roast and ground coffee. However, any cold grinding method can be utilized which maintains the coffee during grinding at a temperature below 40° F., preferably below 35° F.

Depending upon the specific particle size distribution desired in the final product of the twelfth group of embodiments, the coffee fractions can be ground to the particle size distributions or “grind sizes” traditionally referred to as “regular”, “drip”, or “fine” grinds. The standards of these grinds as suggested in the 1948 Simplified Practice Recommendation by the U.S. Department of Commerce (see Coffee Brewing Workshop Manual, page 33, published by the Coffee Brewing Center of the Pan American Bureau) are as follows:

| | Sieve (Tyler) | Wt. % |
|---|---|---|
| “Regular grind”: | on 14-mesh | 33% |
| | on 28-mesh | 55% |
| | through 38-mesh | 12% |
| “Drip grind”: | on 28-mesh | 73% |
| | through 28-mesh | 27% |
| “Fine grind”: | through 14-mesh | 100% |
| | on 28-mesh | 70% |
| | through 28-mesh | 30% |

Typical grinding equipment and methods for grinding roasted coffee beans are described, for example, in Sivetz & Foote, “Coffee Processing Technology”, Avi Publishing Company, Westport, Conn., 1963, Vol. 1, pp. 239-250.

### B. Blending

The high-moisture roast and ground coffee fraction is blended with the low-moisture roast and ground coffee fraction to form a mixed-moisture roast and ground feed for the roll-milling operation. Any suitable method of admixing the coffee fractions which does not involve high shear mixing can be employed. High shear mixing is unsuitable because shear mixers work the roast and ground coffee causing increased particle size reduction.

Especially desirable and suitable mixing devices are revolving “horizontal plane baffle” mixers such as a common cement mixer; however, the most preferred blenders are falling chute riffle blenders. A falling chute riffle blender is comprised of a large cylindrical tube-like vessel with downwardly mounted baffles on the inside walls thereof. To promote gentle tumbling and intermixing, the high-moisture roast and ground coffee particles and the low-moisture roast and ground coffee particles to be admixed are gravity fed through the baffled vessel.

It is important to the operation of the method that the roast and ground coffee fractions during the blending step be maintained at a temperature of below 40° F. Better results are achieved when coffee fractions during blending are maintained at a temperature of 35° F. to 40° F. Best results are obtained when the coffee fractions' temperature is between about 35° F. and 40° F. during blending. This cold blending minimizes aroma material losses and thus aids the realization of the initial aroma levels exhibited by the aggregated flaked coffee products of the twelfth group of embodiments.

### C. Roll Milling

In the step of roll milling the mixed moisture roast and ground coffee to produce the present aggregated flaked coffee, it has been found important to control several processing variables: (1) coffee feed temperature, (2) roll surface temperature, (3) roll diameters, (4) static gap, (5) the roast and ground coffee feed moisture content, (6) feed rate, (7) roll peripheral surface speed, (8) roll pressure, (9) the mill feed particle size distribution, and (10) density of mill feed.

The process of the twelfth group of embodiments can be practiced with the aid of any of a variety of roll mills of various roll diameters capable of subjecting roast and ground coffee to mechanical compressing action and adapted to the adjustment of roll pressure, roll speed and roll temperature. Suitable mills are those having two parallel rolls such that coffee particles passed between the rolls are crushed or flattened into flakes. Normally, smooth or highly polished rolls will be employed as they permit ready cleaning; other rolls can, however, be employed if the desired flaking effects can be obtained.

### 1. Coffee Feed Temperature

The temperature of the mixed moisture roll mill roast and coffee when fed into the roll mill should be about 35° F. to 40° F. Maintenance of the coffee feed temperature along with maintenance of the roll surface temperature within the ranges given below insures that aroma losses during the roll milling step are sufficiently reduced such that the resultant flaked coffee has an aroma level sufficient to provide the desired initial aroma layer for flakes of all thicknesses.

### 2. Roll Surface Temperature

Control of the surface temperature of each roll has been found to be important to the provision of flaked roast and ground coffee of high extractability. Roll surface temperature, as used herein, is measured in degrees Fahrenheit and refers to the average surface temperature of each roll of the roll mill. The rolls can be operated at differential operating temperatures. However, operation under conditions of differential roll temperatures is not preferred. Best results are obtained when each roll is operated at the same temperature.

The surface temperature of each of the respective rolls can be controlled in known manner. This is usually accomplished by control of the temperature of a heat exchange fluid passing through the inner core of the rolls.

To produce the aggregated, mixed moisture flaked roast and ground coffee of the twelfth group of embodiments, it is important that the roll surface temperature be within the range of from 50° F. to 80° F., preferably between about 60° F. to 70° F. In general, higher roll surface temperatures produce flakes of roast and ground coffees which typically have undesirably low levels of aroma. Lower roll surface temperatures require elaborate cooling systems and therefore higher costs.

### 3. Roll Diameters

The diameter of the roll mills controls the angle of entry into the nip which in turn affects flake thickness and bulk density. Rolls smaller than 6 inches in diameter can be employed to flake coffee; however, such small rolls tend to hamper passage of the coffee through the mill by a churning effect which decreases throughput and efficiency. Roll mills with diameters of up to 48 inches are suitable for use herein. However, best results are obtained from mills having diameters in the range of from 6 to 30 inches. Examples of suitable mills which can be adapted in known manner to operate within the parameters defined hereinbefore include any of the well-known and commercially available roll mills such as those sold under the tradenames of Lehmann, Thropp, Ross, Farrell and Lauhoff.

### 4. Static Gap

As used herein, the term “mechanical static gap” represents that distance separating the two roll mills along the line of nip while at rest and is typically measured in mils. A special condition of roll spacing is “zero static gap” which is used herein to indicate that the two rolls are in actual contact with each other along the line of nip when the roll mills are at rest. As roast and ground coffee is fed into the roll mills and drawn through the nip, it causes the rolls to deflect an amount which is dependent upon the roll peripheral speed, roll pressure, and coffee feed rate. Accordingly, the aggregated mixed-moisture flaked coffee of the twelfth group of embodiments can be made even when the roll mills are set at zero static gap. Because of the deflecting action of the coffee feed as it passes through the roll mill, the static gap setting must be less than the desired flake thickness. Suitable static gap settings range from 0 (i.e., from a zero gap setting) up to about 1 mil, 0.001 in.

In the most preferred method of practice, a zero static gap spacing of the roll mills is employed. Differential roll peripheral surface speeds are to be strictly avoided when the roll mills are set for zero static gap operation. Contact along the line of nip between rolls operating at differential peripheral surface speeds can cause several physical damage to the roll mill. Differential roll peripheral surface speeds can be utilized, however, with static gap spacings exceeding about 1 mil.

### 5. Moisture Content of the Roll Mill Feed

As indicated above, in producing consumer-acceptable aggregated flaked roast coffee, it is important that the average aggregated flaked moisture content be from about 3% to 5% by weight. Since the moisture level of the coffee particles is not significantly affected by the flaking operation, the moisture level of the aggregated flaked coffee product herein can be controlled by controlling the moisture content of the roast and ground coffee feed.

### 6. Feed Rate

The feed rate into the roll mill is to be distinguished from the throughput rate of the roll mill. The feed rate to the roll mill is that amount of material per hour per inch of nip which is fed into the nip area. The throughput rate is the amount of material per hour per inch of nip that actually passes through the roll mill. When the feed rate exceeds the throughput rate, a condition occurs which is referred to in the art as “choke feeding”. When choke feeding occurs, there is a buildup of material which “boils” in the nip region before passing through the nip. Such boiling may cause an undesirable effect on the particle size distribution of the flaked coffee product by increasing the percentage of fines and, therefore, is to be avoided.

Conversely, when the feed rate falls below the theoretical throughput rate, the feed rate and throughput rate are the same. This condition is referred to in the art as “starve feeding”. Starve feeding offers the particular process advantages as increased equipment life and increased process flexibility and is, therefore, the suitable mode of operation in the method of the twelfth group of embodiments.

### 7. Roll Peripheral Surface Speed

Control of the peripheral surface speeds of the rolls is also believed to be important to the provision of the present aggregated flaked coffee. The roll peripheral surface speed is measured in feet per minute of roll surface circumference which passes by the nip. Generally, the roll mill should be operated at a roll speed of from about 470 ft./min. to 1880 ft./min., preferably from about 1180 ft./min. to 1650 ft./min.

For a given set of roll mill operating conditions, the throughput rate, the roll peripheral surface speed and the thickness of the flaked coffee produced are closely related. In the production of flaked coffee of a specified thickness, the throughput rate is directly related to the roll peripheral surface speed. Thus, an increase in the roll peripheral surface speed allows an increase in the throughput rate in producing flakes of specified thickness. When a constant throughput rate is maintained (e.g., by controlling the feed rate), higher roll peripheral surface speeds produce thinner flakes and conversely, lower roll peripheral surface speeds produce thicker flakes.

As the roll peripheral surface speeds increase to greater than about 1700 ft./min., the production of undesirably high levels of fines begins to occur. Moreover, high peripheral surface speeds promote temperature increases which can alter and degrade the flavor of the roast and ground flakes produced.

While peripheral surface roll speeds have been set forth in connection with operation of a roll mill to provide flaked coffee of improved extractability, it will be appreciated that optimal speeds will be determined in part by the other roll mill conditions such as the size of the rolls employed, the static gap setting, etc., as well as the physical and organoleptic properties desired in the flaked product.

### 8. Roll Pressure

Roll pressure will also influence the nature of the aggregated, mixed-moisture coffee flakes obtained by the process of the twelfth group of embodiments. Roll pressure is measured in pounds per inch of nip. Nip is a term used in the art to define the length of surface contact between two rolls when the rolls are at rest. To illustrate, it can be thought of as a line extending the full length of two cylindrical rolls and defining the point or line of contact between two rolls.

To produce the present coffee flake aggregates in high yield, roll pressures should be within the range of from 150 lbs./linear in. of nip to 4,000 lbs./linear in. of nip and preferably within the range of from 1,000 lbs./linear in. of nip to 2,000 lbs./linear inch of nip. In general, operable feed rates are directly related to the roll pressure. Thus, higher roll pressure allows a higher feed rate to the roll mill to produce a flake of specific thickness for otherwise equivalent operating conditions of the roll. Roll pressure can also be used to fine tune finished product density, e.g., lower roll pressure results in slightly lower density. A disadvantages of using higher roll pressures are primarily mechanical, e.g., more expensive equipment is needed to produce higher roll pressures. Conversely, at low roll pressures, the feed rate can drop below commercially desirable rates.

### 9. Mill Feed Particle Size Distribution

The particle size distribution of the roll mill feed mixture of high and low moisture roast and ground coffees has an effect on the particle size distribution of the aggregated flaked coffee product of the twelfth group of embodiments. A coarse mill feed particle size distribution causes the final flaked product to have a coarser particle size distribution than if the mill feed particle size distribution had been finer. Therefore, depending upon the specific particle size distribution desired in the final product, the coffee can be “ground” to meet the specifications. The ranges that are used for mill feed particle size distribution in the twelfth group of embodiments are:

| | Weight % of the |
|---|---|
| Sieve Size (U.S. Standard) | Composition |
| remains on 12 | 0-80 |
| through 12, remains on 16 | 0-40 |
| through 16, remains on 20 | 0-45 |
| through 20, remains on 30 | 0-55 |
| through 30 | 0-40 |

### 10. Mill Feed Density

The density of the roll mill feed mixture of high and low moisture roast and ground coffees has an effect on the density of the final aggregated flaked coffee product. The density of the flaked product will be higher when the mill feed density is high than if the mill feed density had been low. The mill feed density is controlled in two ways: by the whole roast density and by the mill feed particle size distribution. The whole roast density can vary from 0.370 gm/cc to 0.415 gm/cc. Since the density of the coffee increases throughout the manufacturing process, the whole roast density sets the lower limit of the density. Secondly, the coarser the mill feed particle size distribution, the less dense the mill feed will be. The mill feed density can vary from 0.375 gm/cc to 0.475 gm/cc.

### D. Screening

After the roast and ground coffee feed has been flaked by being passed through the roll mill, it is essential that the aggregated, mixed-moisture flaked coffee produced goes through a sizing operation to insure a particle size distribution as described above. Impurities in the roast and ground coffee feed to the roll mill typically produce oversized flakes which can be readily removed by the sizing operation. And too, since operation of the roll mill within the parameter ranges given above can result in a secondary grinder effect, the sizing operation serves to remove an undesirable level of fine particles.

A wide variety of suitable sizing methods and apparatus are known in the art (see for example, “Perry's Handbook for Chemical Engineers”, McGraw-Hill Book Co., pp. 21-46 to 21-52, incorporated herein by reference). For example, the aggregated, mixed-moisture flaked coffee can be effectively screen-sized by dropping the flaked coffee particles from a hopper, chute or other feeding device into a mechanically vibrating screen or into a multiple sieve shaker such as those marketed by Newark Wire Cloth Company and the W. S. Tyler Company. Typically, the sizing operation separates the flaked coffee of various particle sizes into desired size fractions in less than one minute.

The aggregated, mixed mixture flaked roast and ground coffee of the twelfth group of embodiments can be packaged and utilized in the preparation of a coffee brew or extract in known manner. When the aggregated flakes are produced by the milling process herein described, a content of fines will normally be present even after the sizing operation, and depending upon the particular extraction method employed, a greater or lesser amount of cup sediment may be observed.

The aggregated coffee flakes can be blended with roast and ground coffee which has not been milled. It may also be blended with roasted grains such as sprouted barley, rye, chicory among others. This mixture can be brewed to produce a coffee-like beverage. The amount of grain used can be from 10% to about 60% of the total blend.

### Instant Coffee

In preparing the coffee compositions as defined in the Summary of the Invention, the coffee in the coffee composition 110/130 and beverage material 120 as shown in FIGS. 1A, 1B, and 1C may comprise various instant coffee. The thirteenth group of embodiments according to the present invention provides novel instant coffee compositions having an especially unique and attractive appearance, and novel processes for obtaining these instant coffee compositions. The thirteenth group of embodiments relates to novel instant coffee compositions characterized by an appearance that presents at least one external planar surface exhibiting high sheen, and novel processes for obtaining these instant coffee compositions comprising polishing, and preferably structuring, thin dense instant coffee flakes by exposing the instant coffee flakes to a jet of moistening fluid comprised of steam or finely atomized water.

The novel instant coffee compositions of thirteenth group of embodiments are instant coffee particles characterized by an appearance that presents at least one external planar face exhibiting high sheen, as for example, a highly polished instant coffee flake having a thickness within the range of from about 0.002 inch to about 0.01 inch. In another, and preferred, embodiment instant coffee flakes are agglomerated, either with other instant coffee flakes or densified coffee powder, into novel structured instant coffee particles which are non-planar, but which present a plurality of external planar faces exhibiting high sheen. These novel instant coffee compositions do not have the appearance of roast and ground coffee to the extent that these compositions present to the observer planar surfaces polished to a high sheen. The planar surfaces of these instant coffee compositions which are polished to a high sheen have a high reflectivity causing these novel instant coffee forms to glisten and sparkle when exposed to light.

The novel process for obtaining instant coffee compositions which present an external planar face exhibiting high sheen comprises polishing thin dense instant coffee flakes by exposing the instant coffee flakes to a jet of moistening fluid comprised of steam or finely atomized water.

In connection to the background of the thirteenth group of embodiments, for many years producers of instant coffee have sought to improve the acceptance of this type of coffee product vis-a-vis roast and ground coffee. Much effort, for example, has gone into improving the flavor quality of instant coffee. While absolute equality of the flavor of instant coffee as compared to roast and ground coffee is yet to be attained, very substantial improvements in the flavor of instant coffee have been made, and a significant increase in consumer acceptance of instant coffee has occurred in the last 10-15 years. Flavor improvement has been a particularly important factor in this increased consumer acceptance of instant coffee. It has become increasingly apparent, however, that other characteristics of instant coffee such as aroma, density, dustiness, foaming properties, and appearance can also greatly affect the acceptability of instant coffee. In particular, it has become more and more clear that appearance especially affects consumer acceptance of an instant coffee product, and recently much effort has been devoted to improving the appearance of instant coffee.

Instant coffee products which have been on the market for the past 10-15 years have generally been in the form of a light brown powder. The appearance of such instant coffee products is not very attractive. Of late, instant coffee producers have been engaged in manipulating instant coffee powders to produce more attractive instant coffee products. For example, U.S. Pat. No. 2,977,203 discloses that instant coffee powder can be darkened and agglomerated with a jet of steam to provide a product with a “robust” appearance when the instant coffee powder and the jet of steam are arranged in a highly specific planar relationship. Other efforts have been directed to giving instant coffee the appearance of roast and ground coffee. See, for example, U.S. patent application Ser. No. 598,004 of Hair, now U.S. Pat. No. 3,493,388 and U.S. patent application Ser. No. 598,085 of Hair and Strang, now U.S. Pat. No. 3,493,389 both filed Nov. 30, 1966, and commonly assigned.

Still other efforts relating to improving the appearance of instant coffee have been directed to giving instant coffee a unique appearance. In particular, commonly assigned U.S. patent application Ser. No. 638,858 of Andre, Joffe, and Strang, filed May 16, 1967, now abandoned concerns attractive instant coffee products which present an especially unique appearance. The appearance of these instant coffee compositions is especially unique in that the compositions are comprised, in whole or in part, of thin flakes of instant coffee having a thickness within the range of from about 0.002 inch to about 0.01 inch. These particular instant coffee compositions not only present a unique appearance, but also have other very desirable characteristics relating to aroma, density, dustiness, and foaming properties. While these instant coffee compositions present a unique appearance, the flakes are flat and generally non-uniform in shape, and thus each flake reflects light differently from a different plane in much the same manner as do particles of roast and ground coffee. Instant coffee compositions comprising a combination of these flakes and conventional instant coffee can have a very close resemblance to roast and ground coffee because of the variety of particle shapes and sizes present in such a combination.

While these, and other, prior efforts have done much to improve the appearance of instant coffee compositions, a particularly unique form of instant coffee presenting an especially distinctive and attractive appearance would be desirable.

One aspect of the thirteenth group of embodiments provides for a coffee composition for use in a beverage unit and method thereof as defined in the Summary of the Invention, wherein the coffee composition comprises especially strong structured instant coffee particles, made from a process comprising

1. forming a mixture of instant coffee particles comprising

a. from about 5 to about 80 percent free-flowing compressed instant coffee flakes, said flakes having a thickness within the range of from about 0.002 inch to about 0.01 inch, and a density within the range of from about 0.8 g./cc. to about 1.7 g./cc., and

b. from about 20 percent to about 95 percent densified instant coffee powder, said powder having a bulk density of from about 0.3 g./cc. to about b 1.0 g./cc., and comprised of particles having a size range of from about 5 microns to about 500 microns,

2. forming a stream of said mixture having a thickness greater than about one-sixteenth inch,
3. introducing to said stream, at a point where the thickness of the stream is greater than about one-sixteenth inch, a jet of moistening fluid, said jet being introduced at a velocity of from 2,000 feet/minute to 10,000 feet/minute, and at an angle of from about 45° to an angle of about 135° with respect to the direction of travel of said stream,
4. collecting the resulting structured instant coffee product.

In more specific examples under this aspect, the jet of moistening fluid (e.g. steam) may have a velocity of from 2000 feet/minute to 8,000 feet/minute. For example, the instant coffee flakes may have a thickness with the range of 0.003 inch to 0.007 inch, and have a size such that they pass a U.S. Standard Screen No. 10 and are retained on a U.S. Standard Screen No. 30. For example, the densified instant coffee powder may be comprised of particles having a size range of from about 10 to about 100 microns; and/or the stream may have the shape of a rod with a diameter of from about one-fourth inch to about 1 inch. For example, the jet of steam may be introduced at an angle of from about 60° to an angle of about 120° with respect to the direction of travel of the stream. For instance, the jet of steam is introduced at an angle of about 90°.

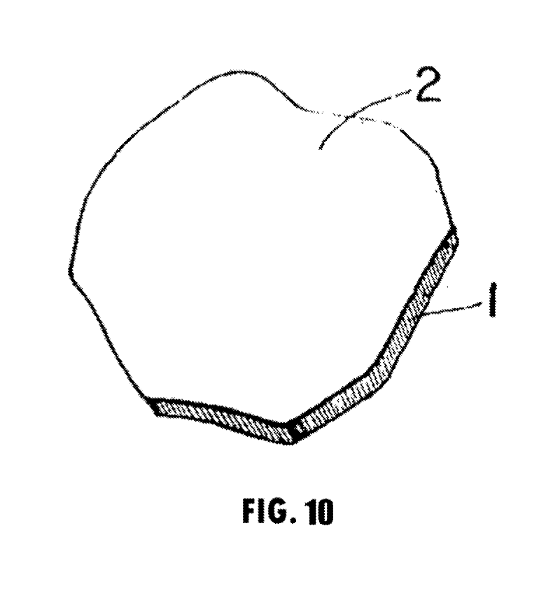

The thirteenth group of embodiments as described above will be further described in the following paragraphs, illustrated in FIGS. 10-13, and exemplified in Examples 50-52.

The thirteenth group of embodiments relates to novel instant coffee compositions having an especially unique and attractive appearance, and novel processes for obtaining these instant coffee compositions. In its broadest aspect the thirteenth group of embodiments provides (1) a process for polishing the planar surfaces of thin dense instant coffee flakes to a high sheen and (2) novel instant coffee particles obtained by this process which present at least one polished external planar face exhibiting high sheen.

It is believed that the surfaces of thin dense instant coffee flakes can be polished to a high sheen by exposing the instant coffee flakes to a jet of moistening fluid, and that these instant coffee flakes can be agglomerated into structured instant coffee particles which are non-planar, but which present a plurality of external planar faces exhibiting high sheen.

The instant coffee flakes contemplated for use in the thirteenth group of embodiments are thin flakes having a thickness within the range of from about 0.002 inch to about 0.01 inch and a density¹ (¹In the thirteenth group of embodiments, the term “density”, used alone, refers to the absolute density of individual particles. The term “bulk density” refers to the overall density of a plurality of particles measured after vibratory settlement in a manner such as that described on pages 130, 131 of “Coffee Processing Technology”, Avi Publishing Co., Westport, Conn., 1963, Vol. 2.) within the range of from about 0.8 to about 1.7 grams per cubic centimeter (hereinafter abbreviated as “gm./cc.”). Instant coffee flakes are not to be confused with the light fluffy, porous particles of instant coffee obtained by drum or freeze drying which have also, on occasion, been referred to as “flakes.”

Instant coffee flakes can be prepared from conventional instant coffee, such as spray-dried instant coffee powder or particles, or freeze-dried instant coffee particles. Other instant coffee particles or powders can also be used as the starting material, for example, drum-dried, foam-mat dried, and vacuum-dried instant coffees or combinations thereof.

Conventional instant coffee particles used as the starting material for preparing instant coffee flakes can be prepared by any convenient process. These conventional instant coffee particles can be prepared domestically or imported. For example, suitable instant coffee particles are readily imported from Brazil and are designated “Brazilian Powders.” Mixtures of domestically produced and imported instant coffee particles are also suitable for use herein as the starting material for preparing instant coffee flakes.

Conventionally, instant coffee is prepared by roasting and grinding a blend of coffee beans, extracting the roast and ground coffee with water to form an aqueous coffee extract, and drying the extract to form instant coffee particles. Various techniques, the most important of which are discussed below, allow the removal and preservation of the more fugitive coffee flavor materials, and their subsequent re-addition to instant coffee in a manner wherein they are not destroyed.

Typical roasting equipment and methods for roasting coffee beans are described, for example, in Sivetz & Foote, “Coffee Processing Technology,” Avi Publishing Company, Westport, Conn., 1963, Vol. 1, pp. 203-226. Coffee oil is often expelled from a portion of the roasted beans prior to grinding as disclosed hereinafter. The coffee beans which have not been oil-expelled are ground, preferably to a united States Standard screen size of from about 8 mesh to about 20 mesh. Typical grinding equipment is described, for example, in Sivetz & Foote, supra, pp. 239-250.

An aqueous coffee extract is obtained by extracting the roast and ground coffee with water. While numerous types of continuous or batch extraction systems can be used, the most commonly used system for the extraction of roast and ground coffee is a multi-column extraction train. This system is composed of a number of elongated extraction columns connected in series for continuous counter-current operation. While in these columns and prior to extraction, the roast and ground coffee can be steam distilled to remove a volatile flavor fraction, and the flavor fraction can be condensed. The distillation often is accomplished by passing steam through the coffee column for from about 10 to about 45 minutes. The condensate can be added immediately to a previously obtained extract; if not, it should be chilled to about 20° F. or less and maintained at that temperature until such time as it is added to an extract.

Once the distillation operation is completed, the coffee is extracted by admitting hot water, such as from about 320° F. to about 375° F., to the last column of the extraction train. The temperature decreases as the water passes through the system, and is withdrawn from the column containing the freshest (previously unextracted) roast and ground coffee at a temperature of from about 190° F. to about 230° F. Typical disclosures of equipment and methods which can be used in the above operations are as follows: steam distillation—Sivetz, “Coffee Processing Technology”, Avi Publishing Company, Westport, Conn., 1963, Vol. 2, pp. 43-46, and U.S. Pat. No. 2,562,206 to Nutting, issued Jul. 31, 1951; extraction—Sivetz & Foote, supra, pp. 261-378, and U.S. Pat. No. 2,515,730 to Ornfelt, issued Jul. 18, 1950.

Once a coffee extract has been obtained, it is preferable for the extract to be concentrated to at least about 45 percent by weight coffee solubles. This concentration step is particularly beneficial for extracts which contain a previously obtained distillate. The high concentration of coffee solubles helps to preserve the fugitive coffee flavor materials from deterioration. Concentration can be by any conventional method, such as freeze concentration, thin film evaporation and flashing, or by the addition of previously dried coffee powder. The extract is then dried to obtain instant coffee particles. While any convenient drying method can be used, the most common drying method is spray-drying. Spray-drying procedures, particularly as related to instant coffee products, are well known in the art and need not be described in detail herein. Typical disclosures on spray-drying processes and equipment are found in Sivetz & Foote, supra, Vol. I, Chapters 11 and 12.

Alternatively, the coffee extract can be freeze-dried. Freeze-dried instant coffee is prepared by freezing a coffee extract prepared as described above. The frozen extract, granulated if desired, then is placed in a chamber under vacuum (preferably less than 500 microns of mercury absolute pressure) and maintained at low temperatures (preferably less than −15° F.). Heat then is applied to remove water from the frozen extract by sublimation. Processes of this type are often capable of achieving excellent flavor retention during drying.

The type of freeze-drying equipment which is used in preparing the freeze-dried coffee particles described above is well known to those skilled in the art. Many manufacturers produce commercial and laboratory-size freeze dryers which are useful in preparing freeze-dried coffee. Freeze-dried coffee for use herein can be prepared by any known freeze-drying process. Typical disclosures relating to processes and equipment for freeze-drying can be found, for example, in Copley and Van Arsdel, “Food Dehydration,” Avi Publishing Company, Westport, Conn., 1964, Vol. II, pp. 105-131; Perry, “Chemical Engineers' Handbook,” McGraw-Hill Book Co., New York, 4th Ed., 1963, pp. 17-26 to 17-28; Tressler and Evers, “The Freezing Preservation of Foods,” Avi Publishing Company, Westport, Conn., Vol. 1, pp. 612-626, and in U.S. Pat. No. 2,751,687 to Colton, issued Jun. 26, 1956.

Irrespective of how the instant coffee particles are obtained, instant coffee flakes useful in the thirteenth group of embodiments can be obtained by roll milling instant coffee particles, and/or a blended mixture of instant coffee particles and coffee oil. Instant coffee particles can be fed into the nip between two rolls of a roll mill which are rotating so that the coffee material is pulled into the nip and compressed into flakes which can then be removed from the roll. Preferably from about 0.01 to about 0.7 percent, most preferably from about 0.1 percent to about 0.3 percent coffee oil is blended with the instant coffee particles to facilitate milling. Greater amounts of coffee oil, for example, 1 percent or more can be used.

Instant coffee flakes useful in the thirteenth group of embodiments can be made from instant coffee particles with no added coffee oil but the milling operation is facilitated and the yield of usable flakes is higher if a blend of instant coffee particles and coffee oil is used. Therefore, while it is not essential, preferably, the instant coffee particles are blended with coffee oil before milling; preferably, the coffee oil is an aromatizing coffee oil.

Aromatizing coffee oils can include those prepared from a variety of sources, both natural or artificial, or mixtures thereof. In either case, the coils preferably contain at least a substantial proportion of those components which are responsible for the aroma and odor of the coffee. A preferred aromatizing oil is raw expelled coffee oil containing an aroma concentrate. Under preferred conditions, such an aromatizing oil is prepared, e.g., by expelling whole roast coffee beans in an inert atmosphere of carbon dioxide or nitrogen. Preferably the oil obtained is maintained and stored under mild to low temperature conditions. (Typical oil-expelling equipment is described, for example, in Sivetz & Foote, “Coffee Processing Technology,” Avi Publishing Company, Westport, Conn., 1963, Vol. 2, pp. 27-30.). Preferably a homogeneous blend of instant coffee particles and coffee oil is formed for roll milling into instant coffee flakes. Such a blend can be formed by adding coffee oil to instant coffee particles, preferably by spraying the desired amount of oil onto the particles under an inert atmosphere, and blending the resulting mixture. The blending can be accomplished in any suitable type of standard power mixer such as an inclined rotating drum or ribbon blender or a paddle mixer.

The moisture content of instant coffee particles to be roll milled is not highly critical, but it is preferably below about 5 percent. Moisture levels appreciably higher than 5 percent tend to cause undesired fusion of the instant coffee flakes obtained.

Important factors in the roll milling of instant coffee particles to obtain instant coffee flakes include: (A) roll diameter, (B) roll surface finish, (C) roll speeds and relative speeds, (D) nip pressure, (E) amount of coffee oil in the blend of instant coffee particles and coffee oil to be milled, (F) temperature, and (G) bulk density of the instant coffee particles.

Thin dense instant coffee flakes useful in the thirteenth group of embodiments can be made with one pass through a two-roll mill having roll diameters within a wide range, e.g., as small as about 2 inches or smaller and as large as about 80 inches or larger, preferably from about 3 inches to about 30 inches, and operating at peripheral speeds from about 1 foot per minute up to about 500 feet per minute, preferably from about 10 feet per minute up to about 400 feet per minute. The optimum yield of desirable flakes is generally obtained when both rolls operate at the same speed. If the oil level in the blend is above about 1 percent, the oil effectively acts as a lubricant thus reducing the shearing action in the flakes caused by a difference in roll speed between the two rolls, and in this event, different roll speeds can be utilized. Speed ratios in excess of 1.5:1 are not desirable irrespective of the amount of oil. Preferably, the roll speed ratio is within the range of from about 1:1 to about 1.4:1.

Highly polished roll surfaces are beneficial, especially for roll diameters above about 6 inches and when using blends of instant coffee particles and coffee oil containing less than about 0.7 percent oil. The polished surfaces reduce friction between the instant coffee particles and the rolls, thus preventing the rolls from dragging excess material into the nip which can result in instant coffee flakes that are undesirably thick and/or dense or which can cause operational difficulties with the roll mill.

Nip pressures can vary from about 25 pounds per inch to about 3,000 pounds per inch. The lower pressures are satisfactory for most applications, and the upper part of the range generally is required if no or little coffee oil is added to the instant coffee particles or if the instant coffee particles to be roll milled are very dense.

The temperature of the mill rolls can be varied over a wide range, e.g., from about 60° F. to about 200° F. The temperature of the mill rolls, however, does affect the color of the flakes. If lighter color flakes are desired the mill roll temperature should be maintained within the range of from about 60° F. to about 140° F. If darker color flakes are desired, the mill roll temperature should be maintained within the range of from about 140° F. to about 200° F. Preferably, however, the mill roll temperature is not maintained above about 200° F., as higher temperatures can damage coffee flavor and/or cause excessive softening of the powder during milling.

Instant coffee flakes useful in the thirteenth group of embodiments having a thickness within the range of 0.002 inch to about 0.01 inch and a density within the range of from about 0.8 g./cc. to about 1.7 g./cc. can be prepared in the manner indicated above. The thickness and density of the instant coffee flakes obtained depend primarily on the nip pressure of the rolls, and density of the instant coffee particles fed to the mill. Denser particles give thicker flakes. Suitable bulk densities for the instant coffee particles to be roll milled are from about 12 to about 25 pounds per cubic foot.

Especially preferred conditions for obtaining very desirable instant coffee flakes useful in the thirteenth group of embodiments are as follows:

### Instant Coffee to be Milled

A blend of (a) instant coffee particles having a bulk density of 17 to 21 pounds per cubic foot and a moisture content of 3 to 4 percent, and (b) from about 0.1% to about 0.7% coffee oil.

### Roll Mill Conditions

Roll surface—moderately to highly polished

Roll diameter—12-24 inches

Roll speeds—150-200 feet per minute

Nip pressure—800-1600 pounds per inch

Roll temperature—150-180° F.

For the purposes of the thirteenth group of embodiments, the instant coffee flakes obtained by roll milling instant coffee particles are preferably size reduced such that all the flakes pass a U.S. Standard Screen No. 6, and most preferably a U.S. Standard Screen No. 12. Preferably, while smaller particle sizes can be used, the instant coffee flakes are not reduced in size to such an extent that the flakes will not be retained on a U.S. Standard Screen No. 30. Suitable apparatus for size reducing instant coffee flakes can include a set of vibrating screens with a plurality of small, hard balls or beads thereon. Other standard grinding, slicing or breaking devices such as a hammer mill, Fitz mill slitter, or Entoleter can also be used for size reduction.

As mentioned hereinbefore the instant coffee flakes contemplated for use in the thirteenth group of embodiments are thin flakes having a thickness within the range of from about 0.002 inch to about 0.01 inch and a density within the range of from about 0.8 g./cc. to about 1.7 g./cc. Instant coffee flakes, such as for example those obtained in the manner indicated above, have planar surfaces which often can appear to be smooth, but the surfaces of the flakes do not exhibit a high sheen.

It is believed that the planar surfaces of instant coffee flakes can be polished to a high sheen by exposing the instant coffee flakes to a jet of moistening fluid. The jet of moistening fluid can be a jet of finely atomized water, or steam. At the point where the jet is introduced to the instant coffee flakes, the velocity of the jet should preferably be from about 100 feet per minute to about 10,000 feet per minute, most preferably from about 200 feet per minute to about 2,000 feet per minute. Preferably, the moistening fluid is steam, and preferably the steam is at a temperature of about 212° F.

The instant coffee flakes can be exposed to the jet of moistening fluid in a variety of ways. Preferably, the instant coffee flakes are exposed to the jet of moistening fluid by introducing to a stream of instant coffee flakes a jet of moistening fluid at an angle of 90° with respect to the direction of travel of the stream of instant coffee flakes. The action of the jet of moistening fluid on the instant coffee flakes polishes one or both planar surfaces of the instant coffee flakes such that instant coffee flakes having at least one external planar surface polished to a high sheen are obtained.

The polished instant coffee flakes obtained should be dried to moisture content of from about 3 percent to about 4 percent to prevent the flakes from fusing or melting together into an amorphous mass. Drying can be accomplished in a variety of ways, as for example by collecting the flakes on a moving bed such as a vibrating conveyor and exposing the moving bed of flakes to heat lamps or warm air. During drying the temperature of the flakes should not exceed 175° F. as higher temperatures can be detrimental to flavor.

While some instant coffee flakes are agglomerated in the above process, the thickness and density of the instant coffee flakes polished in the above process which are not agglomerated does not change appreciably. (Less agglomeration occurs when the velocity of the jet of moistening fluid is low, as for example 500 feet per minute, and the stream of flakes is thin, as for example when the stream has a thickness of about one thirty-second inch.). The polished instant coffee flakes obtained are comprised of novel instant coffee flakes having (1) a thickness of from about 0.002 inch to about 0.01 inch, (2) a density of from about 0.8 g./cc. to about 1.7 g./cc. and (3) at least one external planar face exhibiting a high sheen. Since these instant coffee forms have planar surfaces polished to a high sheen, the polished surfaces of these instant coffee forms have a high reflectivity, causing these novel instant coffee forms to glisten and sparkle when exposed to light. These novel instant coffee compositions are especially unique and attractive in that they present an appearance distinctly resembling the appearance of crystals which glisten and sparkle when exposed to light. These compositions are useful per se; or they can be used in admixture with conventional instant coffee particles for example in weight ratios of novel composition to conventional instant coffee particles ranging from about 20:1 to about 1:20.

In another, and preferred, aspect of the thirteenth group of embodiments instant coffee flakes are agglomerated during the above-described polishing process, with other instant coffee flakes and/or densified domestic or imported coffee powder, into novel structured instant coffee particles which are non-planar, but which present a plurality of external planar faces exhibiting high sheen. Each of these novel particles can also be described as being comprised of a plurality of instant coffee flakes fused together into a particle which is a three-dimensional structured array of instant coffee flakes.

One problem with instant coffee products comprised of planar flakes of instant coffee is that the flakes because of their form tend to nest together. Unlike planar instant coffee flakes, the novel structured three-dimensional instant coffee particles of the thirteenth group of embodiments desirably do not tend to nest together. In addition, the structured instant coffee particles are especially desirable in that they can present external planar surfaces polished to a high sheen disposed in many different planes. Since the structured instant coffee particles do not tend to nest together as do instant coffee flakes, instant coffee products comprised of the structured instant coffee particles can have heightened glisten and sparkle. This is so because more of the polished surfaces present are exposed, thus enhancing the attractive crystalline appearance of the product. The appearance of instant coffee products comprised of the structured instant coffee particles of the thirteenth group of embodiments is additionally enhanced because the exposed polished planar surfaces of the structured instant coffee particles are disposed in many different planes. This highly enhances the appearance of an instant coffee product comprised of these particles because as the line of sight of an observer with respect to product changes, numerous highly polished reflecting surfaces can continually momentarily enter and leave the line of sight of the observer.

The highly polished, planar surfaces momentarily entering the line of sight of the observer present to the observer intermittent flashes of reflected light. As a result of these intermittent flashes of light from the structured instant coffee particles, an instant coffee product comprised of these particles appears to twinkle and sparkle when exposed to light, presenting an especially unique and attractive appearance.

It is believed that structured instant coffee particles can be obtained by a novel agglomerating and polishing process comprising

1. forming a stream of instant coffee flakes, said stream having a thickness greater than about one-sixteenth inch;

2. introducing to said stream of flakes, at a point where the thickness of the stream of flakes is greater than about one-sixteenth inch, a jet of moistening fluid, said jet being introduced at an angle of from about 45° to an angle of about 135° with respect to the direction of travel of said stream, and

3. collecting the resulting structured instant coffee particles which are non-planar, but which present a plurality of external planar faces exhibiting high sheen.

It is important that the instant coffee flakes hereinbefore described as contemplated for use in the thirteenth group of embodiments be used in this agglomerating process. As mentioned hereinbefore, such flakes have a thickness of from about 0.002 inch to about 0.01 inch. In this process it is preferred that the flakes have a thickness of from about 0.003 inch to about 0.007 inch, and most preferably from about 0.003 inch to about 0.005 inch. It is also preferred that the instant coffee flakes be of such a size that they are retained on a U.S. Standard Screen No. 30, and pass a U.S. Standard Screen No. 6. Preferably the flakes pass a U.S. Standard No. 10, and most preferably a U.S. Standard Screen No. 12.

The stream of instant coffee flakes can have a thickness of from about one-sixteenth inch to about 2 inches, and greater. At the point where the jet of moistening fluid is introduced to the stream of instant coffee flakes, the stream of coffee flakes preferably has a thickness of from about one-fourth inch to about 1 inch, and most preferably a thickness of from about one-fourth inch to about three-fourths inch. The most preferred results are obtained when the stream of instant coffee flakes has a circular or ellipsodial cross-sectional shape (rod shaped when viewed from the side). In order to get good agglomeration, the stream of instant coffee should be comprised of a substantial number of coffee flakes.

Suitable moistening fluids are finely atomized water and steam. Steam is the preferred moistening fluid, and most preferably the steam is at a temperature of about 212° F. The jet of moistening fluid is introduced to the stream of instant coffee flakes at an angle of from about 45° to about 135° with respect to the direction of travel of the stream of flakes. Preferably the jet of moistening fluid is introduced at an angle of from about 60° to about 120°, most preferably at about 90°, with respect to the direction of travel of the stream of flakes. Also preferably, the stream of coffee flakes is freely falling downward by the force of gravity. Thus, in a preferred aspect of the agglomeration, a jet of steam hits a rod of freely falling instant coffee flakes at an angle of about 90° rather than, for example, a rectangular shaped falling curtain of particles (planar when viewed from the side). The jet of moistening fluid preferably has the same shape as the falling flakes, i.e., preferably it has the configuration of a rod. The velocity of the jet of moistening fluid should be sufficient to redirect the direction of travel of the stream of flakes, and provide sufficient contact among the flakes to form agglomerates. Preferably the velocity of the jet is from about 2,000 feet per minute to about 10,000 feet per minute, most preferably from about 3,000 feet per minute to about 8,000 feet per minute, at the point where the jet is introduced to the stream of flakes.

The structured particles produced by the action of the jet on the stream of flakes can be collected in any suitable manner. Initially, the particles are preferably collected on a smooth inclined plane of material, for example an inclined plane of sheet metal at an angle of 30° to the horizontal. The particles can move down the inclined plane under the force of gravity, and can be transferred to any suitable moving conveyor, for example a moving belt or vibrating conveyor. It is preferable to initially collect the particles in the manner indicated above because this method of collecting the particles is gentle. The particles should be dried to a moisture content of from about 3 percent to about 4 percent by weight, for example, about 3.8 percent by weight. The particles are most conveniently dried while on the conveyor. Drying can be accomplished with heat lamps or warm air. During drying, the product temperature preferably should not rise above about 175° F., as higher temperatures can be detrimental to the flavor of the instant coffee particles.

It is known in the art that random-shaped particles such as crystals and, for example, flake-like products are difficult to agglomerate, and that in many cases the agglomerates formed from such particles are likely to be fragile. In particular, instant coffee powder comprised of random-shaped instant coffee particles has been included in this category. The difficulty is probably due to the lesser exposed surface area and the probability of insufficient interfacial contact. (See, World Coffee & Tea, November, 1967, Vol. 8, No. 7, page 41.).

In another preferred aspect of the thirteenth group of embodiments, a mixture of instant coffee flakes and densified instant coffee powder comprised of from about 5 percent to about 80 percent instant coffee flakes and from about 20 percent to about 95 percent densified instant coffee powder is agglomerated according to the above process.

It is believed that this preferred novel agglomerating process gives especially preferred structured instant coffee particles, characterized by improved strength, which are non-planar, but which present a plurality of external planar faces exhibiting high sheen. Because of the increased strength and stability of the structured instant coffee particles obtained in this process, this process is highly preferred.

The instant coffee particles obtained in this preferred novel agglomerating process also have a desirable size and a surprisingly low bulk density. The agglomeration process gives a good yield of particles which will not pass a U.S. Standard Screen No. 30. Preferably all the particles obtained pass a U.S. Standard Screen No. 4, and most preferably all will pass a U.S. Standard Screen No. 6. Undersized and oversized particles can be separated by vibrating screens. The bulk density of the particles obtained is from about 0.20 g./cc. to about 0.40 g./cc., preferably from about 0.27 g./cc. to about 0.36 g./cc. This is the usual range for instant coffee products and is equivalent to using about one teaspoon per cup to obtain a desirable coffee brew.

Also the instant coffee particles obtained in this preferred novel agglomerating process have desirable water-solubility properties, e.g. they are fast dissolving and can be characterized as truly instant; delectable coffee can be made therefrom by simply adding water. Moreover, these instant coffee particles are more free-flowing than conventional instant coffee powders and therefore are easily measured for use by the consumer. Furthermore, these instant coffee particles are low foaming compared to conventional instant coffee powder.

The instant coffee flakes useful in this preferred process have the same characteristics as the instant coffee flakes useful in the above agglomerating process. The densified instant coffee powder must have a bulk density of from about 0.3 to about 1.0 g./cc., preferably from about 0.4 to about 0.9 g./cc., and most preferably from about 0.5 to about 0.8 g./cc. In addition, the densified instant coffee powder should be comprised of instant coffee particles having a size of from about 5 to about 500 microns, preferably a size of from about 10 to about 200 microns, and most preferably a size of from about 15 to about 100 microns.

This preferred process utilizes a mixture of instant coffee flakes and densified instant coffee powder comprised of from about 5 to about 80 percent instant coffee flakes and from about 20 to about 95 percent densified instant coffee powder. Preferably the mixture of instant coffee flakes and densified instant coffee powder contains from about 40 to about 90 percent densified instant coffee powder, and most preferably from about 60 to about 85 percent densified instant coffee powder, by weight of the mixture, the balance being flakes. Mixtures with greater than about 95 percent densified instant coffee powder do not give a sufficient yield of the desirable structured instant coffee particles which have planar faces exhibiting high sheen. Mixtures containing less than about 20 percent densified instant coffee powder do not give particles of markedly improved strength.

Densified instant coffee powder can be prepared from ordinary spray-dried instant coffee particles, freeze-dried instant coffee particles, and other suitable instant coffee particles. These instant coffee particles may be densified by passing the instant coffee particles through a roll mill, in such a manner that the particles are not compressed into instant coffee flakes, or by subjecting the instant coffee particles to other types of pulverizing equipment such as a hammer mill, or impact mill. The “Simpactor” manufactured by The Sturtevant Mill Co. is an example of a suitable hammer mill, and the Entoleter Centrifugal Machine manufactured by the Entoleter Division of Safety Industries, Inc. is an example of a suitable impact mill.

Attention is directed to the fact that the structuring process of the thirteenth group of embodiments represents a substantial departure from conventional agglomerating processes in regard to the results obtained. Whereas conventional agglomeration of small particles such as instant coffee yields larger but similar particles as the starting material, the structuring process of the thirteenth group of embodiments converts flakes into novel particles of a crystalline-like, three-dimensional array.

The novel structured instant coffee particles herein are useful per se or in admixture with unstructured flakes of the thirteenth group of embodiments having sheen or in admixture with conventional instant coffee particles or in admixture with both unstructured flakes having sheen and also with conventional instant coffee particles. A very preferred instant coffee composition comprises by weight from about 20 to about 85 percent structured instant coffee particles, from about 15 to about 80 percent of unstructured flakes of the thirteenth group of embodiments having sheen, and from 0 to about 15 percent of loose conventional instant coffee powder.

Treating instant coffee flakes, or a mixture of instant coffee flakes and densified instant coffee powder with a jet of moistening fluid as provided herein is additionally advantageous in that the instant coffee particles so treated are darkened to a rich brown color. Other aqueous fluids other than steam and finely atomized water, for example coffee extracts, are suitable moistening fluids.

### EXAMPLES

The following examples further describe and demonstrate various embodiments within the scope of the present invention. These examples are given solely for the purpose of illustration and are not to be construed as a limitation of the present invention, as many variations thereof are possible without departing from the invention's spirit and scope.

### Example 1

Batch A (dark roasted dried beans): 100% green robusta coffee beans with an 11% moisture content are dried at 170° F. (77° C.) for 6 hours to a 5% moisture content. The dried beans are fast roasted in a Thermalo roaster, Model Number 23R using 45 kg (100 lb) batches. The gas burner input rate is 1.7 million Btu/hr (498 kW). The roasting time is 130 seconds. The roasted beans have a Hunter L-color of 15 and a tamped density of 0.31 grams/cc.

Batch B (roasted non-dried beans): A blend of green coffee beans (50% washed Arabica, 50% natural Arabicas) with an 11% moisture content are fast roasted in a Thermalo roster using 45 kg (100 lb) batches. The gas burner input rate is 1.4 million Btu/hr (410 kW). Roasting time is 165 seconds. The roasted beans have a Hunter L-color of 18 and a tamped density of 0.36 grams/cc.

A 20:80 blend (Batch A to Batch B) is cracked, normalized, ground and flaked to an average flake thickness of 127 um (0.005 inches). Roasted beans from Batch B are ground to an average particle size of about 1000 um. The ground coffee is admixed with the coffee flakes in a 1:1 weight ratio. The brewed acidity index is 2800. f(1) is 1046, f(2) is 2100 and f(3) is 149.

### Example 2

Batch A (dark roasted dried beans): 100% green robusta coffee beans with an 11% moisture content are dried at 170° F. (77° C.) for 6 hours to a 5% moisture content. The dried beans are fast roasted in a Thermalo roaster using 45 kg (100 lb) batches. The gas burner input rate is 1.7 million Btu/hr (498 kW). The roasting time is 120 seconds. The roasted beans have a Hunter L-color of 17 and a tamped density of 0.31 grams/cc.

Batch B (roasted non-dried beans): A blend of green coffee beans (65% washed Arabica, 35% natural Arabicas) with an 11% moisture content are fast roasted in a Thermalo roster using 45 kg (100 lb) batches. The gas burner input rate is 1.4 million Btu/hr (410 kW). Roasting time is 165 seconds. The roasted beans have a Hunter L-color of 18 and a tamped density of 0.36 grams/cc.

A 29:71 blend (Batch A to Batch B) is cracked, normalized, and ground to an average particle diameter of 500 um. The brewed acidity index is 2650. f(1) is 1139, f(2) is 1738 and f(3) is 211.

### Example 3

Batch A (dark roasted dried beans): A blend of green coffee beans (50% washed Milds, 30% natural Arabicas, 20% Robustas) with an 11% moisture content are dried at 170° F. (77° C.) for 6 hours to a 5% moisture content. The dried beans are fast roasted in a Thermalo roaster using 45 kg (100 lb) batches. The gas burner input rate is 1.7 million Btu/hr (498 kW). The roasting time is 120 seconds. The roasted beans have a Hunter L-color of 17 and a tamped density of 0.31 grams/cc.

Batch B (roasted non-dried beans): A blend of green coffee beans (50% washed Milds, 30% natural Arabicas, 20% Robustas) with an 11% moisture content are fast roasted in a Thermalo roster using 45 kg (100 lb) batches. The gas burner input rate is 1.4 million Btu/hr (410 kW). Roasting time is 165 seconds. The roasted beans have a Hunter L-color of 18 and a tamped density of 0.36 grams/cc.

A 5:95 blend (Batch A to Batch B) is ground to an average particle diameter of 900 um. About 25% of the ground coffee is flaked to an average flake thickness of 127 um (0.005 inches). The flakes are admixed with the remaining ground blended coffee. Tamped density is 0.37 grams/cc.

### Example 4

### Thermalo Roast

A blend of green coffee beans with an initial moisture content of 11%, consisting of ⅓ washed Arabicas, ⅓ natural Arabicas, and ⅓ natural Robustas are pre-dried at 250° F. (121° C.) for 2 hours on a Wenger belt dryer. The pre-dried beans are then roasted in a Thermalo roaster, Model Number 23R, manufactured by Jabez Burns, under fast conditions using 100 lb. batches (45 kg) and a gas burner input rate of 1.7 million Btu/hr (498 kW). Roasting time of 120 seconds is used. Whole roast tamped bulk density is less than 0.35 g/cc. The whole roast beans have a Hunter L-value (L-color) of 19. The roast beans are then water quenched. The quenched coffees are then cracked, normalized and ground to an automatic drip coffee grind of 900 μm and flaked to 20 thousandths of an inch (508 μm) flake thickness. The ground tamped bulk density is less than 0.335 g/cc and the Hunter ΔL is less than 0.6. The flavor strength of the resulting coffee is greater than that of an 11.5 oz. ground and roast coffee produced without pre-drying.

### Example 5

### Jetzone Fluidized Bed Roast

Green Robusta coffee beans are pre-dried at 160° F. (71° C.) for 6 hours in a Wenger belt dryer at a feed rate of 1300 pounds (590 kg) per hour. Next, the pre-dried beans are cooled with dry ambient air and then roasted at 600° F. (315° C.) for 47 seconds on a Jetzone fluid bed roaster, Model 6452, manufactured by Wolverine Corp. with a burner rate of 2.4 mm Btu/hr (703 kW) and an air recycle of 400 cfm (11,300 liters/min.). The roast beans are cooled to ambient temperature with 70° F. (21° C.) air at a relative humidity of 40%. The resulting whole roast tamped bulk density is 0.34 g/cc and the Hunter L-value (L-color) is 19.

### Example 6

### Fluidized Bed Roast

Pre-dried coffee beans, prepared according to Example 4, are fast roasted in a Jetzone, Model 6452, two-stage, fluidized bed, continuous coffee roaster manufactured by Wolverine Corp. at 440°-470° F. (227° C. to 243° C.) for 50 seconds in the first stage, and 515°-545° F. (268° C. to 285° C.) for 50 seconds in the second stage. The roaster is operated at a 1070 pound (486 kg) per hour feed rate and at a 2.4 btu/hr (703 kW) burner rate. The roast beans are cooled to ambient temperature with 70° F. (21° C.) air at a relative humidity of 40%. The resulting whole roast tamped bulk density is 0.38 and the whole roast Hunter L-color is 22. The beans are then ground to an automatic drip coffee grind of 900 μm. The Hunter ΔL value is less than 0.6 and the ground tamped bulk density is 0.36. The flavor strength of the resulting coffee is greater than that of a 13-oz. ground and roast coffee prepared without pre-drying.

### Example 7

### Thermalo Roast

Three batches of green coffee beans with an initial moisture content of 11% are pre-dried at 160° F. (71° C.) for 6 hours on a Wenger belt dryer. The batches consist of a natural Arabica batch, A Robusta batch and a washed Arabica batch. The pre-dried beans are then roasted on a Thermalo roaster, Model Number 23R, manufactured by Jabez Burns, under fast conditions using 100 lb. (45 kg) batches and a gas burner input rate of 1.7 million Btu/hr (498 kW). A roast time of 120 seconds is used. Whole roast tamped bulk density is less than 0.35 g/cc. The roast beans are then water quenched and the three batches are combined in equal proportions. The whole roast Hunter L color is in the range of from 17 to 22. The quenched coffees were then cracked, normalized and ground to an automatic drip coffee grind of 900 μm, and flaked to 20 thousandths of an inch (508 μm) flake thickness. Ground tamped bulk density is less than 0.335 g/cc and the Hunter ΔL value is less than 0.6. The flavor strength of the resulting coffee is greater than that of a 10 oz. ground and roast coffee prepared without pre-drying.

### Example 8

The roast coffee of Example 5 is ground using a Gump Model 666 grinder manufactured by Modern Press. The grinding conditions are set to yield an average particle size of from 300 to 3000μ. The resulting Hunter ΔL is less than 0.6. The flavor strength of the resulting coffee is greater than that of an 11.5 oz. ground and roast coffee.

### Example 9

The ground and roast coffee of Example 8 is flaked using an 18″×33″ Ross roll mill hydraulic flanking unit manufactured by Ross Equipment Co. The milling gap is set to yield a flake thickness of from 2 to 40 thousandths of an inch (51 to 1016 μm).

### Example 10

A blend of Arabica and Robusta coffee beans is roasted in a continuous roaster for 2.5 minutes at about 500° F. (260° C.) to a Hunter L-color of about 20. The roasted beans are then cracked with Gump cracking rolls to the following particle size distribution: 65% on a 6-mesh screen, 22% on an 8-mesh screen, 10% on a 16-mesh screen, and 3% in the pan. Next the cracked beans are normalized in a Gump normalizer for about 15 to 30 seconds, just long enough to change the appearance of the chaff. Finally, the cracked and normalized beans are ground in Gump grinding rolls to a typical ADC (Automatic Drip Coffee) grind. The density of the roast and ground coffee is now about 0.35 g/cc, contrasted with about 0.45 g/cc for conventionally ground and normalized coffee. The coffee has an excellent non-chaffy appearance.

### Example 11

A batch of Arabica coffee beans is roasted in a Thermalo batch roaster (Blaw-Knox Food & Chemical Equipment, Inc., Buffalo, N.Y.) for 3.2 minutes at about 450° F. (232° C.) to a Hunter L-color of about 24. The beans are then cracked with Gump cracking rolls to a particle size distribution of 70% on a 6-mesh screen, 20% on an 8-mesh screen, 8% on a 16-mesh screen, 1% on a 20-mesh screen, and 1% in the pan. Next they are normalized in a ribbon blender until the chaff is broken up and mixed with the coffee oil. The cracked and normalized coffee particles are then ground to the standard electric perk grind. The density of the particles is 0.34 g/cc. The coffee's appearance is non-chaffy.

### Example 12

A blend of Arabica and Robusta beans is roasted in a Probat Batch Turbo roaster Probat Corp., Emmerich, Germany for 2 minutes at about 600° F. (315° C.) to a Hunter L-color of about 16. The roasted beans are then cracked in Gump cracking rolls to a particle size distribution of 60% on a 6-mesh screen, 25% on an 8-mesh screen, 10% on a 16-mesh screen, and 5% in the pan. Next, the cracked beans are normalized in a Gump normalizer until the chaff is broken up and darkened, and hard to see against the background of the coffee. Finally, the beans are ground to the typical Italian fine grind. The density of the coffee product is 0.25 g/cc. It has an excellent non-chaffy appearance.

### Example 13

A flavored coffee composition is prepared by mixing 50 pounds of a roast and ground coffee source with 1.5 pounds of an orange flavor source. The roast and ground coffee source is a blend of 70%, by weight, of an arabica type coffee, roasted on a Thermalo model roaster set at 450° F. for 3 minutes to a Hunter L color of 20.5 L, and 30%, by weight, of a robusta type coffee roasted on a Thermalo model roaster set at 450° F. for 3 minutes to a Hunter L color of 19.5 L. Once roasted the coffee source is cooled and then ground so that it has a mean particle size distribution of 743 microns. The ground coffee source blend has a particle density of 0.31 g/cc and a moisture content of 4.5%.

The flavor source is a commercially available dry orange flavor purchased from Givaudan Flavors of Cincinnati, Ohio. The flavor component particles have a mean particle size distribution of 47 microns, a particle density of 0.5 g/cc, and a moisture level of 2%.

The ground coffee component particles and the flavor component particles are mixed in an American Process Systems brand ribbon mixer for 5 minutes, set at 45 rpm. Upon completion of mixing five samples are taken from different regions of the mixer, one from each of the four corners and one from the center of the mixer. The Distribution Value (DV) is measured according to the Distribution Value Determination Method described herein. The DV for Samples 1-5 is determined to be in the range of from about 5% RSD to about 7% RSD.

### Example 14

A flavored coffee composition is prepared by mixing 50 pounds of the roast and ground coffee source of Example 13 with 1.5 pounds of a vanilla flavor source. The flavor source is a commercially available encapsulated liquid vanilla flavor purchased from Givaudan Flavors of Cincinnati, Ohio. The flavor component particles have a mean particle size distribution of 47 microns, a particle density of 0.5 g/cc, and a moisture level of 2%.

The ground coffee component particles and the flavor component particles are mixed in a American Process Systems brand ribbon mixer for 5 minutes, set at 45 rpm. Upon completion of mixing five samples are taken from different regions of the mixer. The Distribution Value (DV) is measured according to the Distribution Value Determination Method described herein. The DV for Samples 1-5 is determined to be in the range of from about 5% RSD to about 7% RSD.

### Example 15

A flavored coffee composition is prepared by mixing 50 pounds of an instant coffee source with 1 pound of a vanilla flavor source. The instant coffee source is a commercially available Brazilian instant coffee blend purchased from Iguacu Coffees of Brazil. The instant coffee source particles have a mean particle size distribution of 820 microns, a particle density of 0.33 g/cc, and a moisture content of 2.5%.

The flavor source is a commercially available encapsulated vanilla flavor purchased from Givaudan Flavors of Cincinnati, Ohio. The flavor component particles have a mean particle size distribution of 47 microns, a particle density of 0.5 g/cc, and a moisture level of 2%.

The ground coffee component particles and the flavor component particles are mixed in a American Process Systems brand ribbon mixer for 5 minutes, set at 45 rpm. Upon completion of mixing five samples are taken from different regions of the mixer. The Distribution Value (DV) is measured according to the Distribution Value Determination Method described herein. The DV for Samples 1-5 is determined to be in the range of from about 8% RSD to about 12% RSD.

### Example 16

A ready to drink beverage is prepared by brewing 35.5 grams of the flavored coffee composition of Example 13 in a standard Mr. Coffee type brewer with 1420 ml of water.

### Example 17

A ready to drink beverage is prepared by dissolving 3.6 grams of the flavored coffee composition of Example 15 in a cup with 240 ml of 185° F. water.

### Example 18

400 pounds of a blend comprising 25% high quality Arabicas, 43.75% Brazils, 6.25% low quality Arabicas, and 25% Robustas is roasted in a Thermolo roaster at air temperatures within the range of from 400° F. to 550° F. The end roast temperature is 430° F. The total roast time is 16 minutes, and the roast was quenched with 7 gallons of water. The blend was ground to regular grind size in a Gump pilot grinder, and the moisture level was measured as 4.24% by weight. The conventional roast and ground coffee particles bulk density was measured and found to be 0.451 grams/cc. Bulk density as used herein refers to the tamped bulk density and refers to the overall density of a plurality of particles measured after vibratory settlement in a manner such as that described on pages 130-1 of Sivetz, Coffee Processing Technology, Avi Publishing Co., Westport, Conn., 1963, Vol. 2. The conventional regular grind roast and ground coffee particles are used to prepare light-milled roast and ground coffee in the following manner. The coffee is fed at a rate of 180 lbs./hr./inch of nip into a Lehman 2-roll mill. The roll mill is further characterized by having rolls of a 13-inch diameter and 32 inches long. The roll pressure is 1000 pounds/inch of nip. The roll surface temperature is 140° F., and the roll peripheral surface speed of each of the rolls is 200 feet/minute. The amount of nip actually utilized during the runs of this and the following examples is only 7 inches. The conditions of pressure, roll speed and feed rate fall within set No. 1 conditions as expressed in the Table.

TABLE

| | Pressure, | Roll speed, | Feed rate, |
|---|---|---|---|
| Set No. | lbs./in. | ft./min. | lbs./hr./in. |
| 1 . . . | 750-1400 | 200-350 | 100-275 |
| 2 . . . | 850-1700 | 350-600 | 275-400 |
| 3 . . . | 1000-2000 | 600-750 | 400-550 |

The resulting product is examined and found to have a moisture content of 4.0% and a bulk density of 0.44 grams/cc, indicating a bulk density substantially identical to that of the feed conventional roast and ground coffee particles. Visual examination of the product reveals that in appearance it is identical with conventional roast and ground coffee particles. However, microscopic examination reveals that a substantial portion of cells, i.e., greater than 20%, are at least partially disrupted. The coffee cells are noted to be distorted from their normal appearance and in particular are noted to be compressed, often cell wall fractured, flattened, and generally weakened in structural integrity.

A panel of four expert tasters prepares cups of coffee from the light-milled coffee in the following manner: The amount of light-milled coffee used is 7.2 grams/cup; the amount of water per cup is 178 ml; the coffee is placed in a conventional percolator and allowed to perk until the temperature reaches 180° F., at which time the coffee beverage is poured into cups to be tasted by the expert panel. The panel compares the taste of the coffee brewed from the hereinabove described light-milled coffee with coffee beverage prepared from regular grind Folger roast and ground coffee. The experts note that the beverage produced from the light-milled coffee is about 15% stronger in taste impact than the coffee brewed from the standard roast and ground coffee.

### Example 19

The process of Example 18 utilizing the roast ground coffee blend of Example 18 is repeated with the following changes: the nip pressure is 1,000 pounds/inch of nip; the feed rate to the mill is 300 pounds/hour/inch; the tamped density of the product is 0.44 grams/cc; and the roll peripheral surface speed is 500 feet/minute. The product has the bulk visual appearance of roast and ground coffee and, when tasted by an expert panel in the manner previously described in connection with Example 18, shows an average of 20% increase in flavor strength over the flavor strength of the roast and ground coffee.

### Example 20

Example 18 is repeated with the following changes: The roll pressure is 1,500 pounds/inch of nip; the feed rate is 500 pounds/hour; the roll speed is 750 feet/minute; the roll surface temperature is 98° F.; the product bulk density is 0.44 g/cc. Visual examination of the product reveals that it looks exactly like conventional roast and ground coffee. Tasting by an expert panel as described in Example 18 reveals that the product is about 25% on an average, stronger in taste than coffee brewed from a standard roast and ground coffee product of regular grind size.

### Example 21

A blend of low quality Arabicas, Robustas, and intermediate quality Brazils and African Naturals, each on a 25 percent weight basis, is prepared. The weight ratio of low quality coffees to intermediate quality coffees is 1:1. Five hundred pounds of this blend is roasted in a Jubilee roaster at air temperatures maintained within the range of 400°-440° F. The end roast temperature is 440° F. The total time is 16 minutes and 31 seconds. Thereafter the roasted beans are quenched with 10 gallons of water.

A 500 pound blend of high grade Arabicas comprised of Colombians and Kenyas is also prepared and roasted as described above.

Portions of the above blended roast coffee beans are ground, as needed, to regular grind size in a Gump pilot grinder. Twenty pounds of the above blended low and intermediate quality roast coffee beans is ground to regular grind size. Five pounds of high quality blend is ground to regular grind size, and is set aside. The low and intermediate quality 20 pound blend is used to prepare flaked roast and ground coffee in the following manner. The coffee is choke fed into a Farrell two-roll mill at a roll pressure of 3000 lbs./in. of nip. The roll surface temperature is 100° F.; the roll peripheral speed is 35 ft./min.; and the coffee moisture level is about 5.4 percent. The thickness of the compressed coffee flakes produced is 0.011 inches and the flake bulk density is 0.45 g./cc. The 20 pound blend of low and intermediate quality flaked roast and ground coffee is admixed with 5 pounds of high quality roast and ground coffee in a revolving horizontal plane baffle mixer. A uniform admixture is achieved after 15 seconds. The admixture is screened so that 3 percent of said product will pass through a 40 mesh U.S. Standard screen and 10 percent of said product remains on a 12 mesh U.S. Standard screen. The percent of ground coffee in the mixture was 20 percent.

A panel of four expert tasters prepared cups of coffee from the improved roast coffee product in the following manner: The amount of improved roast coffee product prepared as described above was 7.2 g./cup; the amount of water used per cup was 178 milliliters; the coffee was placed in a conventional percolator and allowed to perk until the temperature reached 180° F. at which time the coffee beverage was poured into cups to be tasted by the expert panel. The panel compared the taste of coffee brewed from the coffee product of this invention with conventionally prepared coffee beverage prepared from regular grind Folger roast and ground coffee. The experts noted that the coffee product of this invention was about 15 percent stronger in flavor strength than coffee brewed from standard roast and ground coffee, regular grind size; additionally it was flavor laden with aromatic notes and had good aroma.

Utilizing the blended and roasted ground coffees prepared in this example, the following tests are conducted:

1. A portion of the blended low and intermediate quality flaked roast and ground coffee is used to prepare a product comprising 100 percent flaked roast and ground coffee, hereinafter product (1).

2. Flaked roast and ground coffee and roast and ground coffee particles are utilized to make a product comprising 70 percent by weight of flaked low and intermediate grade roast and ground coffee and 30 percent by weight of high grade roast and ground coffee particles, hereinafter product (2).

A panel of four expert tasters prepared cups of coffee from products (1) and (2) in the manner previously set forth in this example. The panel compared the taste of coffee brewed from products (1) and (2). In comparing product (1) beverage with beverage produced from the improved roast coffee product of this invention (product 2), the panel noted that product (1) was lacking in flavor-laden aromatic and volatile constituent flavor and aroma notes and characterized the coffee as somewhat flatter in taste than the coffee product of this invention.

### Example 22

Five hundred pounds of a blend of low quality Robustas, intermediate quality Brazils, and low quality Arabicas each on a 33⅓ percent weight basis are roasted in a Jubilee roaster at air temperatures maintained within the range of 400°-435° F. The weight ratio of low quality to intermediate quality coffees is 2:1. The end roast temperature is 435° F. The total roast time is 15 minutes; and the roast is quenched with 9 gallons of water.

One hundred pounds of the above referred to blended and roasted coffee beans are ground to regular grind size in a Gump pilot grinder and used to prepare flaked roast and ground coffee in the following manner. The coffee is choke fed into a Farrell two-roll mill; the roll pressure is 6000 lbs./inch of nip; the roll surface temperature is 100° F., the roll peripheral surface speed is 35 ft./min. and the coffee moisture level 3.2 percent. The thickness of the coffee flakes produced is 0.0145 inch. The flake bulk density is 0.47 g./cc.

Five hundred pounds of high quality prime Arabica roast and ground coffee, known as Colombians is roasted and ground as described earlier in Example 21. A 25 pound portion of the high quality prime roast and ground coffee, regular grind size, is placed in a loading hopper mounted above a falling chute riffle blender; and likewise the 100 pounds of flaked roast and ground coffee is placed in a second loading hopper mounted above the blender. The high grade prime roast and ground coffee particles are gravity fed into the blender at a rate of 10 lbs./min. and the flaked roast and ground coffee is gravity fed into the blender at a rate of 40 lbs./min. The admixed product is collected at the bottom of the blender. The percent of ground coffee in the mixture was 20 percent.

A panel of four expert tasters prepared cups of coffee from the admixed product in the manner previously described in Example 21. The experts noted about a 25 percent increase in strength in comparing the improved roast coffee product beverage with conventional roast and ground coffee beverage. Besides the strength increase the panel also noted that the coffee product of this invention was flavor laden with aromatic and volatile constituent flavor notes.

While in Examples 21 and 22 the method of preparing brewed cups of coffee from the coffee product of this invention was percolation, other equally suitable brewing methods can also be employed such as the drip method or the vacuum pot method.

For a detailed description of a preferred method of making roast and ground coffee flakes useful in the practice of my invention see application Ser. No. 823,942, filed May 12, 1969, of McSwiggin et al., entitled “A Method of Making Flaked Roast and Ground Coffee.” Another application, Ser. No. 823,900, filed May 12, 1969, of Menzies et al., entitled “A Method of Starve Feeding Coffee Particles,” shows a further process improvement in the process of roll milling coffee particles to produce coffee flakes.

### Example 23

A blend of commercially sold roast and ground intermediate quality coffees, regular grind size comprising 25 percent African Naturals and 75 percent Brazils, was obtained. Five hundred pounds of this blend was used to prepare flaked coffee in the following manner. The coffee was choke fed into a Farrel two-roll mill at a roll pressure of 4000 lbs./inch of nip. The roll surface temperature was 100° F.; the roll peripheral speed was 4 ft./minute; and the coffee moisture level was 4.5 percent. The thickness of the flake produced was 0.016 inch and the flake bulk density was 0.45 g./cc. The flake moisture content was 4.5 percent and the flake Hunter Color “L” scale value was 21. The flakes were of a proper size dimension such that 3.0 percent of them pass through a 40 mesh U.S. Standard Screen and not more than 35 percent remains on a 12 mesh U.S. Standard Screen.

Photomicrographs of the above described roast and ground coffee flakes showed substantially complete (nearly 100 percent) cellular disruption.

A panel of four expert tasters prepared cups of coffee from the flaked coffee product in the manner previously described in Example 21. The panel compared the taste and aroma of coffee brewed from the flaked intermediate quality coffee product with conventionally prepared coffee beverage prepared from regular grind Folger roast and ground coffee. The experts noted that the flaked coffee product was about 33 percent stronger in taste than coffee brewed from standard roast and ground coffee, regular grind size. In further comparing the flaked product with a roast and ground coffee product prepared from the same intermediate quality coffee blend, the panel noted the strength increase was coupled with a slight loss of natural aroma and a noticeable increase in the characteristic flavor of intermediate grade Brazils and African Naturals.

When the flaked intermediate grade coffee of this example is admixed with high grade coffee grounds (85 percent flakes and 15 percent grounds) and cups of beverage prepared therefrom the panel rates the product as of good aroma and flavor.

### Example 24

Three hundred and one pounds of low grade Robustas were roasted in a Jubilee roaster at air temperatures maintained within the range of 400°-550° F. The end roast temperature was 450° F. The total roast time was 19 minutes, and the roast was quenched with 6 gallons of water.

Fifty pounds of the above referred to roasted Robusta coffee beans are ground to regular grind size in a Gump pilot grinder and used to prepare flaked roast and ground coffee in the following manner. The coffee was choke fed into a Farrel two-roll mill; the roll pressure was 4000 lbs./inch of nip; the roll surface temperature was 100° F.; the roll peripheral surface speed was 6 ft./minute and the coffee moisture level, 4.5 percent. The thickness of the Robusta flake produced was 0.015 inch and the flake bulk density was 0.45 g./cc. The flake moisture content was 4.0 percent by weight and the flake Hunter Color “L” scale value was 23.

A panel of four expert tasters prepared cups of coffee from the flaked Robusta product in the manner previously described in the above Examples 21-23. The experts noted that there was a substantial decrease of natural Robusta flavor in the coffee beverage produced from the flaked Robustas. Additionally, the panel noted a flavor and aroma enhancement in the flaked Robusta over unflaked Robusta in that the bitterness and rubbery note usually characteristic of Robusta was much less dominant.

When the flaked low grade coffee of this Example is admixed with high grade coffee grounds (70 percent flakes and 30 percent grounds), and cups of beverage prepared therefrom, the panel rates the product as of good aroma and acceptable flavor.

### Example 25

Four hundred pounds of a blend comprising high quality Arabicas is roasted in a Thermalo roaster at air temperatures maintained within the range of 400°-550° F. The end roast temperature is 430° F. The total roast time is 16 minutes and the roast is quenched with 7 gallons of water.

The above referred to high quality roasted blend is ground to regular grind sizes in a Gump pilot grinder and used to prepare flaked roast and ground coffee in the following manner. The coffee is starve fed into a Lehman two-roll mill; the roll pressure is 3000 pounds/inch of nip; the roll surface temperature is 100° F.; the roll peripheral speed is 184 ft./minute and the coffee moisture level 4.5 percent. The thickness of the flakes produced is 0.0135 inch and the flake bulk density is 0.425 g./cc. The flake moisture content is 4.0 percent by weight and the flake Hunter Color “L” scale value is 20.

A panel of four expert tasters prepared cups of coffee from the roast and ground high quality compressed coffee flakes in the manner previously described in Example 21. In comparing the flaked coffee of this example with regular grind Folger roast and ground coffee and roast and ground high quality coffee particles, the panel notes the flaked coffee is about 33 percent stronger in taste than the regular grind Folger, and lacking in characteristic prime quality flavor and aroma notes. In comparison with the high quality ground but not flaked product, the same distinctions are noted except the lack of prime flavor and aroma is even more noticeable.

### Example 26

Four Hundred pounds of a blend comprising 25 percent high quality Arabicas, 43.75 percent Brazils, 6.25 percent low quality Arabicas and 25 percent Robustas is roasted in a Thermalo roaster at air temperatures within the range of from 400° F. to 550° F. The end roast temperature is 430° F. The total roast time is 16 minutes and the roast was quenched with 7 gallons of water.

Four hundred pounds of the above referred to roasted blend is ground to regular grind size in a Gump pilot grinder. The roast and ground coffee moisture level is 4.0 percent. The regular grind roast and ground coffee is used to prepare flaked roast and ground coffee in the following manner: The coffee is choke fed into a Lehman two-roll mill. The roll mill is further characterized by having rolls of a 13 inch diameter. The roll pressure is 3,000/inch of nip; the roll surface temperature is 140° F.; and the roll peripheral speed of each of the rolls is 500 ft./min.

The thickness of the flakes produced is 0.011 inches, and the flake bulk density is 0.44 grams/cc. The moisture content of the resulting flaked coffee is 4.0 percent. The yield on a weight basis of flaked coffee is 92 percent.

A panel of four expert tasters prepares cups of coffee from the flaked coffee in the following manner: The amount of flaked coffee used is 7.2 grams/cup; the amount of water used per cup is 178 milliliters; the coffee is placed in a conventional percolator and allowed to perk until the temperature reaches 180° F. at which time the coffee beverage is poured into cups to be tasted by the expert panel. The panel compares the taste of coffee brewed from the hereinbefore described flakes with conventionally prepared coffee beverage prepared from regular grind Folger roast and ground coffee. The experts note that the beverage produced from the flaked coffee was about 33 percent stronger in taste than the coffee brewed from standard roast and ground coffee regular grind size. In comparing the beverages produced from flaked coffee and ground coffee, the panel notes that little or no flavor degradation of the flaked coffee had occurred.

Subsequent packaging tests reveal that the hereinbefore described flakes exhibit a very low incidence of flake breaking, indicating the flakes are of high structural integrity. The product bulk density does not change significantly after packing as a result of this low breakage incidence.

Substantially similar results are obtained when the roast and ground coffee particles utilized in the example are decaffeinated particles in that high yields of consumer acceptable flakes of high structural integrity are produced.

### Example 27

Seventy pounds of a blend comprising 30% high quality Arabicas, 30% Brazils, and 40% Robustas are roasted in a Probat/Jubilee roaster to endpoint temperatures within the range of from about 230° C. to 260° C. in about 12 min. total roast time. The roasted beans are quenched with about 6.75 liters of water. The roast coffee is then halved into two portions. One half is used for a control production of thick-flaked roast and ground coffee, while the remaining half is utilized for the production of thin-flaked roast and ground coffee.

Portions of the above-blended roast coffee beans are ground coarser than a regular grind size in a Gump pilot grinder. A sample of the ground coffee is taken for analysis. A sieve screen analysis indicates that 30% by weight remains on a No. 12 U.S. Standard sieve, 70% by weight is retained on a No. 16 U.S. Standard sieve, while 85% by weight remains on a No. 20 U.S. Standard sieve and 95% by weight remains on a No. 30 U.S. Standard sieve. The moisture level is about 4.4% by weight. The coarse grind size roast and ground coffee is starve-fed by dropping a cascade of the particles into the rolls of a “Ross” two-roll mill set at zero static gap, each roll being of about 46 cm diameter. The feed rate is about 575 kg/meter of nip per hour, while the roll pressure is adjusted to provide a pressure of 250 kilonewtons/meter of nip. Each roll is operated at a peripheral surface speed of about 300 meters per minute and at an average roll surface temperature of about 16° C. The thin-flaked coffee particles dropping from between the rolls are gravity-fed into a hopper. The result sieve analysis is: about 50% passes through a No. 30 U.S. Standard sieve. The product had a bulk density of 0.44 g./cc. and a moisture level of 4.4% by weight.

The flaked coffee product is characterized by an average flake thickness of 0.16 mm in the following manner: 100 grams of the thin-flaked coffee is poured onto U.S. Standard No. 12 circular sieve and is agitated by a “Ro-Tap” sieve shaker (manufactured by U.S. Tyler Co.) for three minutes. The thin-flaked coffee which passes through the No. 12 sieve is thereafter similarly screened using a U.S. Standard sieve No. 16. From the portion remaining on the No. 16 sieve, ten (10) representative flakes from the portion remaining on the No. 16 sieve are selected for flake thickness measurement. Each representative thin-flake particles are measured for thickness using a Starrett Model 1010 gauge manufactured by L. S. Starrett Co. The ten-flake thickness measurements are averaged to characterize the average flake thickness.

The thin-flaked coffee product prepared in the above-described manner exhibits increased extractability of the water-soluble constituents and produces a coffee brew characterized by lower acididty.

### Example 28

The second half of the roast portion referred to hereinbefore was ground to a “regular” grind particle size and was made into thick flakes by a control process utilizing the roll mill described in Example 27, except that each roll was adjusted to a static gap setting of about 0.75 mm, to the peripheral surface speed of 30 meters per minute, and to a roll surface temperature of 21° C. Starve feeding at a rate of 1700 kg per hour per meter of nip and a roll pressure of 175 kilonewtons per meter of nip is employed. The thick-flaked coffee that is removed from the roll mill is characterized by a thickness of 0.38 mm. This product corresponds to a prior art flaked coffee product made in accordance with the process disclosed in U.S. Pat. No. 3,615,667, issued Oct. 26, 1971 to F. M. Joffc.

### Example 29

Some thin-flaked coffee is made using a prior art flaking method, as follows:

Three hundred pounds of a blend comprising 30% high quality Arabicas, 30% Brazils and 40% Robustas are roasted in a Thermalo roaster to endpoint temperature within the range of 230°-260° C. in about 10 minutes total roast time. The roasted beans are quenched with about 29.5 liters of water.

The roast coffee is ground to a “regular” grind particle size and made as described by McSwiggin, U.S. Pat. No. 3,660,106.

Each roll was adjusted to zero static gap, to the peripheral surface speed of about 120 meters per minute, and to a roll surface temperature of about 65° C. Starve feeding at a rate of about 1340 kg per hour per meter of nip and a roll pressure of about 250 kilonewtons per meter of nip is employed. The thin-flaked coffee particles dropping from between the rolls are gravity-fed into a hopper. The resultant sieve analysis is: about 20% by weight passes through a 30 mesh U.S. Standard sieve. The product has a bulk density of 0.42 gm/cc and a moisture level of 6.1% by weight. The thin-flaked coffee product is characterized by an average flake thickness of 0.21 mm.

### Microscopic Evaluation Test in the Eighth Group of Embodiments and Examples 27-29

Samples of the flakes from Examples 27 and 28 were microscopically viewed and photographed to determine and compare the degree of cellular disruption.

Embedding Procedure for Coffee Sections: For each sample received, 10-15 flakes of coffee are placed in each of two small round plastic vials, 15 mm in diameter and 8.5 mm in height. Epoxy is then added to the vials, to the upper edge. The composition of the epoxy is:

26 grams—Nonenyl Succinic Anhydride™

10 grams—Bakelite Epoxy Resin ERL-4206™

8 grams—Epoxy Resin DER736™

0.4 grams—Dimethylaminoethanol

If the coffee pieces float to the surface of the epoxy, the vials are placed in a vacuum of 30 mm of mercury absolute pressure for approximately 5 minutes. If the pieces do not sink when the vacuum is released, the procedure is repeated until they do.

The vials are then held at 70° C. overnight (about 16 hours) to cure (harden) the epoxy. After curing, the plastic vial is cut away from each block, and the blocks are mounted in a hand-operated microtome. The microtome is set to cut sections 15μ thick. Sections are cut from both blocks for each sample and mounted in mineral oil on glass slides for examination and photographs.

The sections are examined and photographed on a “Zeiss Universal” Microscope equipped with a 35 mm camera using Kodachrome II Professional color film. The thin coffee flakes of Example 27 of the present invention had from 50% to about 100% of their microscopic observable internal and surface cells disrupted. However, the coffee flakes of Example 28 had from up to about 100% of their cells in the planar surface regions disrupted—their internal cells were somewhat distorted but a majority of those cells were observably undisrupted. Disruption as used herein means that a cell wall is observably fractured or substantially unidentifiable as cells at magnification of about 35×.

### Extraction Tests in the Eighth Group of Embodiments and Examples 27-29

The enhanced extractability of the thin-flaked coffee of the present invention compared with prior art coffees as a reference is demonstrated by the following procedure: A drip coffee extraction is performed by charging 57.0 g. of coffee to a Bunn OL20 12-cup coffee maker and allowing the coffee to be drip brewed. The brew is cooled to room temperatures and analyzed for solids content by index of refraction. The drip extraction is performed on (1) the invention, the thin-flaked roast and ground coffee product of Example 27, (2) the thick-flaked coffee product of Example 28, (3) a retail flaked roast and ground coffee, (4) a commercial flaked roast and ground coffee, and (5) a prior art thin-flaked coffee. The results of such extraction tests are set forth in the following Table 3.

TABLE 3

| | | | Titratable |
|---|---|---|---|
| | | Brew Solids | Acidity ml/g |
| | Coffee | Wt./% | Brew Solids |
| 1. | Example 27 (Invention) | 0.88 | 4.9 |
| 2. | Example 28 (Joffe - thick-flaked) | 0.79 | 5.4 |
| 3. | Retail flaked roast & ground coffee | 0.76 | 5.6 |
| 4. | Commercial flaked roast & ground | 0.79 | 5.4 |
| | coffee | | |
| 5. | Example 29 (McSwiggin-thin-flaked) | 0.82 | 5.2 |

As is apparent from an inspection of the data in Table 3, the thin-flaked coffee of the eighth group of embodiments, Coffee 1, provided a substantially higher extractability of brew solids and a substantially lower titratable acidity as compared with the prior art flaked coffees 2 and 5 and marketed thick-flaked coffees 3 and 4.

### Example 30

Seventy pounds of a blend comprising 30% high quality Arabicas, 30% Brazils, and 40% Robustas was roasted in four approximately equal portions in a Probat roaster to endpoint temperatures within the range of from 450° F. to 500° F. The four separately roasted portions were each quenched with 1.75 gallons of water and were characterized by roast colors of 80, 70, 60 and 50 (photovolts), respectively.

Each of the four portions hereinbefore described was ground slightly coarser than a regular grind size in a Gump pilot grinder. The roast and ground coffee moisture level was about 5.7%. Each portion was halved. One half was used for a control production of roast and ground flakes while the remaining half was utilized for the production of high-sheen roast and ground flakes in the following manner: The coffee was passed by starve feeding into a Ross two-roll mill, each roll being of 18-inch diameter and adapted to independent adjustment of peripheral roll speed and surface temperature. The feed rate was 2.6 pounds per inch of nip per minute while the roll pressure was adjusted to 2400 pounds per inch of nip. A first (slower) roll was operated at a peripheral surface speed of 355 feet per minute and at a roll surface temperature of 70° F. while the second (faster) roll was operated at a peripheral surface speed of 1415 feet per minute (4:1 speed differential) and at a roll surface temperature of 180° F. Flaked coffee particles dropping from between the rolls exhibited a high-sheen appearance and were characterized by a thickness of 0.023 inch.

The second half of each roast portion referred to hereinbefore was made into flakes by a control process utilizing the roll mill described in Example 30, except that each roll was adjusted to the same peripheral surface speed of 471 feet per minute and a roll surface temperature of 70° F. Starve feeding at a rate of 3.3 pounds per minute per inch of nip and a roll pressure of 3400 pounds per inch of nip were employed. The flaked coffee removed from the roll mill was characterized by a thickness of 0.023 inch.

Utilizing the reflectance measurement technique described hereinbefore, the flaked coffee products of Example 30 and of the control process were measured. Measurements were taken for each side of the resulting flakes; the side in contact with the faster roll of the differential roll-speed process of Example 30 and exhibiting sheen is denoted as Side 1. The following results were obtained (Table 4).

TABLE 4

| | Reflectance Value From 6328A Beam | |
|---|---|---|
| Roast Color | Product of Example 30 | Control Product |

| (photovolts) | Side 1 | Side 2 | Side 1 | Side 2 |
|---|---|---|---|---|
| 80 | 48 | 34 | 20 | 17 |
| 70 | 41 | 19 | 15 | 10 |
| 60 | 45 | 22 | 18 | 19 |
| 50 | 44 | 21 | 24 | 22 |

As is apparent from inspection of the data of Table 4, each product of Example 30 exhibited considerably higher reflectance values than the control product.

### Example 31

Decaffeinated roast and ground coffee flakes were prepared in the manner of Example 30, utilizing the same method and operating conditions, except that the four roast portions were obtained by roasting, under the same conditions, a decaffeinated coffee blend. The decaffeinated blend comprised 30% high quality Arabicas, 30% Brazils, and 40% Robustas. Each decaffeinated separately roasted portion was halved and utilized in the production of flakes by the differential-roll speed and -temperature process and the control process described in Example 30. The results of reflectance measurements, made as described in Example 30, are set forth in Table 5 as follows:

TABLE 5

| | Reflectance Value From 6328A Beam | |
|---|---|---|
| Roast Color | Product of Example 30 | Control Product |

| (photovolts) | Side 1 | Side 2 | Side 1 | Side 2 |
|---|---|---|---|---|
| 80 | 37 | 15 | 13 | 11 |
| 70 | 40 | 20 | 16 | 13 |
| 60 | 50 | 21 | 15 | 18 |
| 50 | 57 | 17 | 11 | 11 |

The flaked decaffeinated product of Example 31 exhibited visually a high sheen. Comparison of reflectance values for the product of Example 31 with those of the control product, as is apparent from Table 5, illustrates the considerably higher reflectance of the flakes produced by the differential-roll speed and -temperature process of the invention.

### Example 32

The extractability of flaked coffee of the ninth group of embodiments was determined by the following extraction method. A slurry extraction was performed by adding 8.1 grams of coffee flakes to 200 ml. of boiling water, brewing for 3 minutes and straining the spent grounds from the brew which was cooled to room temperature and analyzed for solids content. In each case, the flaked coffee sample was the fraction through U.S. 12 mesh but on 16 U.S. mesh so as to avoid interference by high levels of rapidly extractable fines. The slurry extraction was performed on the regular and decaffeinated products of Examples 30 and 31 and on their respective controls with the results set forth in the following Table 6.

TABLE 6

| | | |
|---|---|---|
| Roast Color | Brew Solids | % |
| (photovolts) | (Wt. %) | Increased |

| Regular Blend | Control | Product of Ex. 30 | Extraction |
|---|---|---|---|
| 80 | 0.60 | 0.72 | 20 |
| 70 | 0.60 | 0.68 | 13 |
| 60 | 0.70 | 0.81 | 13 |
| 50 | 0.68 | 0.87 | 28 |
| | | | Avg. 18.5% |
| Decaffeinated | | | |
| Blend | Control | Product of Ex. 31 | |
| 80 | 0.43 | 0.52 | 21 |
| 70 | 0.44 | 0.54 | 23 |
| 60 | 0.50 | 0.60 | 20 |
| 50 | 0.62 | 0.71 | 15 |
| | | | Avg. 19.8% |

As is apparent from inspection of the data of Table 6, the regular and decaffeinated products of Examples 30 and 31, prepared by a process of differential-roll speed and -temperature milling, exhibited higher extractability compared with the products of their respective controls. This was especially true for the decaffeinated products.

### Example 33

A blend of coffee composed by weight of 35% Arabica milds, 40% Brazilians and 25% Robustas is roasted to a roast color of 80. The resulting blend is halved, one half being ground in a Gump pilot grinder to a regular grind and one half being ground to a coarse grind. The Coarse ground coffee is dropped from a vibrating chute between the rolls of a Ross two-roll mill at a starve rate feed of 2.8 pounds per inch of nip per minute. The roll mill, adjusted to a roll pressure of 2400 pounds per inch of nip and equipped with a pair of 18-inch rolls is operated such that a first roll has a peripheral surface speed of 400 feet per minute and a surface temperature of 70° F. and the second roll has a peripheral surface speed of 1600 feet per minute (4:1 ratio) and a surface temperature of 190° F. Roast and ground coffee flakes of high sheen and extractability are removed from the mill. A coffee product is prepared by mixing 50 parts by weight of the regular grind referred to above with 50 parts of the high-sheen flakes. The resulting product has a distinctive sheen and when brewed in conventional manner provides a pleasing and flavorful brew.

### Example 34

A blend of green coffee composed by weight of 33% Arabica milds, 33% Brazilians and 33% Robustas is decaffeinated by conventional solvent decaffeination and roasted to a 60 roast color. The decaffeinated roast and ground blend is halved and one half is ground to a regular grind on a Gump pilot grinder while the second half is coarse ground. The coarse ground portion is starve fed at a rate of 3 pounds per inch of nip per minute by dropping a cascade of the particles from a feed hopper into the rolls of a Ross two-roll mill. The mill, comprising two 18-inch rolls and adjusted to provide a pressure of 2400 pounds per inch of nip, is operated such that a first roll has a peripheral surface speed of 300 feet per minute and a surface temperature of 65° F. and a second roll has a peripheral surface speed of 1500 feet per minute (5:1 ratio) and a surface temperature of 190° F. A decaffeinated coffee product is prepared by admixing 40 parts by weight of the high-sheen flakes removed from the roll mill and 60 parts of the regular grind. The product exhibits an attractive physical appearance and brewed in a conventional manner provides a flavorful decaffeinated brew which compares favorably with non-decaffeinated brews.

### Example 35

Washed Arabica coffees from Guatemala having a Standard Green Titratable Acidity of 2.2 were fast roasted on a batch Thermalo roaster with a 100 pound charge to a roasted bean temperature of 441° F. (227° C.), achieving a roast color of 15.6 Hunter L with a roast time of 226 seconds. The coffee was then quenched to 3.9% moisture and yielded a whole roast density of 0.32 g/cc. The coffee was then ground to an average particle size of 850 μm and then flaked to a 14 mil flake thickness. The product provided a coffee brew with a brew absorbance of 1.72, a Titratable Acidity of 1.77, and brew solids of 0.51%.

### Example 36

Washed Arabicas from Colombia having a Standard Green Titratable Acidity of 2.7 were fast roasted on a Probat RZ2500SY continuous roaster with a roast time of 120 seconds, a hot air temperature of 635° F. (335° C.), achieving a roast color of 15.9 Hunter L and a whole roast density of 0.36 g/cc. The roasted coffee was quenched to 4.7% moisture and then cooled with air. The cooled beans were than ground to an average particle size of 950 μm and then flaked to a 14 mil flake thickness. The product provided a coffee brew with a brew absorbance of 1.52, a Titratable Acidity of 2.60, and brew solids of 0.49%.

### Example 37

A blend of Arabicas from Central and South America having a Standard Green Titratable Acidity of 2.4 were fast roasted on a Probat RZ25005Y continuous roaster with a roast time of 120 seconds, a hot air temperature of 675° F. (357° C.), achieving a roast color of 16.7 Hunter L and a whole roast density of 0.34 g/cc. The roasted coffee was quenched to 4.4% moisture and then cooled with air. The cooled beans were then ground to an average particle size of 1000 μm and then flaked to a 14 mil flake thickness. One ounce of the product was added to a filter pack with impermeable side walls. The filter pack coffee product provided a coffee brew with a brew absorbance of 1.44, a Titratable Acidity of 2.39, and brew solids of 0.50%.

### Example 38

The whole roasted beans from Example 36 were ground to an average particle size of 900 μm and then flaked to a 10 mil flake thickness. The product provided a coffee brew with a brew absorbance of 1.60, a Titratable Acidity of 2.70, and brew solids of 0.51%.

### Example 39

A blend of Decaffeinated Washed Arabicas from Central America and Colombia having a Standard Green Acidity of 2.35 were fast roasted on a Probat RZ2500SY continuous roaster with a roast time of 120 seconds, a hot air temperature of 607° F. (319° C.), achieving a roast color of 15.9 Hunter L and a whole roast density of 0.36 g/cc. The roasted coffee was quenched to 4.5% moisture and then cooled with air. The cooled beans were then ground to an average particle size of 1025 μm and then flaked to a 14 mil flake thickness. The product provided a coffee brew with a brew absorbance of 1.42, a Titratable Acidity of 2.30, and brew solids of 0.44%.

### Example 40

The whole roasted beans from Example 35 were blended with whole roasted beans from Example 36 in a weight ratio of 70:30. This bean blend was then ground to an average particle size of 900 μm and then flaked to a 14 mil flake thickness. The product provided a coffee brew with a brew absorbance of 1.67, a Titratable Acidity of 2.02, and brew solids of 0.50%.

### Example 41

The whole roasted beans from Example 36 were ground to an average particle size of 390 μm. The product provided a coffee brew with a brew absorbance of 1.52, a Titratable Acidity of 2.50, and brew solids of 0.46%.

### Example 42

Natural Robustas from Uganda having a Standard Green Acidity of 1.63 were fast roasted on a batch Thermalo roaster with a 100 pound charge to a roasted bean temperature of 448° F. (231° C.), achieving a roast color of 15.3 Hunter L with a roast time of 219 seconds. The coffee was then quenched to 4.0% moisture and yielded a whole roast density of 0.34 g/cc. This whole roast was then ground to an average particle size of 400 μm. This ground product was then blended with the flaked coffee from Example 38 in weight ratio of 5:95. (At the 5:95 ratio, the equivalent Standard Green Titratable Acidity for the total blend was 2.6.) The blended product provided a coffee brew with a brew absorbance of 1.77, a Titratable Acidity of 1.89, and brew solids of 0.50%.

### Example 43

The ground coffee from Example 41 was blended with flaked coffee from Example 35 in a weight ratio of 50:50. The product provided a coffee brew with a brew absorbance of 1.67, a Titratable Acidity of 2.15, and brew solids of 0.47%.

### Example 44

The flaked coffee from Example 38 was brewed using a standard brew set up, except that the brewer was modified so that only 750 ml of water was added in 85 seconds to the brew basket. The resultant brew resembled an “espresso” style coffee beverage which could be used for Cappuccinos, Lattes, etc. Also, this concentrated brew was diluted with 1100 ml of hot distilled water to a final normal brew volume of 1800 ml which provided a coffee brew with a brew absorbance of 1.38, a Titratable Acidity of 2.38, and brew solids of 0.45%. In addition, the amount of water added to the brewer was varied from 400 to 1200 ml to change the strength of the “espresso” style coffee beverage. Also, the coffee weight added to the brew basket was varied from 1 to 3 ounces to change the strength of the “espresso” style coffee beverage. Also, the equivalent amount of water added to dilute the coffee was varied from 300 to 2000 ml to deliver a range of coffee strengths from “very strong,” “strong,” “medium,” “mild,” to “very mild.”

### Example 45

A flaked coffee product particularly suitable for use in a ½-gallon brewer is prepared as follows. One thousand pounds of a blend comprising 25 percent high quality Arabicas, 38.75 percent Brazils, 6.25 percent low quality Arabicas and 30 percent Robustas is roasted in a Jetzone roaster at air temperatures within the range of from 590° F. to 600° F. The total roast time is 67 seconds and the roast is then quenched with cool air to a temperature below 65° F. (18° C.).

The roasted blend is ground to coarse grind size in a Gump pilot grinder. After grinding, water is sprayed onto the ground beans to increase their moisture level to about 6.0%. The coarse grind roast and ground coffee is then starve-fed by dropping a cascade of the particles into the rolls of a “Ross” two-roll mill. The feed rate of the particles is about 130 lbs./hr./linear inch of nip. The two-roll mill is set at zero static gap, and each roll is about 18.1 inches (46 cm) in diameter. The roll pressure is about 281 lbs./linear inch of nip. Each roll is operated at a roll peripheral surface speed of about 942 ft./minute. The surface temperature of the rolls is maintained between 60° F. (16° C.) and 80° F. (27° C.) by water cooling; the average surface temperature is about 70° F. (21° C.). The flaked coffee particles dropping from between the rolls are gravity-fed into a 12 mesh (U.S. Standard) Sweco screening device and are screened for 180 seconds.

The product coffee flakes have an average moisture level of 2.9% by weight. Additionally, the coffee flakes have a particle size such that 10% by weight of the particles remain on a No. 12 U.S. Standard Screen, 30% by weight remain on a No. 16 screen, 30% by weight remain on a No. 20 screen, 10% by weight remain on a No. 30 screen, and 20% by weight pass through a No. 30 screen. (A total of 30% by weight pass through a No. 20 screen.) The product has an average flake thickness of 0.008 inch (0.20 mm).

When 48.2 g of the flaked coffee is brewed in a Bunn OL-20 ½-gallon brewing machine with ½ gallon of water, the brew solids yield is 0.92%.

### Example 46

A flaked coffee product is prepared as described in Example 45, with the following changes. After roasting and grinding, the coffee beans are sprayed with water to a moisture level of about 6.0%. The feed rate to the mill is about 160 lbs./hr./inch. The roll pressure is about 75 lbs./linear inch of nip. The roll peripheral speed of each roll is about 942 ft./minute. The particles are not screened after flaking.

The product coffee flakes have an average moisture level of 5.5% by weight. The flakes have a particle size such that 7.9% by weight remain on a No. 12 screen, 20.8% by weight remain on a No. 16 screen, 30% by weight remain on a No. 20 screen, 16.7% by weight remain on a No. 30 screen, and 24% by weight pass through a No. 30 screen. (A total of 40.7% by weight pass through a No. 20 screen.) The average flake thickness is 0.012 inch. When 283.5 g of the flaked coffee is brewed with 3 gallons of water in a Cecilware FE-100 urn brewer, the brew solids yield is 0.88%.

### Example 47

Seventy-five pounds of a blend comprising 30% high quality Arabicas, 30% Brazils and 40% Robustas is roasted in two approximately equal fractions in a Jubilee roaster to end point temperatures within the range of from about 450° F. to 500° F. in about 12 minutes total roast time. The two separately roasted fractions are quenched with 0.5 gallons of water and 1.0 gallons of water, respectively, and are characterized by a roast color of 75 photovolts. After equilibrating for 3 hours at 70° F. in separate storage bins, each fraction is cooled to a temperature 0° F. Thereafter, each fraction is separately ground slightly finer than a regular grind size in a Gump pilot grinder. Upon exiting the grinder, the fractions are at a temperature of 35° F. A sample of each fraction of the roast and ground coffee is taken for analysis. A sieve screen analysis of the first fraction indicates a particle distribution as follows:

| Sieve (U.S. Standard) | Wt. % |
|---|---|
| On No. 12 | 5% |
| Through No. 12 on No. 16 | 32% |
| Through No. 16 on No. 20 | 38% |
| Through No. 20 on No. 30 | 14% |
| Through No. 30 on Pan | 12% |

The moisture level of the first roast and ground coffee fraction is about 2.5% by weight and is therefore a “low-moisture” roast and ground coffee fraction. The second fraction has a similar particle size distribution and has a moisture level of about 5.5% by weight and is therefore a “high-moisture” roast and ground coffee fraction.

Both the low-moisture and the high-moisture roast and ground coffee fractions are halved into two portions. One-half of each fraction is used for a control production of non-mixed moisture flaked coffee, while the remaining half is utilized for the production of aggregated mixed moisture flaked coffee in the following manner:

A 19 pound portion of low-moisture roast and ground coffee is mixed with a 19 pound portion of high-moisture roast and ground coffee by simultaneously feeding it into a falling chute riffle blender at a feed rate of 500 lbs/hr. The temperature of the two fractions is 35° F. when entering the riffle blender. Upon exiting the riffle blender the mixture of high-moisture and low-moisture roast and ground coffee is at the temperature of 38° F. Thereafter, the roast and ground mixed moisture feed is starve-fed by dropping a cascade of the particles into the rolls of a Ross 2-roll mill which is set at a zero static gap, each roll being of 18 inch in diameter. The feed rate is 110 lbs./hr./in. of nip. The roll pressure is adjusted to provide a pressure of 1000 lbs./linear inch of nip. Each roll is operated at a peripheral surface speed of 1414 ft./min. and at an average roll surface temperature of 70° F. The aggregated mixed-moisture flaked coffee particles dropping from between the rolls are gravity fed into a 6 mesh Sweco screen and are screened for 30 seconds.

Fifty-five percent by weight pass through a 30 mesh U.S. Standard Sieve. The sieve-screened product has a bulk density of 0.445 g/cc, and an average moisture level of 4.2% by weight.

Ten representative flakes from the No. 16 sieve are selected for flake thickness measurement. Each is measured using a Starrett Model 1010 gauge manufactured by L. S. Starrett Company. The ten flake thickness measurements are averaged and are reported to the nearest whole number. The aggregated mixed-moisture flaked coffee product is characterized by an average flake thickness of 10 mils.

The aggregated mixed-moisture coffee product prepared in the above-described manner exhibits increased extractability of the water-soluble constituents and increased initial aroma level over the control product and exhibits acceptable drain time performance of 3.5 minutes.

Flaked coffee compositions of substantially similar physical and organoleptic character are realized when a low-moisture roast and ground fraction having an average moisture content of 2.0% by weight and a high-moisture roast and ground coffee fraction having an average moisture content of 6.0% by weight is used in Example 47.

### Example 48

Two batches of approximately 150 pounds each of regular green beans of a similar blend to that in Example 47 are roasted in a Thermalo roaster. The roasted coffee batches are water-quenched with 2.0 gallon and 4.0 gallons of water, respectively. Thereafter, the two coffee bean fractions are equilibrated for 3 hrs. at 70° F. The integrity of the respective moisture contents is maintained through separated coffee storage bins.

The first regular coffee bean fraction (2.0% moisture) is separately ground in Gump grinder along with 20 lbs. of dry ice having an average particle size of ¼ in. to form a “coarse” grind sized low-moisture ground coffee stream. Upon exiting the grinder, the coffee's temperature is 34° F. The second green bean fraction comprising 130 lbs. of roasted coffee beans (6.0% moisture) is simultaneously fed to the Gump grinder along with 20 lbs. of dry ice having an average particle size diameter of ¼ inch to form a “fine” grind sized stream with particle size distributions as follows:

| Sieve (U.S. Standard) | Coarse | Fine |
|---|---|---|
| On No. 12 | 30% | 0% |
| Through No. 12, remains on No. 16 | 43% | 6% |
| Through No. 16, remains on No. 20 | 15% | 32% |
| Through No. 20, remains on No. 30 | 6% | 40% |
| Pan | 6% | 22% |

The exit temperature of the high-moisture coffee from the grinder is 36° F. The two streams are added simultaneously to a common cement rotary mixer which is maintained at a room temperature and are mixed for one minute to achieve substantial uniform admixing. The well-mixed coffee temperature is 38° F.

Thereafter, the mixed moisture stream of regular roast and ground coffee is passed through a 2-roll mill, as in Example 47, except the feed rate is about 50 lbs./hr./in. and the roll peripheral surface speed is 1650 ft./min.

The aggregated mixed-moisture flaked coffee particles dropping from between the rolls are passed through a 6-mesh screen (U.S. Standard) to provide a product having a particle size distribution as follows:

| Sieve (U.S. Standard) | Weight |
|---|---|
| On No. 12 | 2% |
| Through No. 12, remains on No. 16 | 12% |
| Through No. 16, remains on No. 20 | 19% |
| Through No. 20, remains on No. 30 | 28% |
| Pan | 39% |

The flaked coffee has an average flake thickness of 12 mils. The product has a bulk density of about 0.45 g/cc. The product is brewed in a Norelco automatic drip coffee maker using 5.35 grams of flaked coffee for each 6 ounces of water and produces a coffee brew in 3 minutes and 30 seconds with 0.97% solids as determined by refractive index measurement. Thus, efficient extraction and rapid drainage are achieved.

Flaked coffee compositions of substantially similar physical and organoleptic character are realized when in the process of Example 48, the flake thickness of the coffee flake aggregates is 12 mils.

### Example 49

Two hundred and ten pounds per minute of a coffee bean blend comprising 50% high quality Arabicas, 30% Brazils, and 20% Robustas are roasted in a Jabez-Burns 21-R continuous roaster at 12 RPM. The roasting temperature is 445° F., the residence time in the roaster is 3.17 minutes and the flight loading is 17.5 pounds. The roasted beans are quenched to a 2.5% moisture level with 2.4 gallons/min. of water. The color of the roast is 79 photovolts. A second stream of coffee of a similar blend is roasted at the same rate and in a similar manner with the exception of quenching to a 5.5% moisture level with 4.9 gallons/min. of water. After equilibrating for 48 hours at 0° F. in separate storage bins, each fraction is ground very coarse in a Gump grinder. A sample of each fraction of the roast and ground coffee is taken for analysis. The particle size distribution analysis of the fraction show:

| U.S. Standard Sieve | Wt. % |
|---|---|
| Remains on No. 12 mesh | 75% |
| Remains on No. 16 mesh | 10% |
| Remains on No. 20 mesh | 8% |
| Remains on No. 30 mesh | 4% |
| Passes through No. 30 mesh | 3% |

One hundred pounds of each of the high and of the low-moisture coffees are simultaneously fed into a falling chute riffle blender. The mixture is about 35° F. when entering the riffle blender. Upon exiting the blender, the high moisture and low moisture mixture is about 38° F. Thereafter, the roast and ground mixed-moisture feed is starve-fed by dropping a cascade of particles into the rolls of a Ross 2-roll mill of dimensions stated in Example 47. The feed rate is 100 lbs./hr./in. while the roll pressure is adjusted to provide 225 lbs./linear inch of nip. The aggregated mixed moisture flaked coffee particles dropping from between the rolls are gravity fed into a Sweco screening device and were screened for 10 seconds. The resultant sieve analysis is:

| Sieve Size, U.S. Standard Sieve | Wt. % |
|---|---|
| Remains on No. 12 | 6% |
| Remains on No. 16 | 18% |
| Remains on No. 20 | 23% |
| Remains on No. 30 | 22% |
| Passes through No. 30 | 31% |

The sieve-screened product has a bulk density of 0.405 g/cc. and an average moisture level of 4.0% by weight. The aggregated mixed-moisture flaked coffee product is characterized by an average flake thickness of 0.016 inch.

The aggregated mixed-moisture coffee product prepared in the above-described manner exhibits increased extractability of the water-soluble constituent, and acceptable drain time performance. The initial aroma level of this product is about 45,000 GC counts.

### Testing and Evaluation of Initial Aroma Level in the Twelfth Group of Embodiments Including Examples 47-49

The present aggregated flaked coffee compositions provide superior levels of coffee aroma in the headspace or voidspace of canisters holding the vacuum packed coffee. Superior coffee aroma levels thus provide an enhancement of the pleasurable “fresh ground” coffee aroma upon the opening of the packed coffee. The superiority of the initial coffee aroma levels of the present flaked coffee compositions can be confirmed and quantified by resort to comparisons of the volatile materials concentration in the voidspace.

A suitable technique for measuring the initial coffee aroma of the flaked coffee aggregates produced by the process of the invention is gas chromatography. The flame ionization gas chromatograph analytical measurement herein measures the total content of organic compounds in a gas headspace or void-space sample from packaged coffee on a scale of relative intensity. The scale is graduated in microvolt-seconds (referred to herein as “counts”) which is a measure of the area under the intensity curve, and the result is reported as an integration of the total area under the curve in total microvolt-seconds (“total counts”).

### A. Principle of Operation in the Twelfth Group of Embodiments Including Examples 47-49

The chromatograph comprises a 36 inch chromosorb WAW (acid washed) 60/80 mesh column of ¼ in. diameter and is housed in an oven section for isothermal temperature control. The column is packed with a uniform sized solid called the solid support but is not coated with a non-volatile liquid (called the substrate) because the gas is not to be separated into individual compounds as is commonly done in this type of analysis. A hydrogen flame detector is used at the outlet port. An electrometer receives the output signal from the flame detector and amplifies it into a working input signal for an integration. The integrator both sends a display signal to a recorder to print out the response curve and electronically integrates the area under the curve.

The gas sample is injected into a heated injection port, and is immediately swept into the packed column by a carrier gas flow. The non-separated gas mixture is swept as a compact band through the column and into the detector. The detector then ionizes the sample and generates an electrical signal proportional to the concentration of the materials in the carrier gas. The ionized gases and carrier gas are then vented from the unit.

### B. Specific Equipment and Conditions in the Twelfth Group of Embodiments Including Examples 47-49

A Hewlett Packard gas chromatograph (Model 700), electrometer (Model 5771A), integrator (Model 3370A), and recorder (Model 7127D), range 0-5 my. and temperature controller (Model 220) were used. Nitrogen pressure in the column is approximately 16 psig. Air pressure of 24 psig is used to flush out the detector. An oven temperature of 100° C. is used and maintained to keep the volatiles vaporized. The hydrogen is supplied from a gas cylinder regulated at 30 lbs. psig.

### C. Analytical Procedure in the Twelfth Group of Embodiments Including Examples 47-49

Each peak is measured in counts, the counts being first measured by the flame detector and then both integrated and recorded. The number of counts for a particular component is directly proportional to the number of milligrams of that component in the vapor sample.

The recorder was synchronized with the integrator as follows:

### 1. Calibration

A standard methane gas is used to precisely set the flame ionization response. Prior to analyzing the samples, a 1 cc. sample of gas is obtained from a gas cylinder (0.5% by weight of CH.sub.4). The gas sample is at a pressure of 4.0 psig. The gas sample is syringed into the inlet port of gas chromatograph. The attenuation of the recorder is set at 8 while the range is 10. The total counts when the procedure is repeated three times average between 145,000 to 150,000 total counts. If the average is not within the specified range, the air flow rate is adjusted.

### 2. Sample Analysis

The sample must be vacuum packed for at least 3 days at 75°±5° F. before sampling. The container is placed in an airtight box supplied with a source of inert gas such as N₂. The vacuum-sealed canister of coffee is punctured to remove the vacuum, then resealed and allowed to equilibrate at least one hour at 75°±5° F. to allow aroma phase equilibration.

After equilibration, a 1 cc. sample of the aromatic atmosphere of the canister headspace/voidspace is taken again using the same type of syringe as used for the standard methane sample. The gas sample is then injected into the inlet port of the gas chromatograph.

TABLE 7
Initial Aroma Level

| | |
|---|---|
| Composition | Total G.C. Counts |

| | | |
|---|---|---|
| 1. | Retail Flaked Coffee | 16,000 |
| 2. | Institutional Flaked Coffee | 16,000 |
| 3. | Example 47 | 20,000 |
| 4. | Example 48 | 30,000 |
| 5. | Example 49 | 45,000 |

Superior initial aroma levels are demonstrated, for purposes of the present invention, by a GC total count of about 20,000 or above. Thus, it can be seen from the above Table that representative aggregated, mixed-moisture flaked coffee compositions of the present invention possess superior initial aroma levels inasmuch as their respective aroma levels all exceed 20,000 GC total counts. The commercially available institutional and retail flaked coffees fail to exhibit such superior initial aroma levels. As a result of the superiority of the initial aroma levels the compositions of the present invention provide surprisingly greater levels of the pleasant “fresh ground” coffee aroma. Also, the present flaked coffee compositions provide coffee brews of superior taste.

### Testing and Evaluation of Bed Permeability/Drain Time in the Twelfth Group of Embodiments Including Examples 47-49

The present aggregated flaked coffee compositions exhibit high bed permeabilities. High bed permeabilities enable the expeditious provision of coffee brew as measured by drain time. The term “drain time” as used herein has its art recognized meaning and refers to that time starting when the water delivery to the coffee bed ceases and stopping when the water level drops completely below the surface of the coffee particles at the top of the wet coffee bed.

### Specific Equipment and Operating Conditions

A Norelco-12 Automatic Drip Coffeemaker (“ADC”) Model No. 5135 is used for the drain time measurement herein. This device is consistent from cycle to cycle in water delivery rate and water temperature (180° F.). Moreover, the bed height in the Norelco-12 unit is higher than in most other commercial brewing devices so the testing is more rigorous. The Norelco-12 ADC consists of a water delivery unit with water reservoir and hot plate, a glass coffee carafe, and a coffee basket with lid. Paper filters (3½ in. disc type) are used in the bottom of the basket to prevent the grounds from falling into the coffee pot. An analytical balance is used for weighing the coffee sample. A 2000 ml. graduated cylinder is used for measuring the distilled water. A stop clock is used for measuring the drain time.

### Analytical Procedure

The water reservoir is filled with 1420 ml of distilled water. The coffee basket with filter is filled with 44.8 gm. of coffee. The measurement of the drain time begins at the point the water delivery stops and is considered complete when there is no longer any water on top of the coffee bed.

Analysis of several samples of the above products according to the described technique is given in Table 8 as follows:

TABLE 8
Drain Time Value

| Composition | | Drain Time (Minutes) |
|---|---|---|
| 1. | Retail flaked coffee | 2:00 |
| 2. | Institutional flaked coffee | 2:30 |
| 3. | Example 47 | 3:30 |
| 4. | Example 48 | 3:30 |
| 5. | Example 49 | 2:30 |
| 6. | Control Example 47 - 3% moisture flakes | 9:00 |
| 7. | Control Example 47 - 4% moisture flakes | 7:00 |

Drain times in excess of 5 minutes are commercially unacceptable. Thus, it can be seen from the above Table 8 that representative, mixed-moisture flaked coffee compositions of the present invention have commercially acceptable drain times, even though they have been cold processed. In contrast, the control products of Examples 47 and 48 which are prepared under equivalent conditions demonstrate poor drain times. The poor drain times result from inferior flake strength.

### Example 50

This example provides a method for obtaining instant coffee flakes polished to a high sheen. Unpolished instant coffee flakes used in the process were obtained in the following manner:

Conventional instant coffee particles obtained from a spray-drying process and having a bulk density of 19 pounds per cubic foot were used as the starting material. These instant coffee particles were blended with an aromatizing coffee oil. This was accomplished by placing the instant coffee particles in a two gallon paddle mixer operating at 20 r.p.m. and then adding an aromatizing coffee oil, which had been expressed from roasted coffee beans, in an amount so that the coffee oil comprised 0.2 percent of the coffee-oil mixture. Mixing was continued for about one minute at which time a homogenous blend was formed.

Milling the instant coffee particles into flakes was accomplished by passing the coffee-oil blend one time through a roll mill having two highly polished 16-inch diameter, 24-inch wide rolls, operating at the following conditions:

| | |
|---|---|
| Front roll peripheral speed | 200 feet per minute |
| Back roll peripheral speed | 200 feet per minute |
| Temperature of rolls | 170° F. |
| Nip pressure | 1,250 pounds per inch |

Light-colored, oil-containing (0.2 percent) flakes having a thickness of about 0.003 inch to about 0.007 inch and having a density of about 1.3 g./cc. were removed from the mill. The flakes were size-reduced on a stack of vibrating screens having one-fourth inch diameter glass beads thereon. The flakes were then size-classified by sifting through a U.S. Standard Screen No. 12 on to a U.S. Standard Screen No. 30. Those flakes retained on the U.S. Standard Screen No. 30 are polished.

The instant coffee flakes are polished in the following process.

A falling stream of the instant coffee flakes in the shape of a rod having a diameter of about one thirty-second inch is formed in the following manner:

The instant coffee flakes are fed from an overhead hopper to a vibrating horizontal vibratory feeder. The vibratory horizontal feeder is electrically driven in a known manner, and has a forward edge which is seven-eighths inch in width. The flakes are spilled from the forward edge of the vibratory feeder onto a forming plate. The forming plate is a fluted sheet of material having a single V-shaped trough, and is inclined such that the trough acts as a chute. The flakes spilled onto the forming plate by the vibratory feeder move down the trough of the plate and spill off as a discrete rod. A constant amount of instant coffee flakes is fed to the vibratory feeder such that the trough of the forming plate spills about 3 pounds of the flakes per hour.

The falling stream of instant coffee flakes is exposed to a jet of steam, the steam being at a temperature of about 212° F. The jet of steam is provided by the open end of a pipe having a diameter of three-fourths inch and connected to a source of steam. The open end of the pipe is situated approximately 3 inches below the forward edge of the vibratory feeder, approximately 3 inches from the falling stream of instant coffee flakes, and is directed, at an angle of about 90° with respect to the falling stream, to a portion of the stream which has a thickness of about one thirty-second inch. The velocity of the jet of steam is about 500 feet per minute at the point where the jet of steam is introduced to the falling stream of instant coffee flakes.

The instant coffee flakes polished by the jet of steam are collected on a vibrating inclined plane. The vibrating inclined plane is situated below and to the front of the open end of the steam pipe, and is electrically driven in known fashion. The vibrating plane disposed in this manner conveniently collects the polished instant coffee flakes, and delivers them to a moving endless belt conveyor exposed to heat lamps. The polished flakes are exposed to heat from the lamps, and heated to a temperature of about 130° F. until the flakes are dried to a moisture content of about 3.5 percent.

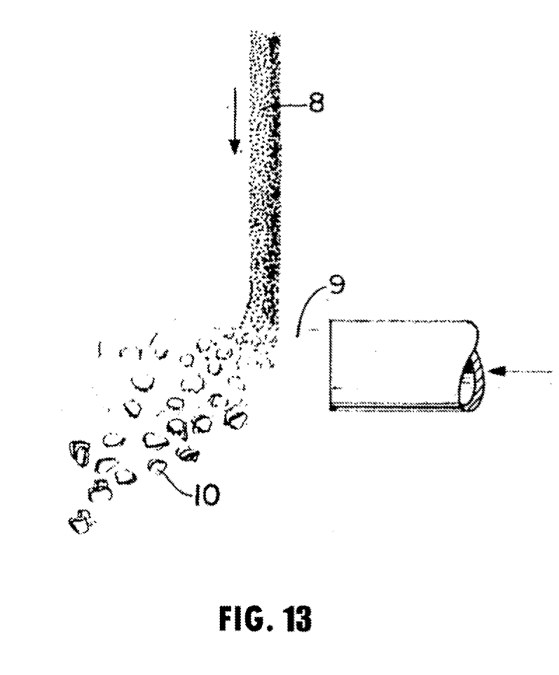

Instant coffee flakes are obtained in this process, which have at least one external planar face polished to a high sheen. An enlarged view of a typical instant coffee flake is illustrated in the Drawing by FIG. 13. FIG. 13 shows a planar instant coffee flake 1 having a planar surface 2 polished to a high sheen.

The instant coffee flakes obtained in this process were darkened to a brown color.

### Example 51

Instant coffee flakes are polished and agglomerated in the following process.

Unpolished instant coffee flakes such as those employed in Example 50 are formed into a falling stream of instant coffee flakes. The falling stream has the shape of a rod having a diameter of about one-half inch, and is formed in the following manner:

The instant coffee flakes are fed from an overhead hopper to a vibrating horizontal vibratory feeder. The vibrating horizontal feeder is electrically driven in a known manner, and has a forward edge which is seven-eighths inches in width. The flakes are spilled from the forward edge of the vibratory feeder onto a forming plate. The forming plate is a fluted sheet of material having a single V-shaped trough, and is inclined such that the trough acts as a chute. The flakes spilled onto the forming plate by the vibratory feeder move down the trough of the plate and spill off as a discrete rod. A constant amount of instant coffee flakes is fed to the vibratory feeder such that the trough of the forming plate spills about 60 pounds of the flakes per hour.

The falling stream of instant coffee flakes in the form of a rod having a diameter of 0.5 inch is exposed to a jet of steam, the steam being at a temperature of about 212° F. The jet of steam is provided by the open end of a pipe having a diameter of three-fourth inch and connected to a source of steam. The open end of the pipe is situated approximately 2 inches below the forward edge of the forming plate, approximately 2 inches from the falling stream of instant coffee flakes, and is directed at an angle of about 90° with respect to the falling stream. The velocity of the jet of steam is about 6500 feet per minute at the point where the jet of steam is introduced to the falling stream of instant coffee flakes. The instant coffee flakes are polished and agglomerated by the action of the jet of steam into structured instant coffee particles.

The structured instant coffee particles formed by the action of the jet of steam are collected on a smooth inclined plane. The inclined plane is situated below and to the front of the open end of the steam pipe. The particles move down the inclined plane by the force of gravity, and drop from the inclined plane onto a moving endless belt conveyor exposed to heat lamps.

The structured particles are exposed to the heat from the lamps, and heated to a temperature of about 130° F. until the particles are dried to a moisture content of about 3.5 percent. Structured instant coffee particles are obtained in this process which are non-planar, but which have a plurality of external planar surfaces exhibiting high sheen. An enlarged view of a typical structured instant coffee particle obtained in this process is illustrated in the Drawing by FIG. 11. FIG. 11 shows a structured instant coffee particle 3 which is nonplanar, but which has a plurality of external planar faces 4 exhibiting high sheen.

The structured instant coffee particles obtained in this process were darkened to a rich brown color.

### Example 52

A mixture of instant coffee particles comprised of instant coffee flakes and densified instant coffee powder was agglomerated in the following process.

Unpolished instant coffee flakes such as those employed in Example 50 were employed in this process. The instant coffee flakes were mixed with densified instant coffee powder such that a mixture comprised of 25 percent instant coffee flakes and 75 percent densified instant coffee powder was obtained. The densified instant coffee powder had a bulk density of 0.7 g./cc. and was comprised of particles within the size range of from 10 to 70 microns. The flakes and the powder had a moisture content of about 3.5 percent.

The mixture of instant coffee particles was fed from an overhead hopper to a vibrating horizontal vibratory feeder. The vibrating horizontal feeder is electrically driven in a known manner, and had a forward edge which is seven-eighths inches in width. The flakes were spilled from the forward edge of the vibratory feeder onto a forming plate. The forming plate was a fluted sheet of material having a V-shaped trough, and was inclined such that the trough acted as a chute. The flakes spilled onto the forming plate by the vibratory feeder moved down the trough of the plate and spilled off as a discrete rod having a diameter of about one-half inch. A constant amount of instant coffee flakes was fed to the vibratory feeder such that the trough of the forming plate spilled about 60 pounds of the instant coffee mixture per hour.

The falling stream of instant coffee was exposed to a jet of steam, the steam being at a temperature of about 212° F. The jet of steam was provided by the open end of a pipe having a diameter of three-fourths inch and connected to a source of steam. The open end of the pipe was situated approximately 2 inches from the falling stream of instant coffee, and is directed at an angle of about 90° with respect to the falling stream. The velocity of the jet of steam was about 6,500 feet per minute at the point where the jet of steam is introduced to the falling stream of instant coffee flakes. This process is illustrated by the Drawing wherein FIG. 13 shows a stream 8 comprised of a mixture of instant coffee flakes and densified instant coffee powder being introduced to a jet of steam 9, whereupon the instant coffee flakes are polished and agglomerated into structured instant coffee particles 10.

The structured instant coffee particles formed by the action of the jet of steam were collected on a smooth inclined plane. The inclined plane was situated below and to the front of the open end of the steam pipe. The particles moved down the inclined plane onto a moving endless belt conveyor exposed to heat lamps.

The structured particles were exposed to the heat from the lamps and heated to a temperature of about 130° F. until the particles were dried to a moisture content of about 3.5 percent.

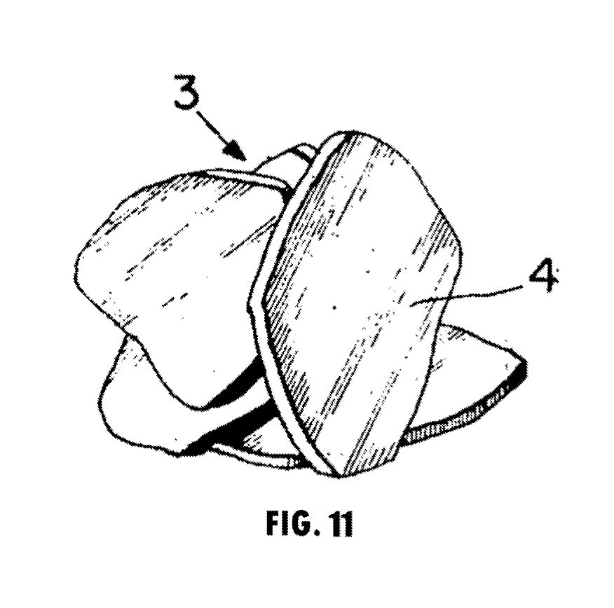

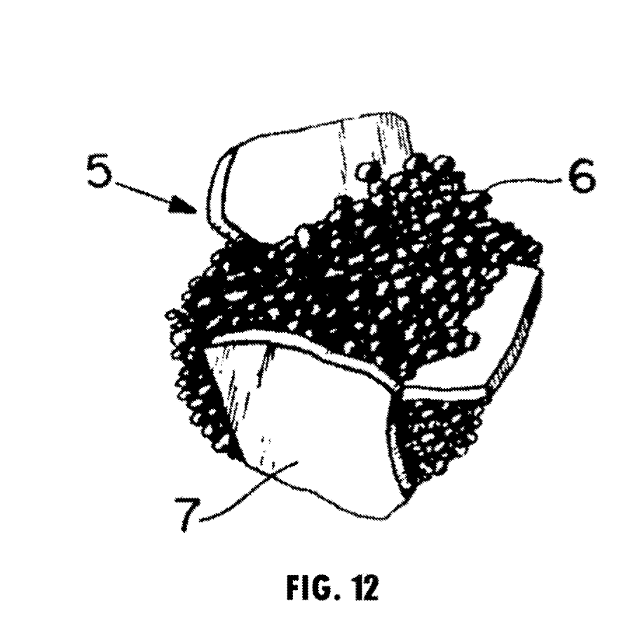

The structured instant coffee particles obtained were non-planar, but had a plurality of external planar surfaces polished to a high sheen. Magnification of the particles under a light microscope revealed fused densified coffee powder interposed among the polished planar instant coffee flakes. An enlarged view of a typical instant coffee particle obtained in this process is illustrated in the Drawing by FIG. 12. FIG. 12 shows a structured instant coffee particle 5 which is non-planar, but which has a plurality of external planar faces 7 polished to a high sheen. This structured instant coffee has good strength and stability, its strength being enhanced by fused densified instant coffee powder 6 in the particle.

The structured instant coffee particles obtained in this process were darkened to a rich dark red-brown color. This color is defined by Hunter Color values of: “L” scale, 18.3; a scale, +6.3; b scale, +6.9. A complete technical description of the Hunter Color value system can be found in an article by R. S. Hunter, “Photoelectric Color Difference Meter,” Journal of the Optical Society of America, Vol. 48, pp. 985-995, 1958.

The particles were size classified to obtain particles all of which passed a U.S. Standard Screen No. 6 and all of which were retained on a U.S. Standard Screen No. 30. These structured instant coffee particles had a bulk density of 0.32 g./cc. This bulk density is the usual range for instant coffee products and is equivalent to using about one teaspoon per cup to obtain a desirable coffee brew.

The particles were fast-dissolving and delectable coffee was made from them simply by adding hot water.

The free-flowing nature of this product was determined by a test generally referred to as the “angle of repose” test. In this test a Measurability Grade is obtained by computing the base angle of repose of a cone of instant coffee formed by pouring 30 grams of the coffee through a funnel onto a flat circular surface. The Measurability Grade thus ranges from 0° to 90° wherein the smaller the angle, the more free-flowing the product is.

These particles were more free-flowing than conventional instant coffee particles. This is shown by the fact that they have a Measurability Grade of 42.4° compared to a Measurability Grade of 45.5° for a conventional instant coffee powder.

The foam was measured by pouring hot water (200° F.) into a cup containing 2.0 grams of instant coffee. Five seconds after addition of the water, the foam in the cup was visually observed and compared to a set of ten standard photographs showing varying degrees of foam graded on a scale of 1-10 wherein a grade of 10.0 indicates essentially no foam and a grade of 1.0 indicates a very excessive level of foam. The foam in the sample cup was then assigned the grade of the photograph to which it most nearly corresponded.

These particles were low foaming compared to conventional instant coffee powders. This is shown by the fact that they have a Foam Grade of 7.5 compared to a Foam Grade of 2.5 for a conventional instant coffee powder.

### Beverage Units

In illustrative embodiments, the coffee compositions described above are designed to be used with the beverage units shown in FIGS. 1A, 1B, 1C and 14-26, and such beverage units are configured to be used with beverage making systems as exemplified in FIG. 27. When water is introduced into the beverage unit it comes into contact with the coffee composition generating a liquid coffee extract, which then exits the beverage unit to produce a coffee-containing beverage. However, aspects of the invention are not limited in this respect.

The container used for the beverage unit may take a variety of different forms, as long as it has at least one closed interior space for housing the coffee composition. The container may comprise a cup having a top opening and a first structure enabling the introduction of a liquid into the container, for example a lid. The cup may also include a a second structure enabling the release of the liquid out from the container, for example a member attached to bottom of the cup. Although the container may have a relatively rigid and/or resilient construction so that the container tends to maintain its shape, the container need not necessarily have a defined shape. To illustrate further, the container could also be made to have a more compliant and/or deformable arrangement, as is the case, for example, with some beverage sachets and pods.

FIG. 1A shows an illustrative example of a beverage unit 1100, a filterless cartridge having a closed interior space 610. A coffee composition 130 is loaded and confined inside the unit 1100 and the coffee composition 130 may comprise any coffee material that is suitable to be included in a beverage, for example, instant coffee, ultrafine roast and ground coffee, and any combination thereof. The coffee composition 130 may comprise one or more of other optional ingredients such as chocolate, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriceuticals, etc.), powdered milk or other creamers, sweeteners, thickeners, and flavorings.

FIG. 1B shows a beverage unit 1200 including a filter member 106, wherein a coffee composition 110 is loaded and confined inside the unit. Although the coffee composition 110 may comprise any coffee material such as regular roast and ground coffee, instant coffee, ultrafine roast and ground coffee, and any combination thereof, in typical embodiments, the coffee composition 110 comprises at least regular roast and ground coffee. The coffee composition 110 may comprise one or more of other optional ingredients such as chocolate, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriceuticals, etc.), powdered milk or other creamers, sweeteners, thickeners, and flavorings.

FIG. 1C shows a beverage unit 1200 wherein a coffee composition 110 and a beverage material 120 are loaded and confined inside the unit of FIG. 1B. The beverage material 120 may comprise any material that is suitable to be included in a beverage, for example, instant coffee, ultrafine roast and ground coffee, and any combination thereof. The beverage material 120 may also comprise one or more of other optional ingredients such as chocolate, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriceuticals, etc.), powdered milk or other creamers, sweeteners, thickeners, and flavorings. In another embodiment the beverage unit may include roast and ground coffee and a creamer and sweetener enabling the cartridge to form a cappuccino- or latte-like beverage. In another embodiment, the beverage unit may include coffee grounds and a hot chocolate material, allowing the beverage unit to form a mocha-type beverage. Other combinations will occur to those of skill in the art, such as leaf tea and a dried fruit material and creamer/sweetener, and so on.

Although illustrative embodiments of beverage units such as 1100 and 1200 are shown in FIGS. 1A, 1B and 1C, useful beverage units may also take many other forms with different outside appearances and structures and may include any suitable forms, such as pods, capsules, cartridges, sachets or any other arrangements.

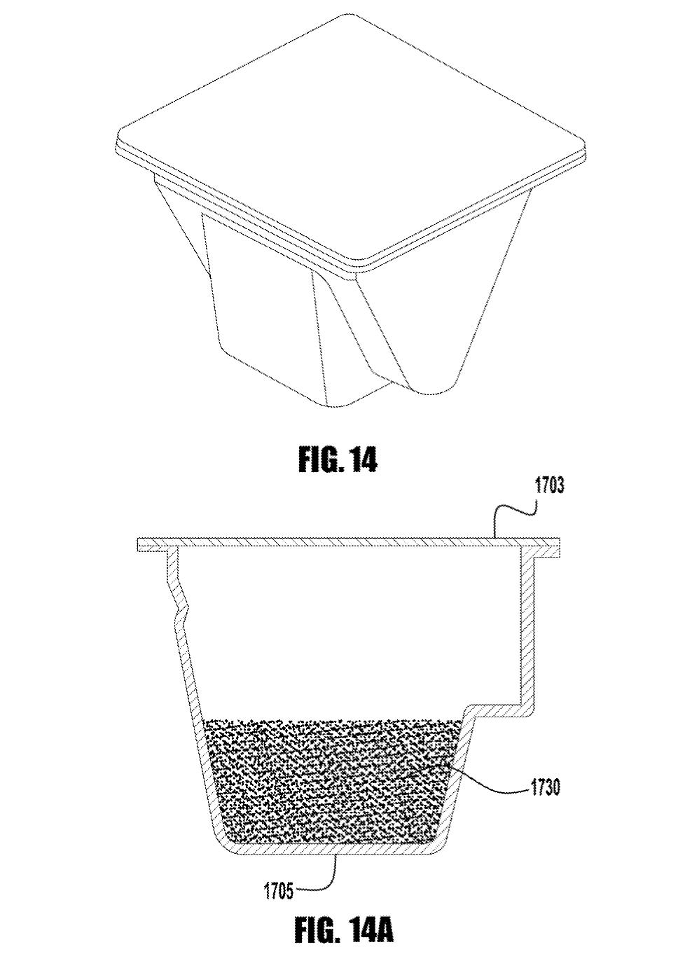

For example, FIG. 14 shows the perspective view of a beverage unit, which may or may not include a filter member.

FIG. 14A is a side cross-sectional view of a beverage unit as shown in FIG. 14, which does not include a filter member. With reference to FIG. 14A, coffee composition 1730 is loaded and confined inside the beverage unit.

FIG. 14B is a side cross-sectional view of a beverage unit as shown in FIG. 14, which includes a filter member. With reference to FIG. 14B, coffee composition 1710 is loaded and confined inside the beverage unit.

FIG. 14C is a side cross-sectional view of another beverage unit as shown in FIG. 14, which includes a filter member. With reference to FIG. 14C, coffee composition 1710 and coffee material 1720 are loaded and confined inside the beverage unit.

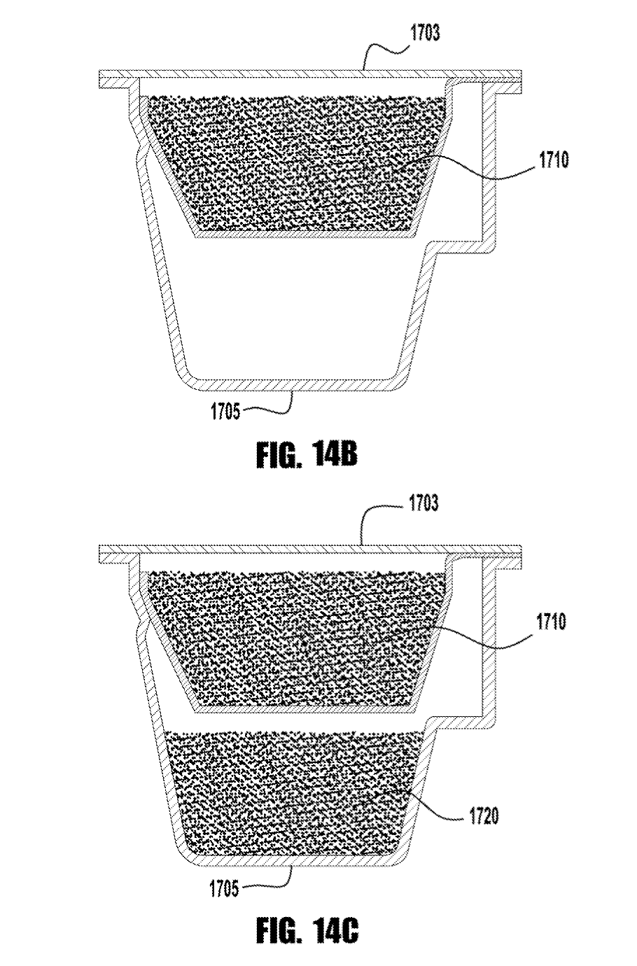

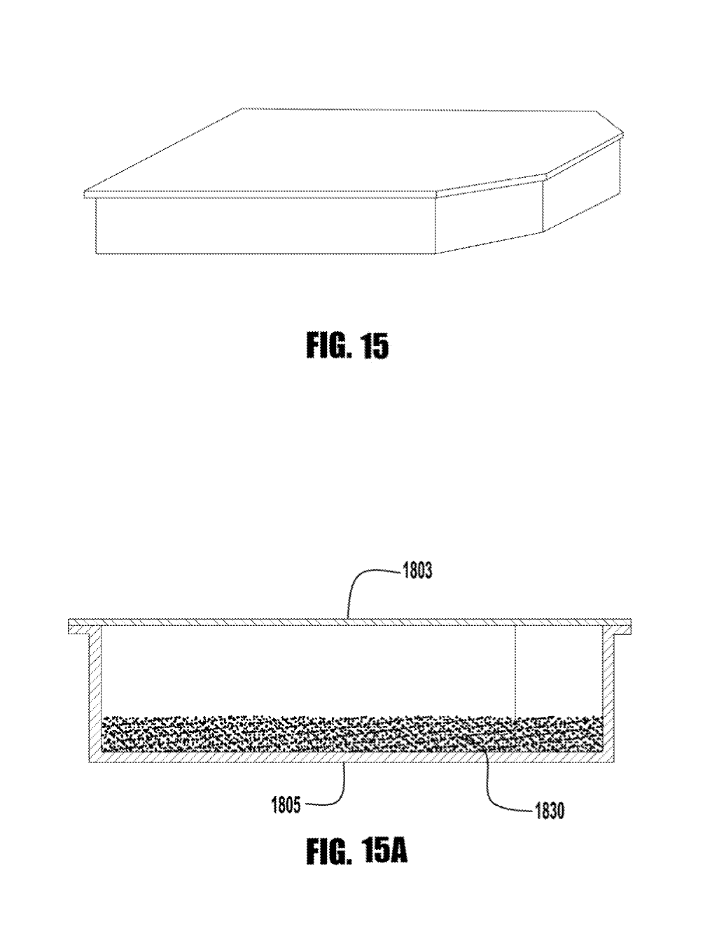

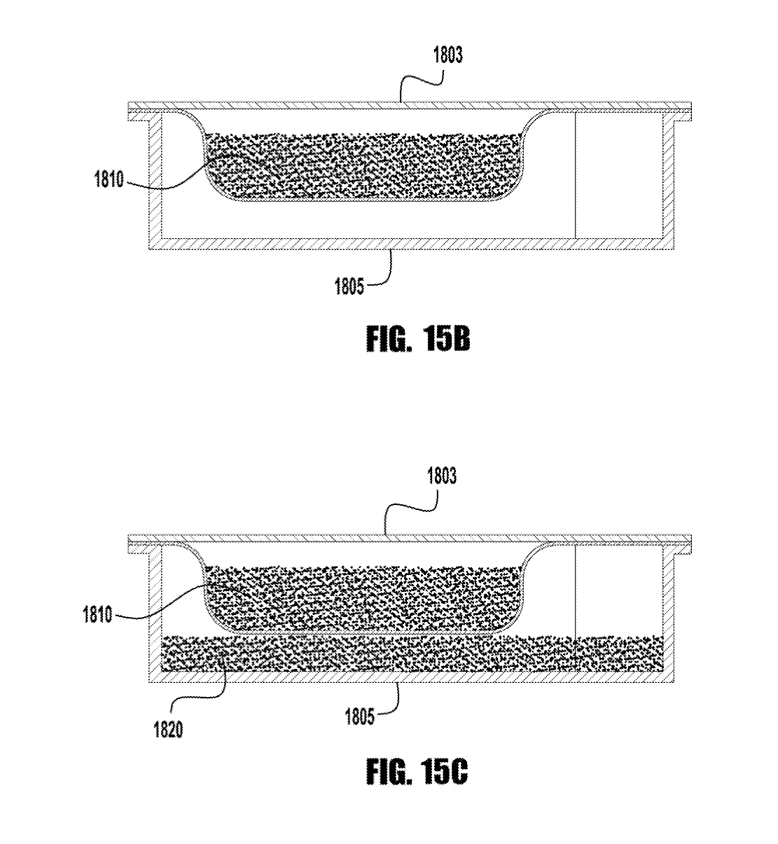

FIG. 15 is the perspective view of a beverage unit in an embodiment of the present invention, which may or may not include a filter member.

FIG. 15A is a side cross-sectional view of a beverage unit as shown in FIG. 15, which does not include a filter member. With reference to FIG. 15A, coffee composition 1830 is loaded and confined inside the beverage unit.

FIG. 15B is a side cross-sectional view of a beverage unit as shown in FIG. 15, which includes a filter member. With reference to FIG. 15B, coffee composition 1810 is loaded and confined inside the beverage unit.

FIG. 15C is a side cross-sectional view of another beverage unit as shown in FIG. 15, which includes a filter member. With reference to FIG. 15C, coffee composition 1810 and coffee material 1820 are loaded and confined inside the beverage unit.

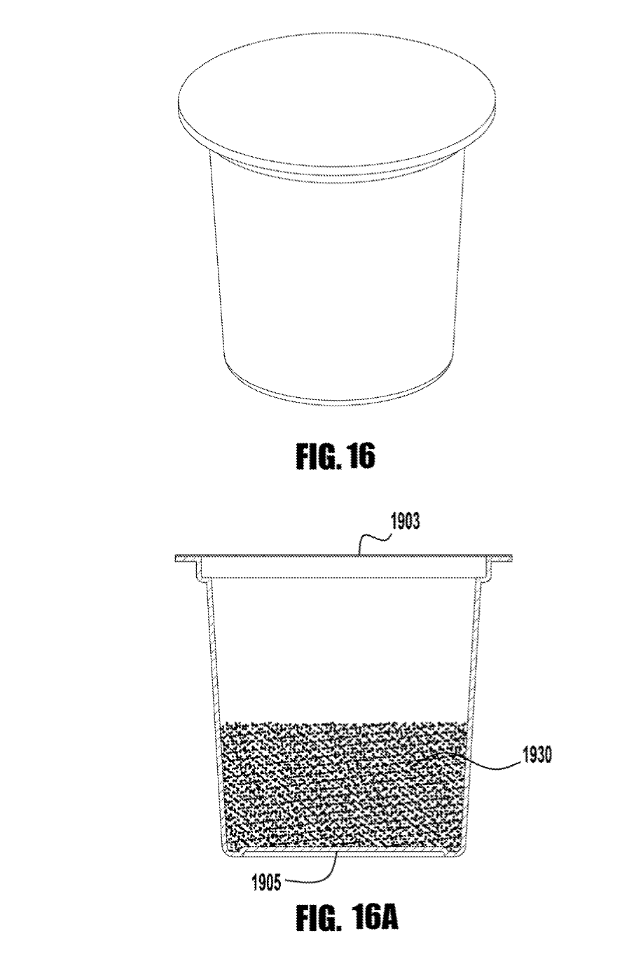

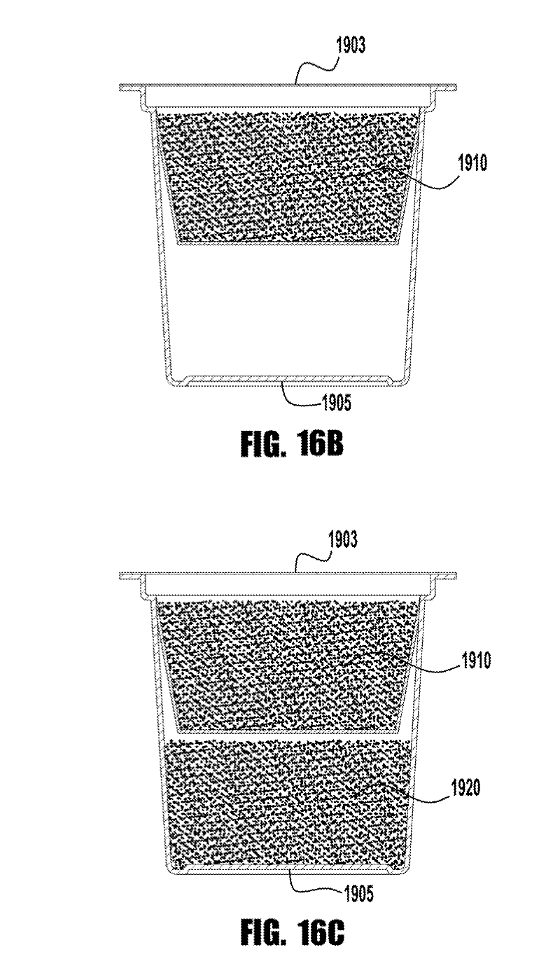

FIG. 16 is the perspective view of a beverage unit in an embodiment of the present invention, which may or may not include a filter member.

FIG. 16A is a side cross-sectional view of a beverage unit as shown in FIG. 16, which does not include a filter member. With reference to FIG. 16A, coffee composition 1930 is loaded and confined inside the beverage unit.

FIG. 16B is a side cross-sectional view of a beverage unit as shown in FIG. 16, which includes a filter member. With reference to FIG. 16B, coffee composition 1910 is loaded and confined inside the beverage unit.

FIG. 16C is a side cross-sectional view of another beverage unit as shown in FIG. 16, which includes a filter member. With reference to FIG. 16C, coffee composition 1910 and coffee material 1920 are loaded and confined inside the beverage unit.

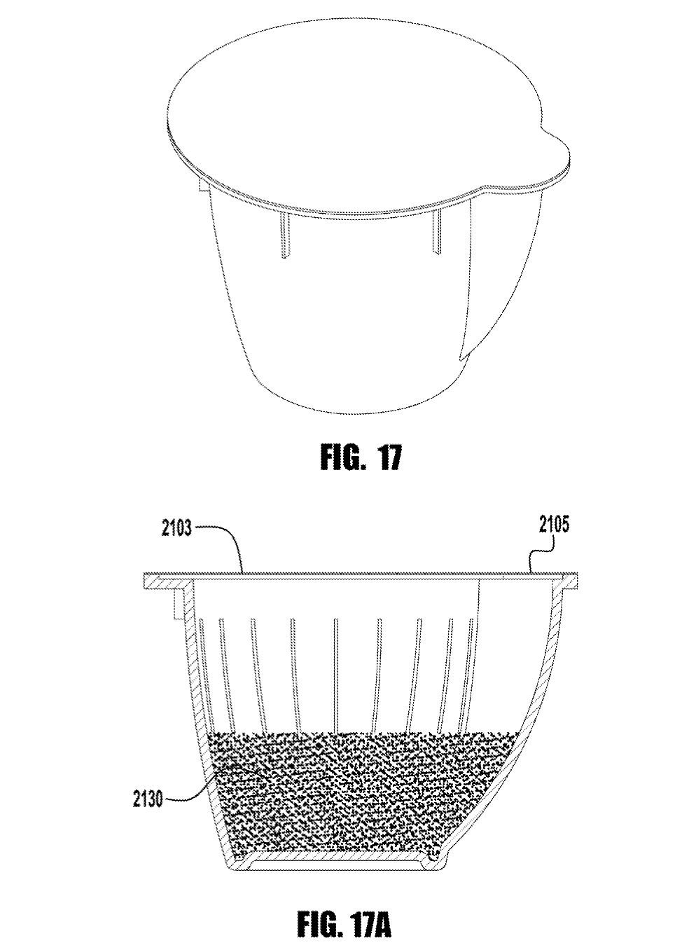

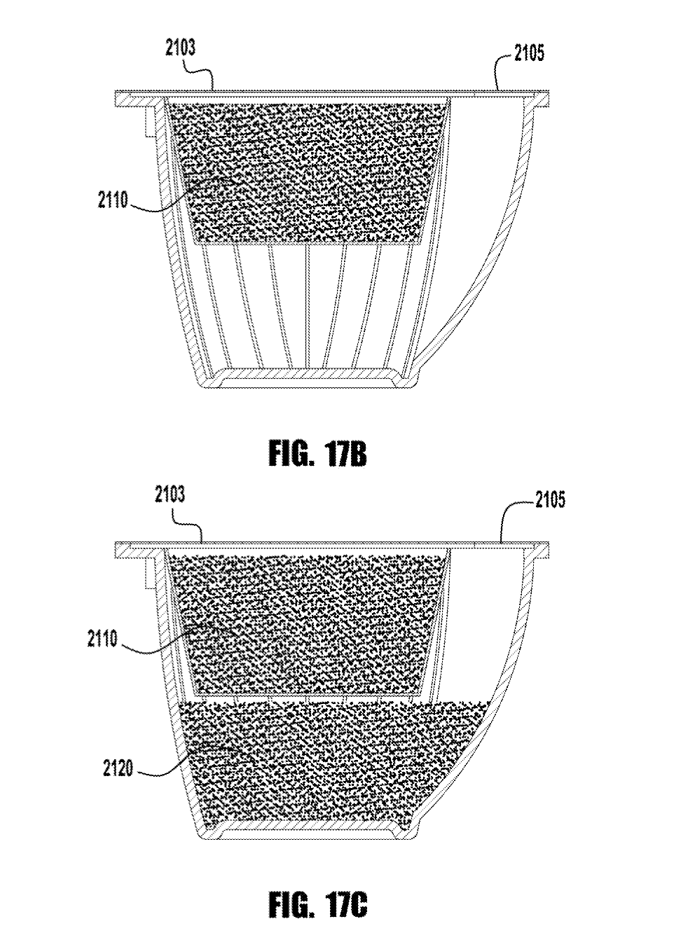

FIG. 17 is the perspective view of a beverage unit in an embodiment of the present invention, which may or may not include a filter member.

FIG. 17A is a side cross-sectional view of a beverage unit as shown in FIG. 17, which does not include a filter member. With reference to FIG. 17A, coffee composition 2130 is loaded and confined inside the beverage unit.

FIG. 17B is a side cross-sectional view of a beverage unit as shown in FIG. 17, which includes a filter member. With reference to FIG. 17B, coffee composition 2110 is loaded and confined inside the beverage unit.

FIG. 17C is a side cross-sectional view of another beverage unit as shown in FIG. 17, which includes a filter member. With reference to FIG. 17C, coffee composition 2110 and coffee material 2120 are loaded and confined inside the beverage unit.

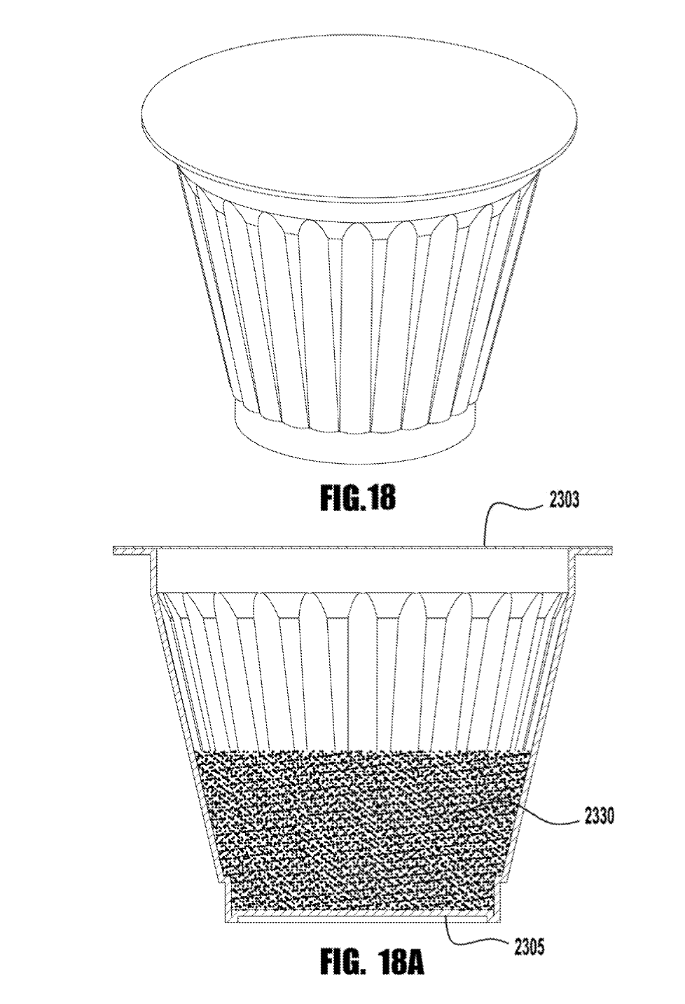

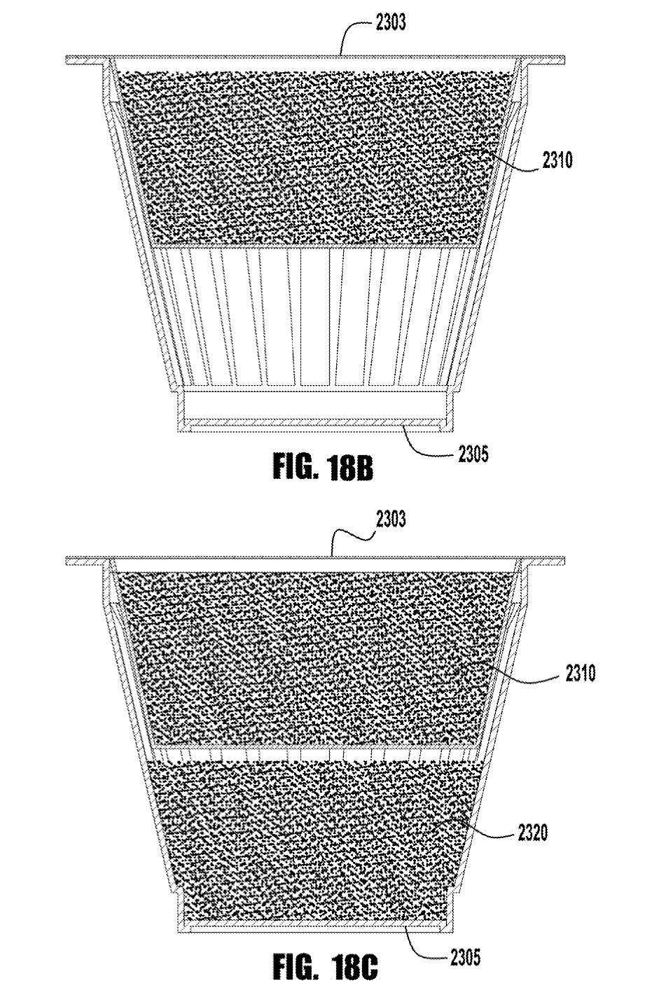

FIG. 18 is the perspective view of a beverage unit in an embodiment of the present invention, which may or may not include a filter member.

FIG. 18A is a side cross-sectional view of a beverage unit as shown in FIG. 18, which does not include a filter member. With reference to FIG. 18A, coffee composition 2330 is loaded and confined inside the beverage unit.

FIG. 18B is a side cross-sectional view of a beverage unit as shown in FIG. 18, which includes a filter member. With reference to FIG. 18B, coffee composition 2310 is loaded and confined inside the beverage unit.

FIG. 18C is a side cross-sectional view of another beverage unit as shown in FIG. 18, which includes a filter member. With reference to FIG. 18C, coffee composition 2310 and coffee material 2320 are loaded and confined inside the beverage unit.

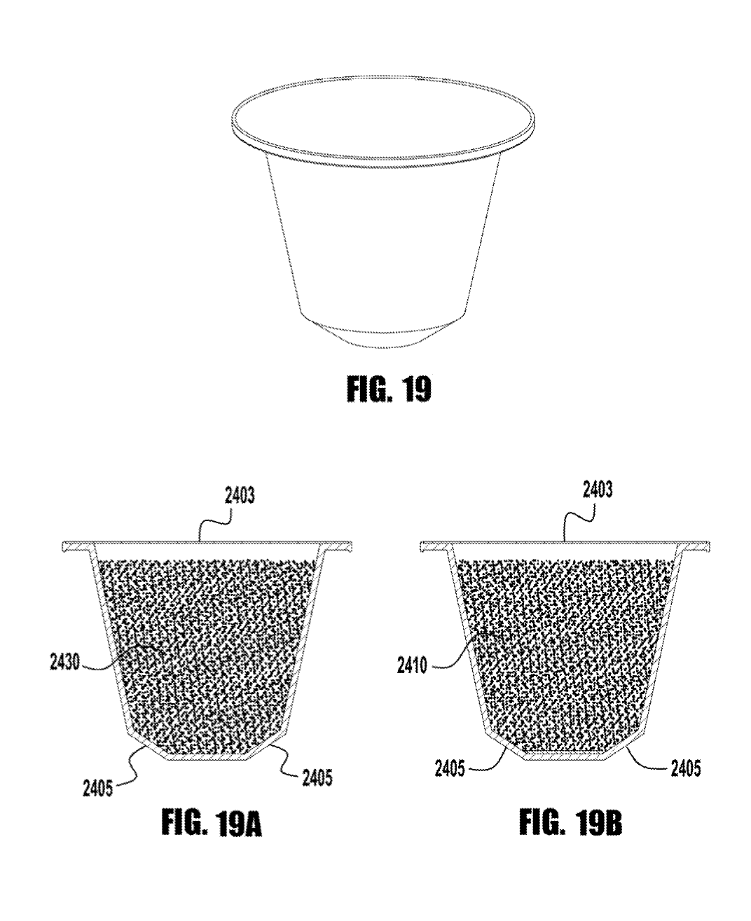

FIG. 19 is the perspective view of a beverage unit in an embodiment of the present invention, which may or may not include a filter member.

FIG. 19A is a side cross-sectional view of a beverage unit as shown in FIG. 19, which does not include a filter member. With reference to FIG. 19A, coffee composition 2430 is loaded and confined inside the beverage unit.

FIG. 19B is a side cross-sectional view of a beverage unit as shown in FIG. 19, which includes a filter member. With reference to FIG. 19B, coffee composition 2410 is loaded and confined inside the beverage unit.

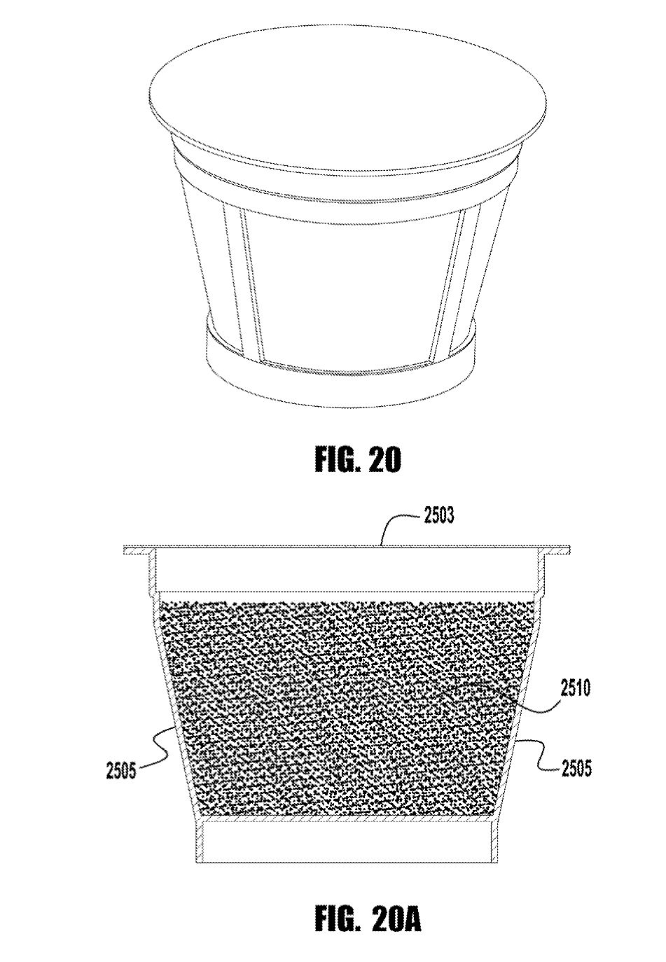

FIG. 20 is the perspective view of a beverage unit in an embodiment of the present invention, which includes a filter member.

FIG. 20A is a side cross-sectional view of a beverage unit as shown in FIG. 20. With reference to FIG. 20A, coffee composition 2510 is loaded and confined inside the beverage unit.

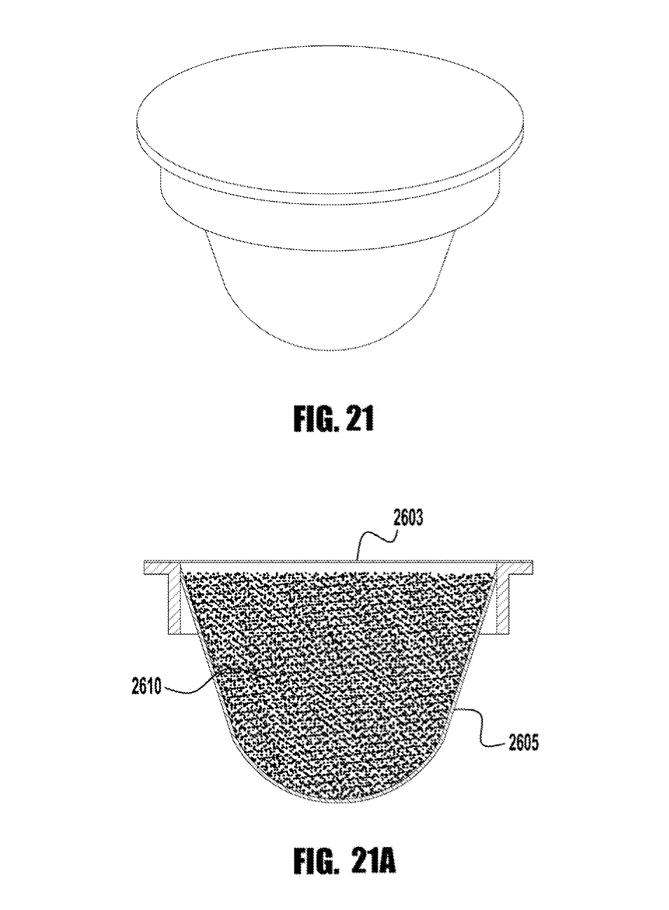

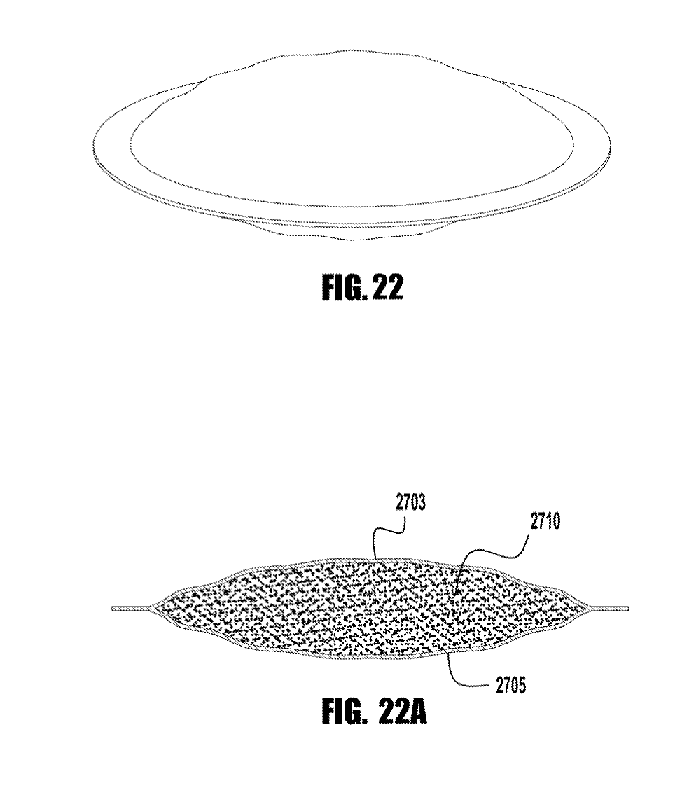

FIG. 21 is the perspective view of a beverage unit in an embodiment of the present invention, which includes a filter member.

FIG. 21A is a side cross-sectional view of a beverage unit as shown in FIG. 21. With reference to FIG. 21A, coffee composition 2610 is loaded and confined inside the beverage unit.

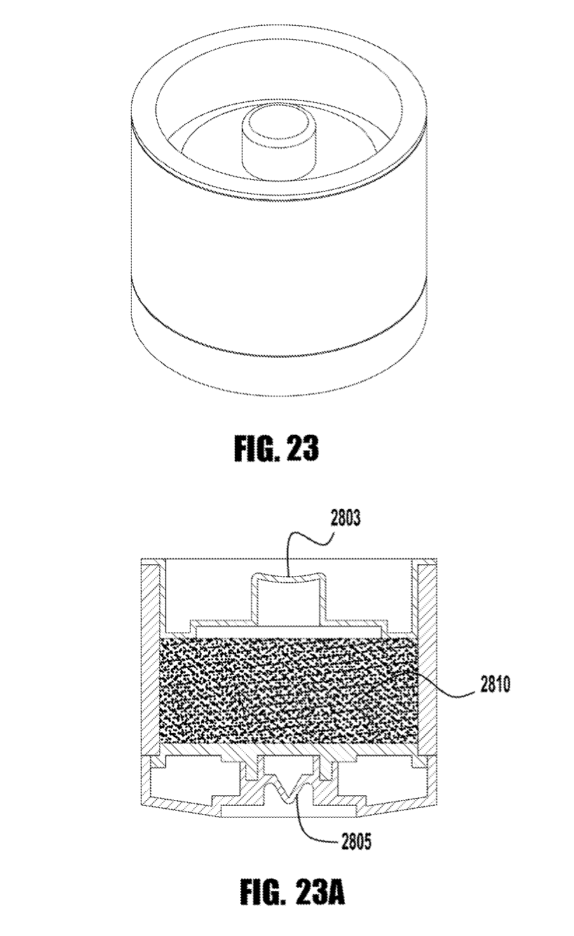

FIG. 22 is the perspective view of a beverage unit in an embodiment of the present invention, which includes a filter member.

FIG. 22A is a side cross-sectional view of a beverage unit as shown in FIG. 22. With reference to FIG. 22A, coffee composition 2710 is loaded and confined inside the beverage unit.

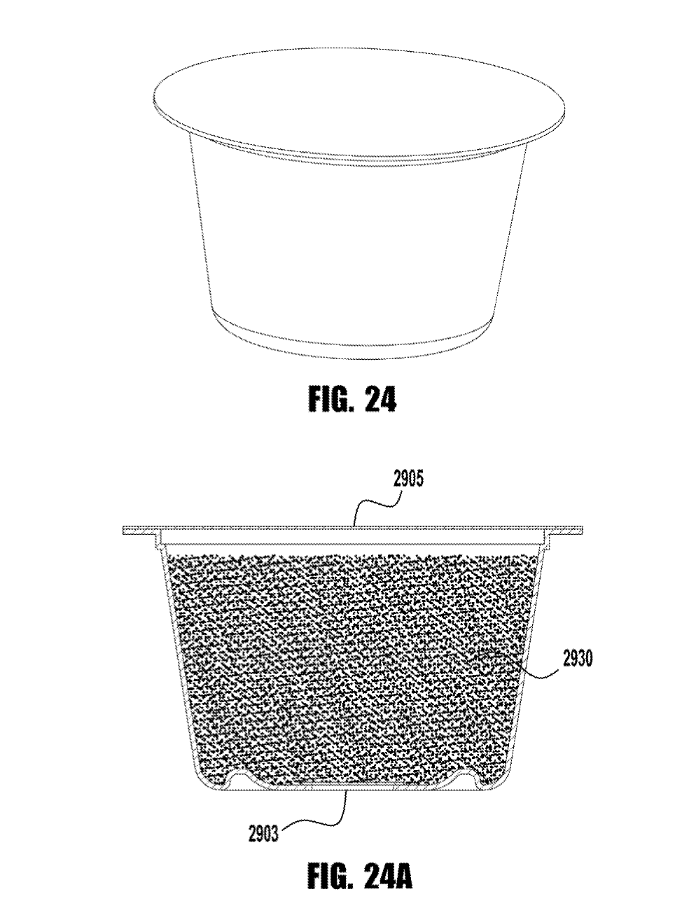

FIG. 23 is the perspective view of a beverage unit in an embodiment of the present invention, which includes a filter member.

FIG. 23A is a side cross-sectional view of a beverage unit as shown in FIG. 23. With reference to FIG. 23A, coffee composition 2810 is loaded and confined inside the beverage unit.

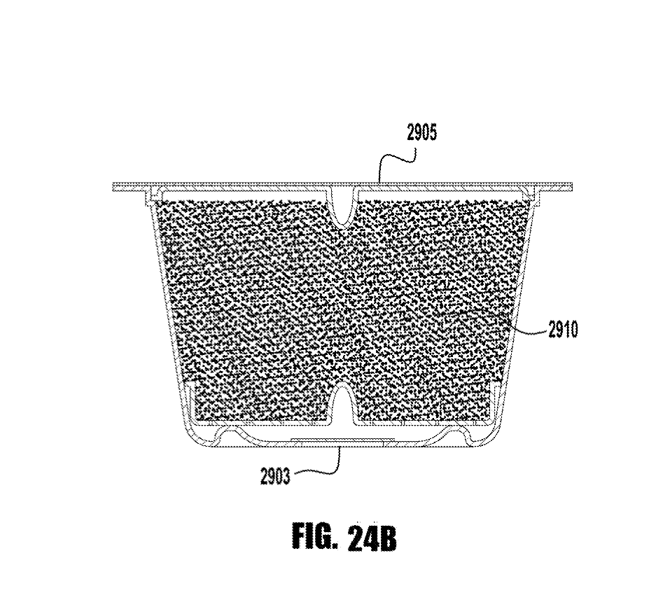

FIG. 24 is the perspective view of a beverage unit in an embodiment of the present invention, which may or may not include a filter member.

FIG. 24A is a side cross-sectional view of a beverage unit as shown in FIG. 24, which does not include a filter member. With reference to FIG. 29A, coffee composition 2930 is loaded and confined inside the beverage unit.

FIG. 24B is a side cross-sectional view of a beverage unit as shown in FIG. 24, which includes a filter member. With reference to FIG. 24B, coffee composition 2910 is loaded and confined inside the beverage unit.

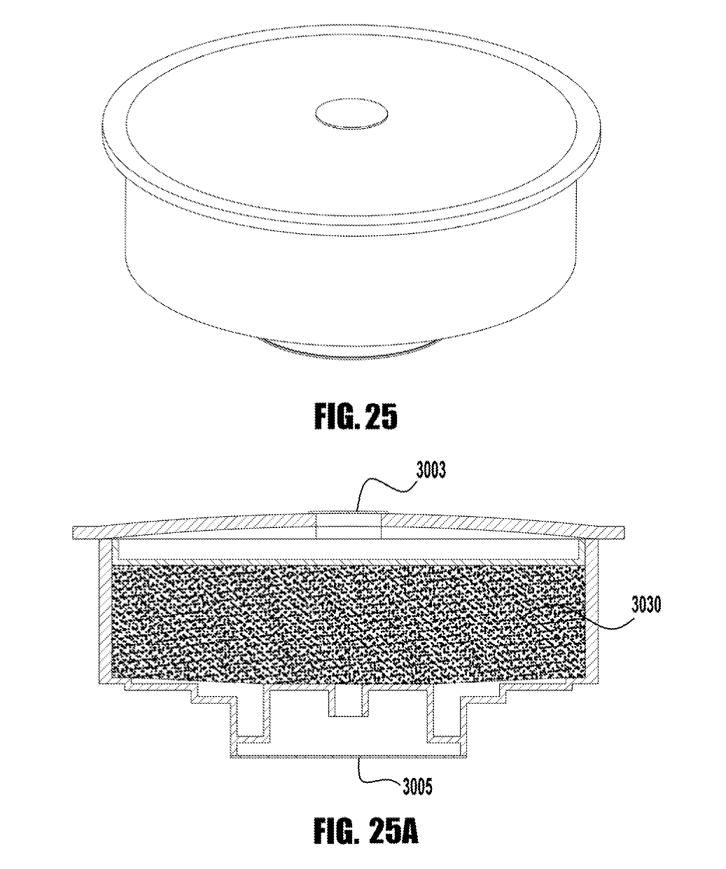

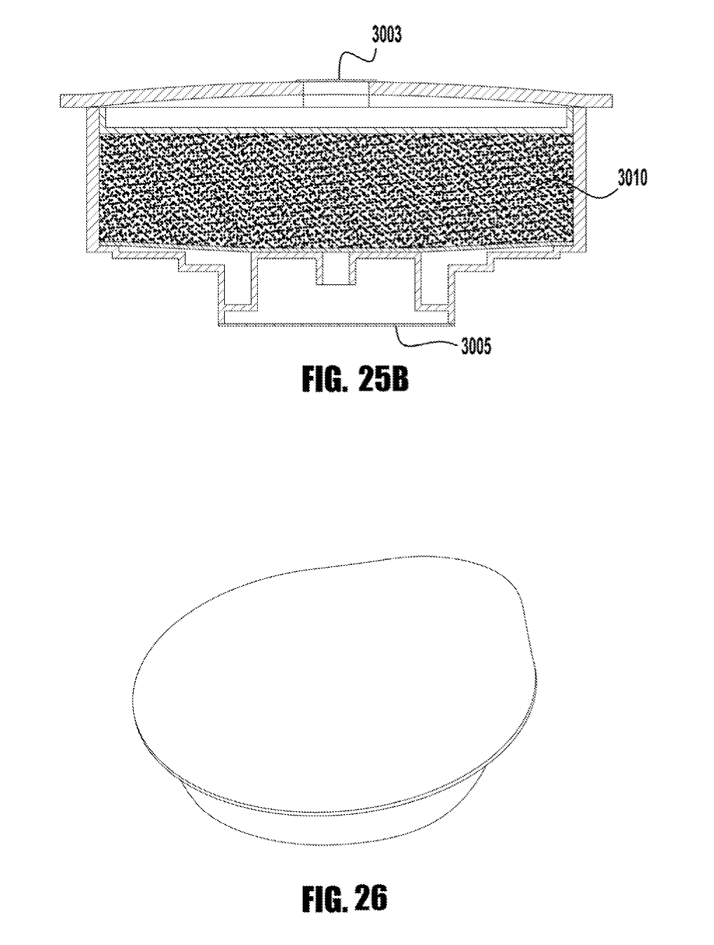

FIG. 25 is the perspective view of a beverage unit in an embodiment of the present invention, which may or may not include a filter member.

FIG. 25A is a side cross-sectional view of a beverage unit as shown in FIG. 25, which does not include a filter member. With reference to FIG. 25A, coffee composition 3030 is loaded and confined inside the beverage unit.

FIG. 25B is a side cross-sectional view of a beverage unit as shown in FIG. 25, which includes a filter member. With reference to FIG. 25B, coffee composition 3010 is loaded and confined inside the beverage unit.

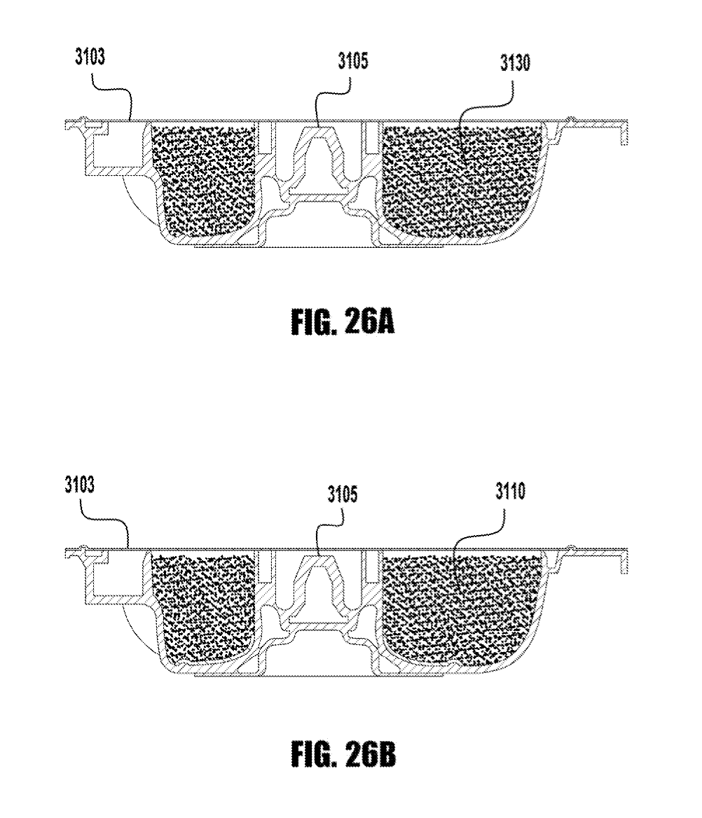

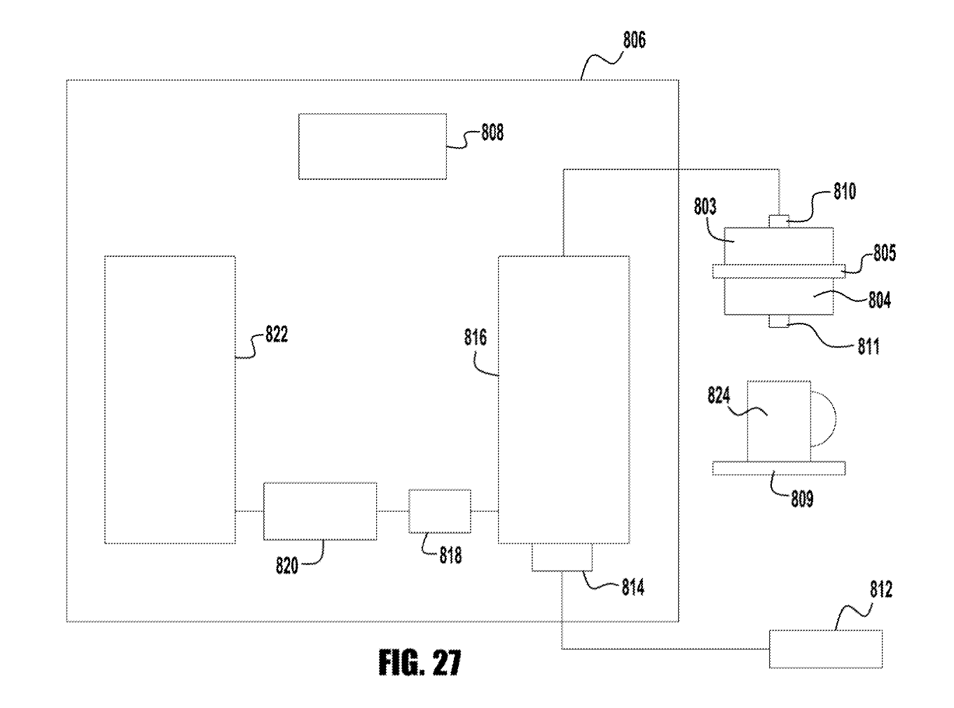

FIG. 26 is the perspective view of a beverage unit in an embodiment of the present invention, which may or may not include a filter member.

FIG. 26A is a side cross-sectional view of a beverage unit as shown in FIG. 26, which does not include a filter member. With reference to FIG. 26A, coffee composition 3130 is loaded and confined inside the beverage unit.

FIG. 26B is a side cross-sectional view of a beverage unit as shown in FIG. 26, which includes a filter member. With reference to FIG. 26B, coffee composition 3110 is loaded and confined inside the beverage unit.

### Beverage Making Systems

The various beverage units described above may be used with any suitable beverage-making systems to prepare a coffee-containing beverage. FIG. 27 shows the schematic diagram of an exemplary beverage-making system. With reference to FIG. 27, the system includes an outer frame or housing 806 with a user interface 808 that the user may operate to control various features of the system. A beverage unit may be provided to the system and used to form a beverage that is deposited into a cup 824 or other suitable receptacle that is placed on a cup support 809 such as a drip tray. The unit may be manually or automatically placed in a unit receiving portion defined by top unit receiving portion 803 and bottom unit receiving portion 804. After placement of the beverage unit, an actuator 805 may be moved to a closed position, thereby at least partially enclosing the beverage unit within chamber e.g. a brew chamber. Once the beverage unit is received, the system may use the unit to form a beverage. For example, heated water or other liquid may be introduced into the beverage unit via liquid inlet 810 and a formed liquid extract then exits the beverage unit via beverage outlet 811. Other components of the system may be included in a housing 806. For example, a pressure regulator 820 may receive water from water source (reservoir) 822 and adjust the water pressure. The water then may be pumped into hot water tank 816 with pump 818, and heated by heating element 814, which is powered by power source 812 outside housing 806.

Having now described several embodiments of the present invention it should be clear to those skilled in the art that the forgoing is illustrative only and not limiting, having been presented only by way of exemplification. Numerous other embodiments and modifications are contemplated as falling within the scope of the present invention as defined by the appended claims hereto.

1. A coffee composition for use in a beverage unit, wherein the beverage unit comprises a container having a first structure to enable introduction of water into the container to contact the coffee composition, and a second structure to enable release of a liquid coffee extract out of the container,
wherein the liquid coffee extract is prepared by introducing water into the beverage unit containing the coffee composition.

2. The coffee composition of claim 1, wherein the coffee composition is a high-yield roasted coffee with balanced flavor made from a process comprising:
(a) drying green coffee beans prior to roasting to a moisture content of from about 0.5 to about 7% by weight, wherein the drying is conducted at a temperature of from about 21° to about 163° C. for from about 1 minute to about 24 hours;
(b) roasting the dried beans from drying step (a) at a temperature of from about 177° to about 649° C. for from about 10 seconds to about 5.5 minutes to a Hunter L-color of from about 10 to about 16; and
(c) blending the dried roasted beans from roasting step (b) with non-dried coffee beans roasted to a Hunter L-color of from about 17 to about 24 and having a moisture content before roasting of greater than about 7% by weight, wherein the blend comprises from about 1 to about 20% by weight of the dried roasted beans and from about 80 to about 99% by weight of the non-dried roasted beans;
wherein the liquid coffee extract prepared from the beverage unit containing the coffee composition has an improved brew yield of from about 30 to about 100%.

3. The coffee composition of claim 1, wherein the coffee composition is a roasted coffee product having from about 1 to about 20% dark roasted coffee as a first component and from about 80 to about 99% coffee roasted to a Hunter L-color of from about 17 to about 24 and derived from green coffee beans having a moisture content prior to roasting of greater than about 7% as a second component, based on the total weight of the first component and the second component,
wherein said dark roasted coffee is made by a method comprising the steps of:
(a)(i) drying green coffee beans prior to roasting to a moisture content of from about 0.5 to about 7% by weight, wherein the drying is conducted at a temperature of from about 21° to about 163° C. for from about 1 minute to about 24 hours; and
(a)(ii) roasting the dried beans from step (a)(i) at a temperature of from about 177° to about 649° C. for from about 10 seconds to about 5.5 minutes to a Hunter L-color of from about 10 to about 16;
wherein the liquid coffee extract prepared from the beverage unit containing the coffee composition has an f(1) value greater than about 900, an f(2) value greater than about 1200, and an f(3) value greater than about 125, where
f(1)=10,000×[pyrazine+pyridine+pyrrole+guaiacol+ethyl guaiacol]/[3-thiazole+4-methylthiazole+peak 13+peak 14+peak 15+tetrahydrothiophene+peak 17+2-thiophenecarboxaldehyde+peak 19+3-acetylthiophene+2-acetylthiophene+peak 22],
f(2)=100×[ethyl guaiacol], and
f(3)=100×[ethanal+propanal+2-pentanone+3-pentanone+2,3-pentanedione]/[pyrazine+pyridine+pyrrole+guaiacol+ethyl guaiacol]; and
wherein the liquid coffee extract prepared from the beverage unit containing the coffee composition has abrewed acidity index greater than about 2200, where brewed acidity index=1000×volume (ml) of 0.1 Normal sodium hydroxide added to 150 grams of coffee brew to adjust the pH of the brew to 7.00; and
wherein the liquid coffee extract prepared from the beverage unit containing the coffee composition has an improved brew yield of from about 30 to about 100%.

4. The coffee composition of claim 1, wherein the coffee composition is a coffee made from reduced density roasted coffee beans made by a method comprising the steps of:
(a) first, drying green coffee beans to a moisture content of from about 0.5% to about 7% by weight, wherein the drying is conducted at a temperature of from about 70° F. to about 325° F. for at least about 1 minute; then
(b) roasting the dried beans at a temperature of from about 350° F. to about 1200° F. for from about 10 seconds to not longer than about 5.5 minutes; and then
(c) cooling the roasted beans, wherein the resulting roast beans have:
(1) a Hunter L-color of from about 14 to about 25;
(2) a Hunter Δ L-color of less than about 1.2; and
(3) a whole roast tamped bulk density of from about 0.27 to about 0.38 g/cc.

5. The coffee composition of claim 1, wherein the coffee composition is a reduced density roast and ground coffee made by a method comprising the steps of:
(a) cracking roasted coffee beans to a size such that about 40% to about 80% are retained on a 6-mesh screen; then
(b) normalizing the cracked beans; and then
(c) grinding the cracked and normalized beans; the coffee product produced having a density between about 0.24 g/cc and about 0.41 g/cc.

6. The coffee composition of claim 1, wherein the coffee composition is a non-agglomerated flavored coffee composition made by a method comprising the steps of:
a) combining:
(i) from about 80% to about 99.9% of a coffee component, wherein said coffee component has a moisture level in the range of from about 1% to about 5%, a particle density in the range of from about 0.28 g/cc to about 0.33 g/cc, a mean particle size distribution in the range of from about 650 microns to about 800 microns; and
(ii) from about 0.1% to about 20% of a flavoring component, wherein said flavor component has a moisture level in the range of from about 1% to about 4%, a particle density in the range of from about 0.4 g/cc to about 0.5 g/cc, a mean particle size distribution in the range of from about 40 microns to about 50 microns;
wherein the size ratio of said coffee component to said flavor component is in the range of from about 100:1 to about 5:1;
b) mixing said coffee component and said flavoring component for a period of time sufficient for said flavored coffee composition to exhibit a Distribution Value of less than about 20% RSD;
wherein said coffee component is selected from the group consisting of roast and ground coffee, instant coffee, and mixtures thereof;
wherein said flavoring component is selected from the group consisting of dried flavoring compounds, crystalline flavor compounds, encapsulated flavoring compounds, encapsulated liquid flavoring compounds, and mixtures thereof; and
further comprising one or more additional ingredients selected from the group consisting of creamers, aroma enhancers, natural sweeteners, artificial sweeteners, thickening agents, and mixtures thereof.

7. The coffee composition of claim 1, wherein the coffee composition is a light-milled roast and ground coffee having a bulk appearance and density like that of roast and ground coffee but providing from about 10% to about 30% increased flavor strength over an equivalent amount of roast and ground coffee; said light-milled roast and ground coffee is made by a method comprising:
passing roast and ground coffee through a roll mill under one of a three-variable set of mutually exclusive processing conditions; said mutually exclusive processing sets comprising: a roll pressure of from 750 pounds/inch of nip to 1,400 pounds/inch of nip, at a roll peripheral surface speed of from 200 feet/minute to 350 feet/minute, and at a roast and ground coffee feed rate to the mill of from 100 pounds/hour per inch of nip to 275 pounds/hour per inch of nip; a roll pressure of from 850 pounds/inch of nip to 1,700 pounds/inch of nip, at a roll peripheral surface speed of from 350 feet/minute to 600 feet/minute at a roast and ground coffee feed rate to the mill of from 275 pounds/hour per inch of nip to 400 pounds/hour per inch of nip; a roll pressure of from 1,000 pounds/inch of nip to 2,000 pounds/inch of nip at a roll peripheral surface speed of from 600 feet/minute to 750 feet/minute at a roast and ground coffee feed rate to the mill of from 400 pounds/hour per inch of nip to 500 pounds/hour per inch of nip, respectively.

8. The coffee composition of claim 1, wherein the coffee composition is a light milled roast and ground coffee having a bulk appearance of conventional roast and ground coffee particles and which has 10 to 30% increase in flavor strength over an equivalent amount of conventional roast and ground coffee particles, made from a method comprising passing roast and ground coffee through a roll mill at a roll pressure of from 750 pounds/inch of nip to 1,400 pounds/inch of nip, at a roll peripheral surface speed of from 200 feet/minute to 350 feet/minute and at a roast and ground coffee feed rate to the mill of from 100 pounds/hour per inch of nip to 275 pounds/hour per inch of nip.

9. The coffee composition of claim 1, wherein the coffee composition is a light milled roast and ground coffee having a bulk appearance of conventional roast and ground coffee particles and which has 10 to 30% increase in flavor strength over an equivalent amount of conventional roast and ground coffee particles, made from a method comprising passing roast and ground coffee through a roll mill at a roll pressure of from 850 pounds/inch of nip to 1,700 pounds/inch of nip, at a roll peripheral surface speed of from 350 feet/minute to 600 feet/minute and at a roast and ground coffee feed rate to the mill of from 275 pounds/hour per inch of nip to 400 pounds/hour per inch of nip.

10. The coffee composition of claim 1, wherein the coffee composition is a light milled roast and ground coffee having a bulk appearance of conventional roast and ground coffee particles and which has 10 to 30% increase in flavor strength over an equivalent amount of conventional roast and ground coffee particles, made from a method comprising passing roast and ground coffee through a roll mill at a roll pressure of from 1,000 pounds/inch of nip to 2,000 pounds/inch of nip, at a roll peripheral surface speed of from 600 feet/minute to 750 feet/minute and at a roast and ground coffee feed rate to the mill of from 400 pounds/hour per inch of nip to 550 pounds/hour per inch of nip.

11. The coffee composition of claim 1, wherein the coffee composition is an improved roast coffee product of enhanced extractability, flavor and aroma characterized by predominance of the delicate flavor and aroma notes naturally characteristic solely of high grade coffees comprising:
a. as a minor portion thereof, noncompressed, high grade roast and ground coffee particles of unimpaired natural flavor and aroma; and
b. as a major portion thereof, roast and ground coffee selected from a class of coffee consisting of the low and intermediate grade coffees, said low and intermediate grade coffees being in the form of compressed flakes wherein the undesirable natural flavor and aroma constituents thereof have been diminished and the extractability thereof enhanced.

12. The coffee composition of claim 1, wherein the coffee composition is an improved roast coffee product characterized by enhanced extractability and a predominance of the delicate flavor and aroma characteristics of high quality coffee utilizing in predominating proportions flaked roast and ground coffee of low and intermediate quality varieties, made from a method comprising the steps of:
a. roasting and grinding into particles low quality coffees and thereafter substantially enhancing the extractability of said coffee particles while simultaneously substantially reducing their natural volatile flavor constituents by expelling a substantial portion of the natural flavor-producing constituents normally entrapped therein by compressing said coffee particles into flakes;
b. roasting and grinding into particles intermediate quality coffees and thereafter substantially enhancing the extractability of said coffee particles while simultaneously decreasing their aroma and increasing their natural flavor producing capacity by expelling a substantial portion of the natural gases normally entrapped therein by compressing said coffee particles into flakes;
c. roasting and grinding coffee of the high quality variety to form non-compressed coffee particles of unimpaired flavor and aroma; and
d. admixing said low and intermediate quality coffee flakes in predominating proportions with said high quality coffee particles to form a highly extractable coffee product of prime quality flavor and aroma.

13. The coffee composition of claim 1, wherein the coffee composition is an improved roast coffee product characterized by enhanced extractability and a predominance of the delicate flavor and aroma characteristics of high quality coffee utilizing in predominating proportions flaked roast and ground coffee of low quality variety, made from a method comprising the steps of:
a. roasting and grinding into particles low quality coffees and thereafter substantially enhancing the extractability of said coffee particles while simultaneously substantially reducing their natural volatile flavor constituents by expelling a substantial portion of the natural flavor-producing constituents normally entrapped therein by compressing said coffee particles into flakes;
b. roasting and grinding coffee of the high quality variety to form noncompressed coffee particles of unimpaired flavor and aroma; and
c. admixing said low quality coffee flakes in predominating proportions with said high quality coffee particles to form a highly extractable coffee product of prime quality flavor and aroma.

14. The coffee composition of claim 1, wherein the coffee composition is an improved roast coffee product characterized by enhanced extractability and a predominance of the delicate flavor and aroma characteristics of high quality coffee utilizing in predominating proportions flaked roast and ground coffee of intermediate quality varieties, made from a method comprising the steps of:
a. roasting and grinding into particles intermediate quality coffees and thereafter substantially enhancing the extractability of said coffee particles while simultaneously decreasing their aroma and increasing their natural flavor producing capability by expelling a substantial portion of the natural gases normally entrapped therein by compressing said coffee particles into flakes;
b. roasting and grinding coffee of the high quality variety to form noncompressed coffee particles of unimpaired flavor and aroma; and
c. admixing said intermediate quality coffee flakes in predominating proportions with said high quality coffee particles to form a highly extractable coffee product of prime quality flavor and aroma.

15. The coffee composition of claim 1, wherein the coffee composition comprises a roast and ground coffee flakes having a flake bulk density of from 0.38 g./cc. to 0.50 g./cc. a flake thickness of from 0.008 inch to 0.025 inch and a flake moisture content from 2.5 to 7.0 percent.

16. The coffee composition of claim 1, wherein the coffee composition is roast and ground coffee flakes wherein said flakes have a flake bulk density of from 0.38 grams/cc to 0.50 grams/cc, a flake thickness of from 0.008 inch to 0.025 inch, and a flake moisture content of from 3.0 to 6.0 percent, made from a method comprising passing roasted and ground coffee having a moisture content of from 3.0 to 6 percent through a roll mill having a roll diameter of from 9 inches to 25 inches, at a roll pressure of from 2,000 lbs./inch of nip to 4,000 lbs./inch of nip, at a roll surface temperature of from 110° F. to 180° F. and at a roll peripheral surface speed of from 350 ft/min. to 800 ft/min., removing from said roll mill on a weight basis of the feed roast and ground coffee a yield of flaked coffee of over 80 percent to provide a flaked coffee product of high structural integrity which does not have a propensity towards changing bulk density after packing.

17. The coffee composition of claim 1, wherein the coffee composition is a thin flaked coffee product having improved structural integrity and wherein the thin flaked coffee is made from a method comprising the steps of:
(1) passing through a roll mill coarse roast and ground coffee having a coarse particle size distribution such that:
(a) from about 90% to 100% by weight is retained on a No. 30 U.S. Standard Screen,
(b) from about 51% to 89% by weight is retained on a No. 16 U.S. Standard Screen, and
(c) from about 20% to 50% by weight is retained on a No. 12 U.S. Standard Screen,
(2) operating said roll mill:
(a) at a static gap setting of less than about 0.1 mm.,
(b) a roll peripheral speed of from about 150 meters/min. to about 800 meters/min.,
(c) a roll temperature of below about 40° C., and
(d) at a pressure of about 100 kilonewtons/meter to about 400 kilonewtons/meter of nip, and
wherein the rolls of said roll mill have a roll diameter of at least about 15 cm, and
wherein the resultant thin flaked coffee comprises:
thin flakes of roast and ground coffee, wherein about 80% to about 98% by weight of said flakes have an average thickness of from about 0.1 mm. to about 0.175 mm.,
said improved roast and ground coffee product having a particle size distribution such that about 30% to about 90% by weight of said product passes through a No. 30 U.S. Standard sieve,
said product having a tamped bulk density of from about 0.35 g./cc. to about 0.50 g./cc., and
a moisture content of from about 2.5% to about 9.0% by weight; and
wherein the liquid coffee extract prepared from the beverage unit containing the coffee composition has enhanced extractability for a less acidic beverage.

18. The coffee composition of claim 1, wherein the coffee composition comprises from 10 to 80% by weight of roast and ground coffee flakes having high sheen and extractability, said roasted and ground flaked having a flake thickness of between 0.008 and 0.025 in. and having a reflectance value of at least 35 reflectance units, said reflectance units representing reflectance by coffee flakes of light from 0.88 helium/neon gas laser beam of 6328 Angstrom wavelength, calibrated against reflectance values of 2 and 89 units, respectively, for the Federal Bureau of Standards Paint Chips 15042 and 11670; and from 20 to 90% of non-flaked roast and ground coffee.

19. The coffee composition of claim 1, wherein the coffee composition comprises roast and ground coffee flakes of high sheen and extractability, made from a process which comprises: passing roast and ground coffee through a roll mill having a first roll operating at a peripheral surface speed of from 30 to 850 feet per minute and at a surface temperature of from 0° to 140° F. and having a second roll operating at a peripheral surface speed of from 2 to 8 times that of the first roll and a surface temperature of from 150° to 300° F.; and removing from said roll mill said roast and ground coffee flakes.

20. The coffee composition of claim 1, wherein the coffee composition is a roast and ground or flaked coffee product having a Hunter L-color of from about 13 to about 19 and which comprises from about 50 to 100% high acidity-type coffee, from 0 to about 30% low acidity-type coffee, and from 0 to about 50% moderate acidity-type coffee, wherein the liquid coffee extract prepared from the beverage unit containing the coffee composition has:
(1) a brew solids level of from about 0.4 to about 0.6%;
(2) a Titratable Acidity of at least about 1.52;
(3) a brew absorbance of at least about 1.25, provided that when the Titratable Acidity is in the range of from about 1.52 to about 2.0, said brew absorbance value is equal to or greater than the value defined by the equation:
1.25+[0.625×(2.0−TA)]
wherein TA is the Titratable Acidity.

21. The coffee composition of claim 1, wherein the coffee composition comprises non-decaffeinated roast and ground coffee flakes particularly suited for use in an urn brewer, wherein the flakes have:
(a) an average thickness of from about 0.004 inch to about 0.022 inch;
(b) an average moisture level of from about 3% to about 6% by weight; and
(c) a particle size fines level such that from about 30% to about 50% by weight of the particles pass through a No. 20 U.S. Standard Screen, and from about 20% to about 50% by weight of the particles pass through a No. 40 U.S. Standard Screen; and
(d) wherein the average flake thickness (“FT”), average moisture level (“MO”), and particle size fines level (“FF”) are adjusted according to the following equation:
0.36 to 0.96=0.686+(0.0244×FT)−(0.0150×FF)+(0.00217×MO×FF).

22. The coffee composition of claim 1, wherein the coffee composition comprises decaffeinated roast and ground coffee flakes particularly suited for use in an urn brewer, wherein the flakes have:
(a) an average thickness of from about 0.004 inch to about 0.022 inch;
(b) an average moisture level of from about 3% to about 6% by weight; and
(c) a particle size fines level such that from about 30% to about 50% by weight of the particles pass through a No. 20 U.S. Standard Screen, and from about 20% to about 50% by weight of the particles pass through a No. 40 U.S. Standard Screen; and
(d) wherein the average flake thickness (“FT”), average moisture level (“MO”), and particle size fines level (“FF”) are adjusted according to the following equation:
0.30 to 0.90=0.686+(0.0244×FT)−(0.0150×FF)+(0.00217×MO×FF).

23. The coffee composition of claim 1, wherein the coffee composition comprises non-decaffeinated roast and ground coffee flakes particularly suited for use in a ½-gallon brewer, wherein the flakes have:
(a) an average thickness of from about 0.004 inch to about 0.018 inch;
(b) an average moisture level of from about 3% to about 6% by weight; and
(c) a particle size fines level such that form about 30% to about 50% by weight of the particles pass through a No. 20 U.S. Standard Screen, and from about 20% to about 50% by weight of the particles pass through a No. 40 U.S. Standard Screen; and
(d) wherein the average flake thickness (“FT”), average moisture level (“MO”), and particle size fines level (“FF”) are adjusted according to the following equation:
0.57 to 0.90=1.254−(0.0361×MO)−(0.0221×FT)−(0.00504×FF)+(0.00068×MO×FF).

24. The coffee composition of claim 1, wherein the coffee composition comprises decaffeinated roast and ground coffee flakes particularly suited for use in a ½-gallon brewer, wherein the flakes have:
(a) an average thickness of from about 0.004 inch to about 0.018 inch;
(b) an average moisture level of from about 3% to about 6% by weight; and
(c) a particle size fines level such that from about 30% to about 50% by weight of the particles pass through a No. 20 U.S. Standard Screen, and from about 20% to about 50% by weight of the particles pass through a No. 40 U.S. Standard Screen; and
(d) wherein the average flake thickness (“FT”), average moisture level (“MO”), and particle size fines level (“FF”) are adjusted according to the following equation:
0.51 to 0.84=1.254−(0.0361×MO)−(0.0221×FT)−(0.00504×FF)+(0.00068×MO×FF).

25. The coffee composition of claim 1, wherein the coffee composition comprises coffee flake aggregates, made from a method comprising the steps of:
(A) comminuting roast low-moisture coffee beans at a temperature of below 40° F., said low-moisture coffee beans having a moisture content of from about 1% to about 3.5% by weight of said low-moisture coffee beans thereby forming a low-moisture roast and ground coffee;
(B) comminuting roast high-moisture coffee beans at a temperature of below 40° F., said high-moisture coffee beans having a moisture content of about 4.5% to 7% by weight of said high-moisture coffee, thereby forming a high-moisture roast and ground coffee;
(C) admixing said low-moisture roast and ground coffee and said high-moisture roast and ground coffee at a temperature of below 40° F., the mixture having an average moisture content of about 3% to 5% by weight;
(D) passing the coffee mixture of step (C) through a roll mill at a feed rate of about 10 lbs./hr.-inch of nip to 400 lbs./hr.-inch of nip, said roll mill having
(I) a roll pressure of from about 150 lbs./in. of nip to about 4000 lbs./in. of nip,
(II) a roll temperature of from about 40° F. to about 80° F.,
(III) a static gap setting of less than 0.001 inch,
(IV) a roll peripheral speed of from about 470 ft./min. to 1880 ft./min., and
(V) a roll diameter of from about 6 inches to 48 inches, to produce coffee flake aggregates having a flake thickness of about 0.009 inch to 0.016 inch; and thereafter
(E) screening said coffee flake aggregates to produce a flaked roast coffee product such that no more than 60% by weight of said product passes through a U.S. Standard 30 mesh screen; and
wherein the liquid coffee extract prepared from the beverage unit containing the coffee composition has increased extractability of water-soluble flavor constituents and increased initial aroma intensity over a coffee extract prepared from an equivalent amount of conventional roast and ground coffee.

26. The coffee composition of claim 1, wherein the coffee composition comprises especially strong structured instant coffee particles, made from a method comprising the steps of:
1. forming a mixture of instant coffee particles comprising
a. from about 5 to about 80 percent free-flowing compressed instant coffee flakes, said flakes having a thickness within the range of from about 0.002 inch to about 0.01 inch, and a density within the range of from about 0.8 g./cc. to about 1.7 g./cc., and
b. from about 20 percent to about 95 percent densified instant coffee powder, said powder having a bulk density of from about 0.3 g./cc. to about b 1.0 g./cc., and comprised of particles having a size range of from about 5 microns to about 500 microns,
2. forming a stream of said mixture having a thickness greater than about one-sixteenth inch,
3. introducing to said stream, at a point where the thickness of the stream is greater than about one-sixteenth inch, a jet of moistening fluid, said jet being introduced at a velocity of from 2,000 feet/minute to 10,000 feet/minute, and at an angle of from about 45° to an angle of about 135° with respect to the direction of travel of said stream,
4. collecting the resulting structured instant coffee product.

27. The coffee composition of claim 26, wherein the total weight of the coffee composition contained in the beverage unit is from about 3 grams to about 20 grams.

28. The coffee composition of claim 27, wherein the total weight of the coffee composition contained in the beverage unit is from about 8 grams to about 12 grams.
